(19) United States
(12) Patent Application Publication
(10) Pub. No.: US 2004/0093331 A1
(43) Pub. Date: May 13, 2004

(54) Computer program products, systems and methods for information discovery and relational analyses

(75) Inventors: Harold R. Garner, Flower Mound, TX (US); Jonathan D. Wren, Norman, OK (US)

Correspondence Address: EDWARDS & ANGELL, LLP, P.O. BOX 55874, BOSTON, MA, 02205, US

(73) Assignee: Board of Regents, University of Texas System

(21) Appl. No.: 10/665,981

(22) Filed: Sep. 19, 2003

Related U.S. Application Data
(60) Provisional application No. 60/412,398, filed on Sep. 20, 2002.

(51) Int. Cl. G06F 7/00

(52) U.S. Cl. 707/3

(57) ABSTRACT

The present invention is a system, method for accessing domains of information to identify heretofore unknown relationships between disparate sources of data to seek and obtain knowledge, the invention includes a source of data with one or more domains of information, an Object-Relationship Database for integrating objects from one or more domains of information and a knowledge discovery engine where relationships between two or more objects are identified, retrieved, grouped, ranked, filtered and numerically evaluated.

### RELATED APPLICATIONS

This application claims priority under 35 U.S.C. § 119(e) to U.S. Provisional Application Serial No. 60/412,398, filed, Sep. 20, 2002, the entirety of which is incorporated by reference herein.

### GOVERNMENT GRANTS

The United States Government may own certain rights in this invention under the NIH National Center For Genome Research (NHGRI) Genome Training Grant number: 2-T32-HG00038-06.

### FIELD OF THE INVENTION

The present invention relates in general to the field of knowledge discovery, and more particularly to relational analyses as a means of linking previously unrelated objects in order to identify and evaluate shared relationships.

### BACKGROUND OF THE INVENTION

Previously, the means of identifying new relationships between independent parcels of information or data has depended on unbounded searches that generate a high number of false positives. Unfortunately, while the amount of data (and objects comprised of data) available to explore is expanding daily, individuals are, as a rule, limited in their ability to accumulate and use the ever-expanding sources of data. Equally important is the limited ability to understand the many implications of the new data as well as the potential relationships between the new and previously known data. In the field of biology, for example, there has been an explosive growth in the amount of data in the past decade. In early 2002, DNA sequences were deposited for over 117,764 species and 352,924 known chemical compounds had been listed with identified molecular structure for 117,481 of these compounds. In addition, the location of more than 18,000 human genes with at least one function had been identified. One source of data (database) includes at least 13,034 human diseases, conditions, or syndromes. The largest literature data source that houses relevant biologic data is MEDLINE. In early 2002, this data source contained approximately 12 million records, and continues to increase at an annual rate of 500,000 records.

With the ever-expanding amount of data, there is a need for improved data management, providing not only a storehouse for data, but a manager that can “understand” the data by retrieving, interpreting, linking, and relating data objects, especially objects previously considered to be unrelated. In fact, the most economic approach to data management is one that successfully uses existing data to arrive at novel solutions. Therefore, knowledge discovery should rely on both existing and new data objects; it should retrieve objects (new and preexisting) from one or more linked or unlinked data sources, it should examine potential relationships that may be shared between objects, offer novel functions and solutions for the objects, and store the new relationships, functions, and solutions for future operations and/or additional analysis.

There are data mining techniques that offer some of the solutions required in this new information era. One such search tool, ARROWSMITH, relies on a method of searching for new information by “bridging” two defined areas of interest. Unfortunately, this tool only searches on a single level, hence unidirectionally, does not score the “results” and offers limited depth of analysis. Another search tool, OPUS, is used to identify genes related to a phenomenon. While effective as a genetic tool, it is of limited use in other fields of information. Similarly limited is a data mining technique described by Perez-Iratxeta and colleagues that associates genes to genetically inherited diseases using fuzzy logic in a binary relation, Nature Genetics, vol. 21, July 2002, pp 316-319.

### SUMMARY OF THE INVENTION

As evidenced by the foregoing explanation, there is a need for a cost-effective system for managing and analyzing large volumes of unrelated data and information. The system should work with multiple sources of data, offer a user-friendly format with multiple levels of analysis, and allow for novel discoveries of unrelated matter not currently possible with query-based methods or single-level searches. Working with such an automated knowledge discovery system, individuals and organizations become empowered with knowledge-based tools that improve their understanding of currently available data, enable them to establish novel relationships in where no link previously existed, and with the added economic benefits, are able to efficiently and effectively arrive at critical solutions with societal benefits.

The invention disclosed herein is an automated knowledge discovery system that establishes a network of relations between objects in order to identify, evaluate and score novel relationships. This network can also be used to identify and evaluate shared relationships among sets of objects as well as identify and evaluate objects that are known only implicitly, by virtue of their shared relationships. Scoring the identified and evaluated relationships is also integral to the system of the present invention. The system may be used with or without other indexes for research, discovery, screening, diagnosis and solution management. The system has non-limiting applications for strategic management of business organizations and government organizations, for predicting behavior in populations (e.g., consumers, patients, etc.), for predicting environmental impact, for identifying fraud, for identifying patterns in resource utilization, and for knowledge discovery in sciences, such as biotechnology, chemistry, physics, engineering, astronomy, geology, management science and the like.

An informatics approach is necessary to manage large volumes of unstructured and structured data, to identify new and shared relationships between objects in data, and arriving at novel solutions and potential functions for such objects. Informatics offers logical interpretations of objects and enables the derivation of new relationships.

In one aspect, the invention provides a system to establish a network of relationships between objects by extracting information from one or more data sources in an automated manner. The system determines implicit relationships between objects in a data source by in silico construction of an entity-based network. Preferably, the data source comprises text. More preferably, the data source comprises unstructured free text. The system enables individuals and organizations to input an “object” of interest and retrieve relational information about other objects it is directly or indirectly associated with, including the strength of the association. For example, when working in one or more fields of science and technology, objects may include a gene (or an allele, transcript, fragment, or methylated form thereof), protein (or a processed, unprocessed, modified, or unmodified form thereof), a chemical compound, a disease and/or clinical phenotype.

In general, the system of the present invention uses one or more data sources to represent a domain of knowledge. The plurality of data sources may include both unstructured and structured data. Entries (referred to as “objects”) are evaluated by the system and used to recognize data within the source, where the co-occurrence of entries within the source eventually identifies potential relationships between objects. The relationships are stored within a newly created or existing dynamic database in the system and used to create a comprehensive network of relationships for further analysis.

In one aspect, the invention further provides a multitask system with the ability to perform one or more, and preferably all of the following tasks: (a) obtain a full source (e.g., such as a domain of knowledge or a database) and parse it to accurately identify multiple objects; (b) create/format representative databases and/or entries; (c) process free-form text (such as ASCII); (d) process data, e.g., by screening for common or uninformative words or objects to reduce next step analysis; (e) identify capitalization requirements for objects to increase precision and recall; (f) resolve acronyms to increase precision, the number of informative objects, and number of recognized objects; (g) expand synonyms to increase recall; (h) use internal or external subroutines in order to enhance data processing speed and efficiency; (i) use queries for analysis of shared and implicit relationships; j) work with a user-friendly interface; (k) be interoperable with other design systems and networks; (l) use a scoring mechanism to provide measures of relevancy for output; (m) create output files with relational scores; (n) perform single or multi-step analysis; and/or (o) model into a network for large-scale or global analysis.

The system may perform its many functions (tasks) through, e.g., an Object-Relationship Database or “ORD”, an integrated database of objects (generally in text format) with direct and indirect relationships with other objects from the same source. ORD may also be used with multiple sources. Sources are generally databases containing millions of objects coded into records or as single entries.

The system provides primary and support code for one or more of (a) data formatting; (b) data processing; (c) data or information extraction from textual sources; (d) populating ORD; (e) source referencing; (f) routines for quality checks; (g) internal and external database maintenance; (h) network interfacing; (i) user interface; j) routines used in data entry, analysis, and output. Additional programs and routines are also encompassed within the scope of the system.

In one embodiment the present invention is a system for accessing domains of information in which a source of data that includes one or more domains of information is accessed by an Object-Relationship Database (ORD) for integrating objects from one or more domains of information and a knowledge discovery engine is used to discover relationships between two or more objects are identified, retrieved, grouped, ranked, filtered and numerically evaluated. As used herein, an object may be any item or information of interest (generally textual, including noun, verb, adjective, adverb, phrase, sentence, symbol, numeric characters, etc.). Therefore, an object is anything that can form a relationship and anything that can be obtained, identified, and/or searched from a source. The source of data may be one or more databases or domains of knowledge (which are not necessarily data bases) with textual information, numeric information, symbolic information, and combinations thereof. The relationships between one or more objects may be identified as direct or indirect, and may even be ranked based on the relative strength of the relationship between direct and indirect objects. Relationships may be categorized by ranking them into categories selected from the group consisting of positive, negative, physical and logical associations. The domains of information for use with the invention may use parcels of data as information are text, symbol, numeric and combinations thereof. In one aspect, the system is partially or fully automated. In another aspect, the knowledge discovery engine trims the one or more objects by lexical processing.

In a further aspect, the system for creating an Object-Relationship Database (ORD) executes one or more of the following non-limiting functions: compiling one or more system database objects, adding synonyms of the database objects, grouping information regarding relationships between objects in the one or more databases into an object-relationship database, constructing a database of lexical variants from the object-relationship database, scanning the object-relationship database with the database of lexical variants to reduce redundancies and checking the object-relationship database for errors. The efficiency of the system may be increased by, e.g., assigning each object a unique numeric ID (e.g., such as a long integer) and storing adirectional relationships by lowest ID first.

Data collections or source databases may serve as the source of data and are generally used to compile the system database objects, these source databases may include, e.g., databases of chemical compounds, small molecules drugs, ChemID, MeSH, and FDA locuslink, GDB, HGNC, MeSH and OMIM, to name a few. The step of screening out common words and identifying capitalization may be accomplished by accessing a word database. Lexical variants may be identified using, e.g., a synonym database or an acronym-resolving algorithm. In one aspect, the system also provides for a one-click query button or control element on a graphical user interface in communication with the system to enable a user to view an object in the system database which was derived from text from the data source. For example, a user may view displayed text from a data source on the graphical user interface, highlight a section of the text (e.g., a phrase or abstract), and click a control element such as a button which causes the system to display if one or more words in the phrase are stored as objects in the system database. New objects can be included in a system database as discussed below.

In one aspect, the system database comprises an Object-Relationship Database is constructed by inputting a block of text from a data source, extracting selected information, such as title, abstract, date, and PMID fields information, from the source to create a record, parsing the record into sentences, parsing each sentence into words, creating one or more arrays to match words against phrases in the object-relationship database, and resolving acronyms. Blocks of text may be selected from the group consisting of a word, a phrase, a chapter, a book, a paper, a magazine, a section of a webpage, and a table. A given block of text may be assigned a higher value if the source of the information is considered to have a higher impact than other like sources, for example, a higher weighting to connections between objects may be made in an abstract from a Science or New England Journal of Medicine article than between objects in an abstract from the Journal of Irreproducible Results.

Yet another embodiment of the present invention is a system for relating previously unrelated objects. In one aspect, the system includes an object-relationship database generated from a data source comprising one or more source databases of information and a knowledge discovery engine that recognizes meaningful relationships between objects within the object-relationship database. Preferably, the knowledge discovery engine identifies one or more co-occurrences of objects within the data source and generates a comprehensive network of relationships. In one aspect, the relationships identified are stored in a system database and evaluated by one or more statistically bounded network models (e.g., such as a Bayesian network model) and a query module that allows a user to identify implicit relationships from the relationships identified by the knowledge discovery engine.

The present invention may be used as a system for identifying, e.g., new therapies, new uses or indications, contraindications, side-effects and/or complications of existing drugs, as well as drug interactions, drug side effects, and pharmacogenomic effects for existing and candidate drugs. The system can be used to identify relationships between candidate therapeutic agents (.e.g, drugs, proteins, genes, ribozymes, antisense molecules, aptamers, etc.) and disease by querying a data source to identify objects relating to the agents and/or by querying a data source to identify objects relating to the disease. In one aspect, the system provides predictions as to new indications for existing drugs (e.g., such as those which are currently approved by the FDA for an existing indication). For example, the system may be used to identify new uses for sildenafil.

In one aspect, the system generates an object-relationship database from a data source comprising one or more source databases of information and uses a knowledge discovery engine that recognizes meaningful relationships within an object-relationship database for a drug or therapeutic agent, to identify one or more co-occurrences of objects within the object-relationship database and the drug name or synonyms thereof and generates a comprehensive network of relationships between data in the object-relationship database and the drug. In one preferred aspect, the system uses a statistically bounded network model to identify this network of relationships. Preferably, the system stores the shared and implicit relationships in a system database. The system database is dynamic in that as additional known or candidate drugs are evaluated, the network stored in the system database evolves to include interactions with these addition drugs. In another aspect, the source databases include clinical data such as patient medical history, demographic data, family medical history, genetic data from the patient and/or family members, exclusion or inclusion criteria for a study, adverse event data, efficacy data, pharmacokinetic data, etc. In a further aspect, the data includes data from longitudinal studies, retrospective studies, and studies of individual patients (e.g., the system can be used in the field of personalized medicine).

The invention also provides a method for identifying relationships within a relationship database of the system. The method includes the steps of identifying shared relationships between objects after a user inputs one or more lists of objects for analysis, compiling from the one or more lists all the relationships for each object, for inclusion in a single list, counting related objects by frequency and calculating an expectation value. In one aspect, shared objects with less than a y% of the total possible connections or less than a y% of the observed/expected ratio are excluded from the relationship database.

In one aspect, objects are identified which are implicitly related. The likelihood that such relationships are meaningful may be evaluated by scoring or ranking the relationships, e.g., such as by determining the direct observed-to-expected ratio and multiplying this value by the number of unique paths to the implicit object.

In another aspect, implicit relationships are identified by computing an association strength vector between one or more first, second and third objects, obtaining a source impact score from a database of source impact scores for the one or more objects for the first, second or third objects, and multiplying the strength vector by the source impact score for one or more of the first, second or third objects. The source impact score may be based on such non-limiting factors as: (1) the publication from which the one or more object were obtained; (2) the number of times the source of the one or more object has been cited by another source; (3) the number of times the source of the one or more object has been cited by a treatise, textbooks, review article and/or was published in a peer-reviewed journal. For example, a higher scoring implicit relationship may have been given a higher score based on the number of times the source of the one or more object was published in the British publication Nature (i.e., the source impact score for the relationship was high). While a relationship will have an impact score, an object, in general, will not have an impact score, because it is the relationship derived from the data source that varies in its quality (e.g., impact). An object can, on the other hand, be scored by the quality of the data source from which it came. The impact score is given an estimate of importance, as used herein to refer to an estimate of certainty or relevance.

The present invention also includes a computer program embodied on a computer readable medium for accessing domains of information from one or more data sources. In one aspect, the computer program includes a code segment adapted to contain a source of data comprising one or more domains of information, a code segment adapted to maintain (e.g., build, maintain, update) an Object-Relationship Database for integrating objects from one or more domains of information and a code segment adapted to contain a knowledge discovery engine where relationships between one or more objects are searched, grouped, ranked, filtered, and retrieved.

A computer program embodied on a computer readable medium for creating an Object-Relationship Database (ORD) may include a code segment adapted to compile one or more database objects, a code segment adapted to group the information in the one or more databases into an object-relationship database, a code segment adapted to construct a database of lexical variants from the object-relationship database, a code segment adapted to scan the object-relationship database with the database of lexical variants to reduce redundancies, a code segment adapted to assign each object a unique numeric ID (long integer) and storing uni- or adirectional relationships by lowest ID first; and a code segment adapted to check the object-relationship database for errors.

Yet another embodiment of the present invention is a list of candidate compounds for new drug therapy generated by a method that include the steps of: accessing a source of data comprising one or more domains of information, compiling domains of information into an Object-Relationship Database for integrating objects from one or more domains of information; and using a knowledge discovery engine where relationships between two or more objects are identified, retrieved, grouped, ranked, filtered and numerically evaluated. The list may exist in the form of a data structure for example that interacts with a computer program for querying, organizing, selecting, and/or managing the data.45

Yet another invention disclosed herein is a method of identifying new therapies for existing compounds or drugs, e.g., a method of treating cardiac hypertrophy by identifying a patient in need of therapy for cardiac hypertrophy and providing the patient with a pharmaceutically effective amount of a compound identified using the system of the present invention. For example, a compound identified using the system of the present invention for the treatment of cardiac hypertrophy is Chlorpromazine.

Yet another invention identified using the present invention is a mechanism and a method for treating of non-insulin dependent diabetes mellitus (NIDDM) by identifying a patient in need of therapy for NIDDM and providing the patient with a pharmaceutically effective amount of a compound identified using the system. In one aspect, the compound is a pharmaceutical composition that increases the methylation of cellular nucleic acids, e.g., such as a DNA methylation precursor. Yet another invention is a nutritional supplement for an individual at risk for NIDDM that includes one or more DNA methylation precursors at an amount effective to increase total cellular DNA methylation.

A method of the present invention includes treating headaches by identifying a patient in need of therapy for a headache; and providing the patient with a pharmaceutically effective amount of sildenafil. Alternatively, a method for treating muscular spasms includes identifying a patient in need of therapy for a muscular spasm; and providing the patient with a pharmaceutically effective amount of sildenafil.

The present invention also includes an automated system for screening that includes a system hereinabove to identify target genes for screening, an oligonucleotide selection module that selects the genes and nucleic acid sequences for making a screening array, and a DNA-on-chip assembly apparatus that receives the nucleic acid sequences from the oligonucleotide selection module and makes a nucleic acid array on a substrate, wherein the nucleic acid array may be used for genetic screening. In one example the target genes are used to screen for NIDDM, however, those of skill in the art will immediately recognize that the other disease conditions having known or even unknown gene associations may be used to prepare a screening array of the present invention.

### BRIEF DESCRIPTION OF THE DRAWINGS

For more complete understanding of the features and advantages of the present invention, reference is now made to the detailed description of the invention along with the accompanying FIGURES:

FIG. 1 depicts the exponential growth of data, including (A) nucleotide sequences listed in Genbank, (B) proteins in Swissprot, (C) the 3-D structural database PDB, (D) human gene and genetic disorders catalogued in Online Mendelian Inheritance in Man, and (E) articles listed in MEDLINE in accordance with the present invention;

FIG. 2 depicts sets (e.g., A and C) with something in common that is not obvious from examining either one independently;

FIG. 3 depicts an approach to searching using related but non-interactive sources (e.g., literatures) in which (A) two concepts (A and C) are hypothesized to be related, but without supportive evidence except through an intermediate, B, and (B) an attempt to discover new connections for concept A, leads to a search through related items, B, followed by another search through items in C that were not found when initially searching A;

FIG. 4 depicts the relationship between keywords and abstracts;

FIG. 5 illustrates a flowchart of the general system logic;

FIG. 6 is a flow chart illustrating the key components of a system according to one aspect of the invention;

FIG. 7 is a flow chart that demonstrates one embodiment by which a system to one aspect of the invention compiles database objects;

FIG. 8 is a flow chart that demonstrates how a system to one aspect of the invention refines the database objects by first flagging ambiguous acronyms;

FIG. 9 is a flow chart that shows one embodiment by which the system according to one aspect of the invention scans a source for the existence of co-occurring objects to reduce redundancies as well as create relationships;

FIG. 10 is a flow chart that shows how a system according to one aspect of the invention creates one or more relationships by assigning each object a unique numeric ID (long integer) and storing adirectional relationships by lowest ID;

FIG. 11 is a flow chart that demonstrates one embodiment of how the system identifies shared relationships after a user inputs one or more lists of objects for analysis;

FIG. 12 is a flow chart that demonstrates how the system identifies the implicit relationships from the information that was input;

FIG. 13 is a flow chart that demonstrates how shared implicit relationships are identified;

FIG. 14 is a flow chart that shows operation of a system according to one aspect of the invention;

FIG. 15 is a graph that shows the top 6,000 implicit relationships for fluoxetine (Prozac®) by score;

FIGS. 16A and 16B depict (16A) distribution of the number of relationships each object in the database has, and (16B) distribution of implicit and direct relationships in accordance with the present invention;

FIG. 17 illustrates a comparison of the average observed-to-expected ratio for the 10 most highly related objects between random and topical sets, where n=10 for random sets, while n varies for the topical sets but is at least 5;

FIGS. 18A and 18B depict statistical properties of related objects that are correlated with the strength of relationship; wherein 20,000 related objects were randomly chosen from the relationship database and (18A) analyzed for the average percentage of the total known relationships they shared and (18B) the average strength of their shared relationships;

FIG. 19 illustrates the protective effect of chlorpromazine against the development of cardiac hypertrophy, where echocardiography was use to estimate the change in weight or thickness of several different cardiac structures over the course of treatment;

FIGS. 20A and 20B illustrates objects related to the gene beta-catenin and the effects of varying the minimum number of observations for a connection to be considered valid, where (A) is the growth in the total number of connections is exponential with time, and (B) is a retrospective look at how many objects were known to be related to beta-catenin indirectly at any given point in time;

FIGS. 21A through 21D depict graphs of the total number of objects indirectly associated with beta-catenin over time, wherein (A) shows a Primary Domain Analysis using only 1,270 abstracts obtained by searching MEDLINE with the keyword “beta-catenin” (1992 to 2002); (B) is the addition of 1,970 records (from 1989 to 2002) involving wnt, an object closely related to beta-catenin, (C) further adding of 4,028 early (before 1993) records that are directly associated with beta-catenin, including objects Wingless, alpha-catenin, armadillo, N-cadherin, E-cadherin, plakoglobin, uvomorulin and p 120, and (D) is then adding 9,490 records from MeSH domain search “magnesium” and keyword “increase;”

FIG. 22 depicts a knowledge discovery method executed by a system according to one aspect of the invention. The system begins with a primary object of interest, such as NIDDM (black node), and identifies all co-citations or co-occurrences with other objects (gray nodes) observed within MEDLINE that represent directly known relationships. The system then examines all these nodes for their relationships with other objects (white nodes) that are not known to be related to the primary object, identifying implicitly related objects. Implicitly related objects that share many relationships (e.g., 3rd node from top) with the primary object are considered prime candidates for further analysis;

FIG. 23 depicts important shared relationships between methylation and NIDDM, wherein a total of 1,287 co-cited objects were identified between the two, of which an estimated 959 of these represent actual relationships of a non-trivial nature, in accordance with the present invention;

FIG. 24 are graphs that shows the correlation of a score determined by a system according to one aspect of the invention with direct and implicit relationships for sildenafil (Viagra®); and

FIG. 25 is a table of object queries and their relationships, including implicit relationships, scores, and other analyses, where abbreviations are: “Query object,” the object being queried for implicit relationships, “shared rels,” the number of relationships the query object shared with the implicit, “implicit relationship,” the object implicitly related to the query object through a set of shared intermediate relationships, “Type,” the type of object (drug, chemical compound, gene, phenotype, etc.), “Quality,” the number of shared relationships estimated to be real based upon the collective statistical probability of each relationship being real, “AB_int_str,” the integral strength as calculated by the area under the curve (AUC) for the matching relationships between A and B [i.e., of all the relationships A has, what is the collective strength (as a % of the total) of the ones that match with B and if all relationships perfectly match, the strength is 1 and if many weak relationships match, this number will be small],“BC_int_str,” same with C and B, “Inp_int_str,” weakest of the relationships connecting A and C (implicit strength), “Imp_Int_Ver,” area under the curve for the veracity scores and a way of measuring relationships not in terms of the importance of the relationship, but an estimate of how likely it is to be true, “Direct_Str,” direct strength, function of the number of co-occurrances seen within MEDLINE and blank if implicit, “Expect,” how many relationships we would expect to see between A and C chance, “Obs/Exp,” key to scoring, this is the estimated Quality divided by the Expect value, “Score,” Quality/Expect.

FIG. 26 is a flow chart illustrating the Information Extraction (IE) step executed by a system according to the invention.

FIG. 27-1 to 27-45 shows relationships identified by microarray analysis using a system according to one aspect of the invention.

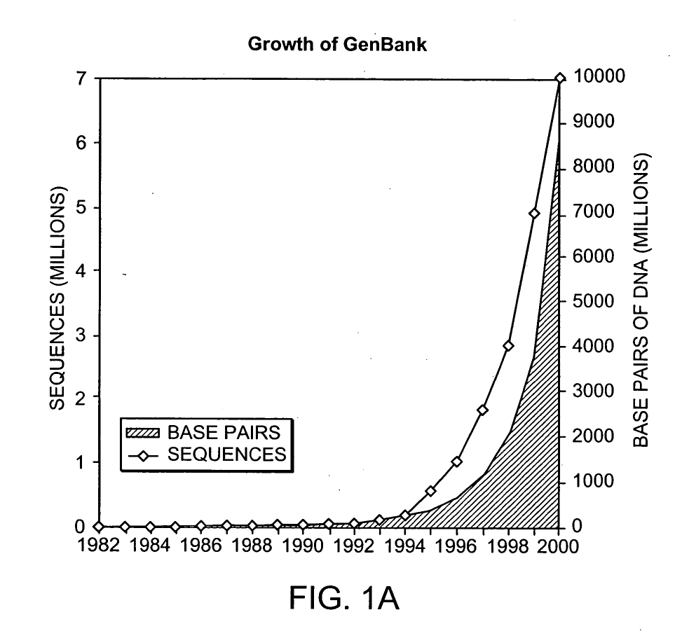

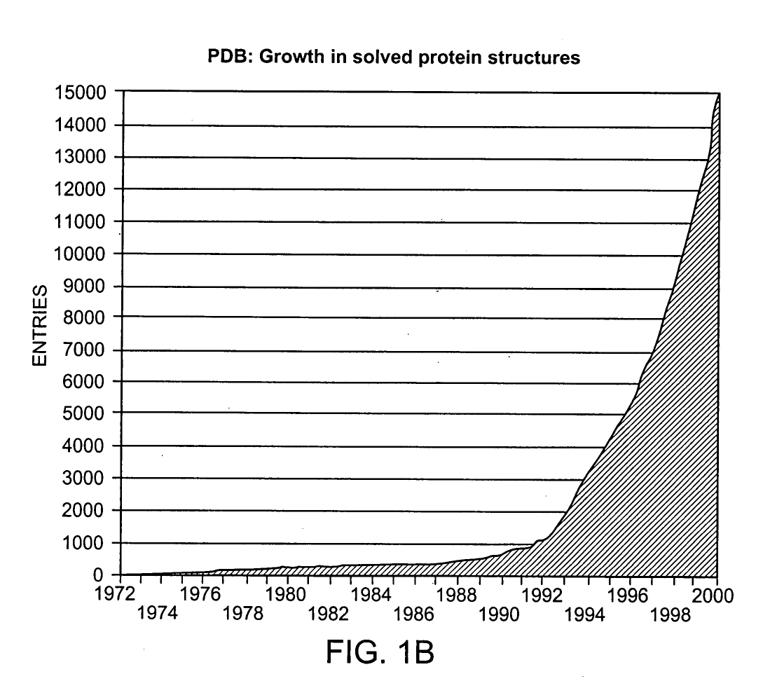

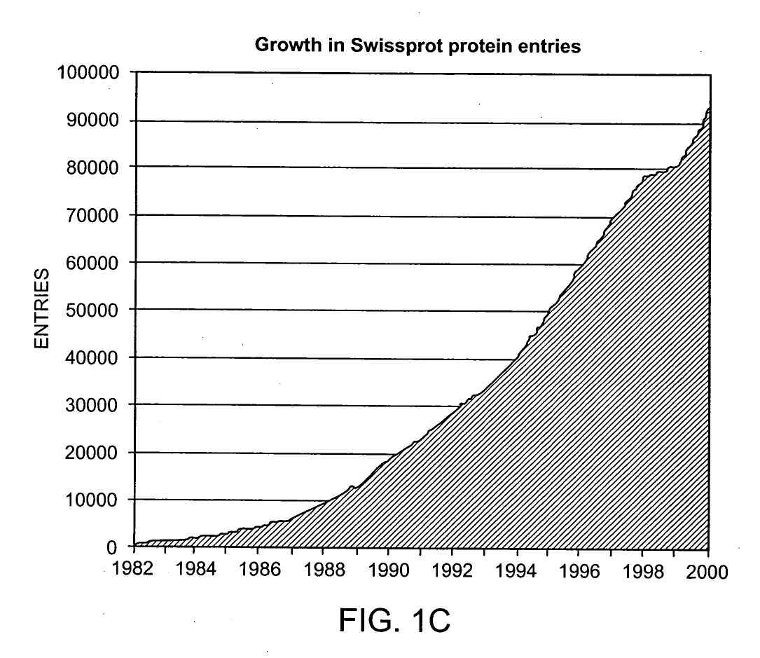

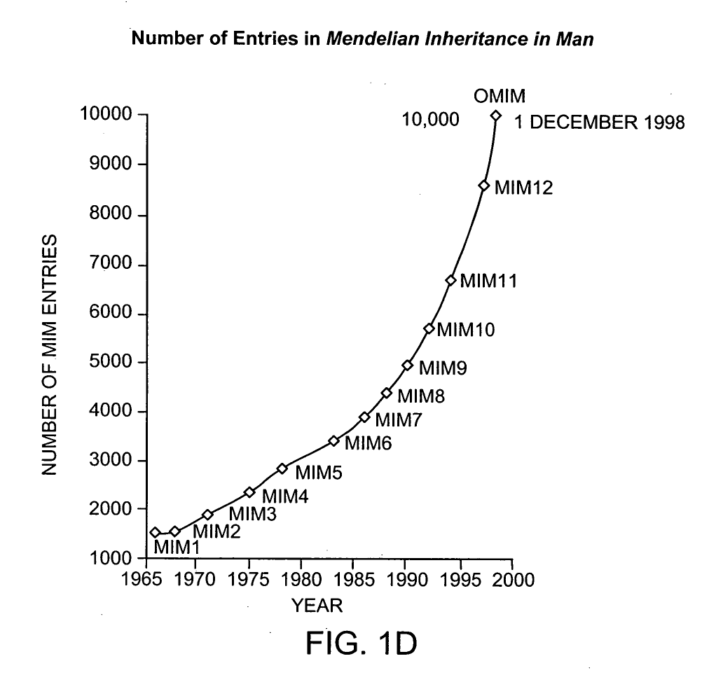

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiment discussed herein are merely illustrative of specific ways to make and use the invention and do not delimit the scope of the invention. Various modifications and combinations of the illustrative embodiments, as well as other embodiments of the invention, will be apparent to persons skilled in the art upon reference to the description. It is therefore intended that the appended claims encompass any such modifications or embodiments.

### Definitions

All technical and scientific terms used herein have the same meaning as commonly understood by one of ordinary skill in the art to which this invention belongs, unless defined otherwise. To facilitate the understanding of this invention, a number of terms are defined below. Terms defined herein have meanings as commonly understood by a person of ordinary skill in the areas relevant to the present invention.

Terms such as “a,” “an,” and “the” are not intended to refer to only a singular entity, but include the general class of which a specific example is used for illustration. The terminology herein is used to describe specific embodiments of the invention, but their usage does not limit the invention, except as outlined in the claims.

The following are terms as they apply to this application.

As used herein, an “object” may be any item or information of interest (generally textual, including noun, verb, adjective, adverb, phrase, sentence, symbol, numeric characters, etc.). Therefore, an object is anything that can form a relationship and anything that can be obtained, identified, and/or searched from a source. “Objects” include, but are not limited to, an entity of interest such as gene, protein, disease, phenotype, mechanism, drug, etc. In some aspects, an object may be data, as further described below.

A “relationship” refers to the co-occurrence of objects within the same unit (e.g., a phrase, sentence, two or more lines of text, a paragraph, a section of a webpage, a page, a magazine, paper, book, etc.). It may be text, symbols, numbers and combinations, thereof

“Meta data content” provides information as to the organization of text in a data source. Meta data can comprise standard metadata such as Dublin Core metadata or can be collection-specific. Examples of metadata formats include, but are not limited to, Machine Readable Catalog (MARC) records used for library catalogs, Resource Description Format (RDF) and the Extensible Markup Language (XML). Meta objects may be generated manually or through automated information extraction algorithms.

As used herein, an “engine” is a program that performs a core or essential function for other programs. For example, an engine may be a central program in an operating system or application program that coordinates the overall operation of other programs. The term “engine” may also refer to a program containing an algorithm that can be changed. For example, a knowledge discovery engine may be designed so that its approach to identifying relationships can be changed to reflect new rules of identifying and ranking relationships.

Various types of analysis may be used to evaluate data. “Orthographic analysis” is the recognition of units of meaning in texts that are made up of character codes. In English, it is common to separate the text at white space (spaces, tabs, line breaks, etc.) and to then treat the resulting units or “tokens” as words. For languages that lack word boundaries, one common approach is to use a sliding window to form overlapping n-character sequences that are known as “character n-grams” or “n-graphs”. “Semantic analysis” identifies relationships between words that represent similar concepts, e.g., though suffix removal or stemming or by employing a thesaurus. “Statistical analysis” refers to a technique based on counting the number of occurrences of each term (word, word root, word stem, n-gram, phrase, etc.). In collections unrestricted as to subject, the same phrase used in different contexts may represent different concepts. Statistical analysis of phrase co-occurrence can help to resolve word sense ambiguity. “Syntactic analysis” can be used to further decrease ambiguity by part-of-speech analysis. As used herein, one or more of such analyses are referred to more generally as “lexical analysis.” “Artificial intelligence (AI)” refers to methods by which a non-human device, such as a computer, performs tasks that humans would deem noteworthy or “intelligent.” Examples include identifying pictures, understanding spoken words or written text, and solving problems.

As used herein, the term “database” is used to include repositories for raw or compiled data, even if various informational facets can be found within the data fields. A database is typically organized so its contents can be accessed, managed, and updated (e.g., the database is dynamic). The term “database” and “source” are also used interchangeably in the present invention, because primary sources of data and information are databases. However, generally, a “source database” or “source data” refers to data such as unstructured text and/or structured data that is input into the system for identifying objects and determining relationships. A source database may or may not be a relational database. However, a system database preferably comprises a relational database or some equivalent type of database which stores values relating to relationships between objects.

As used herein, a “system database” and “relational database” are used interchangeably. More specifically, a “relational database” refers to a collection of data organized as a set of tables containing data fitted into predefined categories. For example, a database table may comprise one or more categories defined by columns (e.g. attributes), while rows of the database may contain a unique object for the categories defined by the columns. Thus, an object such as a gene, might have columns for nucleotide sequence, amino acid sequence, expression in a particular tissue or cell, organism of origin, association with a phenotype, etc. A row of a relational database may also be referred to as a “set” and is generally defined by the values of its columns. A “domain” in the context of a relational database is a range of valid values a field such as a column can contain.

As used herein, a “domain of knowledge” refers to an area of study over which the system is operative, for example, all biomedical data. It should be pointed out that there is advantage to combining data from several domains, for example, biomedical data and engineering data, for this diverse data can sometimes link things that cannot be put together for a normal person that is only familiar with one area or research/study (one domain).

A “distributed database” is one that can be dispersed or replicated among different points in a network.

The terms “data” and “information” are frequently used interchangeably, as are “information” and “knowledge,” therefore, it is necessary to know the distinctions between terms. “Data” is the most fundamental unit, consisting of an empirical measurement or set of measurements. Data is compiled to contribute to information, but it is fundamentally independent of it. Information, by contrast, is derived from interests. For example, data may be gathered on height, weight, race and diet for the purpose of finding variables correlated with risk of heart disease. But the same data could be used to develop a formula or to create information about height/weight or race/diet correlations.

“Information” when referring to a data set includes numbers, sets of numbers, or conclusions resulting or derived from a set of data. “Data” is then a measurement or statistic and the fundamental unit of information. “Information” may also include other types of data such as words, symbols, text, such as unstructured free text, code, etc. “Knowledge” is loosely defined as a set of information that gives sufficient understanding of a system to model cause and effect. To extend the previous example, information on race and diet could be used to develop a regional marketing strategy for food sales while information on height/weight ratios could be used by physicians as guidelines for diet recommendations. It is important to note that there are no strict boundaries between data, information, and knowledge; the three terms are, at times, considered to be equivalent. In general, data comes from examining, information comes from correlating, and knowledge comes from modeling.

As used herein, “a program” or “computer program” is generally a syntactic unit that conforms to the rules of a particular programming language and that is composed of declarations and statements or instructions, divisible into, “code segments” needed to solve or execute a certain function, task, or problem. A programming language is generally an artificial language for expressing programs.

A “system” or a “computer system” generally includes one or more computers, peripheral equipment, and software that perform data processing. A “user” or “system operator” in general includes a person, that utilizes a computer network accessed through a “user device” (e.g., a computer, a wireless device, etc) for the purpose of data processing and information exchange. A “computer” is generally a functional unit that can perform substantial computations, including numerous arithmetic operations and logic operations without human intervention.

“Application software” or an “application program” is, in general, software or a program that is specific to the solution of an application problem. An “application problem” is generally a problem submitted by an end user and requiring information processing for its solution.

A “natural language” is a language whose rules are based on current usage without being specifically prescribed. Examples of natural language include, for example, English, Russian, or Chinese. In contrast, an “artificial language” is a language whose rules are explicitly established prior to its use. Examples of artificial languages include computer-programming languages such as C, Java, BASIC, FORTRAN, or COBOL.

As used herein, a “physical association” refers to co-occurance of an object in a selected portion of a data source (e.g., a phrase, line, paragraph, section, chapter, book, etc.).

As used herein “logical associations” refers to associations linked by logical operators such as “not”, “includes”, “and”, “or” where a connecting word associates objects in a particular way, for example, “We studied the genes XX, YY, ZZ and found that they were not genetically associated in cancer”, in this case XX, YY, ZZ would using only co-occurance be linked, but logically from the context of the rest of the sentence, they are not. Logical associations can be from databases were objects have explicitly been linked or associated, such as those in the Genome Ontology (GO).

As used herein, “a comprehensive network of relationships” refers to a network that is as complete as possible, including data from many sources or domains of knowledge. Preferably, such data relating to such a network can be accessed without being limited by any constraints such as “show me only associations from Medline text and do not include associations generated by other literature.”

As used herein, a “partial network” refers to a network that is computed from only a portion of the available data sources (e.g., such as literature published in scientific journals). A partial network identified in one data source can be compared to a partial network identified in another data source to validate relationships. The term also refers to the use of only a portion of any pre-computed network, for example, “show me the connections from literature that is only from Medline” or “show me connections derived from Medline literature that only discusses “cancer.”

As used herein, a “topical cluster” refers to a group of objects that are associated by topic, such as “breast cancer” or “those genes that have reproducibledifferential expression when studied in heart disease and normal patents” or an arbitrary grouping of objects generated by any user to generate additional information or verifying information for a their given study or hypothesis.

As used herein, “statistical relevance” refers tousing one or more of the ranking schemes (O/E ratio, strength, etc) where a relationship is determined to be statistically relevant if it occurs significantly more frequently than would be expected by random chance.

As used herein, “resolving” refers to verifying that the object is in the Object-Relationship Database and assuring that lexical variants and synonyms, etc., are also contained in the Object-Relation database for the object. It also refers to then finding the object and any of its variants from within the literature, i.e., extracting them from the literature successfully.

As used herein, “to assign a nature to a relationship” refers to to any method used to distinguish one type of relationship from another, and this could include relationships that are only due to co-occurances, as well due to inclusion in a particular class of objects (e.g., drugs, genes, etc.). It also includes result objects that can reveal something about a set of objects, such as the fact that members of the set are frequently “transcription factors” and are therefore indicative of some type of control function and probably involve the interaction between DNA and some protein.

### Knowledge Discovery

In some technologies, such as science, data is gathered to gain information and/or knowledge about an object of interest, but it may also contain or lead to new information about other objects not originally intended for study. There are a number of anecdotes about scientific discoveries inspired by accident or by a sudden insight that arose from research in an unrelated field. These empirical observations indicate that there are potentially critical relationships between objects that, though seemingly unrelated, unify the objects into a new set of relationships.

While information is, in general, derived from a specific interest and most data is gathered in pursuit of that single interest, a system according to the invention enables one to expand the interests without additional cost to the individual. Thus, the system also creates more knowledge at no additional cost. This value-added benefit is unlimited and, thus, the source of the system's role in knowledge discovery.

Individuals are excellent at finding patterns and elucidating relationships within data, but are limited in the amount and rate by which they can assimilate new data. On the other hand, computers are limited in their ability to find patterns or understand relationships but are faster and more comprehensive in assimilating data. To comprehensively search existing data for patterns, it is, therefore, necessary to use computers. A system according to the invention accomplishes several essential tasks for relational analysis of data, including: (a) obtaining a domain of knowledge in electronically readable format; (b) using software for recognition of data contained within this domain; (c) identifying informational relationships between items of data contained therein; (d) using the relationships to discover and identify novel trends, functions and solutions.

### Inefficient Methods of Knowledge Discovery

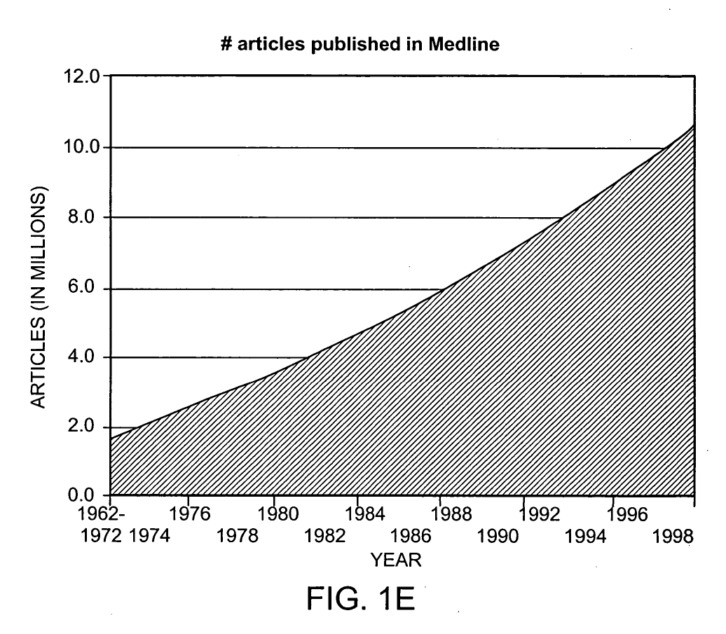

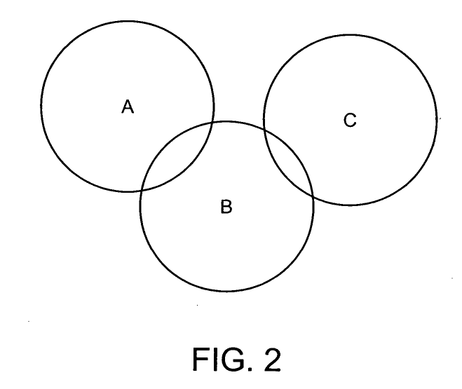

One such source of data that is of interest to those pursuing knowledge in science and technology is MEDLINE. In 1986, when MEDLINE had less than half the number of entries it does today, a researcher named Don Swanson demonstrated that two biologic phenomena without a known link could be related through an intermediate link in an semi-automated way. The concept is illustrated in FIG. 2 in which the relationships between A and B and relationships between B and C have been reviewed; however, no relationship between A and C has been identified. Swanson termed these relationships “Non-interactive literatures” and developed a method of working with non-interactive literatures pairing keywords from the titles of MEDLINE records to identify commonalities between two sets of literature. Using this method, he identified a relationship between Raynaud's Disease, a circulatory disease (literature A), and fish oil (literature C) by the associated blood and vascular changes related to both phenomena (literature B). Because of this identification, Swanson was able to hypothesize that fish oil (a substance that increases many beneficial circulatory agents) might have a positive effect on patient's with Raynaud's Disease. The method was used to identify other previously unknown relationships, such as levels of magnesium and migraine headaches and levels of arginine and plasma somatomedins.

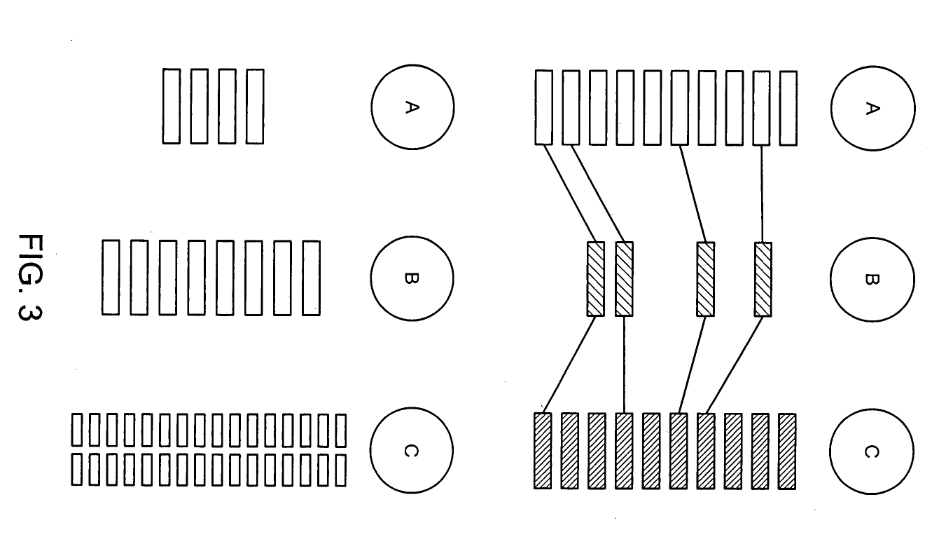

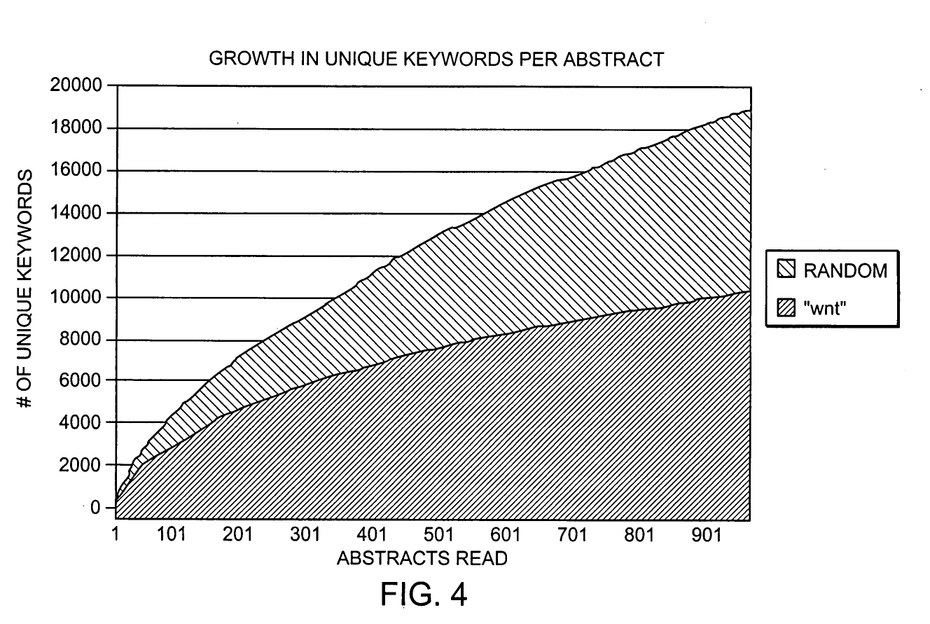

Swanson published a program, ARROWSMITH, which enabled one to search for “non-interactive” literatures. FIGS. 3A and 3B conceptually demonstrate how Arrowsmith operates. In FIG. 3A, the method of a directed search between two concepts, A and C, is shown, where A and C are a general concepts of interest in the form of text (keywords or phrases) to be used in a topical search of MEDLINE. The titles obtained from the search are parsed into a set of individual words. From this set, “uninformative” words are filtered out leaving a set of keywords (unshaded boxes underneath A). C, with a different topical search is not known to overlap with A. That is, if one searches MEDLINE for the combined set “A and C,” one should find nothing, i.e., no entries that suggest a relationship. Through the use of ARROWSMITH a set of keywords found in both A and C is found, represented by B. It is in this set that undocumented connections may be found; however, it is left to the individual to determine if the connections in B are relevant or of consequence.

FIG. 3B represents the results of ARROWSMITH's undirected search, the approach one might take if interested in simply finding any new or interesting connections related to A. From an initial set of keywords derived from a topical search of A, one would conduct another independent search on this entire set of keywords. The results are combined into another set of keywords, B, and again, from each of these keywords, another search is conducted. This third list of references, obtained from a search on all of the keywords in B, can be processed to exclude references already found in the initial set, A, leaving a final set, C.

As creative as the method is, there are a number of reasons why Swanson's method is highly inefficient. First, ARROWSMITH only uses titles of articles. And, while it serves a practical purpose by reducing the number of keywords a user has to analyze, titles do not always describe the discovery in specific terms, nor do they include much of the relevant information found in the other parts of the article, such as the abstract. Second, only key words rather than phrases are used, leaving no distinction between key elements. For example, “cardiac” may collect terms associated with “cardiac arrest” as well as “cardiac development.” Third, while the method is termed “automated” it is actually semi-automated because it requires a manual compilation of records as input, and another manual evaluation of each matching keyword for relevance, where the evaluation generally requires an “expert” in the particular field(s) of interest. One group, however, has used a normalized statistical frequency of keyword and keyphrase occurrences in an attempt to buoy the most relevant words and phrases to the top of a search. The disadvantage of a keyword-based approach, aside from limiting the data pool, is the size of the domain analyzed. Even after stop words are screened out; the number of unique keywords grows rapidly, as illustrated in FIG. 3B. Therefore, undirected searches and methods that employ this type of search are of little benefit when vast amounts of data or to be analyzed.

### Word-Pairing and Its Limitations

Any knowledge discovery system that uses word-pairing or co-occurrence of terms is limited by the scale of analysis. An example of the large scale of data that exists in a single source can be found by looking at databases. Databases are considered repositories for raw data, even if various informational facets can be found within the data fields. As previously discussed, one source of extensive science and technology knowledge is MEDLINE, which is available at no cost to the public as electronic text in XML (eXtended Markup Language) format from the National Library of Medicine (NLM).

In early 2002, MEDLINE contained 12,063,000 records, 6,400,000 with abstracts. When parsed, these 12 million records were found to contain over 4,400,000 unique words. To illustrate how quickly unique words from a set of abstracts related to a common topic can grow, titles and abstracts from 973 MEDLINE records were obtained from a topical search on the keyword “wnt” and processed into individual words using the word parsing routine of the system. A total of 11,226 unique words were found within a total of 191,165 words. Merging only the simple root variants of these words (e.g. counting “bind”, “binds” and “binding” as one word) trimmed the list down to 9,479 words. A filter was then applied to exclude 220 uninformative words (e.g. “hence”, “where”, “did”, “at”) and probable adverbs (words ending in “ly”). The final list contained 8,495 keywords. A number of these were more complex word root variants (e.g. bind/bound, cell/cellular), proper nouns (e.g. “Beckman”, “Smith”), numbers or percentages, a few uninformative words that weren't screened (e.g. “hundred”, “liter”). A large number of words whose usefulness in conducting another search was probably low (e.g. “agarose”, “filter”) and a large number of words whose usefulness was uncertain because they represent extremely broad concepts (e.g. “cell”, “development”, “Drosophila”). By querying MEDLINE abstracts cumulatively using the most frequent keywords on this list with the National Library of Medicine's PubMed Web site (i.e., 1 word, then 2, then 3, up to 50) and calculating the asymptote, an estimate of 6,100,000 MEDLINE articles contains one or more of the keywords from the wnt list in its abstract. This represents approximately 97% of the MEDLINE records that contain an abstract. Therefore, examining a domain of implicitly related articles for potential relationships is tantamount to reading a majority of the 12 million MEDLINE articles.

A further illustration of how tremendously inefficient this type of system is, can be illustrated by viewing the growth rate of keywords from randomly examined records. In FIG. 4, the total growth in unique keywords from the wnt abstracts is plotted against the same number of effectively random abstracts (obtained from MEDLINE using the keyword “result”). All the words in the abstracts were recorded into a database, adding to the cumulative total every time a new word was found.

As FIG. 4 shows, a relatively small set of 100 abstracts quickly balloons into 4,000 unique words. The wnt keyword growth analysis shows that an undirected search on anything but a small starting domain quickly becomes inefficient and impractical. Therefore, a system that is effective is also able to reduce irrelevant keywords from analysis. Fortunately, the system of the present invention is able to accomplish this.

### Overcoming Obstacles in Knowledge Discovery Using Text-Based Sources

A very practical way to evaluate any source is by answering three questions:

(1) How comprehensive is the source?;

(2) What is the rate of error of the source?; and

(3) How much work does it take to identify a novel but useful relationship?

Given that there are very real limitations of time and money that one faces when evaluating the validity of a relationship, the system of the present invention is designed to restrict the analysis to things known to be of concern and/or relevance in a particular field of interest. For example, in biotechnology, current areas of interest generally lie in genes, diseases, clinical phenotypes, proteins, small molecules, mechanisms of action, potential new drugs and therapeutic chemical compounds. A system according to the invention is also specifically designed to restrict analysis to sources with fields of interest. For example, using MEDLINE as a source, searches are restricted to titles and abstracts. This is primarily because these areas house the largest amount of information that may be suitable for new relational discoveries.

In terms of creating relational analysis using data sources with large amounts of text, there are a large number of inherent difficulties that must be overcome. The largest difficulty is to properly assign and evaluate the text in the context within which it is placed. S Artificial relationships may exist that are only contextual in nature, which is especially important with scientific sources. For example, an abstract may identify an interaction that is dependent on the test conditions. An animal strain containing a gene knockout mutation may be used to determine the effect of a drug and a misleading relationship between the drug and its effect may be constructed, e.g., “Drug ABC is lethal.” To overcome the misevaluation of information, in one aspect, the system includes an incrementing counter that accounts for each time an object or relationship is identified. If an object happens to fall in this category of special circumstances, the documented relationship should have a proportionately small counter when compared to the sum of the occurrences of the object.

Another problem that must be overcome is the use of non-standard notation to describe artificial constructs. For example, take the statement “The ABCΔ130-140 protein was unable to bind DEF.” While two things may be understood from this statement: ABC normally binds DEF (implied) and without amino acids 130-140 it is unable to. Such notation could easily be accommodated if it was standard, but there are several ways of showing this deletion, including ABCΔ1d (for 1st domain), ΔABC-2 (for 2nd deletion construct), ABC-DEFBR (ABC without DEF Binding Region) or any number of ways related to what is being studied. The system will only catalog relationships of identified objects.

Two other types of errors may exist in a data source. For example, the system of the present invention may be taught to correctly identify an object/relationship or the conclusions/results of a research. A better evaluation is conducted by relying on one or more counter variables that sum the total number of times a relationship between two objects is identified and is used to help identify errors. The evaluation involved taking subsets of the entries in the Object-Relationship Database (ORD), going back to the original reference and evaluating how many are accurate. The accuracy of the evaluation may be critical to providing scores to rank potentially undocumented relationships. Hence, the system described herein is designed to reduce the systematic errors in building the ORD. The other type of error that might occur from rare or poor semantic phrasing presents a larger challenge. Preferably, the system emphasizes accuracy over thoroughness, which is to say that it is acceptable to overlook a relationship that is extremely infrequent in favor of finding a relationship identified as correct.

By providing a consistent and standard classification to objects of study, most of the above-mentioned obstacles can be overcome. In addition, tools such as NLM's MetaMap for their Metathesaurus may first be used to match phrases and word variants with concepts contained within the Metathesaurus. The Metathesaurus helps users select a variety of topical areas once they input their general interests in a “freehand” manner.

### A Novel Knowledge Discovery System

The problem solved by the invention is to use a source to comprehensively identify relationships and subsequently model them in order to discover new knowledge and identify local and global trends within the field of search (e.g., field of research).

In one aspect, the system comprises a memory which stores documents from which information can be mined. Alternatively, or additionally, the system comprises a processor connectable to a network through which access is obtained to one or more collections of documents (collectively, a data source).

Preferably, a processor of the system comprises a central processing unit (CPU), which executes one or more programs embedded in a computer readable medium (“a computer program product”) to execute the evaluation method described below. Computer readable medium includes but not limited to: hard disks, floppy disks, compact disks, DVD's, flash memory, online internet web site, intranet web site; other types of optical, magnetic, or digital, volatile or non-volatile storage medium. As used herein, “computer readable medium” includes cooperating or interconnected computer readable media, which exist exclusively on single computer system or are distributed among multiple interconnected computer systems that may be local or remote. Thus, in one aspect, the processor executes a server program that receives and fulfills requests from a client (e.g., a computer, workstation, portable device, multi CPU server such as Dell 4600, laptop, office assistant, or other wireless device connectable to the network) to implement one or more system functions. A server program executed by the server may be used to regularly recompute a network of object relationships (discussed further below), providing a network database that can then be downloaded to a client machine where the user can interact or interrogate it. Alternatively, the server computer retains the network database and the client/user interacts with the network database via the server without having to have a local copy on the client machine. This architecture provides flexibility in allowing the database to grow, providing more disk space and speed than can be obtained in a client/user machine.

Suitable servers for use in the system include, but are not limited to, an SQL server, Oracle, and Microsoft access.

In one preferred aspect, the system further includes a program for developing, deploying, and managing enterprise database applications (e.g., such as a Microsoft Access program).

In one aspect, the system comprises an engine that monitors recomputation results (after adding literature or new objects) of a network database to identify groups of objects that may suddenly become linked by some newly added object or source data, providing a flag or system trigger for executing a program with code segment comprising instructions for inspecting results. In this way, the system identifies relationships that may provide new opportunities for discovery (e.g, by identifying candidate drug targets). Thus, the system models typical human thought and scientific method, some discovery is made, and then the system exploits this new discovery to make additional new discoveries.

Computer program products described herein for implementing system functions operate in a general-purpose computer. A computer can include a stand-alone unit or several interconnected units. A functional unit is considered an entity of hardware or software, or both, capable of accomplishing a specified purpose. Hardware includes all or part of the physical components of an information processing system, such as computers and peripheral devices.

Preferably, the system further includes a user interface for displaying results of the data evaluation method. The user interface can be provided on a client system which accesses the system according to the invention by accessing a server, or the user interface and system can both be contained on a general-purpose computer. A window (e.g., a part of a display image with defined boundaries in which data is displayed) can be provided which is customized according to the type of data mining operation being performed. For example, the window may be customized to display data relating to genes, proteins, chemical compounds, their functions and/or interactions, etc., in a user-friendly graphical format. For example, the window can include elements such as a titlebar, tool bar, drop down menus and control elements such as buttons or links.

In one aspect, the user interface includes, but is not limited to, one or more fields for receiving text input from a user relating to a an interest of the user (e.g., a query) or input (text, numerals, symbols, chemical formulas, mathematical formulas, and the like) relating to data from a data source, one or more fields for receiving input from a remote computer accessed by the system in response to an interaction of the user with the interface, e.g., a user operation such as selecting and clicking on a control element (e.g., button, drop down menu, task bar, link, etc). The user interface may be customized to reflect particular interests of the user, e.g., including links to data sources that are particularly relevant to the user's interests.

Input relating to data from a data source may be converted to an easily exchangeable format such as XML using a standard text or data converter. Thus, data sources comprising pdf, bmp, tiff formats, HTML, CHM, RTF, HLP, TXT (ANSI and Unicode), DOC, XLS, MCW, WRI, WPD, WK4, WPS, SAM, RFT, WSD can be converted to a format such as XML. In one preferred aspect of the invention, the data converter function of the system is used to convert data to a format similar to a data source such as Medline.

In one exemplary system according to the invention, computations are performed using, e.g., a desktop 800 MHz Pentium III with 256 MB RDRAM and 36 GB SCSI Hard Drive and a Pentium4 PC with 1 GB RDRAM, a 36 GB SCSI drive and backup 72 GB SCSI drive. In the examples discussed below, MEDLINE was stored locally on the 72 GB drive due to the instability of the local 1.3 terabyte cluster. In one aspect, program code for the system is written in Visual Basic 6.0 (VB 6); however, those of ordinary skill in the art aided by the present disclosure may use any of a number of programming languages to perform the present invention. For example, the system may use, e.g., Open Database Connectivity (ODBC) extensions to enable database access from Microsoft Access 2000. VB 6 also accommodates SQL server extensions via ODBC, which enables upgrades.

The evaluation method or data mining operations performed by the system may generally be divided into the following parts::

1. Informational relationships within a domain of knowledge are assimilated.

2. Recognition of meaningful relationships (in the domain of knowledge, e.g., data source) is based on the assumption that the primary domains are categorized in a general manner and that these categories are of sufficient importance to be contained within specific databases.

3. A comprehensive identification of relationships within the domain of knowledge is made through the co-occurrence of objects within key areas of the domain of knowledge.

4. A comprehensive network of relationships is stored in a database and then used to create queries that involve shared relationships and those that are only known implicitly.

5. Shared and implicit relationships are evaluated statistically using bounded network models.

6. The identified relationships are tested for accuracy by applying them against existing problems.

Assimilation of informational relationships within a domain of knowledge generally begins with providing input to the system from a data source.

Exemplary data sources include, but are not limited to, published research papers (e.g., Science Citation Index., Medline, BIOSIS), published technology papers (e.g., Engineering Compendex), conference proceeding records, results databases of published technical reports (e.g., NTIS), patent databases (e.g., available at www.uspto.gov, and databases such as DERWENT, LEXIS, WESTLAW, DELPHION, MICROPATENT, etc), databases of program narratives (e.g., RADIUS), webpages of regulatory agencies (e.g., FDA, NIH, USPTO, FTC, SEC websites), letters, memos, white papers, chat room text, , court decisions, news articles, articles in an encyclopedia, books, treatises, lists, tables, tables of contents, indexes, market analyses, and other data typically published online or in a digital form. In addition to internet sources, intranet sources and other documents that may be unique to a particular business structure and/or proprietary to that business may become data sources including, but not limited to, memos, letters, business plans, research papers, grant proposals, emails, manuals, handbooks, clinical data (including processed and unprocessed data), customer information, competitor information, etc. Additionally, educational or reference materials may be included, such as books (e.g., Physician's Desk Reference, Merck Manual,: Goodman and Gilman's, The Pharmacological Basis of Therapeutics, Tenth Edition, A. Gilman, J. Hardman and L. Limbird, eds., McGraw-Hill Press, 155-173, 2001; various online books available at http://onlinebooks.library.upenn.edu/new.html, http://www.bartleby.com/, http://www.ipl.org/div/books/, http://promo.net/pg/, http://www.bibliomania.com/, www.netlibrary.com., etc.).

Documents include those that are currently on line as well as those that are retrospectively converted to electronic documents, e.g., by OCR scanning. For example, documents not available on line or legacy documents can be copied using standard xerographic techniques and/or a scanner.

In one aspect, the system according to the invention comprises an OCR module comprising a scanner and a processor in communication with the scanner which is also in communication with a system processor linked to the system database. Preferably the scanner is used to obtain an image of a data source (e.g., a book, magazine, letter, lab notebook, etc.) and the processor in communication with the scanner and the system translates the text from print form to a file usable as a data source.

The module can be used to scan an entire page or two at a time (e.g., using a flatbed scanner) or can scan selected portions of a page (e.g., the scanner may be in the form of a portable device). In one aspect, the scanner comprises a feeder system for scanning large volumes of loose documents, or a disposable book from which papers can be removed or which can be cut along its spine to separate pages.

In one aspect, the data source file is an editable text file or graphic from which relevant data can be abstracted. Documents that are scanned by the system are preferably associated with at least one meta-object relating to at least one key feature of the document. Association of the document with a meta-object may require interaction with an operator of the system who exercise some control over the scanning or conversion method such that documents without the at least one meta-object do not become part of the system data source. In one aspect, a temporary database is generated for storing documents to be reviewed and eliminated as data sources or edited to abstract content. An operator may be an expert or may be an individual trained to review documents for the presence of one or more keywords.

In the case of documents stored in audio or comprising graphical components, methods for extracting textual data from such components may be used (e.g., speech-to-text algorithms or optical character recognition algorithms) to generate additional data sources. The documents contributing to a data source may be stored in a single memory or distributed on many servers coupled to, for example, the World Wide Web or an Intranet. Such documents may be accessed by a processor of the system through the network prior to or during the method discussed below. A web crawler may be utilized in generating the collection of documents to be operated upon by the system.

Source selection may be based on the particular technical field being evaluated and/or on the goals of the evaluation being performed (e.g., drug discovery vs. identification of adverse effects of a drug, identification of interactions of a drug, identification of consumer trends, etc.). Other criteria that may be important include, but are not limited to, temporal coverage of the data source (e.g., recent publication or a selected time stamp) to identify emerging trends, and geographic coverage (e.g., place of publication).

In one aspect, a data source evaluated combines a plurality of databases, e.g., databases covering allied and/or diverse technical fields or a plurality of domains of knowledge. For example, databases which are combined may include pharmaceutical and biotechnology databases, biomedical and engineering databases, biotechnology and and information technology databases, to name a few combinations. In some aspects, no restrictions are made as to technology when data sources are identified to evaluate. For example, the DIALOG and STN data sources include databases from disparate technical fields which may be evaluated in combination or separately.

In a further aspect, data sources comprise unstructured text data (e.g., text from the scientific literature) as well as structured data. In one aspect, a data source comprises unstructured text from a data collection of scientific literature (e.g., journal articles, text books, patent documents, website data) with DNA sequence homology data, Gene Ontology group names, protein structure similarities, and the like.

### Overview of System Functions

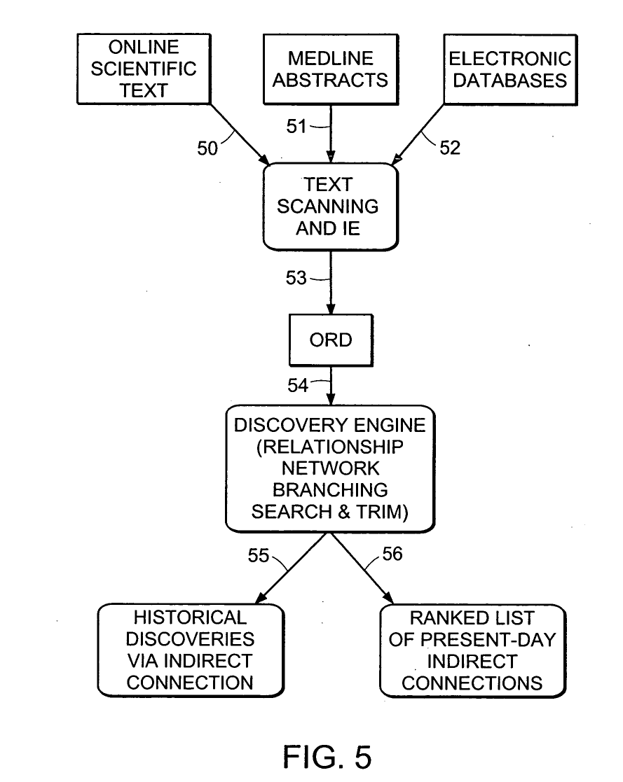

A flowchart of the general system logic using various sources such as, e.g., MEDLINE, as an example, is shown in FIG. 5. The selected source, such as online scientific texts 50, MEDLINE abstracts 51 or electronic databases 52 are text scanned in block 53. This method can be fully automated or it may be performed interactively. When multiple text collections are used as a data source, the data can be stored on a single machine or in a client/server architecture. Collection-specific meta-objects may be associated each collection.

Information is extracted from the selected sources via an Inference Extraction in block 53 and fed into ORD 54. Data can be extracted from data sources existing in diverse forms, e.g., in file directories,: ASCII, Doc, PDF, database records, flat files, etc. In one aspect, the system provides program code for converting data stored in multiple different file types into a single form, e.g., unstructured data stored as PDF, TIFF, Word and Text files may be converted to XML.

ORD 54 feeds into a Discovery Engine 55 for relationship network branching search and trim. The Discovery Engine 55 produces historical discoveries via indirect connections 57 and/or a ranked list of present-day indirect connections 56.

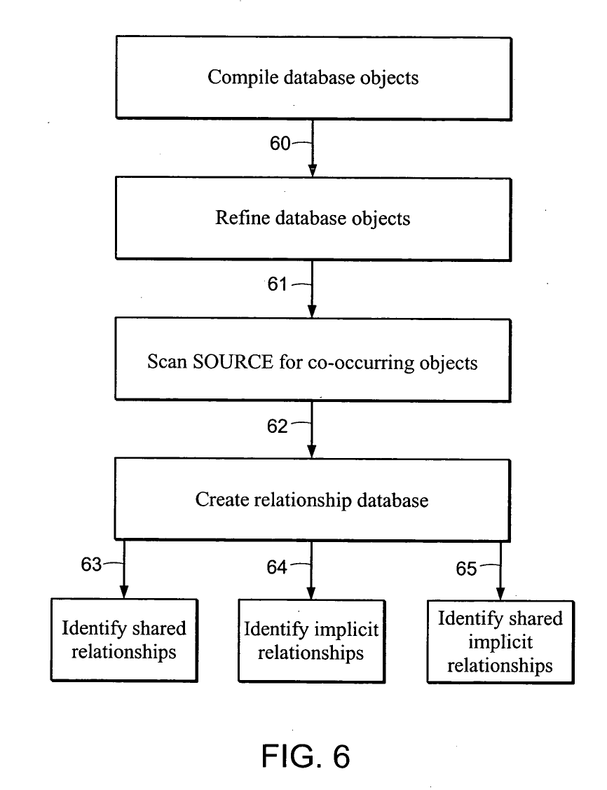

FIG. 6 is a flowchart illustrating the key components of the system. In general, a system according to the invention compiles database objects in block 60, then refines the database objects in block 61, scans a source for co-occurring objects in block 62, and creates one or more relationship databases in block 63. The relationship database 63 can identify shared relationships in block 67, identify implicit relationships in block 64, and/or identify shared implicit relationships in block 65.

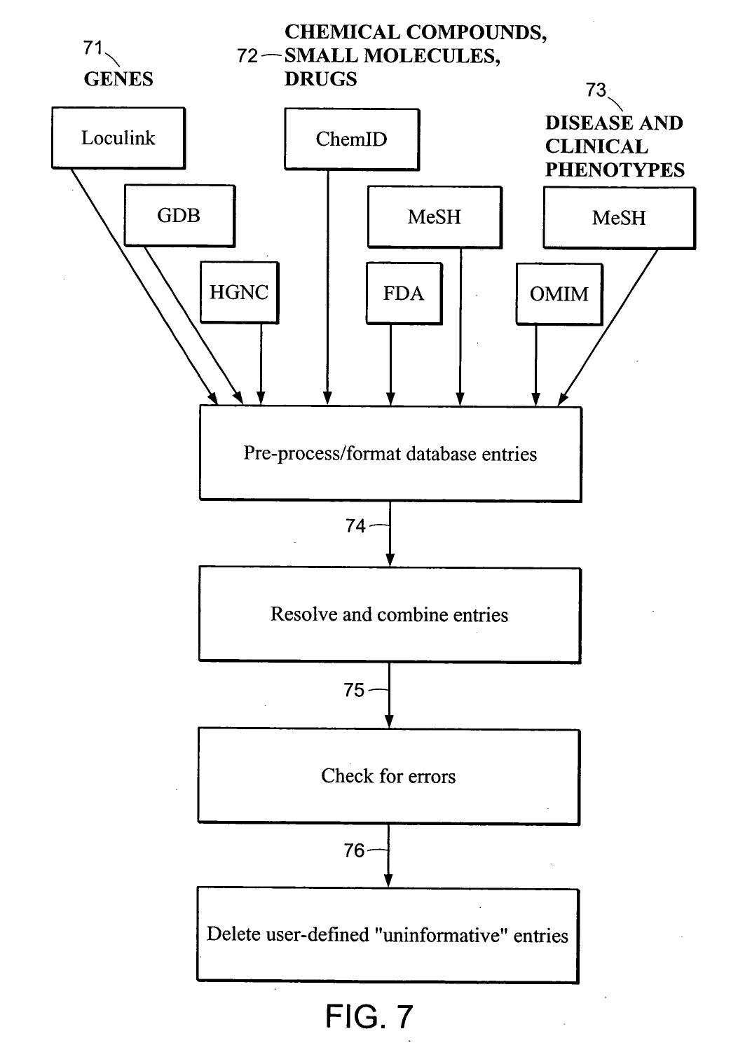

In one aspect, the system compiles database objects as shown in FIG. 7. Fields are areas of interest that can be grouped together and databases that house similar groups of information may be used independently of combined as needed. For example three fields of interest in science and technology may be: genes 71 (where databases may include locuslink 71a, GDB 71b, and HGNC 71c); chemical compounds, small molecules and drugs 72 (where databases may include ChemID 72a, MeSH 72b, and FDA 72c); and disease and clinical phenotypes 73 (where databases may be MeSH 73a and OMIM 73b). The groups of databases for genes 71, chemical compounds, small molecules, drugs 72, and disease and clinical phenotypes 73 are then preprocessed and formatted as database entries in block 74. Entries are then resolved and combined in block 75 and checked for errors in block 76. Any unwanted or “uninformative” entries (automated or as defined by the user) may be deleted in block 77.

In another aspect, an user of the system views a display of text from a data source (e.g., online or provided to the system by an OCR module) and can select and highlight text to add new words to an object list. Preferably, the graphical user interface on which text is displayed includes also displays which of the words in the text being viewed are currently in the object list. In this way, text may be rapidly scanned to to select important new objects that are not currently used.

This processed information can be combined with information from other data sources and/or obtained from previous compiling and relationship-determining steps. In certain embodiments, the information can be further evaluated using with traditional data mining techniques such as clustering, classification and predictive modeling.

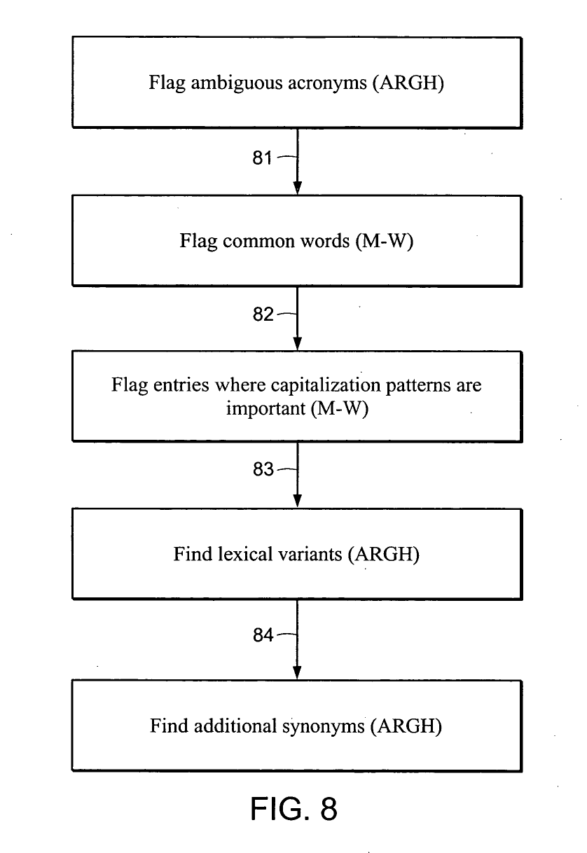

To refine the database objects, as shown in FIG. 8, in one aspect, the system first flags ambiguous acronyms (using, e.g., an acronym—resolving program, as discussed below) in block 81. The common words are generally flagged using another word database or resources such as the Merriam-Webster Database (M-W) in block 82. In addition, entries are flagged where capitalization patterns are important (again using an automated system, tool or resource such as M-W) in block 83. Another refinement is to find lexical variants using, for example, acronym-resolving program, in block 84 and to find additional synonyms using, for example, acronym-resolving program, in block 85.

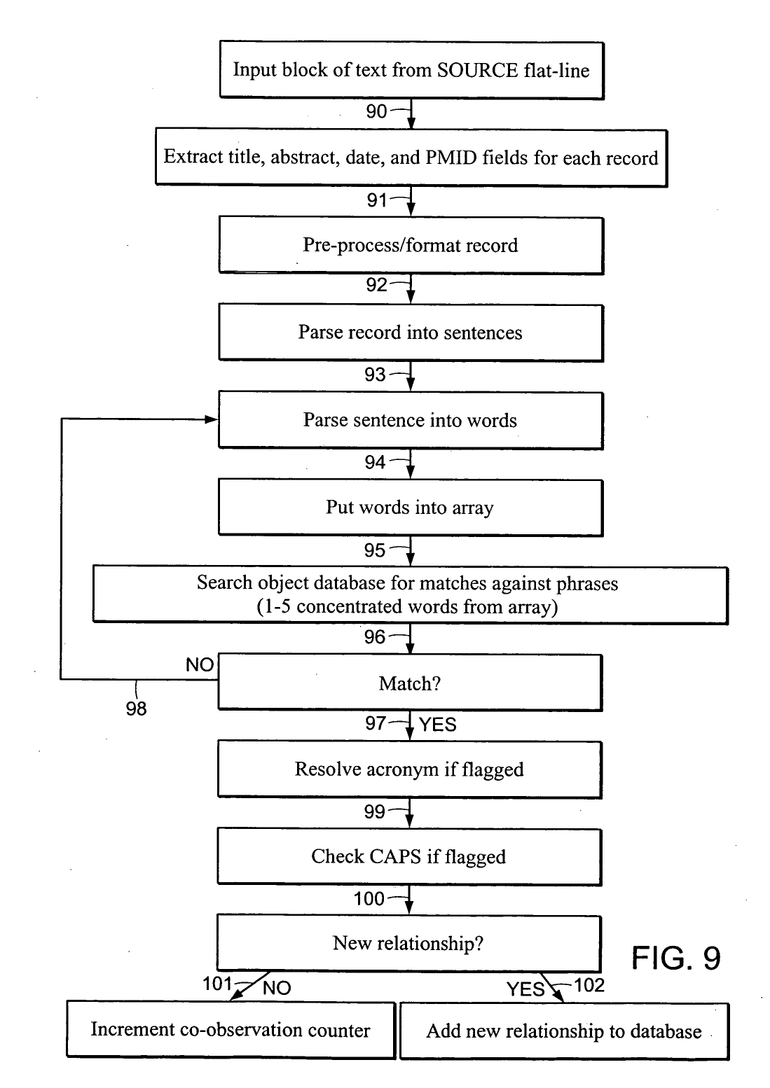

The system next scans a source for the existence of co-occurring objects to reduce redundancies as well as create relationships as shown in FIG. 9. For example, a block of text is input from a data source, e.g., the source flat-line, in block 90. The system then extracts pieces of information from the source in block 91. For example, using MEDLINE as a source, the system can extract information that includes the title, abstract, date, and PMID fields for each record. The system can pre-method and format the records from the source in block 92, parse the record into sentences in block 93, parse each sentence into words in block 94 and put the words into one or more arrays in block 95. In addition, the system may search the object database for matches against the phrases (where 1 to 5 concentrated words form a phrase from any array. A decision is then made as whether there is or is not a match as determined in block 97. If there is a match, any flagged acronym is resolved in block 98 and capitalizations (CAPS) are checked if flagged in block 99. If there is no match, then processing returns to block 94 where a new set of words are parsed from sentences and continues as previously described. Any new relationship based on the match as determined in block 100 (after all flags are checked and resolved) is added as a new relationship to a database in block 102). If, however, no new relationship is found, a co-observation counter is incremented in block 101.

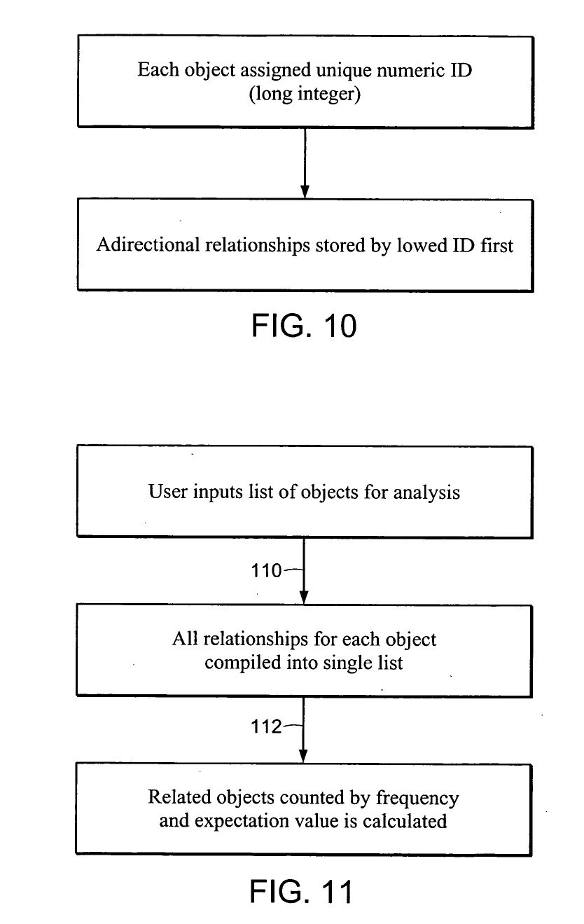

FIG. 10 shows how the system creates one or more relationships by assigning each object a unique numeric ID (long integer) in block 105 and storing adirectional relationships by lowest ID first in block 106.

As shown in FIG. 11, the system identifies shared relationships after a user inputs one or more lists of objects for analysis in block 110. From the one or more input lists, all relationships for each object are compiled into a single list in block 112 and related objects are counted by frequency and an expectation value is calculated in block 114. The expectation value is based upon the probability that a co-occurrence of objects equates to a non-trivial relationship between the objects.

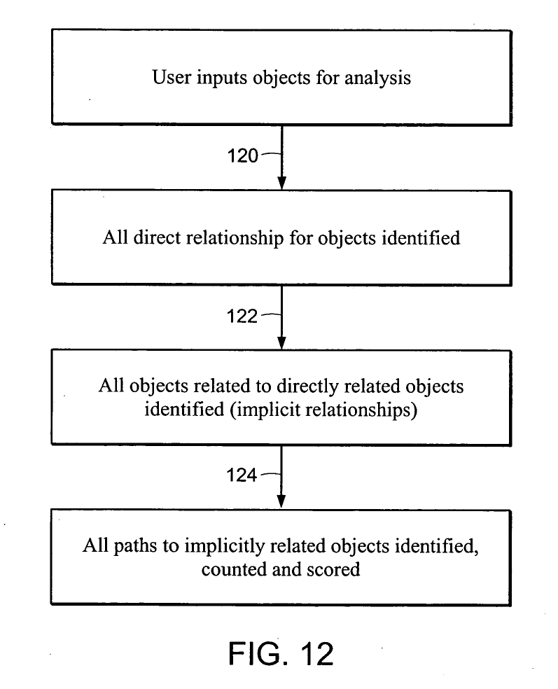

The system then identifies the implicit relationships from the information that was input as shown in FIG. 12. As before, a user or an automated system input objects for analysis in block 120 and all direct relationships for each object are identified in block 122. All objects related to objects related directly are identified as implicit relationships in block 124 and all paths to implicitly related objects are then identified, counted and scored in block 126 as discussed in more detail below.

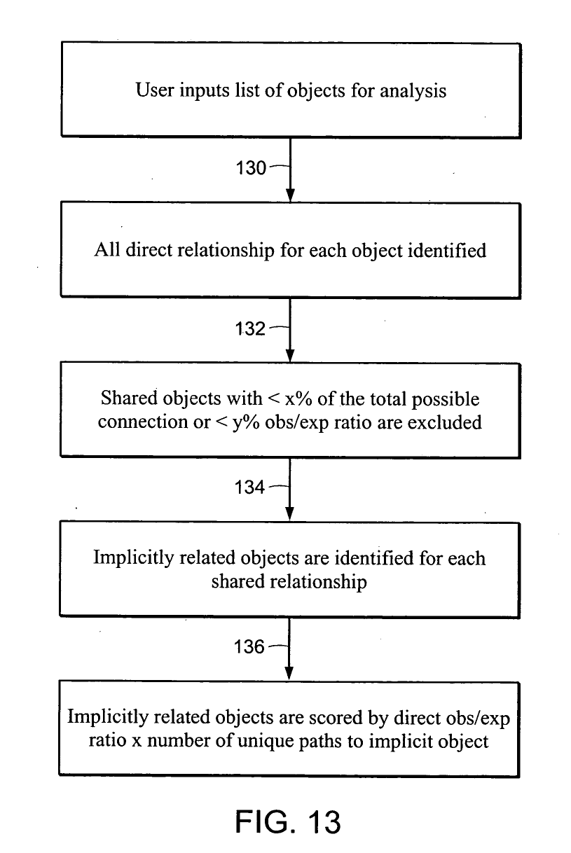

Shared implicit relationships are identified as shown in FIG. 13. Here, a user or an automated system inputs one or more lists of objects for analysis in block 130. All directly relationships for each objects are identified in block 132 followed by the exclusion of shared objects with less than x% of the total possible connection or less than y% of the observed/expected ratio in block 134. Implicitly related objects are identified for each shared relationship in block 136 and implicitly related objects are scored by direct observed/expected ratio times the number of unique paths to the implicit object in block 138.

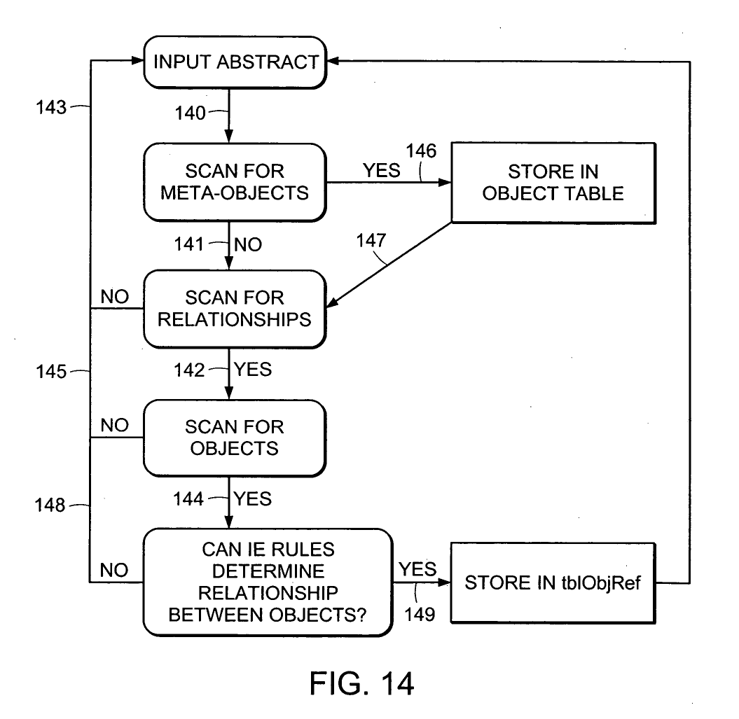

FIG. 14 is a flow chart that shows the system in operation. An a data source, e.g., a n abstract in input into a database in block 140 and scanned for meta-objects in block 141. If no meta-objects are found in block 141 then the data source 140 is scanned for relationships at 142, however, if meta-objects are found in the data source 140 then the meta-object is stored in an object table at 146. Objects stored in 146 are then scanned for relationships a 142. If meta-objects are not found in block 141 then the data source 140 is scanned for relationships at 142, if relationships are founds then the meta-objects are scanned for objects at 144, if not then the system returns to input another data source at 140, e.g., an abstract. If the object scan at 144 is successful, then a decision tree is reached that determines if the knowledge engine determines a relationship between the object at 145, if an relationship is identified then the relationship is stored at 149, if not then the system returns to 140 to enter another abstract.

The system summarizes data and displays representations of relationships identified. Graphical (e.g., visual) displays are typically used, but displays involving other senses (e.g., auditory displays) can be useful in some cases.

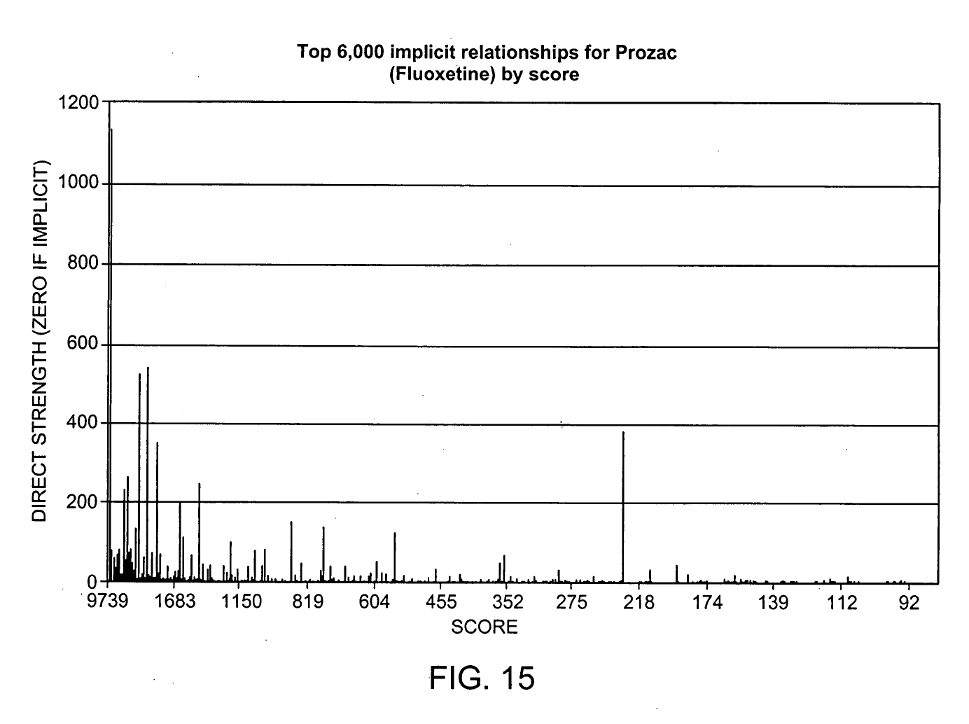

FIG. 15 is a graph that shows the top 6,000 implicit relationships for fluoxetine (Prozac®) by score identified by a system according to one aspect of the invention. Direct strength is measured by the amount of direct associations. Strength is a function of the number of times two objects have co-occurred and the probability that each co-occurrence represents a non-trivial relationship. Implicit relations are shown in the graph as zero.

In one embodiment of the present invention, a user-interface allows the user to click in the areas and/or on the lines in a graph that represents an implicit relationship to view the actual source of the implicit relationship found by the system. Alternatively, a user may chose to be directed to the location in a table or even within the original source data where the implicit relationship was found, and the system will display the key word in the context of the actual source. To improve scoring efficiency, the system may even be directed to screen out sources that provide high direct strength associations to vary the signal to noise ratio and increase implicit relationship scores.

The system may also be used to screen out irrelevant or negative associations. The score at the bottom of the graph shows the number of links of associations that the system located, in a sense the strength of the relationship vectors. Below a certain threshold, which may be varied according to how crowded the art may be, size of the database(s), source reliability or impact, size of the text converted into an object, etc., the score is most likely to be irrelevant and therefore the user's focus is placed on those implicit relationships above a certain strength score threshold.

### Processing

Adding new objects to the system's database increases the search time according to the inverse exponential function, 1/n², where n>0). Text-scanning increases time linearly. Both the size of the database and the amount of text can be continually increased.

### Object-Based Analysis

Most sources contain data and information that are complex in structure, with diverse formats, and no well-defined standards. On the other hand, most sources provide an excellent media for term recognition.

In one aspect, system routines are written to process a number of diverse textual formats in order to populate the ORD with objects. In another aspect, a system according to the invention provides a number of additional features for identifying novel relationships in science and technology. For example, gene entries were obtained from GDB (Genome Data Base) and HGNC (the Human Genome Nomenclature Committee) data sources that house accepted standards for gene nomenclature, and LocusLink. Greater than 35,579 listed synonyms for over 13,104 official gene names (including the official name) for entries in all three lists were made. OMIM entries on inherited disorders (and potential disorders) numbered over 13,068 disease names for over 7,290 entries and were incorporated, including most clinical phenotypes. Greater than 7,713 subheadings from MeSH were incorporated and categorized as Small Molecules (drugs, metabolites, chemicals, elements) if they were in the “D” main category. If the entry was under the MeSH “C” category, the entry was categorized as a disease/phenotype. The Internet locations of several files used are presented in TABLE 1. MEDLINE was obtained from NLM in XML format and is located locally on a 73 GB drive on a computer; copies are kept on accessible Web sites. Thus, the system can integrate an evaluation of both unstructured text data (e.g., such as text from a scientific journal) and structured data (e.g., such as sequence information; expression data, such as obtained from microarray analysis; data relating to effects of a drug, interactions between drugs, efficacy and/or safety data relating to drugs and drug combinations; and the like).

Some exemplary data sources for biological sciences (e.g., biotechnology, biomedicine) are listed in Table 1, below.

TABLE 1
Example of Online Text-based Sources

| Name | Location | Data |
|---|---|---|
| Human Gene | http://www.gene.ucl.ac.uk/nomenclature/ | Official (HUGO) gene names |
| Nomenclature | | |
| Committee (HGNC) | | |
| Genome Database | http://gdbwww.gdb.org/gdb/advancedSearch.html | Gene names & synonyms; |
| (GDB) | | diseases; cytolocs; |
| Online Mendelian | ftp://ncbi.nlm.nih.gov/repository/OMIM/ | Human diseases & phenotypes |
| Inheritance in Man | | |
| (OMIM) | | |
| Medical Subject | http://www.nlm.nih.gov/mesh/filelist.html | Diseases, phenotypes, |
| Headings (MeSH) | | chemicals, drugs, tissues, |
| | | pathogens |
| Center for Disease Control | ftp://ftp.cdc.gov/pub/Health | Pathogenic diseases & drugs |
| (CDC) | Statistics/NCHS/Publications/ICD9-CM/2000/ | |
| Kyoto Encyclopedia of | http://www.genome.ad.ip/kegg/ | Pathways, genes, orthologs, |
| Genes and Genomes | | functions, enzymes and ligands |
| (KEGG) | | |
| MEDLINE Plus | http://www.nhn.nih.gov/MEDLINEplus/druginformation.html | Drug names & synonyms, |
| | | phenotypes (side effects) |
| Locuslink | http://www.ncbi.nlm.nih.gov/LocusLink/ | Gene names, aliases, OMIM |
| | | links, cytolocs, homology |
| Enzyme and co-factor | ftp://ftp.expasy.ch/databases/enzyme | Enzymes, co-factors, diseases, |
| database | | metabolite associations |
| The University of | http://www.labmed.umn.edu/umbbd/index.html | Pathways, enzymes, metabolic |
| Minnesota Biocatalysis/ | | compounds |
| Biodegradation Database | | |
| Swiss-Prot | ftp://expasy.cbr.nrc.ca/databases/swiss-prot/ | Gene names, protein families & |
| | | members |
| FlyBase | http://flybase.bio.indiana.edu/(Drosophila gene homologs) | Drosophila homologs: their |
| | | cellular locations & functions |
| Mouse Genome Database | http://www.informatics.jax.org/ | Mouse homologs & human gene |
| | | names, GO classifications |
| Genome Ontology | http://genome-www.stanford.edu/GO/ | Biological processes, molecular |
| Project | | functions & cellular |
| | | components. |
| Unified Medical Language | https://umlsks.nlm.nih.gov/KSS/(queries only; CDROMs | Acronyms, drug names, medical |
| System (UMLS) | contain actual Metathesaurus) | vocabulary, biological objects |
| Structural Classification of | http://scop.mrc-hnb.cam.ac.uk/scop/data/scop.I.html | Protein structural classifications: |
| Proteins (SCOP) | | Folds, families, superfamilies |
| Alliance For Cellular | http://afcs.swmed.edu/ | G-protein coupled receptor |
| Signalling (AFCS) | | database |
| MaizeGDB: Maize | http://www.maizegdb.org/ | Maize genes |
| genetics and genomics | | |
| database | | |
| Wormbase | http://www.wormbase.org/ | Genes, protein sequences, |
| | | markers and genetic maps. |
| The Arabidopsis | http://www.arabidopsis.org/ | Gemes, proteins, markers, |
| Information Resource | | ecotypes, mutations, etc. |
| ZFIN Zebrafish | http://zfin.org/cgi-bin/webdriver?MIval=aa-ZDB_home.apg | Mutants, genes, mapping |
| Information Network | | panels. |
| The Binding Database | http://www.bindingdb.org/bind/index.jsp | Database of measured binding |
| | | affinities for biomolecules. |
| Stanford HIV Drug | http://hivdb.stanford.edu/ | Reverse transcriptase and |
| Resistance Database | | protease sequences; including |
| | | associations between |
| | | sequences and drug resistance. |
| HIV molecular | http://hiv-web.lanl.gov/content/immunology/maps/maps.html | Epitope sequences recognized |
| immunology database | | by cytotoxic and helper |
| | | lymphocytes |
| HIV protease database | http://mcll.ncifcrf.gov/hivdb/ | 3D structure database of |
| | | proteases. |
| ChemIDPlus | http://chem.sis.nlm.nih.gov/chemidplus/setupenv.html | Chemical structure database |
| ChemFinder.com | http://chemfinder.cambridgesoft.com/ | Chemical structures and |
| database | | physical properties |
| NIST Chemistry | http://webbook.nist.gov/ | Chemical property database |
| webbook | | |
| CASREACT - Chemical | http://www.cas.org/CASFILES/casreact.html | Chemical reactions of organic |
| Reactions Database | | compounds |
| AGTSDR: Agency for | http://www.atsdr.cdc.gov/toxpro2.html | Toxicology profiles |
| Toxic Substances and | | |
| Disease Registry | | |
| database | | |
| The University of | http://umbbd.ahc.umn.edu/ | Microbial biocatalytic |
| Minnesota | | reactions and biodegradation |
| Biocatalysis/Biodegradation | | pathways primarily for |
| Database | | xenobiotic, chemical |
| | | compounds |

TABLE 1 shows many of the sources used to construct the ORD. In addition, TABLE 1 contains additional online text-based sources that may offer supplemental data in science and technology (e.g., synonyms or types). Although TABLE 1 shows primarily biological or chemical databases, many other databases from many other fields can be used as a data source as discussed above. The system is dynamic in that newly created databases can provide data sources for the system as they are created. Similarly, data sources can be updated to incorporate new data added to existing databases.

Additional data sources according to the invention include collections of data obtained from ongoing experiments, such as high throughput screening assays or microarray data. In one aspect, the data source comprises expression data from a biomolecule array such as an oligonucleotide array, expressed sequence array, cDNA array, SNP array, protein or peptide array, antibody array, glycoprotein array, tissue array and the like. The data source may include, but is not limited to objects such as a gene name, accession number, nucleic acid sequence, amino acid sequence, cell line number (e.g., ATCC number), binding affinity, modification state, Tm, expression pattern, alternative alleles, coordinates on the microarray, as well as information about a sample contacted to the array, e.g., such as organism from which the sample is obtained, cell type, tissue type, lineage, stage of development, exposure of the sample to an agent, phenotype/morphology of a cell within the sample, patient information where the sample is from a mammal such as a human and the like. Expression data obtained from microarray analysis can be qualitative (expressed vs. not expressed) or quantitative (e.g., relating to levels of expression). The data may additionally be correlated or linked to other data sources; for example data relating to a polymorphic sequence associated with a disease may be linked to data relating to wild type function, drug interactions with the gene product and the like, information on MEDLINE and/or any of the data sources listed in the table above.

Similarly, other high throughput screening modalities can provide data sources, e.g., output from systems based on mass spectrometry, cell-based assays, transcription assays, binding assays, FRET based assays, and the like, may provide data sources to be evaluated by the system.

In one aspect, based on predictions made by the system as to novel relationships between objects, experiments are performed and data from these experiments are used as additional data sources for methods implemented by the system.

Entries in system databases may require additional formatting since they are for text matching rather than categorization. For example, an entry such as “Cassette, ATP-Binding” may be preferably written as “ATP-Binding Cassette” when in an abstract. Similarly, parenthetical comments such as “Color Blindness (x-linked) Syndrome” are not likely to be matched against textual input. These formatting issues were necessarily addressed as described hereinbelow.

Because a keyword-based approach for knowledge discovery is currently impossible (there are over 4.2 million unique words within MEDLINE, alone, and a single keyword alone is often operationally limited), a different approach was used. This approach limits the bulk of computational power to irrelevant terms such as “the” and “what.” The system according to the invention centers the analysis on pre-defined objects so that relationships with a high probability of being informative are obtained. Other Natural language systems typically extract all words following some set of rules, however, this has been the downfall of many of the systems because real language is so complex. By pre-defining a set of objects rather than allowing the system to freely select objects, only really relevant objects that are compiled from object list databases such as discussed herein or those identified manually or verified by a human from an automated extraction system will greatly minimize false positive relationships via linking of unimportant words. Imagine of a word like ‘the’ were to slip thru, then everything would be linked to everything else in a set of then irrelevant relationships. Importantly, it is not necessary for the system to assimilate as many objects as possible, but rather to have a set of objects representing very broad and popular areas or fields of use/interest.

### Using Co-Occurring Terms to Exhaustively Identify Potential Relationships

The system according to the invention is designed to identify as many relationships as possible by postulating that a potential relationship exists between two objects when they are observed to co-occur within the same data record (e.g., such as an abstract). Co-occurrences are calculated both within a data record as well as in text extensions (e.g., sentences), with the presumption that two objects mentioned in the same text extension are more likely to represent a non-trivial relationship. Clustering of co-occuring objects to identify their frequency of association may be performed by creating a co-occurrence matrix or by generating a dendogram that shows how phrases are linked to other phrases, or by using other standard statistical algorithms known in the art.

To test this method, a random set of 25 MEDLINE records (titles and abstracts) was chosen and objects co-occurring within each abstract were manually evaluated to establish if they shared a non-trivial relationship. It was determined that two objects co-mentioned within the same sentence were more likely (83%) to be related to one another in a non-trivial manner than objects co-mentioned in the same abstract (58%). Sentence co-mentions, however, have a relatively high rate of false-negatives, missing 43% of the non-trivial relationships within an abstract.

Two types of false positive (FP) errors were observed: random and systematic. Random FP errors occur, for example, when an object within an abstract was specific to the assay, for example, and not the study (e.g. sodium, EDTA), when no relationship existed (e.g. “We found no relationship between A and B”), or when speculative information was included (e.g. “We hypothesize a possible role in . . . ”). Random FP errors, however, may be predicted; the more co-mentions observed between two objects, the less important this random source of error became, because even if the number of relationships was inaccurate, the existence of a relationship was true.

Systematic FP errors, however, are more problematic; they invalidated a relationship between observed co-mentions as low as 1% to as high as 100% of the time. Primary contributors to systematic errors are homonym-like and polynym-like terms. Homonyms are words spelled identically but with different meanings; homonym-like terms are matching terms that are not necessarily words but can encompass acronyms and abbreviations. Polynyms are acronyms spelled identically but with multiple definitions; polynym-like terms encompass symbols (e.g. p40) that are not necessarily acronyms, per se, but are used to refer to different objects within the same group (e.g., genes).

### Acronym Resolution

Critical for Increasing Precision and Recall. Acronyms, abbreviations, and other forms of word or phrase shortening (collectively “acronyms” hereafter) aid in the efficiency of communication, but confuse text-mining software when the acronym has multiple definitions (i.e., is a polynym). An example of some ambiguous acronyms found in one data source, MEDLINE, is shown in TABLE 2. While an acronym has different meanings within the literature, the frequency of occurrence of each definition within a data source can be estimated by the Definition Percentage of unique Acronym (DPA) score. DPA is calculated by dividing the number (#) of times one specific definition is used for a unique acronym by the total number (#) of definitions used for the acronym.

TABLE 2
Examples of Ambiguous Acronyms in a Source

| Gene | Definition | Most Popular Alternative Meaning(s) | DPA score |
|---|---|---|---|
| GAS | Gastrin | Group A Streptococci, Global Assessment Scale | 3% |
| NM | Neutrophil Migration gene | Nuclear Matrix, Nodular Melanoma | 1% |
| SD | Segregation Distortion gene | Standard Deviation, Sprague-Dawley | <1% |
| CT | Cytidylyltransferase I | Computed Tomography, Calcitonin | <1% |
| ACT | Activator of CREM in Testis | Activated Clotting Time, Antichymotrypsin | <1% |

In one aspect, to remove the ambiguity of acronyms, the system implements 20 acronym resolving program code. Preferably, the code provides an automated, accurate and scalable method to identify acronym definition pairs was developed. For example, a program such as contained within the Acronym Resolving General Heuristic (“ARGH”) software may be used (Wren, J. and Garner, H. Heuristics for Identification of Acronym-Definition Patterns Within Text: Towards an Automated Construction of Comprehensive Acronym-Definition Dictionaries. 2000 Methods of Information in Medicine, referenced and relevant portions incorporated herein by reference).

An acronym-resolving program enables a system according to the invention to resolve author-defined acronyms within text. In one aspect, the acronym resolving program executable by the system enables comprises a plurality of acronym definitions. Preferably, the acronym-resolving program enables identification of relative frequencies for alternate acronyms and definitions as well as spelling, phrasing and hyphenation variants for a unique acronym-definition pair. A set of heuristics locate and identify accurately the boundaries of acronym-definition pairs and refines the precision and recall of subsets of a source record. These subsets (named training sets) are gradually increased in size and then re-evaluated by heuristics to ensure scalability. The acronym-resolving component of the system may be tailored for a specific source to improve accuracy.

In one aspect, an acronym-resolving program of the system differs from online acronym and abbreviation definitions databases; by not requiring manual compilation and curation. Preferably, the acronym-resolving component of the system does not have a narrow scope, and is generally tailored for a specific source (e.g., biomedical source) rather than encompassing too many different sources as others do. In addition, because system according to the invention must “decide” which acronyms will require resolution, the acronym-resolving system according to the invention flags an acronym in the ORD whose primary meaning consists of less than 90% of recognized definitions for further acronym resolution whenever it occurs within text before a relationship is established.

Other automated methods/programs pre-define what an acronym is supposed to look like and then write rules for its recognition. For example, other programs may require that an acronym begin with an alphabetical character, and comprise a specified character length (e.g., 3-6 characters long, etc.). Such programs typically then measure the precision and recall of the predefined rule set. Preferably, a system according to the invention implements an acronym-resolving program that identifies as many acronyms as possible ads heuristics to reduce the amount of false positives. After several rounds of use with an acronym resolving program of the invention, keeping track of the FP and FN rates, it was further refined and can be used with extremely large sources such as MEDLINE with over 12 million abstracts.

Preferably, an acronymn-resolving program executed by the system does not pre-define patterns for acronym-definition pairs. In one aspect, the program first moves right-to-left across text, matching consecutive letters found within an acronym to letters within a definition in an acronym-definition list and then uses a heuristic set to distinguish between valid and invalid pattern matches. Also, preferably, the acronym resolving program imposes very loose length restrictions on the length of definitions and acronyms (e.g., up to about 255 characters) and, instead of using a list of “noise words” to be skipped in matching patterns, the program simply allows a finite number of non-matching intermediate words (e.g., “rats” will be skipped if used as “Sprague-Dawley rats (SD)”).

TABLE 3 illustrates some examples of how acronyms are constructed within a science and technology source such as MEDLINE. Here, a sample of 100 abstracts were examined and several acronyms and abbreviations were identified. These were identified as Terms. The Terms were then categorized into one or two primary Types: acronym-like (Type I) and abbreviation-like (Type II). Each Type also contained several variations 20 defined as a subset. For example, Type IIa deviates from the standard method of constructing abbreviations by using definition letters in non-sequential order. TABLE 3 also shows are relative frequencies of each type.

TABLE 3
Example of Acronym Terms, Types and Frequencies in a Source Sampling.

| Type | Freq. | Term | Definition | Comments |
|---|---|---|---|---|
| I | 38% | AD | Alzheimer Disease | Sequential matching of capital acronym letters 1st |
| | | | | letter to each word |
| I | 1% | Bpm | beats per minute | Acronym letters correspond to 1stletters in |
| | | | | definition words, |
| | | | | capitalization unimportant |
| I | 5% | OTG7 | Orchid Transitional Growth | More words in definition than letters in acronym |
| | | | related gene 7 | |
| I | 2% | scFv | single-chain variable | Acronym letters are not in the same |
| | | | fragments | order as major letters in the definition |
| Ib | 2% | TBK | Total Body Potassium | Consecutive 1st letter matches, except a symbol is |
| | | | | substituted for a definition word |
| Ic | 4% | EPNP | 1,2-epoxy-3-(p- | First acronym letter is not first word |
| | | | nitrophenoxy)-propane | letter in definition |
| II | 9% | TGFbeta | Transforming Growth | Acronym is a mixture of 1st letter capitals and |
| | | | Factor beta | spelled-out symbol/word |
| II | 14% | GGA | Geranylgeranylacetone | Definition is concatenation of multiple words, |
| | | | | acronym letters correspond to each word |
| II | 22% | MVA | Mevalonic acid | Some acronym letters match 1st letters in definition |
| | | | | words, others are intermediate |
| | 1% | | Dishevelled | Abbreviation consists of letters within nearest word |
| II | <1% | Botox | botulinum toxin | Abbreviation is concatenation of first letters from |
| | | | | adjacent words |
| II | 1% | EcoRec | ecotropic retrovirus | Abbreviation is concatenation of first letters from |
| | | | receptor | separated words |
| Ha | 1% | EP | Phosphoenzyme | Acronym letters rearranged within the same word |

In one aspect, the acronym-resolving program defines acronyms as any abbreviatory shortening of words or phrases, not purely symbolic in nature, from a corresponding definition. Potassium (K) and Silver (Ag) are examples of purely symbolic representations, since the symbols used to represent the words are not derived from the word itself. Acronyms that are derived from a combination of their representative words and a symbolic reference, are not counted as valid acronyms (e.g., triiodothyronine [T3]). Definitions and acronyms are also no more than 255 characters long. Additionally, the rate of systematic precision (true positives/[true positives+false positives]), systematic recall (true positives/[true positives+false negatives]) and per-identification-event rate of precision and recall are determined.

“Systematic rates” refer to database entries and reflect how accurate and inclusive compiled acronym-definition patterns from set in a source (“literature” hereafter). Per-identification-event rates refer to the ability of the system to recognize instances of acronym-definition patterns within text. The two differ because a system can have an impressive rate of 98% accuracy per-identification-event on relatively small sets of literature that may be adequate for automated recognition of terms in text-processing, but may be insufficient for automated construction because as more literature is processed, errors accumulate in the database.

Entries considered false positives are those containing words unrelated to the definition of the acronym. For example, a definition of “interleukin-2” for the acronym “IL-2” would be considered a false positive error. If a heuristic was added that excluded this entry and it was the only one containing “interleukin-2” as a definition for IL-2, the exclusion would affect the systematic recall. However, if the heuristic excluded this entry but no other entries containing valid definitions for IL-2, it would only lower the per-identification-event recall. A definition such as “Interleukin-2 gene” for IL-2 would not be considered an error because, even though the word “gene” is not represented by any symbols within the acronym, it is directly relevant to the description of what IL-2 is and can be considered a definition variant. Finally, only entries that result from a software identification error were counted as FPs. For example, the definition “Interleukine-2” for IL-2 is most likely a spelling error, but could also be a valid variation (e.g., “armor” versus “armour”). Such spelling variations may be tolerated by the system according to the invention.

The set of heuristics used in an acronym resolving program according to one aspect of the invention, is summarized in TABLES 4 and 5. TABLE 4 shows heuristics used to locate acronym-definition pairs and their boundaries. In the embodiment shown in the table, a set of heuristics was cumulatively applied to batches of records (in this case, MEDLINE titles and abstracts) to identify acronym-definition patterns. As the size of the dataset increased, more variation was observed in the way acronym-definition patterns were constructed, requiring the addition of new heuristics to increase overall precision. False negatives for the additional rules are reported as how many additional valid entries are excluded from the database.

TABLE 4
Basic Heuristics for Locating Acronyms.

| | | | | | Recall | |
|---|---|---|---|---|---|---|
| Basic heuristics for locating acronyms | Total | True | False | Systematic | Per ID | Systematic |
| &definitions (n = 100) | Positive | Positive | Negative | Precision | Event | Recall |
| Term encased within | 520 | 165 | 4 | 32% | 97.6% | 100% |
| parentheses | | | | | | |
| Term consists of one word | 311 | 165 | 4 | 53% | 97.6% | 100% |
| only | | | | | | |
| Term must contain at least | 211 | 165 | 4 | 78% | 97.6% | 100% |
| one alphabetic character | | | | | | |
| All acronym letters also in | 162 | 159 | 10 | 97.9% | 94.1% | 93.8% |
| definition, in consecutive | | | | | | |
| order | | | | | | |
| Allow non-sequential 1″ | 163 | 160 | 9 | 97.9% | 94.7% | 93.9% |
| letter matches in definition | | | | | | |
| words | | | | | | |
| Additional heuristics for | | | | | (est.) | (est.) |
| boundary definition | | | | | | |
| (n = 1,000) | | | | | | |
| None | 1054 | 825 | — | 78.3% | 94.7% | 93.9% |
| Require 1S letter match on | 1054 | 869 | +0 | 82.4% | 94.7% | 93.9% |
| abbreviation-type | | | | | | |
| acronyms | | | | | | |
| Limit number of definition | 876 | 867 | +2 | 99.0% | 94.6% | 93.7% |
| words to number of letters | | | | | | |
| in acronym + 2 | | | | | | |

TABLE 5 shows the heuristics developed to reduce error rates in large-scale sources, that is, sources with over 1 million sets of data, e.g., records. While the basic heuristics for identifying acronym-definition patterns as shown in TABLE 4 work well on smaller datasets, the variability in constructing these patterns eventually lowers the systematic precision (number (#) of correct entries/total number (#) of entries) as more text is analyzed. For TABLE 5, over 153,616 unique acronym-definition patterns were recognized within 1,000,000 MEDLINE records. It was found that approximately 133,031 of the unique acronym-definition patterns were valid entries.

TABLE 5
Heuristics Developed to Reduce Error Rates

| Large scale heuristics | | | Total # | # Valid | | |
|---|---|---|---|---|---|---|
| for validating | Dataset | Dataset | Entries | Entries | | Syst. |
| acronym/definition | Total | Valid | Matching | Discarded | Systematic | Recall |
| patterns (n = 1,000,000) | Entries | Entries | Criteria* | (est.) | Precision | (est.) |
| None | 500 | 433 | — | — | 86.6% | 93.7% |
| Certain words in | 468 | 433 | 7,950 | 809 | 92.5% | 93.1% |
| definition restrict | | | | | | |
| which acronym types | | | | | | |
| are valid | | | | | | |
| Allow only certain | 465 | 433 | 1,485 | 119 | 93.1% | 93.1% |
| punctuation within | | | | | | |
| acronyms & defs. | | | | | | |
| Restrict types of valid | 458 | 433 | 3,616 | 217 | 94.5% | 92.9% |
| parentheticals within | | | | | | |
| def. | | | | | | |
| Restrict occurrence of | 450 | 433 | 7,999 | 80 | 96.2% | 92.8% |
| acronym as contiguous | | | | | | |
| substring of def. | | | | | | |
| Acronym/definition | 448 | 433 | 2,294 | 138 | 96.6% | 92.8% |
| ratio restrictions | | | | | | |
| Restrict automatic | 445 | 433 | 164 | 0 | 97.3% | 92.8% |
| extension for units | | | | | | |
| (Require 1st letter | 443 | 433 | 2,312 | 0 | 97.7% | 92.8% |
| matches for “II”, “III” | | | | | | |
| and “OH” | | | | | | |

All of MEDLINE processed (n = 12,037,763)

| | | | | |
|---|---|---|---|---|
| None | 500 | 481 | 96.2% | 92.8% |

*Some entries match more than one criterion;
Abbreviations:
def. = definition;
# = number,
syst = systematic;
est. = estimate.

TABLE 5 also shows the results of processing all records obtained from the National Library of Medicine (NLM) in XML format, representing a total of 12,037,763 records (37.3 gigabytes in size) dating up to February 2002. From a total of 6,418,919 abstracts, an acronym processing module according to the invention recognized 4,562,567 acronym-definition patterns, of which 98.8% were found in the format definition (acronym) and the other 1.2% in the format acronym (definition). From these patterns, a database of 737,330 records was created, containing 174,940 unique acronyms/abbreviations (“acronym” hereafter) and 638,976 unique definitions. Of the unique acronyms, 63,440 (36%) were associated with more than one definition and 62,974 definitions (10%) were associated with more than one acronym.

To estimate overall precision per database entry, 3 random subsets of 500 records were chosen by generating random record ID numbers. Each subset identified either 19, 15 or 18 FP errors. Thus, the overall systematic precision rate is 96.5±0.4% per entry. From observing the number of unique acronym-definition patterns excluded, the systematic recall rate was estimated to be 92.8%. To verify the accuracy of this estimate, an additional 3 sets of 100 random abstracts (differing from the previous set) were collected by searching PubMed using the non-topical keywords “determined ” “below,” and “set.” The number of acronyms defined in any manner within the titles and abstracts for each set was manually determined as was the existence of the corresponding acronym-definition pair. Ratios of identified/existing acronym-definition pairs were 139/152 (91.4%), 101/105 (96.1%) and 86/94 (91.5%) for the sets, respectively, yielding an overall rate of 93.0±2.7%.

Frequency statistics were compiled for each acronym-definition pattern found within MEDLNE; the statistics were used in the online interface to sort acronyms or definitions by their relative abundance. Use of frequency statistics enables a user to quickly identify acronyms/definitions that are more common or likely to be implied in the absence of additional information. Frequency rankings may also be used to identify preferred or “standard” spelling, hyphenation or phrasing variants. The date of the earliest occurrence for each acronym or definition was also included in the database (for historical perspective, analysis of growth in number and variants).

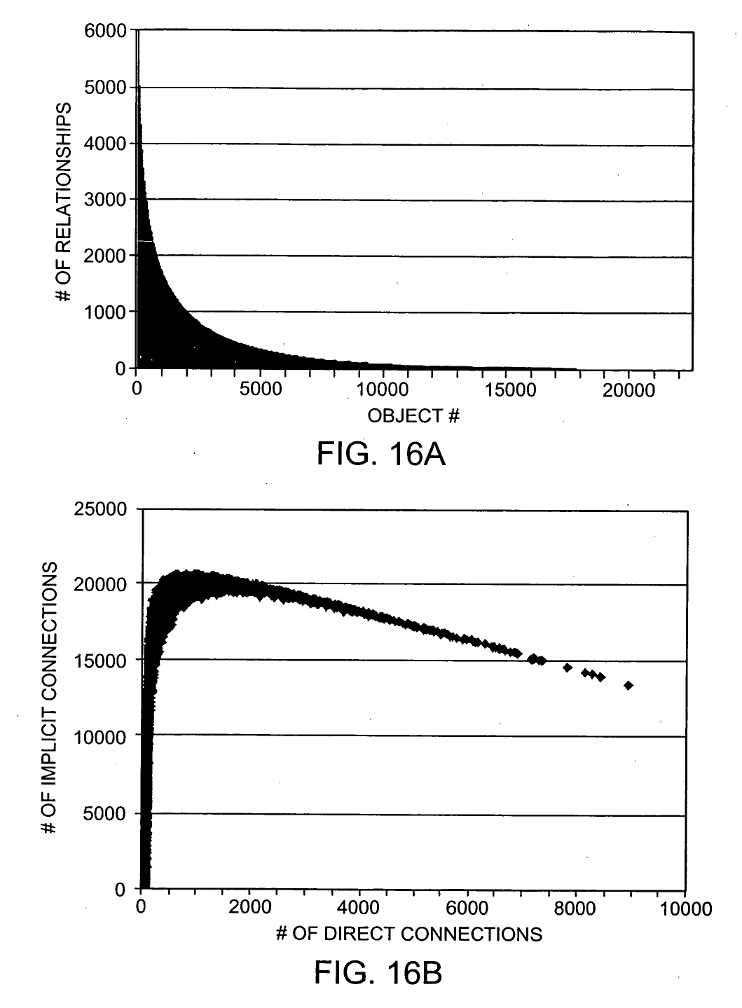

FIGS. 16A and 16B show the distribution of object and relationship. Only a relatively small fraction of objects in the database are directly related, while an extensive amount of relationships are implicit (FIG. 16A). Indeed, most objects are either directly or implicitly related to other objects in a database. These intrinsic characteristics highlight the need for a method to score implicit connections and rank their potential relevance. It is less likely that in the absence of a definition within the originating text, an acronym will be unambiguously associated with the intended definition. Because of this association, it important to know how likely a given acronym is associated with one particular definition and vice versa. To create this association, the Definition Percentage of unique Acronym (DPA) and Acronym Percentage of unique Definition (APD) are calculated as a way of estimating the likelihood of a specific acronym being associated with a specific definition in the absence of an explicit definition.

TABLE 6 shows an example of acronyms with a large number of alternative 5 definitions, giving the two most popular definitions in the database and their DPA scores. Some acronyms such as CT are predominantly associated with one definition (or its variant), while others such as PA are not. The ambiguity extends to the creation of acronyms from definitions as shown in TABLE 6. Within MEDLINE, a number of acronyms have many different definitions (polynyms). TABLE 6 includes the ten most ambiguous acronyms, 10 many of which have the least number of letter combinations to represent them. The DPA core provides a quantitative estimate of how likely an acronym is specifically associated with a definition (within the examined record) in the absence of a definition.

TABLE 6
Example of Acronyms with Polynyms

| | # Unique | Total | | | |
|---|---|---|---|---|---|
| Acro- | Defi- | # Defi- | | # times | |
| nym | nitions | nitions | Most Popular Definitions | Found | DPA |
| CA | 1,206 | 6,857 | Calcium Carbonic | 1,376 | 20% |
| | | | Anhydrase | 598 | 9% |
| PA | 1,084 | 6,466 | Plasminogen Activator | 745 | 12% |
| | | | Phosphatidic Acid | 703 | 11% |
| PC | 1,068 | 7,548 | Phosphatidylcholine | 2,741 | 36% |
| | | | Phosphorylcholine | 315 | 4% |
| CS | 1,002 | 5,527 | Conditioned Stimulus | 566 | 10% |
| | | | Circumsporozoite | 310 | 6% |
| PS | 925 | 5,236 | Phosphatidylserine | 1,269 | 24% |
| | | | Paradoxical Sleep | 409 | 8% |
| PI | 921 | 9,419 | Phosphatidylinositol | 1,978 | 21% |
| | | | Inorganic Phosphate | 1,010 | 11% |
| SC | 887 | 4,810 | Superior Colliculus | 757 | 16% |
| | | | Subcutaneous | 548 | 11% |
| AP | 879 | 7,026 | Alkaline Phosphatase | 1,120 | 16% |
| | | | Action Potential | 590 | 8% |
| CP | 868 | 5,537 | Cyclophosphamide | 607 | 11% |
| | | | Cerebral Palsy | 462 | 8% |
| CT | 866 | 25,899 | Computed Tomography | 14,033 | 54% |
| | | | Computed Tomographic | 3,414 | 13% |

TABLE 6 shows that multiple acronyms can exist for a unique definition within a source. Acronyms can be created from definitions in a variety of ways, adding a different kind of ambiguity in uniquely associating acronyms with a definition. TABLE 7 shows ten definitions with the greatest number of acronyms and/or abbreviations along with their APD score, providing an estimate of how frequently a specific acronym is used to represent a unique definition. Note that the APD score does not take into account the ambiguity of an acronym in representing other definitions. For example, BG was defined 40 times as beta-glucuronidase 40 times as well as Blood-Glucose 199 times.

TABLE 7
Example of Multiple Acronyms for a Unique Definition

| | # times | | | | |
|---|---|---|---|---|---|
| | Definition | # Different | Most Popular | # times | |
| Definition | Found | Acronyms | Acronyms | Acronym Used | APD |
| alkaline phosphatases | 3,227 | 38 | ALP | 1,624 | 50% |
| | | | AP | 1,120 | 35% |
| beta-glucuronidase | 848 | 36 | GUS | 654 | 77% |
| | | | BG | 40 | 5% |
| glucose-6-phosphate | 1,585 | 35 | G6PD | 910 | 57% |
| dehydrogenase | | | G-6-PD | 262 | 17% |
| alpha-tocopherol | 246 | 29 | alpha-T | 63 | 26% |
| | | | AT | 38 | 15% |
| beta-endorphin-like | 113 | 27 | beta-END-LI | 28 | 25% |
| immunoreactivity | | | bet-EI | 14 | 12% |
| beta-Endorphin | 822 | 25 | beta-EP | 349 | 42% |
| | | | beta-END | 199 | 24% |
| 5′-nucleotidase | 194 | 25 | 5′-NT | 37 | 19% |
| | | | 5′-Nase | 29 | 15% |
| peripheral blood | 6,953 | 25 | PBMC | 4,933 | 71 |
| mononuclear cells | | | PBMCs | 1,370 | 20% |
| glyceraldehyde-3-phosphate | 650 | 25 | GAPDH | 474 | 73% |
| dehydrogenase | | | G3PDH | 42 | 6% |
| 2-chloroadenosine | 172 | 24 | 2-CADO | 33 | 19% |
| | | | CADO | 32 | 19% |

The DPA Score. The DPA score is useful for estimating how ambiguous an acronym is (in the absence of a definition). The DPA score, however, is limited when a definition has a wide variety of spellings, hyphenation patterns or phrasings. For example, “JNK” had 77 different definitions in one database, but all were variants on the definition “c-Jun N-terminal kinase.” For this acronym, a DPA score of 41.6% for the most common definition might give the impression that JNK has alternative definitions, when it does not. As a partial solution to this problem, a “stemmed” version of an acronym-resolving database was created. Here plural endings, spacing and punctuation have been removed. Stemming reduced the number of unique definitions to 540,821 (85% of the original size); however, for some entries like JNK where the second most common definition is “c-Jun NH2-terminal kinase,” it did not reduce the number of unique definitions. A routine to align the definitions and compare similarity scores was then developed, and found, in general, to be useful (see TABLE 8). The routine, however, was unable to distinguish circumstances under which a minor variance was critical to the meaning of a definition (see TABLE 9). Nonetheless, the routine matches conceptually identical definitions from their semantic variants. The routine enables one to determine whether the difference exists in one contiguous block of text and if terms are otherwise identical over a given percentage of their length. Thus, an estimate can be made as to which terms are identical in meaning.

TABLE 8
Routine for Aligning Definitions

| Acro- | | Simi- |
|---|---|---|
| nym | Definitions | larity |
| DMH | dimethylhydrazine | 81% |
| | 1,2-dimethylhydrazine | |
| | −−−−++++++++++++++++ | |
| 12- | 12-hydroxy eicosatetraenoic acid | 73% |
| HETE | 12-hydroxy-5,8,10,14-eicosatetraenoic acid | |
| | +++++++++−−−−−−−−−−−+++++++++++++++++++++ | |

TABLE 9
Example of Less Successful Alignments

| Acronym | Definitions | Similarity |
|---|---|---|
| ABP | Androgen binding protein | 71% |
| | Auxin binding protein | |
| | −−−−−−−+++++++++++++++++ | |
| AD | Alzheimer's disease gene | 63% |
| | Aujeszky's disease gene | |
| | −−−−−−−−−+++++++++++++ | |
| ACG | Acetylgalactosamine | 74% |
| | Acetylgluc osamine | |
| | +++++++−−−−−+++++++ | |

### Text Requirements and Screening Out Uninformative Words

When conducting direct textual comparisons, capitalization patterns of text words are important. For example, in science and technology databases, not all gene names are capitalized (e.g. alpha-2 microglobulin); however, if the text word begins a sentence then capitalization is forced. In addition, some capitalization patterns are inconsistent between the object as given by the database and the object as it appears within text. Consequently, in one aspect, the system according to the invention conducts all word comparisons in lower-case.

Shown in TABLE 10 are five gene names that match common words, and are genes with the most entries returned from a PubMed query. These 5 gene words share the same spelling with common words. During text scanning, this type of error may be corrected by checking capitalization patterns.

TABLE 10
Matching of Gene Names and Words

| | | Term |
|---|---|---|
| Gene symbol | Full Name | Frequency |
| LARGE | Like-acetylglycosyltransferase | 346,940 |
| MICE | MHC class I polypeptide-related E | 252,904 |
| END | Endoglin | 194,157 |
| LIGHT | Ligand invasive growth herpes transmembrane | 177,995 |
| SEX | Sex chromosome X (Plexin A3) | 127,176 |

To determine if the capitalization pattern within a word matters, the Merriam-Webster (MW) dictionary was assimilated from Project Gutenberg. While any source of text words will work (e.g., Cosmopolitan magazine), sources that are electronically available are beneficial. Words in the ORD that match entries from the MW dictionary were flagged so that when identified within text, their capitalization patterns were checked with that in the ORD. In a few instances, the method still created redundancies/irregularities (TABLE 11). In general, the method shows that the number of terms identical to ‘common’ words (as defined by MW dictionary) varies with each source as shown in TABLE 12.

TABLE 11
ORD Matches

| Abbreviation | Full Name(S) |
|---|---|
| For | Formate, Forssman antigen |
| As | Arsenic, anti-sense, Aspermia |
| And | Androstenedione |
| if- | Fetal insulin, Free inhibitor |
| But | Butanol, Butirosin |

TABLE 12
Common Words from Different Sources

| Database | Number of Single- | Entries Matching |
|---|---|---|
| OMIM | 15,859 | 580(3.6%) |
| HGNC/GDB | 24,736 | 604(2.4%) |
| Locuslink Human | 16,767 | 343(2%) |
| Locuslink Mouse | 16,102 | 563(3.5%) |
| Locuslink Drosophila | 6,249 | 1,163(18.6%) |
| SGD | 6,626 | 9(0.1%) |

All 150,922 words found within the MW dictionary were assimilated into a database and compared with each of the single-word entries in the sources used in TABLE 12. By conducting this comparison, entries that require capitalization checking to be considered valid and those that have a high probability of being confused with common words regardless of capitalization can be found.

### Term Variance and Identification

As previously discussed, many terms have various spellings within a source and between sources. In addition, some terms are assigned official abbreviations or symbols that are also recognized/used as acronyms or abbreviations for other terms. For example, the Human Gene Nomenclature Committee (HGNC) assigns official names to every gene to avoid duplication of symbols; however, many of the “symbols” still have synonyms in one or more records or are synonymous with other general abbreviations, symbols, acronyms used/entered into a database (see TABLE 13).

TABLE 13
Symbols that also Serve as Primary Names

| Gene Symbol | Gene Name |
|---|---|
| P40 | Nucleolar protein p40 |
| | Laminin receptor I (alias) |
| | Proteasome 26S subunit (alias) |
| TPO | Thyroid Peroxidase |
| | Thrombopoietin (alias) |
| RSS | Russel-Silver Syndrome gene |
| | Rigid Spine Muscular Dystrophy (alias) |
| MCD | Malonyl CoA Decarboxylase |
| | Medullary Cystic Kidney Disease (alias) |

It is also not uncommon for symbols (e.g., abbreviations, acronyms, official names) to change or evolve over time; however, older records are rarely updated to “correct” for these evolutions. This can prove problematic in proper recognition of the terms. Shown in TABLE 14 is the number of times a specific “symbol” observed within MEDLINE is associated with a specific definition. For an acronym such as TNFR2, the duplication can be dealt with in part by expanding nested acronyms (e.g. TNF) into their full definitions before comparisons are made and to determine if two definitions are equal. If two terms are still not equal, as would be the case with the definition “TNF-receptor type 2,” an imperfect solution is to “align” the different definitions as discussed earlier.

TABLE 14
Symbol and Definition Association

| | | # of Times |
|---|---|---|
| Symbol | Definitions | Observed |
| JNK | c-Jun N-terminal kinase | 538 |
| | c-Jun NH2-terminal kinase | 150 |
| | c-Jun amino-terminal kinase | 58 |
| TNFR2 | Tumor Necrosis Factor Receptor 2 | 13 |
| | TNF receptor 2 | 7 |
| | TNF-receptor type 2 | 1 |
| TIF2 | Transcriptional Intermediary Factor 2 | 7 |
| | Transcription Intermediary Factor 2 | 6 |
| | Transcriptional Intermediate Factor 2 | 2 |

### Analysis Using MEDLINE as a Source of Knowledge

In one example, the system according to the invention was used to process 12,037,763 text records from MEDLINE (“source” hereafter; records dated from 1967 to January 2002) and to create a network of 3,482,204 unique relationships between objects in a database. Approximately ⅔ of the objects in the database found exact literal matches, identifying at least one relationship for 22,482 of the 33,539 unique objects (85,234 total terms when including synonyms) within the database.

### Entries as a Basis for Object Identification

In one aspect, recall rates for the system were estimated from a set of records (i.e., review articles) culled from MEDLINE. Four objects were randomly chosen from a collective object database of the system, representing one of each object type, with the stipulation that at least 2 MEDLINE records (review articles) were about the object within the past 3 years. A set of 2-3 review article records was then selected, and a list of all other objects mentioned therein having any non-trivial relationship to the original query object was compiled. Only objects of the same type as those in the central database were counted (e.g., genes, diseases, phenotypes and small molecules). Review articles records were selected for CTLA-4 (gene), Fragile-X Syndrome (disease), cachexia (clinical phenotype), and dynorphin (small molecule). The list from each set of records was then compared to the relationships identified by the system after processing all of MEDLINE.

As TABLE 15 shows, objects contained within the collective system database represent an estimated 78% (141/181) of the total number of objects of their type found within the selected records described above. Here, the relationships within MEDLINE records are compared to the relevant relationships between objects in the selected records. Of the 40 objects mentioned in the literature but not found in the database, 2 were, diseases, phenotypes, 7 genes, and 22 small molecules. The 2 disease names (Graves' Opthalamopathy and Relapsing-remitting Experimental Autoimmune Encephalomyelitis) a 9 phenotypes were ones not mentioned in OMIM. Three of the phenotypes turned out to be the result of semantic difference between OMIM and MEDLINE (i.e., “rocking” versus “body-rocking,” “greater interocular distance” versus “increased interocular distance,” and “fetal akinesia” versus “akinesia”). Interestingly, for the small molecule category, many chemicals and drugs that were mentioned in MEDLINE (e.g., DAMGO, DADLE, isoprenaline) were not found in its MeSH trees database.

TABLE 15
Database Objects Used by the System to Identify Relevant Relationships

| | | Total # | Total | Total | Object in | Object in |
|---|---|---|---|---|---|---|
| Name | | MEDLINE | Rel. in | Rel. Found | DB with | Record; |
| (# of reviews) | Category | Records^{a} | Record | in DB | No Rel. | Not in DB |
| CTLA-4 (3) | Gene | 1,191 | 44 | 37 | 2 | 5 |
| Dynorphin (2) | Molecule | 2,647 | 40 | 23 | 4 | 13 |
| Fragile-X (3) | Disease | 2,141 | 35 | 22 | 6 | 7 |
| Cachexia (3) | Phenotype | 2,933 | 62 | 42 | 5 | 15 |
| TOTAL | | | 181 | 124 | 17 | 40 |

^{a}Culled as of 1/23/02. This analysis was conducted after all MEDLINE records were processed.
Abbreviations:
# = number;
Rel = relationship;
DB = the system's identified relationship database.

Further analysis revealed that 17 of the 141 database objects cited in the MEDLINE records to be related to one of the central query objects were not mentioned within any MEDLINE title or abstract related to the query object. Of these, 9 were unrelated because of spelling/phrasing differences, 1 because it was flagged as an ambiguous acronym and not defined in the record (PKI), and I because it the article review record used a name (NFAT) not used in the MEDLINE abstracts. The remaining 6 unrelated objects represented relationships not mentioned in the titles/abstracts of the review article record. Out of 138 relevant relationships mentioned in MEDLINE (i.e., titles and abstracts), the system according to one aspect of the invention identified 127 of them, proving to have a recall rate of 92% in terms of identifying the conceptual occurrence of database objects within textual input.

In terms of identifying informative relationships between object types within MEDLINE, the system recognized an estimated 78% (141/181) of those considered relevant relationships with an estimated recall rate (identifying relevant relationships within a domain) of 70% (127/181).

The FNs (i.e., failure to identify objects within text) were generally found to be systematic error (e.g., the MeSH entry 5,8,11,14,17-Eicosapentaenoic Acid is almost always referred to in MEDLINE simply as eicosapentaenoic acid). Failures varied in their rates. For example, JNK was spelled 81 different ways, including “c-Jun N-terminal kinase” (605 times), “c-Jun NH2-terminal kinase” (154 times) and “c-Jun amino-terminal kinase” (62 times).

### Scoring

The scoring mechanism that was developed was based on the statistical properties of relationships in a network. As shown, the number of relationships identified per object follows an exponentially decreasing distribution (FIG. 16A), indicating a highly disproportionate distribution of object terms within a source. Using MEDLINE source as an example, sodium was found to be the most abundantly mentioned object. It was found at least once in the same abstract with 8,868 other objects (−40% of all objects identified). Using this as a network of relationships, the number of direct connections for each object versus the number of purely indirect (implicit) connections can be projected (FIG. 16B). The projection shows that as the number of direct relationships increases, the number of implicit relationships rapidly approaches a theoretical maximum, which is the total number of nodes in the network. Even objects with relatively few direct relationships can still be implicitly related to the vast majority of objects in the network. While this high degree of implicit connectivity may be due, in part, to some objects being associated with extremely abundant terms, such as sodium, it also demonstrates how trivial an implicit relationship really is.

Therefore, the fundamental challenge in identifying novel relationships with potential value relies on the relevancy and an assignment of relevancy to each implicit relationship. Furthermore, the system must be able ascertain the relevancy of shared relationships (as a measure of exceptionality) within the context of the network and its connective properties.

For direct relationships between two objects, there is a straightforward method that assigns strength scores to each relationship based upon an estimated error rate and frequency of co-occurrence. Terms that co-occur more frequently are more likely to represent valid relationships; thus, object relationships are assigned a score based on the number and type of co-mentions observed (i.e., abstract versus sentence) and their corresponding error rates.

Using terminology adapted from graph theory, objects can be considered as “nodes” and relationships (co-citations or co-occurrences ) as “connections”, also known as the “edges” between nodes. An implicitly related node (C) is defined as one that has no direct connection to the query node (A), yet is connected to one or more intermediate nodes (B)that are simultaneously connected to A. To evaluate the potential significance of an implicitly related node, the set of i nodes (Bi ) shared by both the query node A and the implicit node C may be compared against a random network model. Because node A is of interest and literature associated with A is related to all nodes in the set Bi, the number of connections between Bi and C that might occur by chance is determined. For example, if C were related to every node in a 1000 node network and A had 100 connections within this network, all of which were shared with C, this would be expected and therefore unexceptional. Thus, dividing the number of observed connections (Obs) between Bi and C by the number of connections expected to arise by chance (Exp) provides a value reflecting the statistical significance of the shared connections.

This value allows an estimate of the potential relevance of a set of connections to be determined the question. For example, if a set of connections linking a disease (A) to a chemical (C)were to encompass highly common nodessuch as “sodium” and “symptom”, whether true or not, these types of connections are sufficiently vague to be of little use to a scientist in postulating how A and C might have an interesting and specific connection through these intermediates. If the shared connections involve specific transporters or genes, which would not be as frequently mentioned in the literature, it becomes easier to postulate how specific actions of (C)could produce (A).

The probability that a relationship between A and B is an error is represented as a function of the number of times, n, the two objects are co-mentioned and the random error rate, r, associated with the co-mention metric used to establish the relationship and is:

P(err)=rⁿ. (1)

Thus, the probability that the relationship is valid can be written as:

P(valid)=1−rⁿ. (2)

The strength of a relationship can be seen as a function of the number of times it has been observed and the collective probability of each observation being an error. Because two different relationship metrics are calculated: sentence co-mentions (Cₛ), and abstract co-mentions (Cₐ), an overall strength of association score (S) is assigned, based upon their individual error rates, rₛ (17% FP) and rₐ (42% FP), respectively, and becomes the formula:

S=Cₛ*(1−rₛ)+Cₐ*(1−rₛ). (3)

For implicit relationships there is no clear statistical parameter that correlates with the probability of it representing a valid relationship; however, one can surmise that the probability of an implicit relationship (A-B-C) being valid would not be greater than the least probable of the two individual relationships linking them (A-B or B-C). Therefore, where the symbol ←→ is defined as the existence of a non-directional relationship between two objects, it is estimated that:

P(A [symbol] C)≦P(A [symbol] B)*P(B [symbol] C). (4)

It is important to provide a control for sets of relationships and implicit relationships to ascertain whether or not such a grouping of objects is meaningful. While it may be difficult to prove that some strongly implicit relationships, such as the many shared relationships observed with the common object “cancer,” are not meaningful, a measure of exceptionality may be assigned to the relationship based upon the total number of relationships each object has within the network. Assuming that a number of objects were randomly connected in a network with the same connectivity as shown in FIG. 16A, the odds can be calculated that any two objects would be implicitly related and how many intermediate relationships the objects are expect to share. The probability that two objects in a network, A and B, are related to each other, assuming a random distribution, given that each object is known to be related to a total of K.ₐ and K_{b} objects, respectively, in a network containing a total of Nₜ nodes is given by the formula:

$$P ( A ↔ B ) = 1 - ( 1 - \frac{{K}_{A}}{Nt} ) * ( 1 - \frac{{K}_{B}}{Nt} ) . \qquad ( 5 )$$

Summing the probability of each individual relationship, the formula maybe extended to estimate the expected number of times n objects in a set, B, would be associated with another object, A, by the equation:

$$P ( A ↔ {B}_{1}^{n} ) = {\sum }_{1}^{n} 1 - ( 1 - \frac{{K}_{A}}{Nt} ) * ( 1 - \frac{{K}_{{B}_{1}}^{ n}}{Nt} ) . \qquad ( 6 )$$

The ability of formula (5) to predict the probability of two objects being associated, assuming a randomly connected network, was confirmed by assigning a random number of relationships (1 to 10,000) to two objects within a 10,000 node network and determining whether or not one of those relationships connected the two objects. This was allowed to run for 10,000 iterations and compared with the expected number of relationships. The result was that the observed/expected ratio converged to 1.0 as the set size increased, demonstrating that formula (5) accurately predicted behavior in this type of network. This was repeated for the system's literature-derived network, randomly picking two objects, each having at least 1 relationship within the network, run 10,000 times, and the ratio of observed to expected relationships was determined to be 0.40. A ratio less than 1 is consistent with a network whose connectivity is not random.

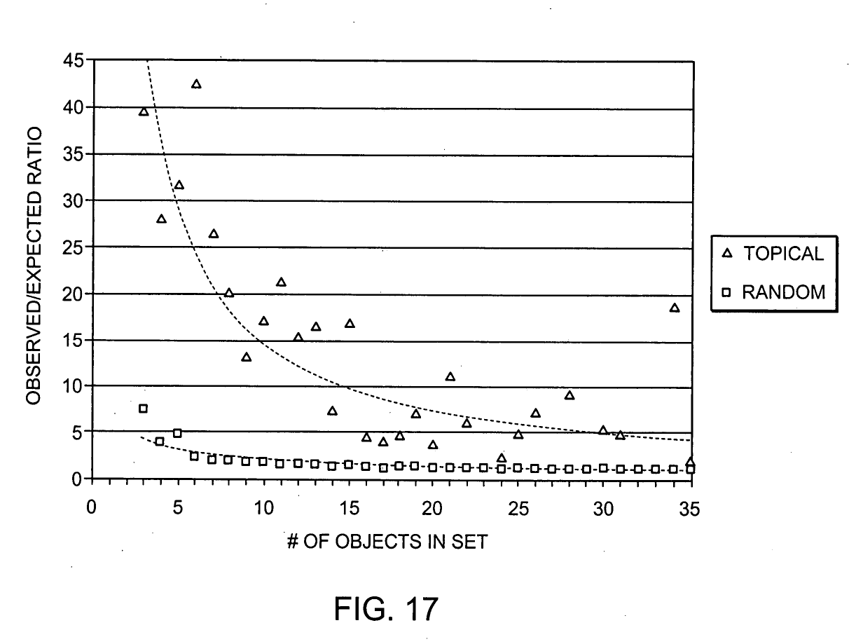

To establish that formula (6) aids in quantitatively evaluating relevant groupings, sets of objects created at random from the database were compared with sets of objects expected to share common elements (obtained by using genes within specifically defined ontological categories from the Genome Ontology database). Using formula (6) to calculate an average observed-to-expected ratio for the 10 most frequently shared relationships between objects, the ratio was consistently higher for the topical set or cluster than for the random set as shown in FIG. 17.

### Estimating the Relatedness of Two Objects by Virtue of Their Shared Relationship

In one aspect, formula (6) was used to estimate how exceptional an implicit relationship is, given the relative abundance of each of the two objects within the network. This method of scoring evaluates the probability of a relationship or property being shared among a set of potentially heterogeneous objects. When evaluating implicit relationships, it is often necessary to determine how relevant a specific relationship is between, e.g., A and C. A system according to the invention allows relevancy to be a subjective quality. Therefore, how important a relationship is between A and C may depend on the analysis, conditions, research, etc. By evaluating the quantitative statistical properties of relationships known to be relevant, they can be compared to the same properties of objects suspected to have an implicit relationship.

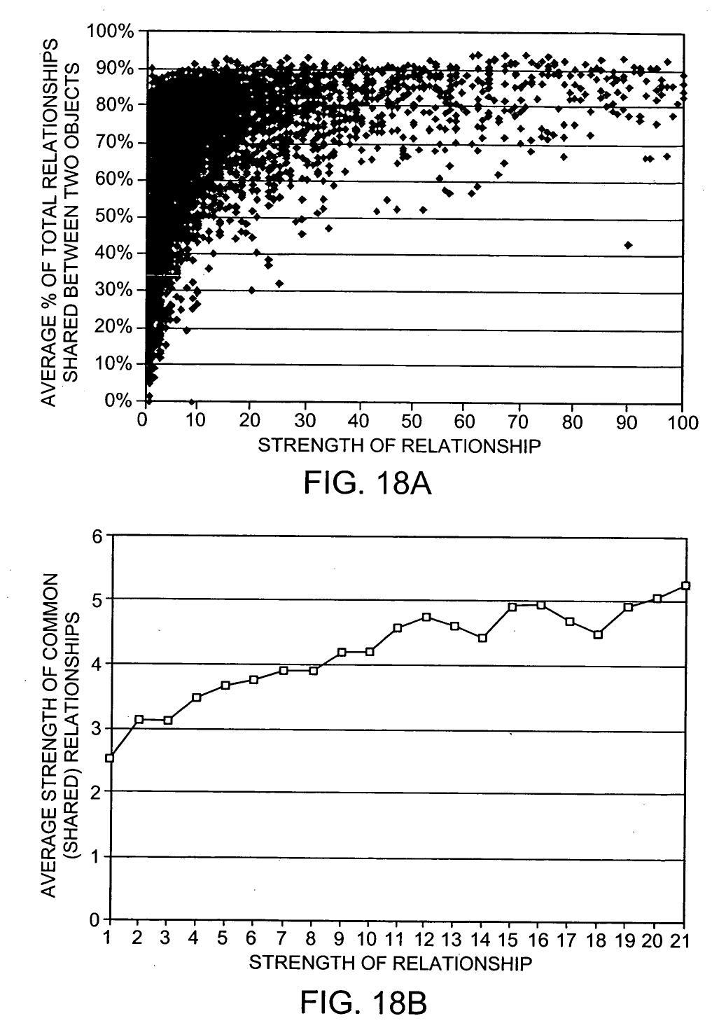

Among a number of properties, the greater the strength of the relationship between two objects, the more relationships they tend to share, as shown in FIG. 18A and the stronger these shared relationships tend to be, as depicted in FIG. 18B. As a result, the greater the number of relationships two objects share and the stronger those shared relationships are, the higher likelihood that the two objects are related. A quantitative estimate of how related two objects are can be derived by calculating the percentage of overlapping relationships.

The system is able to estimate what proportion of important relationships are shared. When an object, A, is implicitly related to another object, C, by a number of intermediates, B, it can be anticipated that the probability of a relationship between A and C is greater if they share a set of strong rather than weak relationships. Dividing the total strength of the shared relationships by the total strength of all relationships, what proportion of the important relationships are shared may be estimated. The area underneath a curve can be calculated as the integral of the total strength of the relationship to provide a total strength number or vector. This total strength number can be calculated for the relationships shared by A or by C, reflecting in part the directionality of the relationship. For example, the development of cardiac hypertrophy is highly correlated with the presence of essential hypertension. Many of the shared relationships with cardiac hypertrophy are those known to contribute to essential hypertension (e.g., genes and phenotypes). Essential hypertension, however, is related to other human conditions such as diabetes, stroke, and obesity. The strength of shared relationships with cardiac hypertrophy is correspondingly lower.

The disadvantage of this exponential weighting scheme is that high priority is given to the few relationships that comprise the leftmost portion of the curve, many of which are generally already understood or have been contemplated, and hence, not novel. As mentioned previously, high frequency of co-occurrence is, in part, a function of how long a relationship has been known. New, important relationships may not have had sufficient time to accumulate high frequency of co-occurrence. To overcome this, the curve can be converted into a linear ranking of relationships by their strength to reduce without eliminating the relative importance of time as a factor. As an example, a biologic agent calcineurin is a relatively new and important factor responsible for transducing cellular signals that may lead to the development of cardiac hypertrophy. Under an exponential weighting scheme, the relative contribution of calcineurin to the area under the curve is [X]. Using a linear ranking scale raises its relative contribution becomes [Y].

An number of additional factors may be used to rank relationships. For example, additional terms to rank results include: the impact factor or importance of information that linked objects (for example give a higher weighting to connections between objects made in a abstract from a Science article than a article from the Journal of Irreproducible Results), the date on which an article was published, giving priority to recent articles that connected objects, the strength of the relationship—such that if an object A is linked to B which is then linked to C is with each link very strong, this would be ranked higher than an association between A-B-D where B-D would be weak. Strength is based on number of occurrences and expected number of occurrences. Still other factors include, but are not limited to:author credibility or institution in which author resides as a method to rank importance of the work; connections validated by appearing in two separate sets of literature, such as medline abstracts and books. Additionally, rank may be based on on the number of connections between objects normalized to the number of connections between any object and other objects in the network (literature database). For it is the connections that are important, and perhaps more important than the number of times a object (word) appears in the network (literature). In the example just sited, the system would compute the ranking based on the observed number of connections to and from object B normalized to the number of times B is connected to all other objects. For example, the object ‘cancer’ may appear in 20% of all medline abstracts and this can be used to calculate the O/E ratio based on object useage, but it may be connected to 27% of all the different objects in medline, and so an O/E ratio based on the number of connections can be made. Of course, as in item #10 above, all these subsequent items, including this one can form the basis of on part of a algebraic ranking value that is comprised of all these different criteria appropriately weighted.

In one aspect, relationships are identified and ranked using a fuzzy set program executed by the system. Classically, a set is defined by its members. An object may have a degree of membership (μ) to the set either equal to one (μ=1), i.e., it is a member of the set or equal to zero (μ=0), i.e., it is not a member of the set. Fuzzy set theory recognizes that any object may be a member of a set to some degree (the degree of membership may be between zero and one (i.e. 0≦μ≦1)), i.e., fuzzy set theory recognizes that membership in a set is not always clearly defined.

By processing data sources comprising a plurality of domains of knowledge, a comprehensive network of tentative relationships is created enabing the relatedness of a set of objects to be evaluated based upon the relationships they share. Assigning a measure of “cohesiveness” to a set allows researchers to infer that an experimental grouping is purposeful (assuming the grouped objects are adequately represented within the literature). Cohesiveness is determined by how much higher a set's average Obs/Exp score is from the random average. When used to analyze relationships shared by a set of objects, general ‘themes’ can be identified (e.g. cancer, apoptosis, diabetes) along with statistically exceptional groupings within the list (e.g. drugs affecting the activity of a group of genes). Further, it provides a method to identify ‘missing members’ in a set, by their relatedness to the group as a whole.

In one aspect, the system executes its scoring function to evaluate microarray data. For example, the system provides a method of ascertaining whether or not a set of transcriptional responders contains members with documented relationships. In this way, a researcher can decide whether or not the experiment measured a specific response, giving the potential to recognize when a transcriptional response is the result of less stringent hybridization conditions or errors such as cross-hybridization. Importantly, the system provides a way to relate non-genetic factors from microarray experiments to be identified and ranked (e.g., such as phenotypes, diseases, metabolites and chemical compounds).

### The Veracity Score

In some instances, the strength of a relationship is not as important as its certainty. For example, if two objects shared a subset of relationships to objects collectively responsible for a specific biologic process (e.g. acute-phase immune response, cell division, microtubule assembly, etc.), the relative strength of such relationships is not necessarily as important as the fact that the relationships are shared. Under this circumstance, it is preferable to evaluate whether the co-mentions represent actual relationships. Assuming that the odds of one co-mention being a FP error is 50%, then, using the veracity score, the odds of two co-mentions both being errors would be 50%·50%=25% or 0.25. The veracity score for any given relationship generally ranges from the lowest possible FP rate measured for co-mentions to 1. Shared relationships in terms of their integral veracity scores may also be plotted.

### System Logic: Meta-Relationships, Semantic Parsing, and Information Extraction

In a standard query-based approach to searching for items of research interest (e.g. such as searches performed using PubMed), irrelevant results are often obtained. Altough the graphical user interface through which a user interacts with PubMed is simple and intuitive, the more information that becomes available the harder it becomes to find items of interest.

For example, a researcher interested in phenomena that cause an increase in magnesium levels might use the words “magnesium” and “increase” in a search, or some variants thereof. Phrase-based searches allow one to use conjunctive terms, e.g., “increases magnesium levels.” However, conjunctive terms have large numbers of permutations, e.g., “found to increase magnesium concentration” or “observed elevated intracellular levels of magnesium”, “demonstrated higher magnesium levels”, etc. Standard query-based methods use a Boolean approach to searching for items of research interest. However, a limitation of such queries lies in the chain of causality-conducting a Boolean search for “‘magnesium’ and ‘increase’” returns results that may be difficult to interpret. For example, it would be unclear whether the returned results are about the effects of an increase in magnesium, what may increase magnesium, how magnesium is increased, what may effect magnesium increase, etc. Further, the results are likely to include a number of false positives containing phrases matching selected search words such as “. . . can cause intracellular magnesium depletion and an increase in intracellular calcium”. Because one would also want to ensure that word root variants like “increasing” and “increased” are not left out, one could employ the use of wild cards like “increas*”. Wildcards will help make the search more comprehensive, but also quickly increase the number of false positives. Worse, synonyms that describe the same phenomena, such as “Mg2+” or “elevation”, “rise” and “higher levels of” are not included in the search.

Some sources have attempted these multiple variations by providing a method of mapping words to a controlled vocabulary for informational categorization. MEDLINE uses MeSH (Medical Subject Headings) to map a word or phrase onto topical (Subject Headings) searches, which helps include synonyms in a search and enables the ability to find documents where commonly used keywords relevant to the study may not be included in the title or abstract. MeSH allows the mapping of a word or phrase onto topical (Subject Headings) searches, Even though not all biomedically relevant synonyms have been mapped, MeSH usually works very well when searching for information on individual topics, and even allows for selection of subtopics. However, MeSH is primarily limited to nouns and will not allow a search on types of interactions that nouns may have. Neither does it provide context or an efficient way of elucidating relationships between one item of interest and others. TABLE 16 illustrates the keyword variance in returned results from MEDLINE searches.

TABLE 16
Example of Results that Vary Depending on
Construction of the Query*

| Query | Results^{a} |
|---|---|
| Magnesium | 58,011 |
| Mg²⁺ | 22,141 |
| Magnesium (MeSH: all subheadings) | 46,151 |
| Increase* | 1,396,427 |
| magnesium and increase | 5,773 |
| magnesium and increases | 2,171 |
| magnesium and increased | 7,936 |
| magnesium and increasing | 2,241 |
| magnesium and (increase or increases or | 13,291 |
| increased or increasing) | |
| “increases magnesium” | 13 |
| “elevates magnesium” | 0 |
| “higher magnesium concentration” | 5 |
| (MeSH: Magnesium) and increas* | 9,490 |

*Results are from all MEDLINE records as of Nov. 21, 2000, obtained using the Ovid search engine.

It is this incredible amount of data and information that is available from such a search that, ironically, makes it harder to find relevant information. Scientists use a variety of shortcuts to aid in this task, such as narrowing the range of journals they read to ones they consider focused and high-quality in the hope that relevant information will be published there as well as attending national meetings to keep in touch with colleagues and current research in their field. While this is effective to an extent, they both rely upon other people who are just as limited as they are to provide coverage and screening of information. And unfortunately, while these strategies help keep people informed, it does not put them at the forefront of knowledge. If nothing else, it is evident that there is a need for more efficient ways of searching the literature for phenomena of interest because there are too many false positive results.

To reduce the number of false positive results, the system according to the invention provides an inference extraction (IE) engine that receives input relating to a data sorce (e.g., text and/or data) and provides output in the form of objects. The system then determines whether there are patterns in the output (e.g., objects which co-occur in an abstract; objects which co-occur in sentences) to determine relationships between objects and to identify topical clusters. As used herein, a “topical cluster” or “topical set” used interchangeably, refers to a grouping of information (data) of interest (as a term, phrase, category). When objects cooccur in a topical cluster, there is a chance they are related. A topical unit may also be a grouping as defined by a source, where each source may have a different grouping. For example, in MEDLINE (as a source), the topical cluster may be an abstract. In other sources, the topical cluster may be paragraph, a page, a spreadsheet, where the grouping may be numeric, textual, symbolic, or any combination thereof.

In addition, the system may use other connections and inductive/deductive logic to hypothesize what sort of properties or behaviors an object should have given similar sets of relationships among other similar objects. In one aspect, the system relies on co-citations to establish relationships that are unidirectional in nature. In another aspect, the system may complete different types of analyses when the nature of the relationship is unknown, such as searching for antagonistic or complementary phenomenon to enable the nature of the relationship to be identified. This rule determination function of the IE engine may be used to catalog the relationship, e.g., defining a meta-relationship as discussed further below.

### Meta-Relationships

An object may have many synonyms, whether a word or a phrase, that can enable a “many-to-one” mapping. Similarly, descriptions of actions, reactions, changes, variance or any other type of relationship an object might have with another object can be described in many different ways. Determining synonyms for relationships is not sufficient for it is the general type of relationship or category represented different synonyms that is of interest. Such a general type of relationship, or categorical clustering, encompasses a large variety of interactions referred to herein as a “Meta-relationship.”

For example, observations can be made regarding the interactions of two proteins and described using terms such as “associate”, “dissociate”, “adhere” or “bind”. Whereas “associate” may have a subtly different meaning than “bind”, it is not entirely incorrect to catalog the interaction under a general terms such as “physical association” rather than under each individual heading. An example of such categorical clusterings can be seen in NCI's MedMiner, which attempts to group together sentences containing search keywords into a general category, but a more accurate comparison would be what the NIH's UMLS system calls a “semantic relationship” and similarly encompasses a broad number of terms.

In one aspect, the system identifies four basic types of Meta-relationships: a positive effect (increase), negative effect (decrease), physical association and logical association. A list of root forms of the keywords denoting such relationships is shown in TABLE 17 below, which indicates how frequently these words or their root form variants appear in MEDLINE. Word spelling variants (e.g., releaser vs. releasor; disassociate vs. dissociate) have been checked for each one and will not be included because they comprise a small portion (typically<2%) of their usage.

TABLE 17
ROOT Meta-relationship keywords in MEDLINE
As of Dec. 18, 2000

| Increase | Decrease |
|---|---|
| Activat* (415,310) | Degrad* (86,234) |
| Enabl* (53,244) | Ubiquitinat* (1,244) |
| Induc* (905,161) | Inactivat* (77,008) |
| Increas* (1,396,427) | Deactivat* (3,877) |
| Upregulat* (13,369) | Block* (271,393)^{†} |
| Up-regulat* (379,907) | Repress* (28,562) |
| Rais* (98,364) | Suppress* (172,959) |
| Elevat* (209,038)^{†} | Decreas* (686,727) |
| Enhanc* (296,430)^{†} | Downregulat* (8,636) |
| Releas* (275,316) | Down-regulat* (24,282) |
| Stabiliz* (54,136) | Depress* (182,205) |
| Higher (518,292) | Reduc* (769,287) |
| Agonist* (103,108) | Inhibit* (743,450) |
| | Sequest* (12,092) |
| | Destabiliz* (5,965) |
| | Lower (410,993) |
| | Antagonist* (167,073) |
| Association, Physical | Association, Logical |
| Bind* (519,336) | Modif* (245,349) |
| Cleav* (63,683) | Regulat* (382,435) |
| Cataly* (98,809) | Acetylat* (12,142) |
| Interact* (321,075) | Phosphorylat* (78,924) |
| Dissociat* (62,378) | Mediat* (323,761)^{†} |
| Heterodimer* (10,190) | Control* (935,431 )^{†} |
| Complex* (356,990)^{†} | Affect/s (187,119) |
| Associat* (879,398)^{†} | Effect* (1,872,664) |
| Symptom* (267,651) | Correlat* (475,991) |
| Abnormal* (283,924) | |
| Deficien* (153,465) | |

Asterisks (*) are used to denote wildcards.
^{†}Noun form of verb or alternative use of words throws off accurate estimate of total (e.g. “blocks of time”, “elevator accidents”, “enhancer element”, “complex behavior”, “association of physicians”, “experimental control”, “mediated discussion groups”)

These specific Meta-relationships were chosen for the purposes of end-utility, i.e., not only defining objects of interest but characterizing these as well. General associations and categorizations can be useful for a variety of purposes, and for obtaining quantitative, rather than qualitative, changes enables the system to search for complementary and antagonistic phenomena. Knowing the phenotypes of a disease and which other phenomena are responsible for generating similar phenotypes and opposite phenotypes can aid in determining the origins of the disease and searching for potential cures.

For example, a medical condition may cause a decrease in alcohol dehydrogenase (ADH). This quantitative phenotype would be of interest to the system because a way of treating this symptom would involve increasing ADH levels. The same condition may have another phenotype of liver toxicity, but the opposite of toxicity is hard to define even though possible antagonistic words like “restoration”, “regeneration” or “growth” might be envisioned. Toxicity is a relatively generic term, qualitative in describing a phenomenon and difficult to define what its antagonist or complement might be. However, it might be useful as a link to understanding if one is working with patients suffering from liver toxicity due to unknown causes.

Quantitative relationships are those in which verbs and verb phrases such as “increases”, “upregulates”, or “elevates the levels of” are used to describe them. Qualitative relationships are those that can be quantifiably measured, but are put in broader terms of “more” or “less” of a characteristic. They are denoted by the use of adjectives or nouns such as “hypertrophic”, “hypoplasia”, or “megalencephaly”. In one preferred aspect, the inference-extraction engine includes additional linguistic capabilities in the system to include relationship analysis for terms (e.g., verbs, adverbs, adjectives) that link current objects, such as are common in the field of biomedicine (e.g., “increases”, “binds” “regulates”) as well as terms that negate (e.g., “Does not . . . ”, “not”, “inversely”.

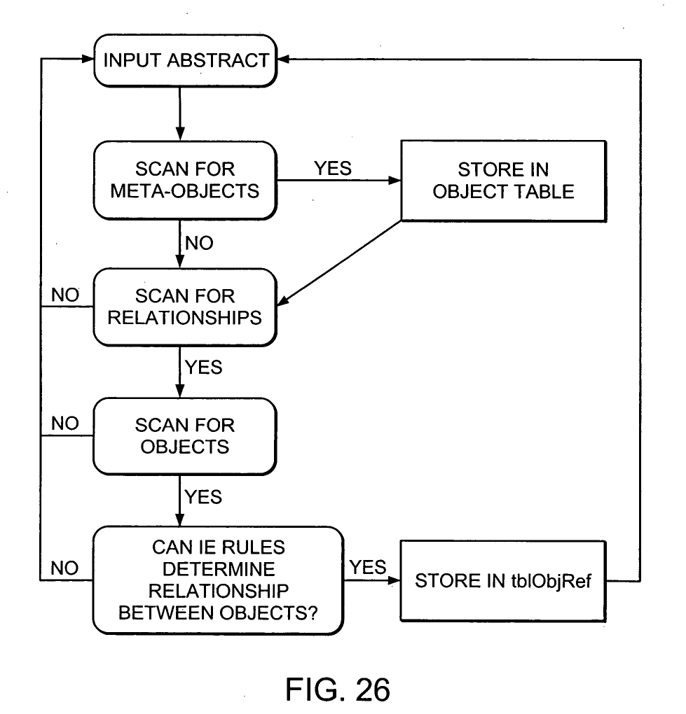

As show in FIG. 26, in one aspect, the inference extraction engine of the system scans sentences from abstracts (e.g., from MEDLINE or other sources) for Meta-objects to be cataloged in an Object table (“tblObjectSynonyms”). Then the text is scanned for the Meta-relationship keywords that indicate a possible relationship. If a relationship is found, the system then scans a sentence for objects. If less than two objects are found, the next sentence is scanned. If a relationship and two objects are found, the system sends the sentence to a grammar parser and then to an IE rule determination set in an attempt to properly catalog the relationship. If a good match is found, it is stored in the system database.

### Relationships: Linking A to B

Relationships between objects are stored in terms of their Meta-relationship, but the same type of relationship can be worded in the literature with a variety of different grammatical constructs, as shown in the Table below. Preferably, the system according to the invention is able to extract these relationships (i.e., to determine that “inhibit” corresponds to the Meta-relationship, “decrease”) as well as their objects (“wnt”, “the quaternary complex”) from a data source. The table below shows different grammatical constructs to express the concept, “wnt signaling somehow inhibits the kinase activity of the quaternary complex.”

TABLE 18
The many grammatical ways to describe
the effect of the gene wnt upon the
kinase activity of the quaternary complex

| | Form of the verb “to |
|---|---|
| Phrase | inhibit” |
| Wnt signaling acts to inhibit the kinase activity . . . | Verb (root form) |
| Wnt signaling somehow inhibits the kinase | Verb (3^{rd} sing. pres.) |
| activity . . . | |
| QC kinase activity is somehow inhibited by wnt . . . | Verb (past) |
| Wnt signaling somehow inhibiting kinase | Verb (pres. |
| activity . . . | particip.) |
| Wnt signaling somehow leads to the inhibition of | Noun form (gerund) |
| kinase activity . . . | |
| Wnt signaling somehow acts as an inhibitor of | Noun form (sing.) |
| kinase activity . . . | |
| Wnt signaling is one of the inhibitors of kinase | Noun form (pl.) |
| activity . . . | |
| . . . study the QC inhibition. It is somehow due | Pronoun reference |
| to wnt signaling . . . | |
| Wnt signaling somehow has inhibitory effects | Adjective |
| upon the QC . . . | |
| Wnt signaling somehow becomes inhibitive | Adjective |
| towards the kinase . . . | |

Terms and phrases included in Meta-relationships can be added and modified as needed. Examples of some Meta-relationships and how they are used are in TABLE 19.

TABLE 19
Example of Meta-Relationships When Meta-Objects are Added

| Meta-Relationship | Keyword(s)/Pattern(s) | Usage |
|---|---|---|
| Subset.family | The * family; | Members of the same family can be |
| | | assumed to have similar properties. |
| Similarity.sequence | Homologous; | Homologs will be assumed to have the |
| | orthologous; paralogous | same roles and associations as their |
| | | counterparts in other species |
| Similarity.structure | Domain is similar to; has | Structural similarities could mean |
| | a conserved fold | functional similarities. If a domain is |
| | | associated with a function and a protein |
| | | has that domain, it will be assumed to have |
| | | that function. |
| Location.cellular | localiz*; found in; located | Association/exclusion studies |
| | in; membrane-spanning; | |
| | transmembrane | |
| Location. systemic | Expressed in; found in* | When all else fails, it can be useful to go |
| | tissues, found in *cytes | over a list of all known ESTs expressed |
| | | only in the specific tissue of interest and |
| | | suggest one of them based upon functional |
| | | domain similarity |
| Logic gate | and along with; in | Logic gates are the core of complexbehavior |
| | addition to; or; but not; | |
| | without; in the absence of; | |
| Subset | part of the; belongs to the; | Logical consistency checking of |
| | is within the; is a; | relationships. |
| Variation | varies/vary in/with x; | Correlation can be used for prediction, |
| | | association or diagnostics as well as a |
| | | potential window into causation |

### The Object-Relationship Database

The Object-Relationship Database (ORD) used by the system is central to its function. The construction and layout of some tables and queries is shown in TABLE 20.

TABLE 20
Layout of ORD Database

| Table | Field | Description |
|---|---|---|
| TblMetaObject | Category | Name of Meta-object (categoty for the general |
| | | items of |
| | | interest) |
| | Subcategory | Subcategory |
| | Keywords | Key word(s) indicating something is part of this |
| | | Meta-object |
| TbiMetaRelationship | Type | General type of relationship (e.g. association, |
| | | increase, subset, etc.) |
| | Subtype | Relationship subclass (e.g. association.physical, |
| | | location.cellular, ID.Genbank, etc.) |
| | WordForm | Grammatical form of the verb |
| | Keywork | Keyword indicating a relationship |
| ThlObjectProperties | Name | Object name (accepted symbol) |
| | Category | General category of object |
| | Subcategory | Subcategory of object |
| | Value | Value of the object |
| | SourceID | Source of this information |
| TblObjRel | Object1 | Object #1 |
| | Relationship | Has this relationship to |
| | Object2 | Object #2 |
| | Source | Source of this information |
| | SentenceNum | Sentence # that this relationship was found in |
| | Date | Most recent date this relationship was seen |
| | | (yyyymmdd) |
| | Observed | # of times this relationship was observed |
| TblObjectSynonyms | Name | Official (shortest) name for object |
| | Synonym | All synonyms found for the object |
| | NumWords | Number of words in description |

The Object-Relationship Database is dynamic just as data sources which provide input into the system are dynamic. In one aspect, the system provides a control element on a graphical user interface (e.g., such as a button or drop down menu) in communication with the system to enable a user to view an object in the system database which was derived from text from the data source. For example, a user may view displayed text from a data source on the graphical user interface, highlight a section of the text (e.g., a phrase or abstract), and click a control element such as a button which causes the system to display if one or more words in the phrase are stored as objects in the system database. New objects can be included in a system database (e.g., such as the Object Relationship Database discussed further below). This assists a user to identify and flag new objects by scanning the literature to compile them for addition to the object list for the next compilation of the network used to evaluate connections.

### Semantic Parsing and Information Extraction

Textual information such as records or abstracts with one or more words are input and parsed. Suitable parsers include but are not limited to dparser, Essens, Gray, opars, ipars, lfg, Olex, Parsec, SPARK Scanning, Parsing and Rewriting Kit, T-Gen T-Gen—The Parser Generator for Visualworks ftp a SmallTalk parser generator, TGrep2 the next-generation search engine for parse trees, and the like.

If the records include sentences, these are parsed sentence by sentence, checking for Meta-objects and Metarelationships. A flowchart of the information extraction (IE) steps performed by the system was shown in FIG. 14, hereinabove. IE may also include parsing information that is nontextual or structured data. For example, IE may involve scanning high-density arrays containing chemical or biologic materials (nucleic acid probes, oligonucleotides, proteins, polypeptides, organic or inorganic molecules/compounds, and the like). Arrays containing more than 65,000 parcels of information (i.e., probes, molecules, chemicals, etc.) may be used, such as those manufactured using conventional photolithographic methods. More conventional techniques or chemistries may also be used to attach molecules or chemicals to the surface of a substrate surface, and depends on the nature of the substrate, the molecule/chemical to be attached and other factors that will be known to those of skill in the art of chemical attachment and synthesis. Biologic arrays are used for genetic analysis, screening, diagnosis, etc. Some arrays have extremely small feature sizes of at least about 20 microns.

As an example, the formation of nucleic acids on the surface of a substrate maybe provide a source of data for IE. Statistically relevant expression analysis can be done by sequence similarity searching of all query open reading frame or gene sequences against expressed sequence tagged cDNA sequence libraries. There are gene networks study projects with the National Institutes of Health-National Cancer Institute (NIH-NCI) that may be particularly suited to use the system of the present invention.

The system provides a tool to identify one or more novel effects or potential solutions for currently identified problems in any field of research. The system can be used it is able to identify one or more unknown relationships between objects in a cost-effective manner. As discussed further in Example 1 below, the system identified a novel therapeutic application for a well-known drug, chlorpromazine, namely, its use as a therapeutic agent for the treatment of cardiac hypertrophy, a disease with severe and debilitating consequences. The system was also identified the potential etiologic root of non-insulin dependent diabetes mellitus (NIDDM) as being epigenetic in origin, among others.

In one aspect, the system is connected to an automated screening system. Using the system to scan the literature for genes related to NIDDM, target genes are identified for methylation screening. The system searches and downloads the target sequences, designs oligonucleotides that may serve as probes on, e.g., a screening array. The screening array is then assembled using, e.g., a digital optic chemistry or even a cumbersome photolithographic DNA-on chip method and used to screen, diagnose and track the methylation status of possible or current NIDDM patients. In one aspect, design of the array is coupled to an online order form, so that a user interacting with the system through can place an order for fabrication of an array comprising appropriate sequences. The graphical user interface may display a representation of the array. In one aspect, moving a cursor to a particular set of coordinates on the array, enables the system to display information about a probe located at the coordinates (e.g., such as nucleotide sequence, gene name, known expression profile, function, and the like).

### EXAMPLES

The invention will now be further illustrated with reference to the following examples. It will be appreciated that what follows is by way of example only and that modifications to detail may be made while still falling within the scope of the invention.

### Example 1

### Validation of the System: Agents for Treating Cardiac Hypertrophy

The system's ability to identify novel and useful implicit relationships for cardiac hypertrophy, a condition with many known, and well-established relationships, was performed using MEDLINE as a source. The goal of the analysis was to identify previously unrelated compounds implicitly related to cardiac hypertrophy and of potential therapeutic benefit.

### The System 's Discovery of Novel Relationships

Cardiac hypertrophy is a method by which cells in the heart expand in size, ultimately resulting in a reduced ability of the heart to pump blood. The condition has been widely studied as evidenced by more than 3,654 articles in MEDLINE that contain the phrase “cardiac hypertrophy.” From the articles, the system according to the invention identified at least about 2,102 objects and at least about 19,718 unique objects implicitly related to cardiac hypertrophy; 1,842,599 different paths were used. Using system's scoring scheme, a ranked list of small molecules (e.g., drugs, metabolites, and chemical compounds) that were implicitly related to cardiac hypertrophy was compiled, twenty of which are shown in TABLE 21. The scoring was a composite function of the probability each individual relationship is valid, the number of relationships each object is expected to have given its relative abundance in the network, and the implicit strength of each connecting relationship. The number of shared relationships between cardiac hypertrophy and the implicitly related objects is shown as Unique Paths. A statistical estimate of how many of these Unique Paths represent valid relationships is provided as Quality Estimate. The frequency of each implicit object in the network is the Number of Relationships (Number of Rel.) and the number of relationships expected to occur by chance given the relative frequencies of each object shown as “Expect.”

TABLE 21
Ranking of Small Molecule Implicit
Relationships to Cardiac Hypertrophy

| Rank | Implicit | Unique | Number | Quality | | Obs/ | |
|---|---|---|---|---|---|---|---|
| 1 | Endotoxins | 1301 | 3280 | 1025.2 | 307 | 4.24 | 1004.8 |
| 2 | Progesterone | 1448 | 4190 | 1131.8 | 392 | 3.70 | 966.6 |
| 3 | Morphine | 1217 | 3029 | 939.3 | 283 | 4.30 | 932.6 |
| 4 | Bromide | 1368 | 4079 | 1048.2 | 381 | 3.59 | 868.7 |
| 5 | Concanvalin | 1317 | 3802 | 1002.3 | 355 | 3.70 | 857.9 |
| | A | | | | | | |
| 6 | Globulin | 1130 | 2836 | 849.7 | 265 | 4.26 | 836.6 |
| 7 | Chlorproma- | 1089 | 2691 | 824.5 | 252 | 4.33 | 824.5 |
| | zine | | | | | | |
| 8 | Polyethylene | 1153 | 2986 | 862.7 | 279 | 4.13 | 823.2 |
| | Glycol | | | | | | |
| 9 | Cisplatin | 1129 | 2932 | 862.0 | 274 | 4.12 | 820.2 |
| 10 | Methotrexate | 1190 | 3297 | 897.1 | 308 | 3.86 | 800.1 |
| 11 | Esterase | 1197 | 3394 | 907.6 | 317 | 3.77 | 791.0 |
| 12 | Neomycin | 1105 | 2908 | 841.5 | 272 | 4.06 | 790.1 |
| 13 | Casein | 1165 | 3289 | 894.9 | 308 | 3.79 | 783.3 |
| 14 | Phytohemag- | 1099 | 2848 | 807.3 | 266 | 4.13 | 769.8 |
| | glutinin | | | | | | |
| 15 | Isoleucine | 1142 | 3134 | 852.2 | 293 | 3.90 | 767.3 |
| 16 | Methanol | 1221 | 3781 | 930.5 | 354 | 3.45 | 742.5 |
| 17 | Galactose | 1104 | 3040 | 826.3 | 284 | 3.88 | 741.5 |
| 18 | Poly- | 1092 | 3160 | 829.4 | 295 | 3.70 | 708.2 |
| | saccharide | | | | | | |
| 19 | Acetone | 1075 | 3045 | 804.2 | 285 | 3.78 | 701.5 |
| 20 | Tetracycline | 1066 | 3022 | 799.9 | 283 | 3.77 | 697.2 |

Abbreviations:
Rel. = relationship;
Obs = observed;
Rxp = expected.

From the ranked list, one molecule, chlorpromazine, was selected for further analysis. Chlorpromazine is an aliphatic phenothiazine compound used principally as an anti-psychotic and anti-emetic. It exhibits a number of physiologic effects with several molecular targets. One known function is as an alpha-adrenergic blocker. Using the system according to the invention, an unknown association was discovered, namely, that Chlorpromazine was relevant to the mechanism of hypertrophy through overstimulation of alpha-adrenergic receptors by agonists and the effect that can be blocked by alpha-adrenergic antagonists. Hence, the system according to the invention uncovered a heretofore unknown association that there is a relationship between chlorpromazine and cardiac hypertrophy.

The analysis was confirmed to be novel as a direct search through MEDLINE showed that no direct relationship between the two objects has been established.

### Validating the System's Novel Discoveries

Validation of a relevant relationship between chlorpromazine and cardiac hypertrophy was performed through a series of laboratory studies in mice comparing the effects of a known beta-adrenergic agonist (also known to induce hypertrophy), isoproterenol, with isoproterenol plus chlorpromazine.

In brief, the study included 2 groups of 8 mice fitted with osmotic micro-infusion pumps. One group was given a continuous dose of 20 mg/kg/day isoproterenol and the other 20 mg/kg/day isopreterenol+10 mg/kg/day chlorpromazine. A smaller dose of chlorpromazine was chosen in preference to a larger one to minimize alterations in feeding behavior. Additionally, it reduced an adverse reaction between chlorpromazine and avertin (tribromoethanol), a anesthetic agent. Echocardiograms were taken before treatment and 7 days after initiation of infusions. Mice were sacrificed and their heart weighed.

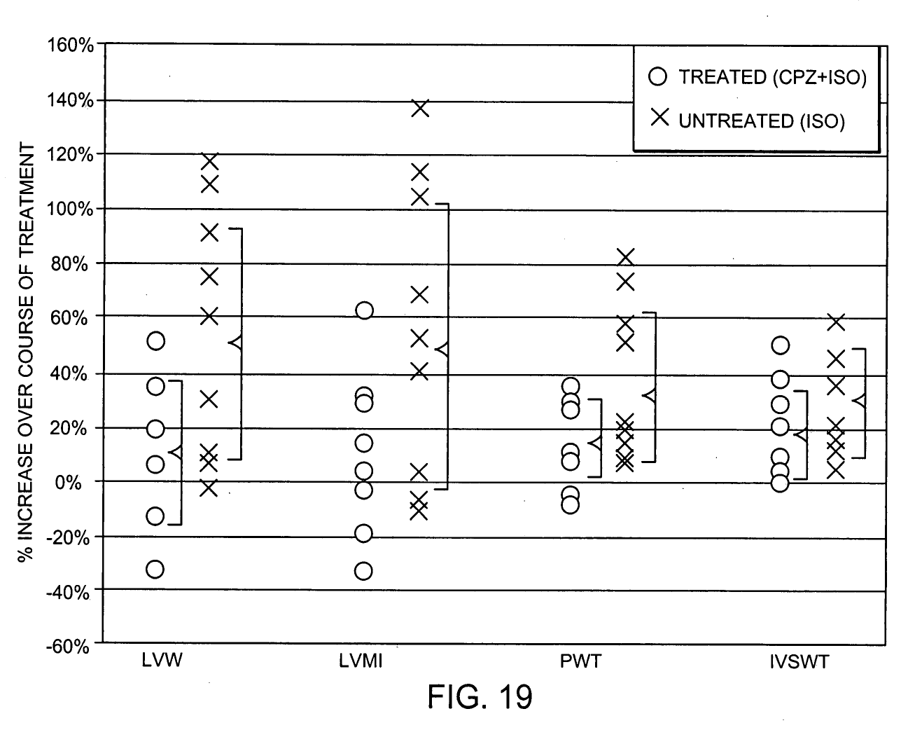

FIG. 19 and TABLE 22 summarize the study findings. Generally, cardiac hypertrophy (as assessed by echocardiography) was reduced in mice treated with chlorpromazine plus isoproterenol. FIG. 19 shows that chlorpromazine protected the mice against the development of cardiac hypertrophy. Echocardiography was use to estimate the change in weight or thickness of several different cardiac structures over the course of treatment. For FIG. 19, ten mice received isoproterenol (ISO) and eight received isoproterenol and chlorpromazine (CPZ+ISO), where LVW=left ventricle weight (CPZ+ISO 11±27%, ISO 51±43%, P<0.02); LVMI=left ventricular mass index (CPZ+ISO 11±28%, ISO 50±52%, P<0.04); PWT=posterior wall thickness (CPZ+ISO 16±16%, ISO 36±27%, P<0.05), IVSWT=intraventricular septum wall thickness (CPZ+ISO 19±18%, ISO 31±20%, P<0.12).

TABLE 22
Development of Cardiac Hypertrophy
after Chlorpromazine (CPZ + ISO)
versus Isoproterenol (IPO)

| Group | LLVW | OLVMI | OPWT | DI VS WT |
|---|---|---|---|---|
| CPZ + ISO | 11% ± 29% | 11% ± 30% | 16% ± 17% | 19% ± 19% |
| ISO | 53% ± 45% | 50% ± 55% | 36% ± 28% | 31% ± 21% |
| t-test | 0.02 | 0.04 | 0.05 | 0.12 |

Additional therapeutic agents identified in silico using the system included Rofecoxib, Naproxen, Prostaglandin, Melatonin, Naloxone and Naltrexone. The utility of Naloxone as a therapeutic agent was validated by determining the effect of the drug in a mouse model of cardiohypertrophy as described above. Based on its similar pharmacological effects, Naltrexone also is likely to be effective in vivo and because of its advantageous pharmacokinetic properties (e.g., its longer half-life) might be a superior drug.

The system according to the invention additionally identified other candidates for treatment of another condition, cardiomyopathy. Given a list of candidate drugs which have not previously been identified as treatment agents for this condition, the system can rank candidate drugs as to their likely impact on cardiomyopathy after their initial selection based on a direct or indirect pharmocological link to heart disease (e.g., such as previous identification of a drug as a myocyte protector). The results of this analysis are discussed further below where a ranking of “5” is the highest score and indicates a strong likelihood that the drug will succeed in in vivo tests. A ranking of 3 and higher was used to identify compounds as candidate drugs for the treatment of cardiomyopathy.

### Triiodothyronine (T3): 3

T3 and thyroxine (T4) constitute the active thyroid hormones. Thyroid hormone, in particular T3, has been demonstrated to promote cardiac myocyte plasma membrane ion transporters. Clinical study shows an unexpected high risk of hypothyroidism and low T3 syndrome in cardiomyopathy patients. Despite the potentially beneficial cardiovascular effects of T3, there are very few studies evaluating its efficacy in the cardiomyopathy population. To date there has been no rigorous clinical investigation of T3 in patients with cardiomyopathy, which leaves T3 an interesting but not over-exposed drug to test.

### Clonidine: 4

The sympathetic nervous system (SNS) plays a pivotal role in the regulation of blood pressure and cardiac function. The effects of sympathomimetic agents are mediated via adrenergic receptors which include alpha and beta subtypes. Clonidine is an alpha2 adrenergic receptor agonist. It acts on central sympathetic neurons, accentuating their sympathoinbibitory function, thus leading to a decrease in norepinephrine release and sympathetic nerve activity and to an overall reduction of sympathetic tone. Beta adrenoceptor blockers are currently used to treat Dilated and Hypertrophic Cardiomyopathy, however the use of alpha blockers have not previously be explored. Clonidine was introduced as an antihypertensive SNS suppressant 35 years ago and has only recently been investigated in other treatment methods. For example, Clonidine is showing promise in treating myocardial ischemia and congestive heart failure. The difference between Clonidine and other adrenergic receptor agents is its central nervous system acting site, which may provide a potentially wider usage.

### Estrogen: 3

Cardiovascular diseases display significant gender-based differences. Estrogen plays an important role in the pathogenesis of heart disease and is able to modulate the progression of the disease. The focus on the beneficial influence of estrogen is gradually shifting from the vascular system to the myocardium. The presence of functional estrogen receptors in the myocardium has been demonstrated. In rodent models of left ventricular hypertrophy (LVH), Estrogen replacement attenuates the development of both right and left ventricular hypertrophy. Estrogen is also used in myocardial ischemia to provide extensive myocardium protection. Dose range is very critical to estrogen. Different doses will have substantially different effects. For example, 0.625 mg estrogen per day is intended for postmenopausal use, and 20-35 μg per day is for oral contraceptive.

### Tamoxifen: 3

Tamoxifen is one of the compounds in clinical use which activates estrogen receptors. It has estrogen-like effects on the cardiovascular system.

### Colchicine: 3

Colchicine is a potent and rapid inhibitor of neutrophils, may reduce inflammatory leukocytosis, prevent postischemic myocardial neutrophil accumulation and protect the myocardium. Although few studies have been done on the cardiovascular effectsof Colchicine, some of them show a positive effect (attenuating the development of cardiac hypertrophy).

### Bradykinin: 4

Bradykinin is a new and promising cardiac myocyte protector. The kallikrein-kinin system is one of the blood pressure regulating systems. As an important agent of kallikrein-kinin system, Bradykinin has more effects other than dilating coronary artery and vascular beds that has been known for many years. In recent research, Bradykinin is shown to enhance cardiac myocyte ischemic tolerance. Since ischemia is one of the leading causes of dilated cardiomyopathy and myocardial ischemia is very common in both dilated and hypetrophic cardiomyopathy, Bradykinin is a candidate drug for treating cardiohypertrophy.

### Omapatrilat: 4

Bradykinin is efficiently and rapidly degraded by several enzymes, especially angiotensin converting enzyme (ACE) and neutral endopeptidase (NEP). Therefore, Omapatrilat as a novel compound with dual inhibitions on ACE and NEP will logically have similar effects as Bradykinin. Omapatrilat is being tentatively used in clinic for chronic heart failure.

### Apstatin: 4

Although ACE and NEP appear to play primary roles in Bradykinin catabolism, recent reports imply that aminopeptidase P may be an important contributor to endogenous Bradykinin turn over. The aminopeptidase inhibitor, Apstatin is another myocyte protective candidate.

### COX-2 Selective Inhibitor (Celecoxib): 3

The cardiovascular effect of this compound is intriguing. On the one hand, use of the drug may reduce the inflammatory contribution to vascular damage and atherothrombosis. On the other hand, by decreasing vasodilatory and antiaggregatory prostacyclin production, administration may lead to increased blood pressure and prothrombotic activity. So it is not surprising to see all the contradicory results from different experiments. Because of its ranking, in silico, Celecoxib is a candidate drug for testing its effects on cardiohypertrophy in vivo.

### 5-LOX Inhibitor (Licofelone): 4

5-LOX inhibitors represent a class of new compounds that have anti-platelet, anti-leukocyte, and anti-inflammatory properties, without the gastric side-effects of Cox-1 inhibitors and thrombotic risk of Cox-2 inhibitors. Licofelone is now in Phase 3 clinical studies for the treatment of osteoarthritis.

### Thromboxane A2 Receptor Antagonist (Sultroban): 3

TXA2 is a potent vasoconstrictor and a powerful inducer of platelet aggregation and release. It has an opposite mechanism for regulating platelets than the Prostaglandins. Thromboxane receptor density is significantly increased in impaired heart compared to normal hearts, which suggests that Thromboxane receptors represent a significant target for therapy. TXA2 synthetase inhibitor or TXA2 receptor inhibitor may be beneficial to cardiomyopathy patients.

### Melatonin: 2

Melatonin is the most prominent product of pineal gland. Other its well-known role in directly influencing circadian rhythm as an anti-oxidant, it actually plays a more extensive role in the human body. The evidence from the last 10 years suggests that Melatonin influences the cardiovascular system. The presence of arterial and ventricular receptors has been demonstrated. Melatonin can also contribute in cardioprotection of the heart following myocardial ischemia. Melatonin is not considered as a drug currently partly because few studies have been done on Melatonin's safety, side effects, interactions with drugs, and long-term effects.

The following additional candidate compounds were identified using the system according to the invention.

### Morphine

Morphine is an opioid peptide, which can exert important cardiovascular effects. Activation of specific opioid receptors results in a potent cardioprotective effects to reduce infarct size in experimental animals and to reduce cell death in isolated cardiomyocyte. The drug may be limited to short-term or emergency use.

### Naloxone

Naloxene is an opioid antagonist. Under normal circumstances, it produces few effects unless an opioid has been administered previously. However, when endogenous opioid systems are activated in certain forms of stress, e.g., in myocardial infarction or dilated cardiomyopathy, Naloxone may inhibit the cardioprotective effects of opioid system. It has a negative impact on the disease. As discussed above, the positive effects of Naloxone predicted in silico have been validated in vivo.

### Warfarin/Heparin

Both drugs inhibit activated congulation factors, and therefore have anticoagulant effects. Since cardiomyopathy patients have the risk of thromboembolism, warfarin and hepararin are candidate drugs for use in preventing stroke and peripheral embolization. Both drugs have been reported as useful for the management of Dilated Cardiomyopathy, especially with atrial fibrillation.

### Cortisol

Cortisol is the main glucocorticoid in human beings. The effects of corticosteroid are numerous and widespread. In cardiovascular system, the striking effect of cortisol is to induce hypertension and hypertensive cardiomyopathy although the mechanism underlying is unknown. Cortisol is an anti-inflammatory and immunosuppressive agent, which may be able to suppress the lymphocyte infiltrate secondary to cardiomyopathy. However, many of the current clinical uses of corticosteroids are based on empirical approaches, rather than on a detailed understanding of the mechanisms by which the drugs act. Cortisol has been previously suggested for the treatment of dilated cardiomyopathy. The therapy does not appear to have a clinically important effect and may be associated with significant complications. Routine clinical use is not recommended at present, for its current application, but for a new efficacy, with a new dose regimin, this compound may be recoverable.

### Example 2

### Evaluating Connections: Indirect Connections and Beta Catenin

### Indirect Connections

Another task this system is designed for is to show how many modem day direct and relevant relationships between objects were at one time indirect relationships. One can envision two basic ways by which knowledge is discovered: (1) by de novo discovery; or (2) relying on prior knowledge. Importantly, de novo discoveries might be accidental or may be arrived at through systematic testing of random approaches that culminates in a connection that was not anticipated otherwise. Similarly, prior knowledge can lead to explicit hypotheses (e.g., A and C interact) or implicit hypotheses (e.g., a target with certain features/properties interacts with several likely candidates antagonists that can be discovered after testing all candidates).

Historically, knowledge discovery has been composed of both types of discoveries. Discoveries achieved by knowledge-based reasoning can be measured by cataloging the relationships an object has with other objects. At any given point in time, an object should have a number of direct relationships with other objects as well as a number of indirect relationships with other potential objects. If it is suspected that some number of indirect relationships will be discovered as direct relationships, then the next step is to measure and estimate how many historically indirect connections eventually become direct.

As an example, assume that in 1995, A (a gene) is discovered to be related to B (a disease). At this time it was known that B was related to C (a phenotype). One could reasonably surmise a connection between A and C, depending on the nature of the relationships. Perhaps the phenotype is seen in other diseases that A is directly or indirectly responsible for. Thus, the A-C connection may be obvious and confirmed by additional analysis or research. On the other hand, the relationship may not be obvious (e.g., the relationship did not appear relevant at the time). It is this aspect that the system focuses on.

The system was put to the test through another analysis as discussed below.

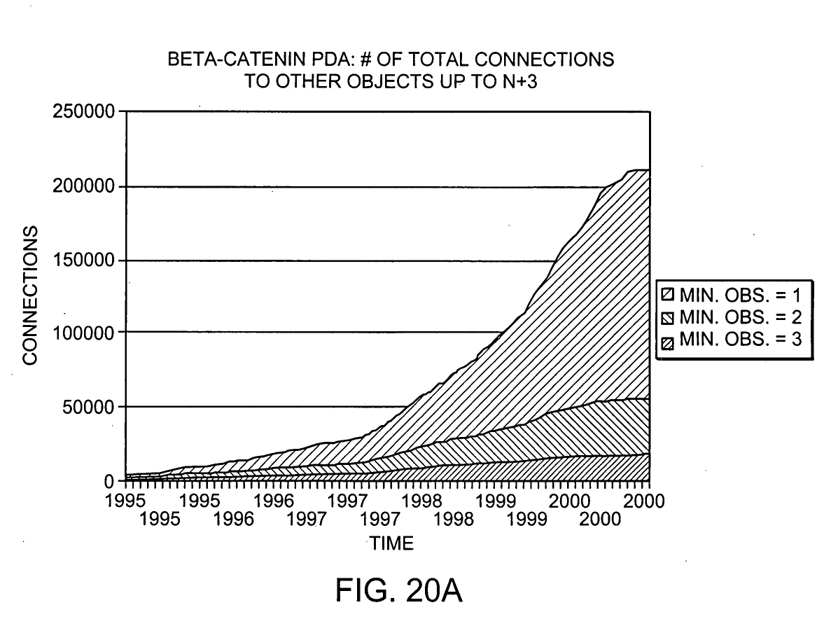

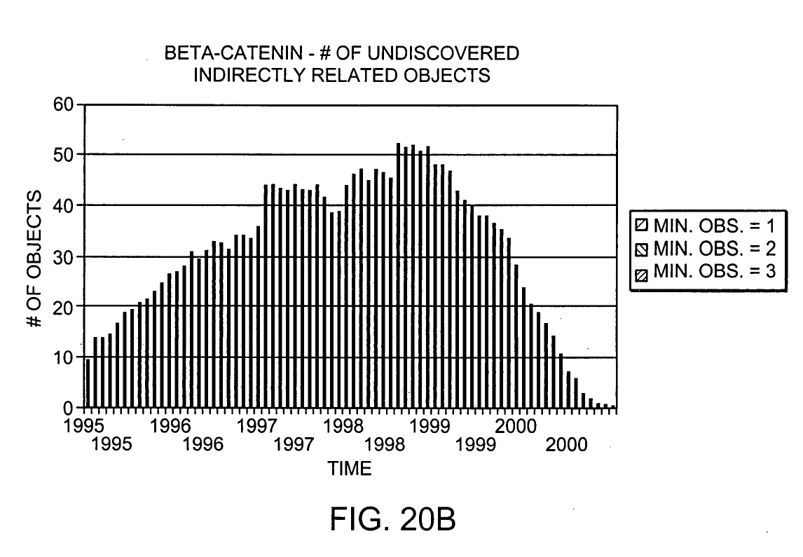

A group of at least about 1,270 abstracts was downloaded from the MEDLINE source using the keyword “beta-catenin.” Beta-catenin is a protein involved in the formation of adherens junctions in mammalian epithelia and its gene is located on human chromosome 3p21, a region with several links to tumor development. For this analysis, objects are n and the objects directly associated with n are n+1. Objects directly associated with n+1 objects but not n are implicitly related and are referred to as n+2. FIG. 20A shows how the number of total connections increases exponentially over time; FIG. 20B shows how many objects with direct connections as observed today were only indirectly connected in earlier years, possible through intermediates (number of different intermediates not shown). Because some connections may be spurious, the minimum number of observations required to establish a downstream connection were varied between 1 and 3. The minimum number of connections between n and n+1 were kept at 1 to increase sensitivity to new discoveries and allow the discovery of downstream connections that may be established. As minimum observation requirements are relaxed, the total number of objects rises. By using present-day direct connections to evaluate how many undiscovered indirect connections existed at an earlier time, the graph necessarily falls to zero as it approaches the present-day.

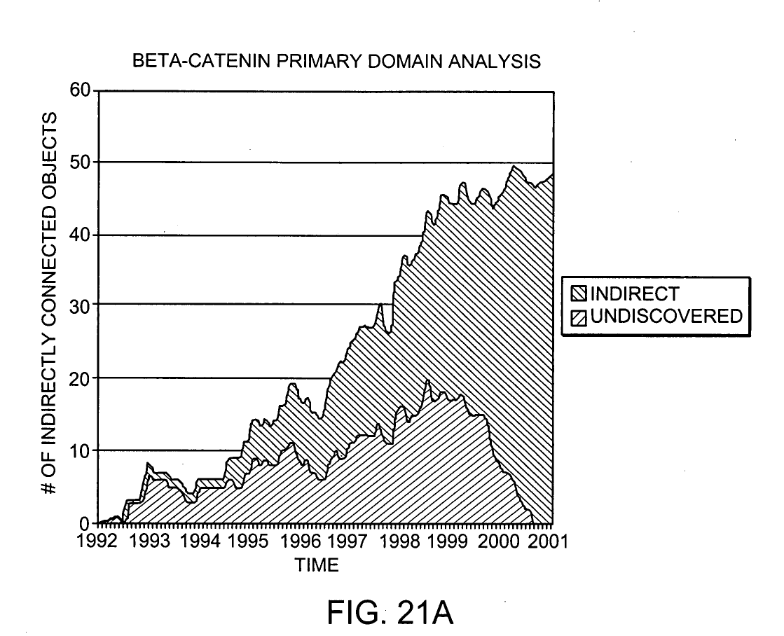

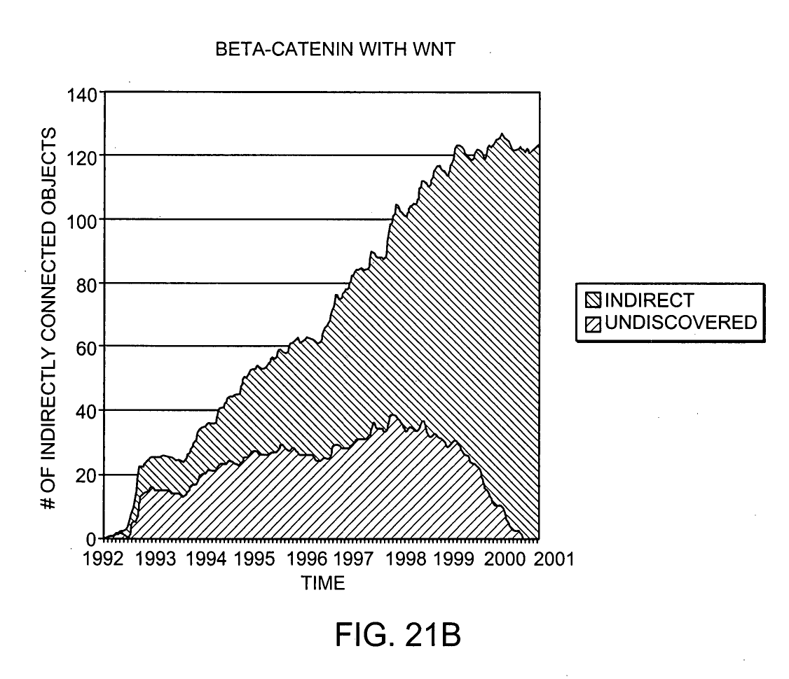

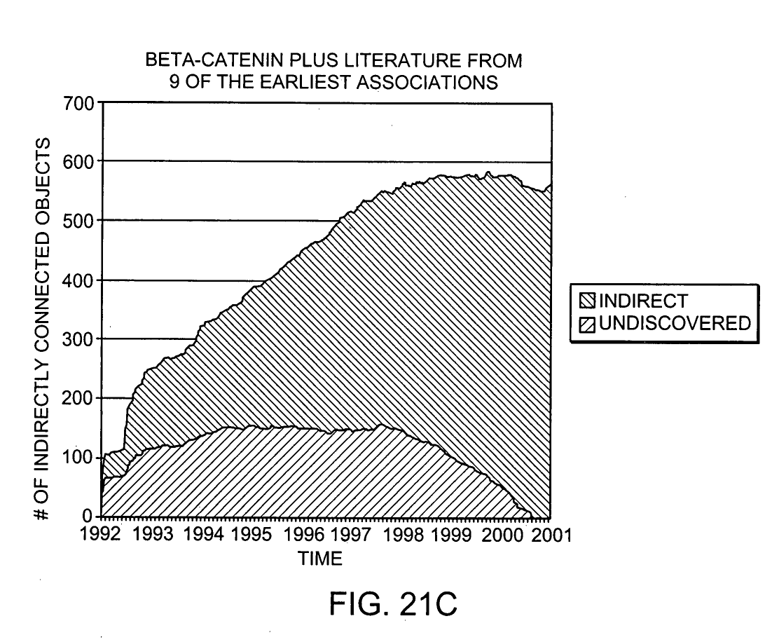

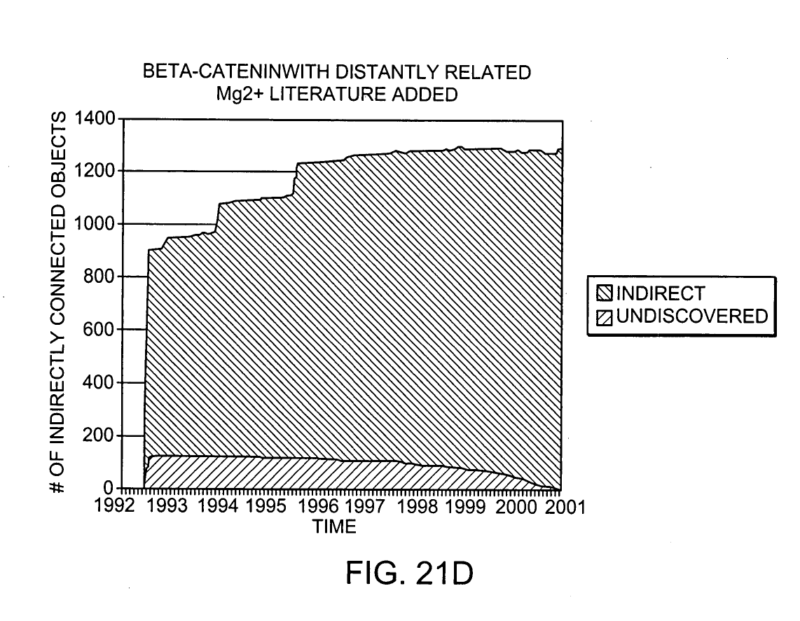

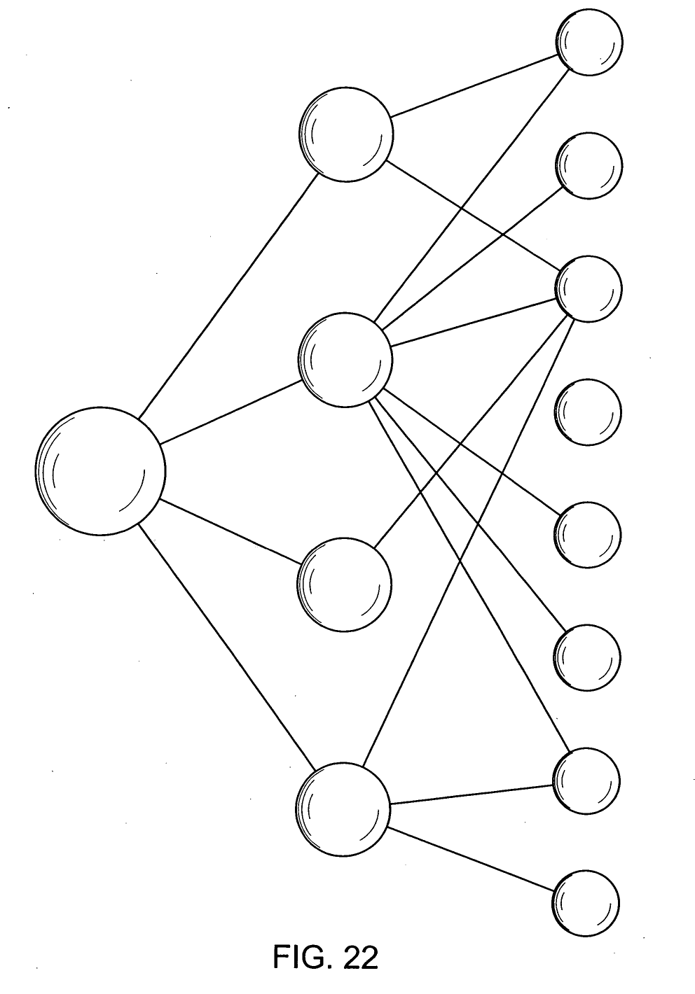

The set of data (e.g., literature) from which a test set analysis is made is named Primary Domain Analysis (PDA). The PDA centers around one keyword-based topic (generally textual); when using a PDA, all indirect and undiscovered associations are derived solely from that data set. Any keyword generally falls into one of three general categories: (a) is the primary aspect/object of the data or record; (b) is of secondary consideration to the data or record; and/or (c) holds a tangential relationship to the data or record. The behaviors illustrated in FIGS. 20A and 20B will change depending on the number of connections known at the time an object was discovered. The number of indirect connections expand as a search is made beyond the PDA (e.g., by incorporating a larger amount of prior knowledge, information and or data outside of the PDA). As shown in FIGS. 21A through 21D, the percentage of indirect connections of modem-day relevance declines over time. This observed decline is either because not enough time has elapsed to show a relevance or because the earliest direct associations are the strongest. The graphs in FIGS. 21A through 21D also show that by adding only a few indirect connections, the number of total connections greatly expands. Expanding on this, then increasing the stringency for identifying downstream connections greatly affects the total number of indirect connections found later to be direct.

To analyze the change in connection frequency, all objects with an initial indirect relation that later became directly connected to beta-catenin were examined. Objects include those with a network distance of n+3 and in the database prior to the 1997. This list of objects retrieved by the system are listed in TABLE 23 by the number of unique paths to beta-catenin and the minimum number of observations (i.e., co-occurrences of the objects in the same sentence) necessary to determine a connection. This analysis uses the same minimum number of observation parameters as in FIGS. 21A through 21D.

TABLE 23
Subset of Objects Indirectly Connected to Beta-Catenin in 1997
and Directly Connected to Beta-Catenin in 2001

| Object Name | Object | Unique Paths | Unique Paths | Unique Paths |
|---|---|---|---|---|
| EGFR | G | 29 | 36 | 58 |
| Pemphigus | D | 25 | 29 | 48 |
| Vanadate | SM | 21 | 25 | 41 |
| PTPRU | G | 21 | 25 | 90 |
| Oxide | SM | 21 | 25 | 72 |
| Adhesions* | D | 21 | 29 | 36 |
| Frizzled | G | 15 | 17 | 29 |
| TCF7 | G | 5 | 5 | 5 |
| Lithium | SM | 4 | 5 | 20 |
| Hh | G | 4 | 4 | 4 |
| Glycogen Synthase | | 3 | 8 | 11 |
| Guanine | SM | 1 | 1 | 1 |
| Connexin | G | 1 | 4 | 39 |
| Sarcoma | | | 44 | 66 |
| IVL | G | | 36 | 43 |
| Recurrence* | D | | 36 | 43 |
| ES | D | | 36 | 99 |
| Phorbol | SM | | 36 | 82 |
| Complement | SM | | 29 | 51 |
| Collagen | SM | | 16 | 74 |
| Death* | D | | 12 | 22 |
| Ester | SM | | 1 | 82 |
| Phosphoserine | SM | | | 77 |
| SDS | G | | | 75 |
| Adenocarcinoma | D | | | 48 |
| ERBB2 | G | | | 43 |
| Keratin | SM | | | 43 |
| PKC | G | | | 41 |
| Plasmid | SM | | | 40 |
| HCCS | G | | | 32 |
| Neuroblastoma | D | | | 21 |
| p105-Rb | D | | | 21 |
| NODAL | G | | | 15 |
| Cytokine | SM | | | 15 |
| CINND1 | G | | | 14 |
| ASK* | G/D | | | 9 |
| Acetate | SM | | | 5 |
| Progesterone | SM | | | 5 |
| SEA | G/D | | | 5 |
| N* | G | | | 4 |
| Bp* | D | | | 3 |
| IGF1 | G | | | 3 |
| Epitope* | SM | | | 1 |
| HCC | D | | | |

*= entries that of questionable value because they represent objects with the same name as a commonly used word or they are very broad in scope or nature (e.g. death, adhesions).

Reviewing TABLE 23, EGFR (Epidermal Growth Factor Receptor) is found to be one of the top 3 objects with indirect connections to beta-catenin prior to 1997. Within the chain of connections, E-cadherin is found to have a very strong association with beta-catenin (484 co-mentions) dating back to 1992. Beta-catenin also has a molecular association with E-cadherin, via an interaction with the actin cytoskeleton and E-cadherin, which dissociates from the extracellular matrix when exposed to EGFR. Consequently, each of the 29 unique paths in the network with an indirect beta-catenin-EGFR connection branch through the EGFR-E-cadherin association via different intermediates. The system shows for the first time EGFR and beta-catenin were directly associated with each other was in July 1997, when EGFR was found to phosphorylate beta-catenin. Interestingly, prior to this date, a record linked EGFR to E-cadherin, however, it was through EGF and not EGFR. The system recognized the EGF-beta-catenin connection from the paper, but does not understand the relationship between EGF and EGFR. The connections between beta-catenin and EGFR that system identified and cataloged in the ORD are shown in TABLE 24. To ensure that there were not any pronoun references that established a connection before 1997, MEDLINE was searched for the keywords “beta-catenin” and “EGFR.”

TABLE 24
Catalogue of Indirect Objects Related to Beta-Catenin
Beta-catenin and EGFR

| | |
|---|---|
| <UID = 99061547> | Focal adhesion kinase was tyrosine phosphorylated more by basolateral than |
| <date = 19981200> | by apical egfr; however, beta-catenin was tyrosine phosphorylated to a much |
| | greater degree following the activation of mislocalized apical egfr. |
| <UID = 98316577> | To assess the specificity of this expression, 124 of the 228 lines were crossed |
| <date = 19980000> | to strains containing either an activated form of armadillo, the drosophila |
| | homolog of beta-catenin, or an activated form of torpedo/egfr, the drosophila |
| | homolog of the epidermal growth factor receptor, under the control of gal4 |
| | target sites. |
| <UID = 97377008> | Tyrosine phosphorylation of beta-catenin was concomitantly induced with |
| <date = 19970703> | association of beta-catenin with egf receptor (egfr) when quiescent cells at |
| | confluence were dissociated into single cells by tryptic digestion, being |
| | accompanied by dissociation of alpha-catenin from e-cadherin. ( ...) Both |
| | tyrosine phosphorylation and association of beta-catenin with egfr were |
| | inhibited by tyrphostin, a specific inhibitor of the egfr tyrosine kinase, |
| | whereas dissociation of alpha-catenin from e-cadherin was not. {...} The |
| | results suggest that tyrosine phosphorylation of beta-catenin is achieved by |
| | egfr upon tryptic digestion of cells and concurrent with but independent of |
| | dissociation of alpha-catenin from e-cadherin. |

Beta-catenin and pemphigus

| | |
|---|---|
| <UID = 981Ta80797 | Ultrastructural localization of cell junctional components (desmoglein, |
| <date = 19980200> | plakoglobin, e-cadherin, and beta-catenin) in hailey-hailey disease, darier's |
| | disease, and pemphigus vulgaris. |
| <UID = 98180797> | The distribution of desmoglein, plakoglobin, e-cadherin, and beta-catenin in |
| <date = 19980200> | the peri-lesional and lesional skin of hailey-hailey disease, darier's disease, |
| | and pemphigus vulgaris was examined by immunoelectron microscopy. |

Beta-catenin and vanadate

| | |
|---|---|
| <UID = 98076315> | The concomitant administration of na vanadate, an inhibitor of tyrosine |
| <date = 19971000> | dephosphorylase, inhibited both the atra-induced clustering and the |
| | dephosphorylation of beta-catenin tyrosine. |
| <UID = 97465729> | Inhibition of dephosphorylation of beta-catenin in early passage cells by |
| <date = 19971000> | vanadate, an inhibitor of protein tyrosine phosphatases, caused overgrowth of |
| | cells beyond the saturation density and loss of alpha-catenin from the e |
| | cadherin-beta-catenin complex. |

Beta-catenin and frizzled (only earliest 3 co-mentions shown)

| | |
|---|---|
| <UID = 98374323> | A novel frizzled gene identified in human esophageal carcinoma mediates |
| <date' 19980818> | apc/beta-catenin signals. |
| <UID = 98263950> | Frizzled receptors transduce a signal to dishevelled, leading to inactivation of |
| <date = 19980507> | glycogen synthase kinase 3 (gsk3) and regulation of gene expression by the |
| | complex of beta-catenin with lef/tcf (lymphocyte enhancer factor/t-cell |
| | factor) transcription factors. |
| <UID = 97433081> | elegans genes described here are related to wnt/wingless, porcupine, frizzled, |
| <date = 19970822> | beta-catenin/armadillo, and the human adenomatous polyposis coli gene, apc. |

The left-hand column contains labels attached to each abstract by the program to track sources and dates; UID = Unique ID.

The second connection most common object indirectly related to beta catenin was Pemphigus Vulgaris, a rare, blistering autoimmune disease that affects the skin and mucous membranes (see OMIM record 169610). Like the indirect EGFR connection, most of the intermediate connections shared one common intermediate path of cadherin and Pemphis Vulgaris, first established by a 1994 record. The system according to the invention found that the relationship was not established until February 1998. The 1994 article mentions the relationship between beta-catenin and Pemphigus; however, the two objects were not included in the same sentence and an abbreviation for the disease (PVA) was used rather than the proper word. Therefore, system did not identify the relationship because of the assumptions that were placed on the analysis.

The system also found a relationship between vanadate and beta-catenin. Vanadate is a small a transition metal oxyanion used in a variety of biologic pathways, usually as an inhibitor of tyrosine phosphatases. A strong connection between the two objects is found through the intermediate relationship between tyrosine and vanadate. The first mention of this intermediate relationship is in February 1995 and for several times thereafter. The connection between beta-catenin and tyrosine is also observed frequently and as early as December 1992. Yet, it is not until October 1997 that the first mention of betacatenin with vanadate is made.

PTPRU is an acronym for Protein Tyrosine Phosphatase Receptor, type U. In the HGNC database, the acronym PTP is listed as a synonym for PTPRU, which may not be completely accurate, because PTP or Protein Tyrosine Phosphatase and PTPRU are related but distinctly different objects. Therefore, the system has actually identified the relationship between beta-catenin and PTP, a protein that works with tyrosine, and in a previously established intermediate relationship with vanadate.

Beta-catenin has a strong association with wnt and so it is not surprising that genes related to wnt may be co-mentioned alongside beta-catenin. The indirect relationship beta-catenin has with the gene frizzled proceeds through both wnt and wingless and the genes directly related to them such as LEF-1, APC, JUP and dsh. The connection between beta-catenin and wnt is mentioned early in the literature in October 1993. The connection between wnt and frizzled was known earlier, but is mentioned first in this set of abstracts in 1996 (month not given in record, so the system defaults to January 1^{st} to err on the safe side).

Beta-catenin and frizzled are first mentioned together in August 1997, but only in terms of a list of genes similar to ones being studied in C. elegans. It is not until the next abstract comentioning the two is published in May 1998 that a functional relationship becomes apparent. An abstract search for the two terms confirms no direct relationship before 1997.

It is important to note that the system databases according to the invention maybe continually refined. For example, after an analysis such as the one just performed, spurious relationships can be removed from the database.

### Example 3

### Validation of the System: Diabetes and Epigenetics

Clearly, it has been shown that a system according to the invention is able to recognize the names and synonyms of diseases, genes, phenotypes and chemical compounds (collectively referred to as “objects”) as they occur within a source such as MEDLINE titles and abstracts. The system is also able to resolve acronyms to avoid confusion of terms. In another example, all MEDLINE records (at least about 12,063,817 records as of January 2002) were processed by the system in order to construct a comprehensive network of object relationships. The relationships shared among sets of objects is then evaluated, including relationships shared between two objects that are not otherwise known to be related. These implicit relationships are used to identify novel relationships. In science and technology, for example, the novel relationships help understand mechanisms of disease etiology, drug action, new therapies, methods of diagnosis, and can be used as an costeffective method for screening one or more objects, especially correlative relationships between disease cause and cure.

Non-insulin-dependent diabetes mellitus (NIDDM) is an increasingly prevalent disease in the world, especially the United States, where the number of new patients grew 49% between 1991 and 2000. The economic cost of NIDDM is staggering, estimated at $98 billion annually in 1997 and affecting as much as 6% of the population in the United States alone. NIDDM is characterized primarily by insulin resistance and hyperglycemia and also frequently associated with glucose intolerance, hyperinsulinemia, hypercholesterolemia and hyperlipidemia. Many factors that correlate with the risk of developing NIDDM have been identified, but causality has proven elusive. NIDDM has consequently been termed a “complex” disorder, thought to be a result of a complex interaction between environmental influence and genetic background. To date, no association has been reported between the etiology of N DDM and epigenetic alterations such as changes in DNA methylation status or chromatin condensation.

DNA methylation is a fundamentally important phenomenon within eukaryotes, serving as a means to distinguish host DNA from foreign, to determine which strand of DNA is newly replicated and to provide a signal for chromatin condensation such that transcriptional programs can be inactivated, a method especially important during normal development. Loss of methylation in regulatory DNA regions has been an active research area in cancer, with a number of genes known to be dysregulated from a loss of methylation in certain tumors. While loss of DNA methylation can be induced chemically (e.g., with 5aza-2′-deoxycytidine), it is not clear what factors may be present in the environment that would have a similar effect.

### The System Identifies Novel Relationships with NIDDM

The system was used to identify and rank objects within MEDLINE implicitly related to Type II diabetes, also known as non-insulin dependant diabetes mellitus (NIDDM). NIDDM was found to share many relationships with two specific objects in a database: “Methylation” and “Chromatin” (TABLE 25).

TABLE 25
Top Ranking Objects with Shared Relationships to NIDDM

| | | | | | Observed/ |
|---|---|---|---|---|---|
| — | 2105 | NIDDM | 1421 | 329 | 4.32 |
| 1 | 1361 | Endotoxin | 1054 | 308 | 3.42 |
| 2 | 1312 | Hydrocortisone | 991 | 296 | 3.35 |
| 3 | 1301 | Neuroblastoma | 975 | 339 | 2.88 |
| 4 | 1287 | Methylation | 959 | 346 | 2.77 |
| 5 | 1256 | Chromatin | 938 | 339 | 2.77 |

TABLE 25 reveals the top five objects (genes, diseases, phenotypes, and small molecules) implicitly related to NIDDM (shown at top as a positive control for the query). These objects are not known (within MEDLINE) to have any direct association with NIDDM and, by virtue of many shared relationships, are implicitly related (see FIG. 22). The nature of each implicit relationship will vary and must be determined by examination of the intermediate connections. Expect is the expected value and represents how many shared relationships would be expected given a randomly connected network of relationships with the same properties as the one that was literature-derived. Quality is a score and a statistical estimate of the number of co-mentions that represent actual relationships based upon the frequency of co-occurring objects. Implicit Relationship may be prioritized by the most shared relationships (as is done here to identify broad and important trends), by how exceptional any given set of relationships is (by sorting on the Observed/Expected score) or a combination of both (not shown).

The first barrier scientists face in hypothesizing a novel relationship between objects is an awareness of common relationships. Assuming a reason existed to hypothesize a novel relationship between epigenetic modification and NIDDM, it would still be necessary to read and organize 24,752 articles on NIDDM and 25,338 articles on methylation to identify commonalities (statistics as of Jul. 5, 2002 as determined by MEDLINE keyword query). An informatics approach was necessary to collate data of such scale.

By examining the entire body of MEDLINE literature associated with NIDDM, the system identified all potential relationships that NIDDM had to other objects by their Co-occurrence within the same journal abstract. From the 33,534

unique objects system is capable of recognizing within text, a total of 2,105 were found directly related to NIDDM. The system then analyzed MEDLINE for all objects directly related to these 2,105 objects, removing those already in the list of direct relationships. The resulting list contained relationships that were known only implicitly, which is to say that no relationship between the two objects was found within the body of MEDLINE titles and abstracts. These implicit relationships were then evaluated by system based upon the number of shared relationships they had with each other, relative strength of each relationship, quality of the relationships (statistical probability that each relationship is valid), and the likelihood the two objects would share a set of relationships by chance, given the relative abundance of both objects and their shared intermediates within the network.

Not all of the 1,287 relationships shared between “methylation” and “NIDDM” were necessarily causal, correlative or even meaningful, but many were causal, correlative and/or meaningful. Collectively, they provided evidence that a relationship exists between epigenetic control and NIDDM and this was then used to develop a more comprehensive theory regarding an epigenetic etiology and pathogenesis of NIDDM.

### NIDDM Shared Relationships

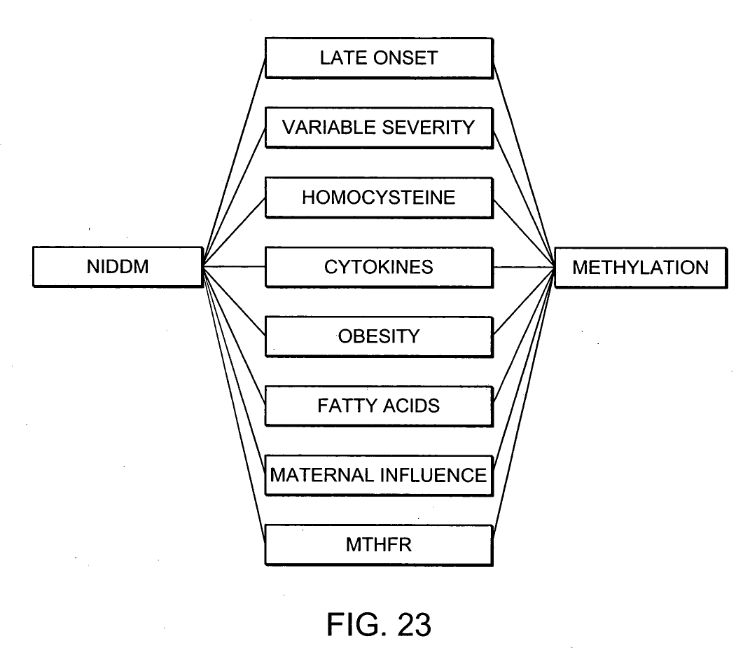

As shown in FIG. 23, system identified a number of common phenotypes in the onset and pathology of NIDDM that are also shared by diseases associated with a change in methylation state. These shared relationships offer a perspective on some of the puzzling properties of NIDDM not easily explained by environmental or genetic mutation models. For example, NIDDM is a disease with variable and late onset, a phenotype linked to some epigenetic disorders through DNA hypomethylation such as aberrant expression of X-linked genes, onset of Huntington's Disease and oncogenesis of tumors. Not all late-onset illnesses are caused by epigenetic changes, but most others share phenotypic abnormalities that are unique to the disease, such as the accumulation of amyloid precursor proteins in Alzheimer's or Lewy bodies in Parkinson's. NIDDM is highly correlated with the presence of obesity and Advanced Glycosylation End products (AGEs), but neither is a requirement for its development nor unique to it as a disease. NIDDM also varies in its severity, generally increasing over time. The increase of severity is a phenotype shared with some tumors that have undergone methylation changes in promoter sequences, leading to higher gene expression and a more aggressive phenotype. Another interesting observation about NT1)DM is the “maternal effect!” in which NIDDM patients report a higher frequency of maternal history of diabetes.

Such an effect could be explained if de novo methylation of DNA sequences during development was due to maternal influence. This type of phenomenon, in fact, has been observed in mice.

The system also identified a number of metabolic alterations in the body's ability to methylate DNA that correlate with the existence of or predisposition to NIDDM. For example, elevated levels of homocysteine have been found in NIDDM patients, correlating with increased severity of the disease as defined by mortality. Homocysteine is a critical metabolic intermediate responsible for carrying out methylation reactions, and elevated serum levels of it are also correlated with DNA hypomethylation. t has also been reported that sulfur-poor diets that force synthesis of cysteine from methionine predispose individuals to Type II Diabetes later in life. Since methionine affects S-adenosyl methionine (SAM), which is the methyl donor for the methylation of newly-synthesised DNA, these individuals develop with an impaired ability to establish de novo DNA methylation patterns. Genetic factors that lead to deficiencies in the methylation pathway have also been shown to predispose individuals to develop NIDDM. There is a well-known polymorphism (C677T) in the methylenetetrahydrofolate reductase (MTHFR) gene that reduces its efficiency, leading to a global hypomethylation of DNA. Individuals with this mutation are also predisposed to develop N DDM and other complications of the metabolic syndrome.

Aberrant methylation patterns have been shown to induce diabetic symptoms in another form of diabetes, Transient Neonatal Diabetes Mellitus (TNDM), which is a result of genetic imprinting. The same imprinted region responsible for TNDM, however, is not known to be responsible for NIDDM. If epigenetic alterations are responsible for NIDDM, then three questions naturally arise: First, what secreted factors are responsible for the NIDDM phenotype? Second, what tissue-type(s) is responsible for expressing the factors, that induce the NIDDM phenotype? And third, what environmental factors could lead to a loss of methylation and consequent dysregulation of the secreted factors?

Insight into an answer for the first question comes from the highest scoring object on system's list in TABLE 25 of implicitly related objects, Endotoxins. While endotoxins are not known to be associated or causal in NIDDM, they have been shown to induce obesity and insulin resistance. Most of the relationships shared between NIDDM and endotoxins are objects that either affect or are involved in the immune response, especially cytokines and inflammatory factors. Elevated levels of pro-inflammatory cytokines are found in NIDDM patients, are positively correlated with obesity, and some such as TNFalpha are found to induce insulin resistance. Indeed, there is a growing body of evidence that cytokines, more specifically the pro-inflammatory cytokines, are responsible for the NIDDM phenotype. It has been observed, for example, that a reversal of NIDDM symptoms can be induced by disruption of the inflammatory pathway with high doses of aspirin. Troglitazone, a medication that was used to treat NIDDM has also been found to have anti-inflammatory properties, and the lifestyle changes of exercise and dietary changes prescribed to NIDDM patients that have been successful in reversing NIDDM phenotypes have also been associated with reductions in inflammatory cytokines.

Since there is evidence that pro-inflammatory cytokines are the causal factor in NIDDM, it is of interest to identify their origin. Besides B-cells and T-cells, adipocytes and endothelial cells are the only other cell types known to normally produce cytokines. Within T-cells, cytokine expression is determined by DNA methylation patterns and can be altered by demethylating agents. Neither T-cells nor B-cells seem a likely candidate since they are not very metabolically active in their naive or memory forms, and their more active differentiated forms are relatively short-lived. Adipocytes, however, are the primary repository for lipids and produce cytokines in proportion to factors such as their size and surrounding obesity. Interestingly, one study demonstrated that short-chain fatty acids (SCFAs) promote the demethylation of actively transcribed regions. SCFAs can also affect chromatin structure by inhibiting HDAC, causing hyperacetylation of histones and making regions of DNA more accessible to transcription factors. SCFAs are not normally present in high concentrations within adipocytes, but are normal metabolic byproducts of the long-chain fatty acids stored within. Higher amounts of SCFA metabolites within adipocytes may provide an environment in which loss of DNA methylation could occur and, coupled with active transcriptional activity, could lead to the hypomethylation and consequent dysregulation of cytokines or cytokine-like factors that lead to NIDDM. IL-6 and TNF-alpha levels were observed in twenty women before and one year after gastric banding surgery. Here, the levels of other obesity markers such as C-Reactive Protein (CRP) declined, while IL-6 and TNF-alpha did not.

Within the proposed model, the etiology of NIDDM occurs within adipocytes, involving a gradual loss of DNA methylation around the promoters of cytokines and/or cytokine-like factors normally secreted by the adipocyte. This loss of methylation is favored under the conditions provided by obesity and is caused by transcriptional activity. The subsequent loss of methylation leads to a dysregulation of these factors, resulting in a constitutive increase in the production of cytokines from adipocytes. Negative regulatory factors can reduce the expression of these factors, enabling a management of the NIDDM phenotype, but only as long as they are present.

An example of a total cellular methylation assay for use with the present invention may be one or more of the following genes (including GenBank reference identifiers): FIZZ? (NM_{—}020415); IL-6 (NM_{—}000600); TNF-alpha (NM_{—}000594); Leptin (NM_{—}000230); IL1beta (NM_{—}000576); IFN-gamma (NM_{—}000619); L-4 (NM_{—}000589); PPAR-gamma (NM_{—}005037); STAT3 (NM_{—}003150); NF-KappaB (NM_{—}003998); IL-8 (NM_{—}000584); IKK-beta (XM_{—}032491). By monitoring the methylation of one or more of these genes using, e.g., a methylation array, the effect of a nutritional supplement that contains one or more methylation precursors may be evaluated to show an effect in individuals at risk for NIDDM or improvement in the epigenomic methylation patterns of cells.

### Etiological Models of NIDDM

This new proposed model is examined in the context of the three existing models for the etiology and pathogenesis of NIDDM: genetic, environmental, and a complex interaction of both factors.

Genetic studies have shown that inheritance plays a role in determining an individual's risk of developing NIDDM. Linkage studies, while delineating a number of potential susceptibility regions, have yet to be successful in identifying a specific gene or set of genes responsible for the most popular form of NIDDM, despite the large cohorts involved. The well-established correlation between obesity and NIDDM also indicates that environmental variables affect the pathogenesis of NIDDM. Environmental variables, however, are correlative rather than causal. The prevailing theory is that the onset of NIDDM is caused by one or more environmental variables acting upon a genetic background of which there may be many contributing genes. This theory explains how susceptibility to NIDDM correlates with genetic background, such as race, as well as with environmental variables such as diet and exercise. There are other observations about the nature of NIDDN that the complex model does not explain but the epigenetic model does: time-dependency and systemic memory.

Even when environmental variables are present on a susceptible genetic background, the onset of NIDDM is still time-dependent. That is to say, the risk of developing NIDDM is positively correlated with age. This is not explained easily by the complex disease model except to postulate an as-yet-unknown “trigger” event, such as an infection. Even if this were true, it would not explain the persistence of NIDDM after onset. NIDDM is diagnosed by the levels of insulin resistance and glucose intolerance experienced by a patient, levels which can be altered to pre-diabetic levels by sufficient changes in lifestyle. NIDDM, however, cannot be reversed. None of the existing models account for a mechanism by which the body can “remember” its state. The methylation status of genes, however, is considered to be a relatively persistent phenomenon, responsible for committing cells into their differentiated states. Given that loss of DNA methylation is correlated with age, that the number of methylated sites in a genome is determined by inheritance, and that loss of methylation can be affected by environmental variables, it would seem that the proposed epigenetic model merits serious consideration.

Contrary to the mutation-centric model, which assumes alterations in function or activity based upon either somatic or inherited mutations in DNA, an epigenetic model implies a dysregulation of a gene or set of genes. Thus, phenotypes resulting from the expression of such genes would make biological sense under other physiological conditions. Preventing energy influx into cells by inducing insulin-resistance makes sense when considered within the context of the role of the immune system. As discussed, expression of cytokines can induce NIDDM symptoms, especially the pro-inflammatory cytokines such as IL-6, TNF-alpha and IL-1b. Acquired immunity in the form of B-cell maturation and antibody production takes time during which pathogens are able to replicate. Part of the early immune response consists of an increase in the presence of pro-inflammatory cytokines within the circulating bloodstream. It would make sense that one role of these earlyresponders would be to stem the influx of resources like glucose into cells to prevent their utilization by invading pathogens. Since adipocytes contain a large reservoir of energy, this makes them ideal targets for invading pathogens and could necessitate their taking a more active role in fighting infection beyond that of other somatic cells.

Finally, if correct, this theory will allow us to diagnose the current level of epigenetic progression towards NIDDM in patients and offer hope for a NIDDM cure that could not be easily provided in a mutation-centric model. It is not apparent how region-specific methylation could be reintroduced to affected regions, but since de novo methylation is a normal process during development, it stands to reason that the mechanism to do so is already in place.

### Example 4

### Using the System to Identify New Therapeutic Applications for Sildenafil (VIAGRA®)

Using the system of the present invention, a relational analysis was performed with sildenafil (VIAGRA®). In one embodiment, the analysis identified relationships between approximately 1,000 electronically available MEDLINE abstracts on sildenafil. In addition, new uses for the drug based upon its relationships with objects (e.g., other chemicals, genes, drugs, phenotypes and/or diseases) were scored and evaluated. Only the 50 highest scoring relationships were examined, the system identified several potential alternative uses of the drug. As expected, the highest scoring relationships were those with anti-hypertensive drugs, relationships that have been previously proposed.

### The Relationship to Asthma (278 Shared Relationships)

Among the system's top 20 identified relationships with sildenafil, several were with Asthma and two compounds used to treat the condition (i.e., epinephrine and theophylline). Interestingly, cGMP-5 is an enzyme abundant in both lung and penile tissues. In addition, one observation has been an improvement in breathing in patients with chronic obstructive pulmonary disease (COPD) and taking sildenafil. The system's has identified a potential relationship in which, as a vasodilatory agent, sildenafil may reduce the symptoms associated with alveolar constriction. Other evidence (e.g., the predominance of a target enzyme, PDE5, in lung tissue) supports this identified relationship and additional therapeutic use of the drug (and while efficacy has not been ascertained, the presence of certain physiological conditions in an individual patient may preclude the use of other drugs, in which sildenafil might represent a preferred treatment).

### The Relationship to Atherosclerosis (268 Shared Relationships)

The system also identified a potential relationship with atherosclerosis. Here, there are several relationships between vascular changes induced by sildenafil and its potential therapeutic use for atherosclerotic risk factors. One risk factor is hypertension. While chronic treatment with sildenafil may not be practical, it may temporarily alleviate hypertension (e.g., increase in blood flow to the peripheral vasculature) and, thus, the risk factors associated with atherosclerosis.

### The Relationship to Migraine Headaches (216 Shared Relationships)

The relationship between sildenafil and migraines is less clear. Several agents with selective vasoconstrictive properties, such as the triptans (e.g., Sumatriptan via the 5-HT1b receptor), are used to treat migraine headaches; however, other anti-migraine agents do not operate through vasoconstriction (vasoconstriction may be correlative or causal). Though headaches are a frequent side effect of sildenafil (and other vasodilating agents), migraines (a unique and specific type of headache), are not generally classified as a frequent side effect of the drug. It is possible that the hypotensive effects of sildenafil may actually counteract the unknown mechanism behind migraines. The system identified a candidate relationship between persistent migraines and coexistent hypertension.

### The Relationship to Spasms (220 Shared Relationships)

The system identified a general relationship between sildenafil and spasms (no filter to distinguish between the different clinical types of spasms, such as in smooth, skeletal or cardiac muscle or the microor macrovasculature, was used). Similarly, there, was a relationship between sildenafil and abrupt focal contraction of a muscle group that was identified. Interestingly, sildenafil was originally evaluated for the treatment of coronary angina by increasing blood flow to the heart. Analysis provides a hypothesis for the action of sildenafil as controlling spasms. The prior hypothesis was that the drug affected angina by restricting blood flow (via injury, ischemia or spasm).

The system has, thus, focused research and provides a more efficient use of technical and financial resources for identifying multiple and previously unknown uses of an object. It may also identify potential mechanisms by which the previously unknown objects may interact.

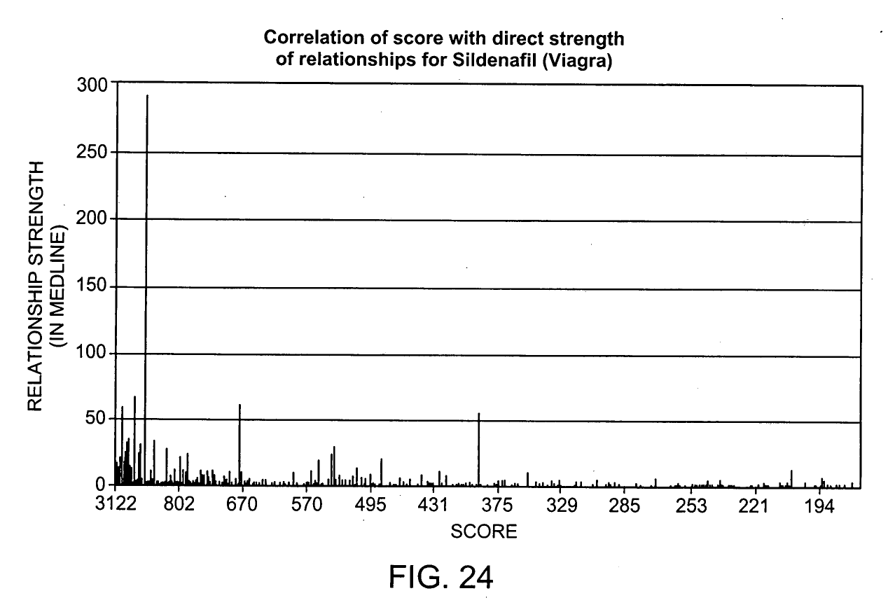

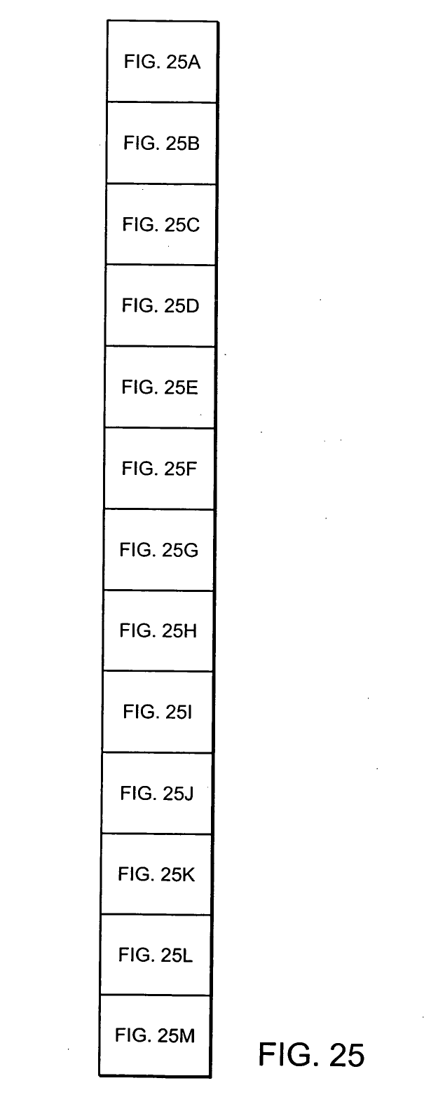

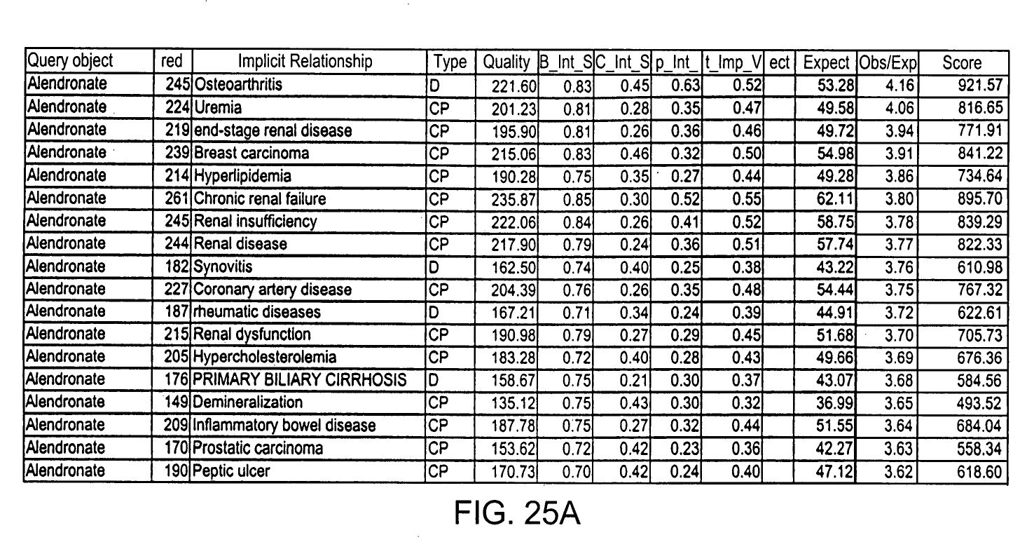

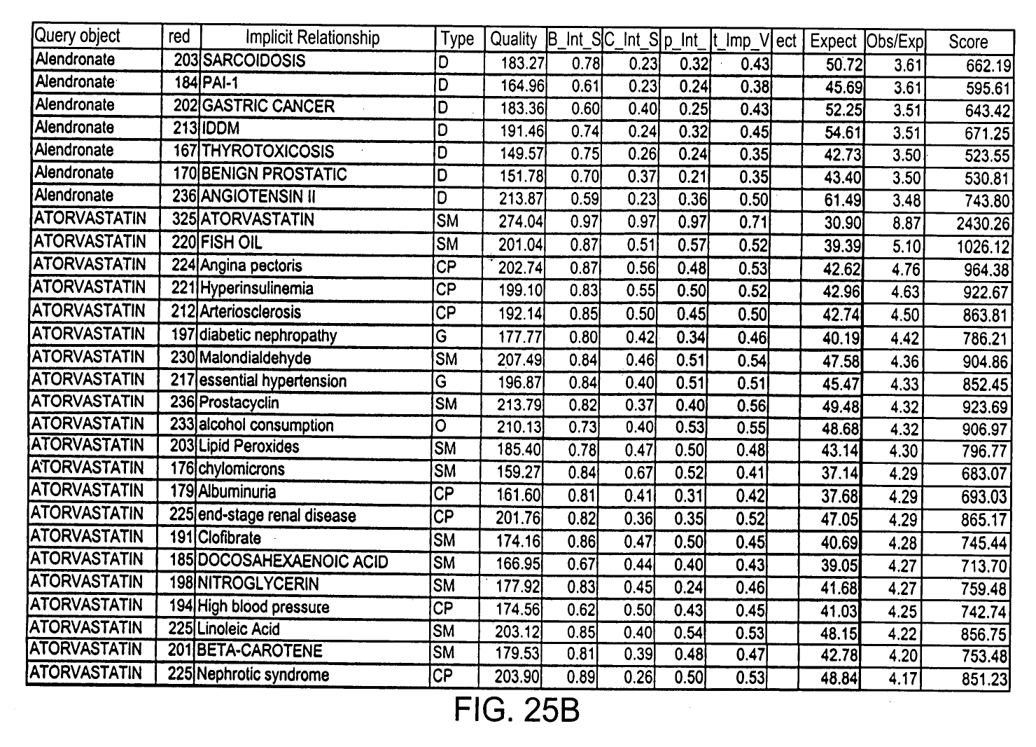

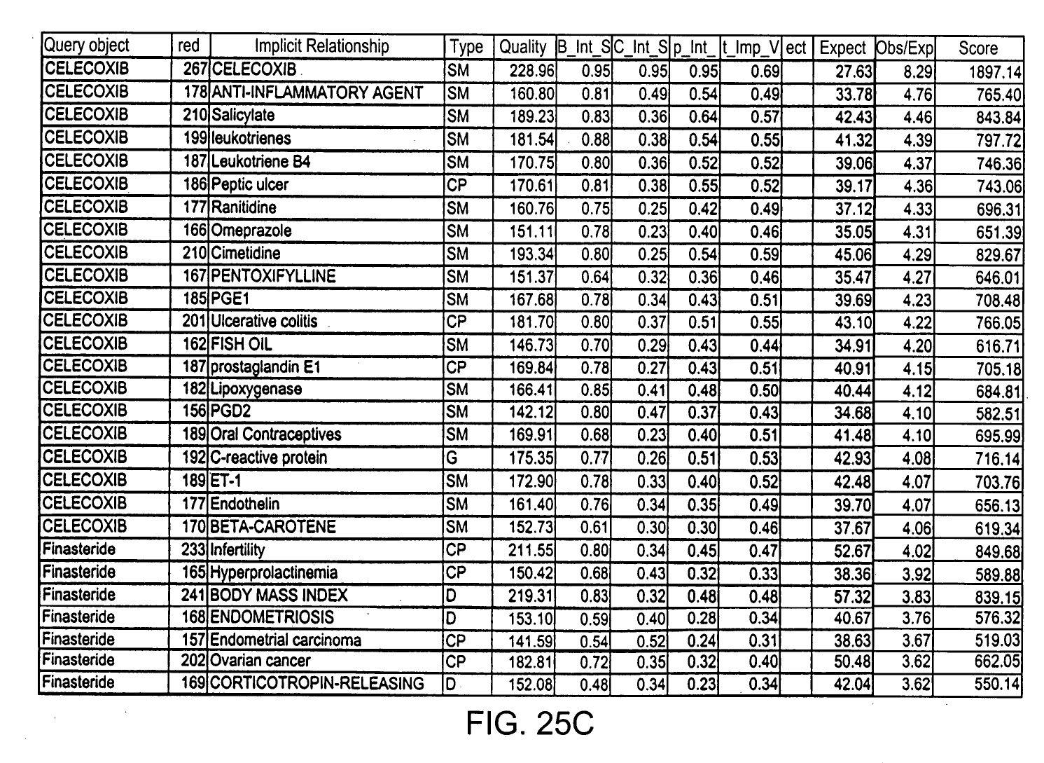

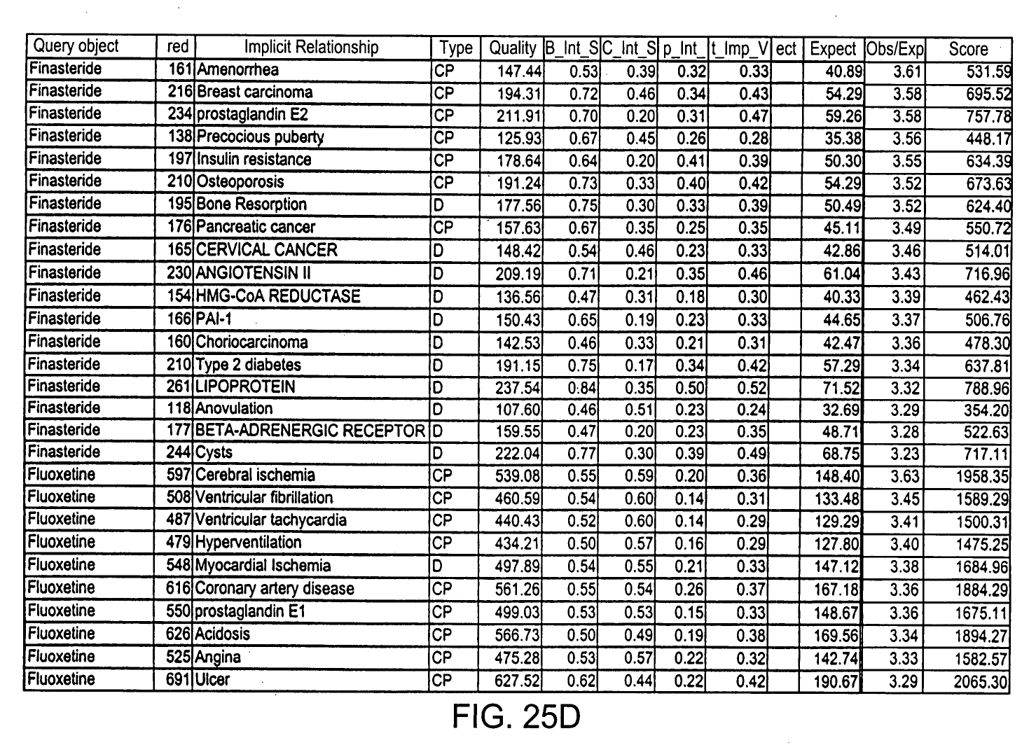

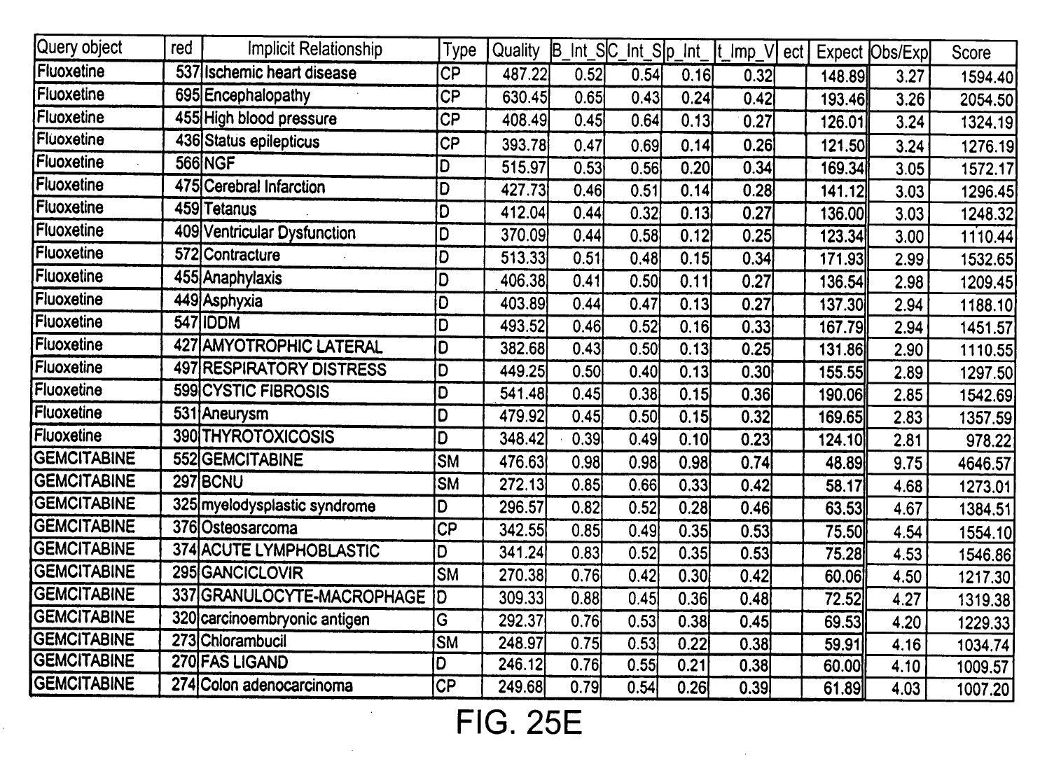

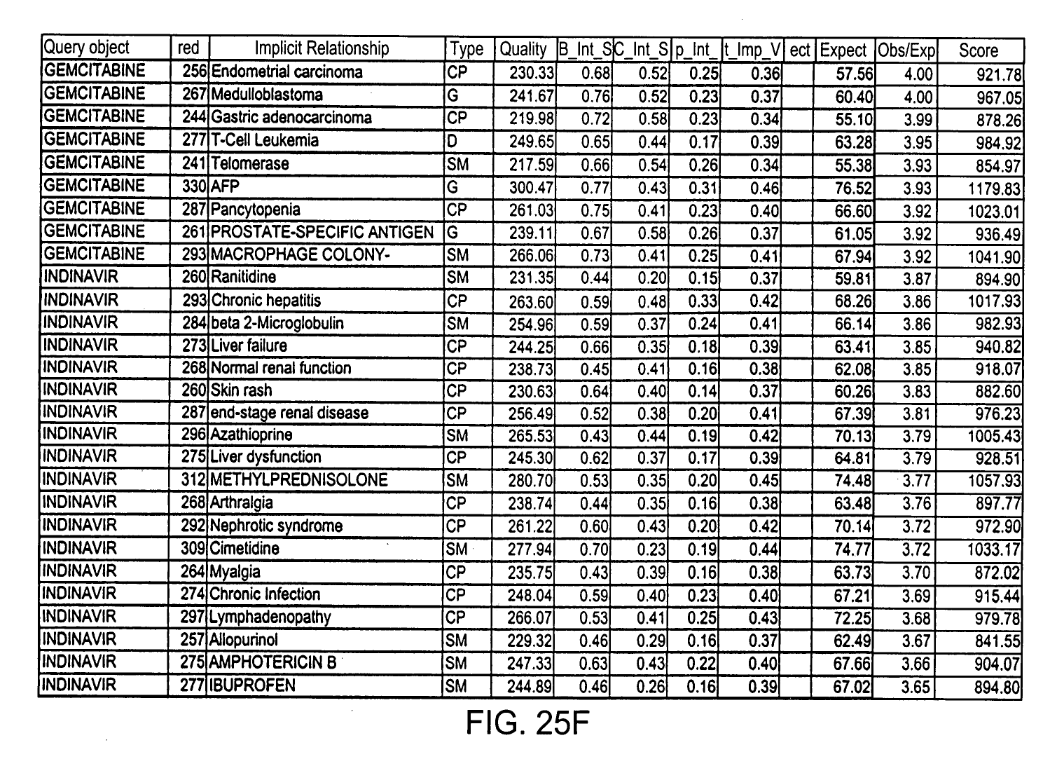

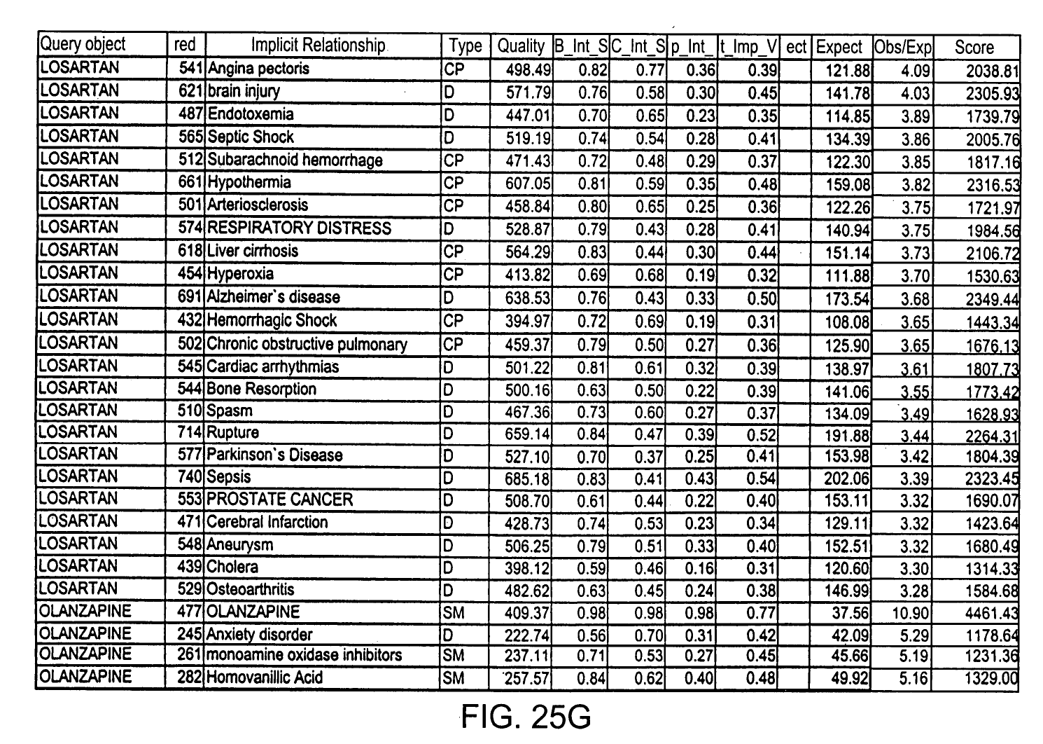

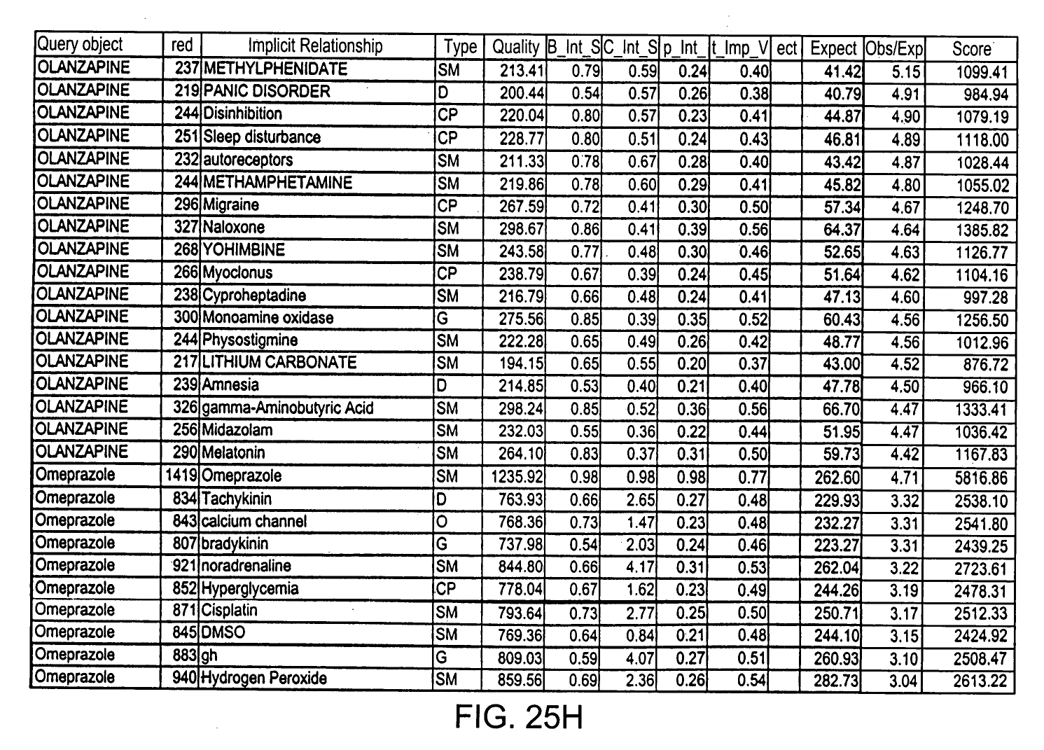

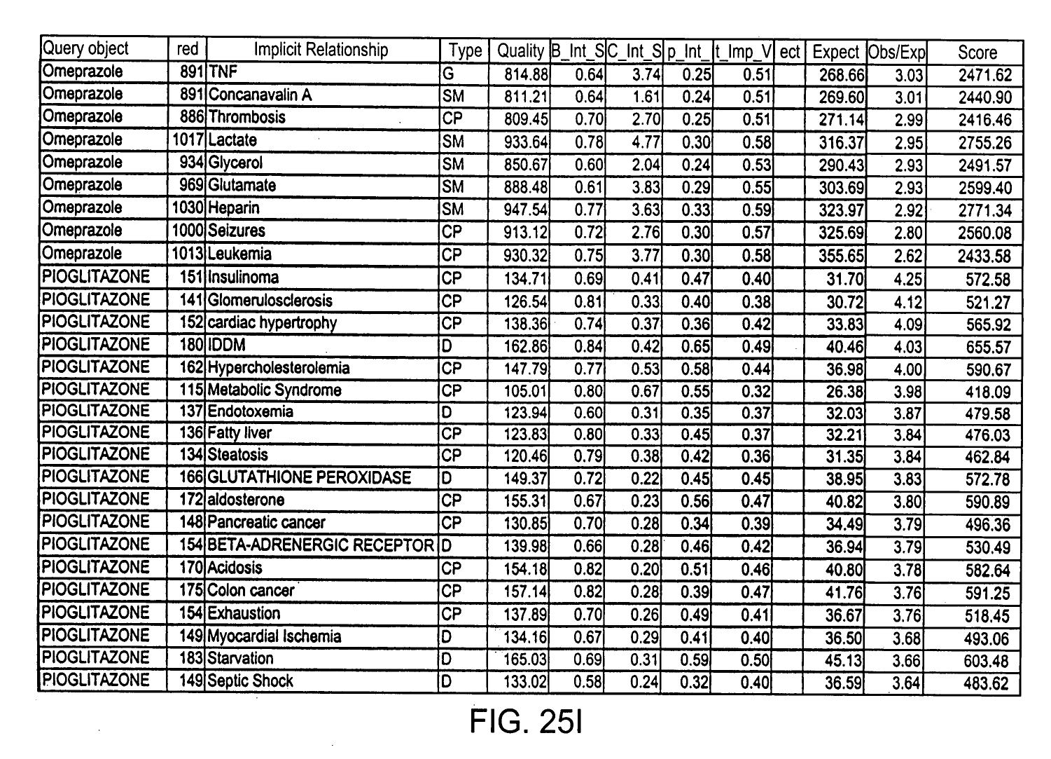

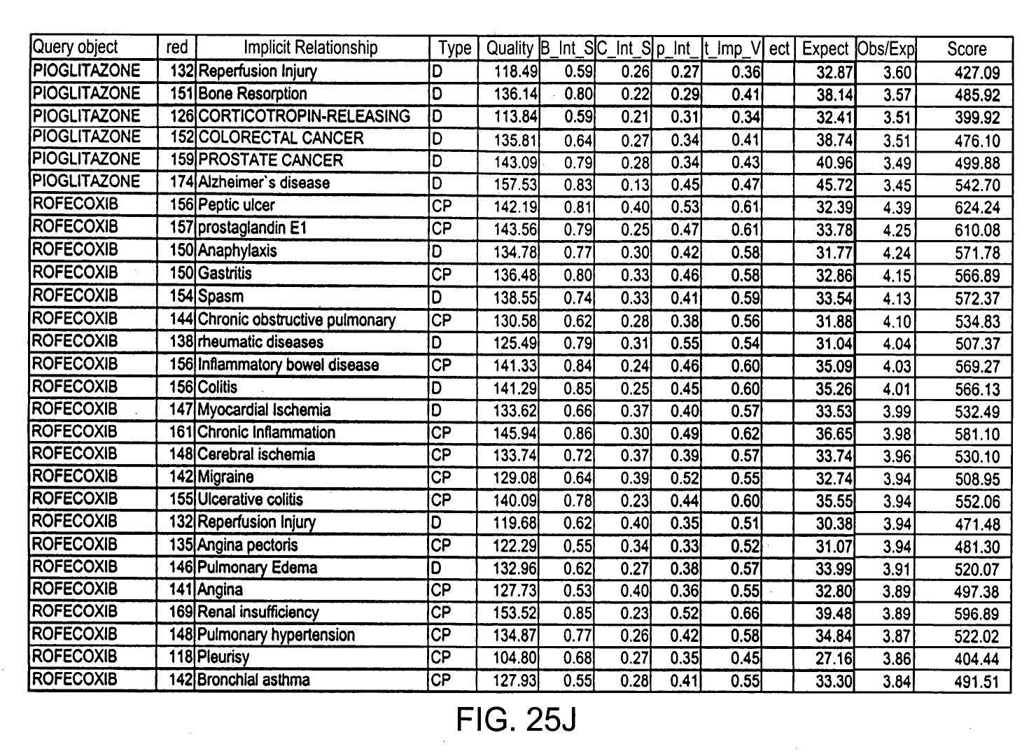

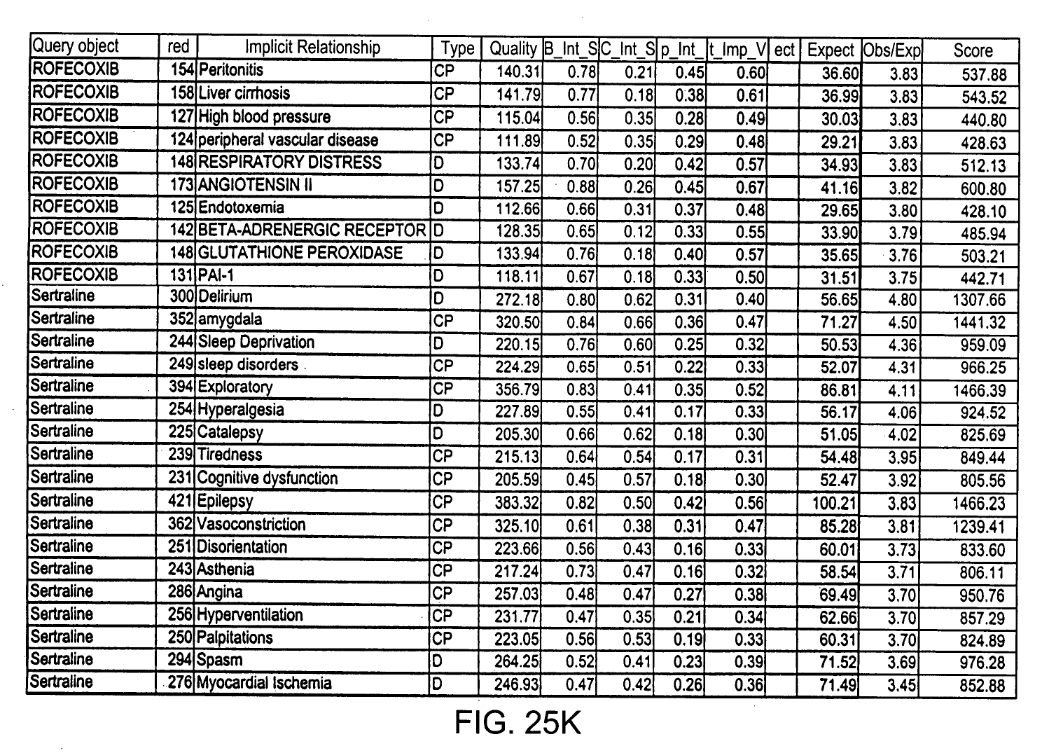

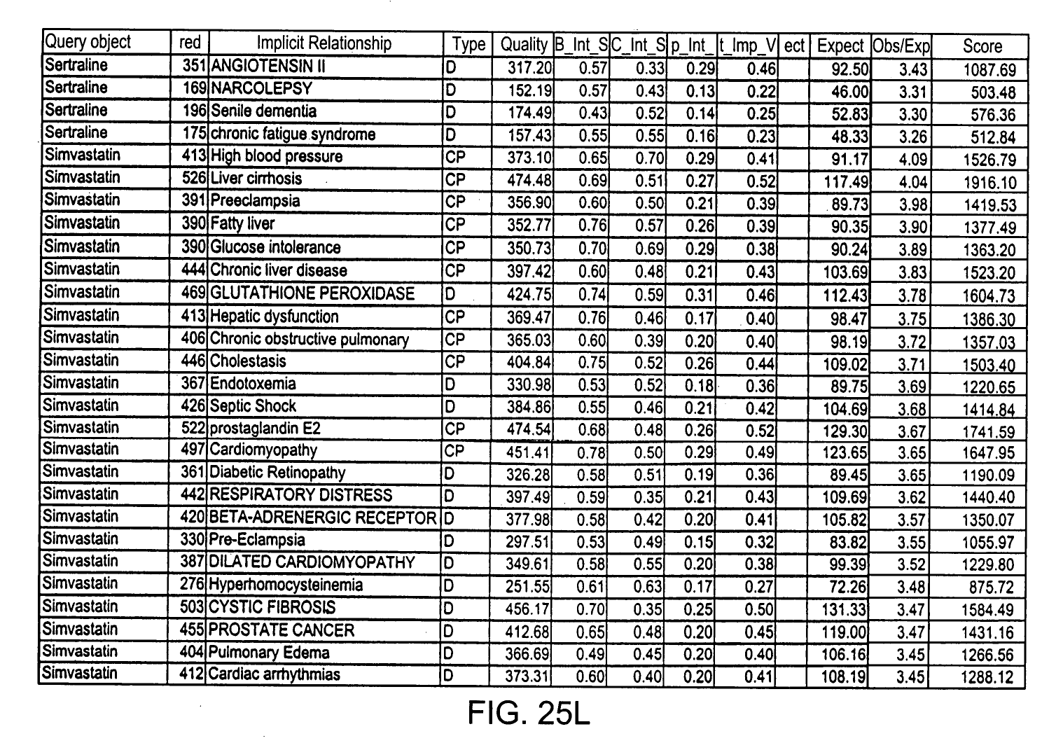

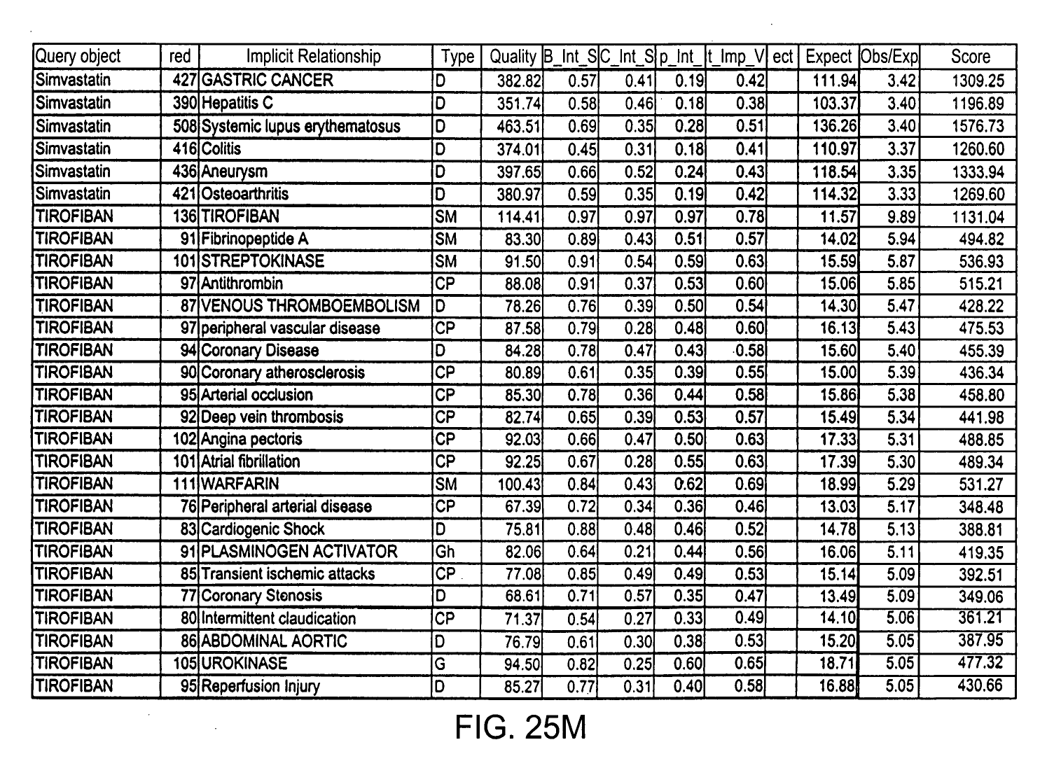

Analysis by the system created a number of objects related to sildenafil by a varying the number of intermediate (shared) relationships. Relationships were identified with a direct strength score. FIG. 24 is a graph that summarizes the purely implicit (no direct strength score) relationships that were identified and appear, therefore, as a smaller or non-existent bar in the graph. The known relationships are included to give the user a measure of confidence that the system has identified relevant relationships, and an idea of what objects it is capable of recognizing within a source such as MEDLINE. Correlation of the score the system derives from analysis of the shared relationships with the actual literature strength was taken from a scoring matrix, listed and plotted in the scoring graph. As shown in FIG. 24, the strongest known relationships (erectile dysfunction off scale on left) correlate with the score the system assigns using only the shared relationships. Gaps indicate the presence of an implicit relationship. The final output produced by the system, “Shared Relationships,” contains a list of many of the relationships connecting sildenafil with the objects mentioned above. Additional shared and implicit relationships between objects, such as a drug useful to treat pathologic conditions are shown in FIG. 25. FIG. 25 identifies many novel implicit relationship that were previously unrelated for several query objects. The query objects include pharmaceutical agents with Federal approval for indications to treat one or more pathologic conditions in humans. The agents include alendronate, atorvastatin, celecoxib, finasteride, fluoxetine, gemcitabine, indinavir, losartin, olanzapine, omeprazole, pioglitazone, rofecoxib, sertraline, simvistatin, and tirofiban,. FIG. 25 illustrates that a system according to the invention easily identifies novel uses for these phannaceutical agents to establish new indication and uses for them.

### Example 5

### Identification of Genes Associated with Breast Cancer as an Example of the Cohesion Analysis of a Group of Objects

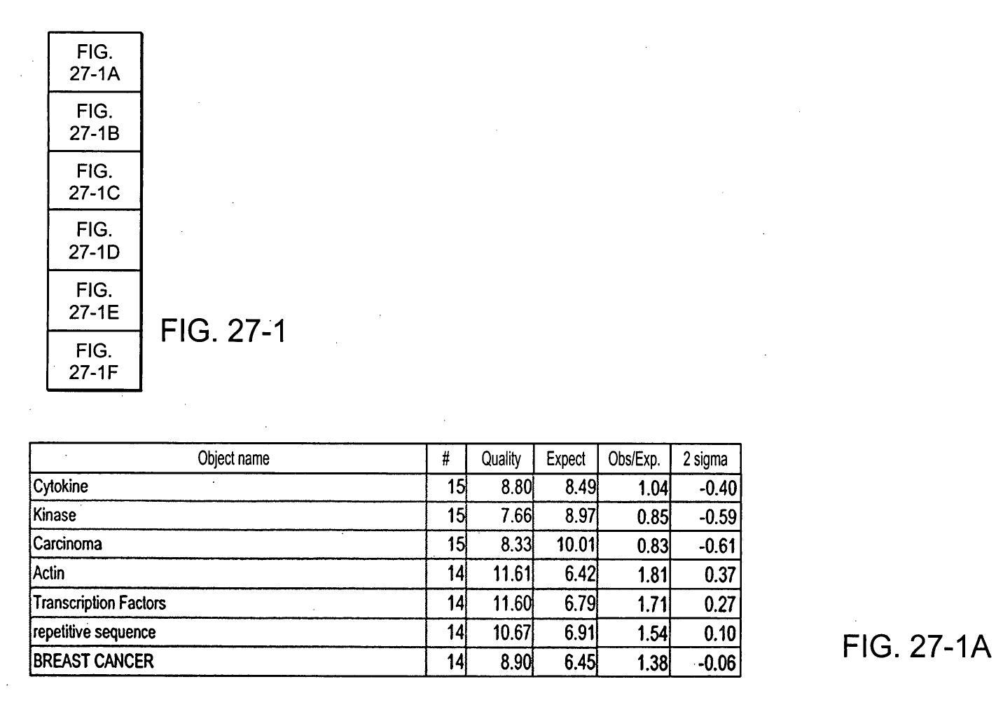

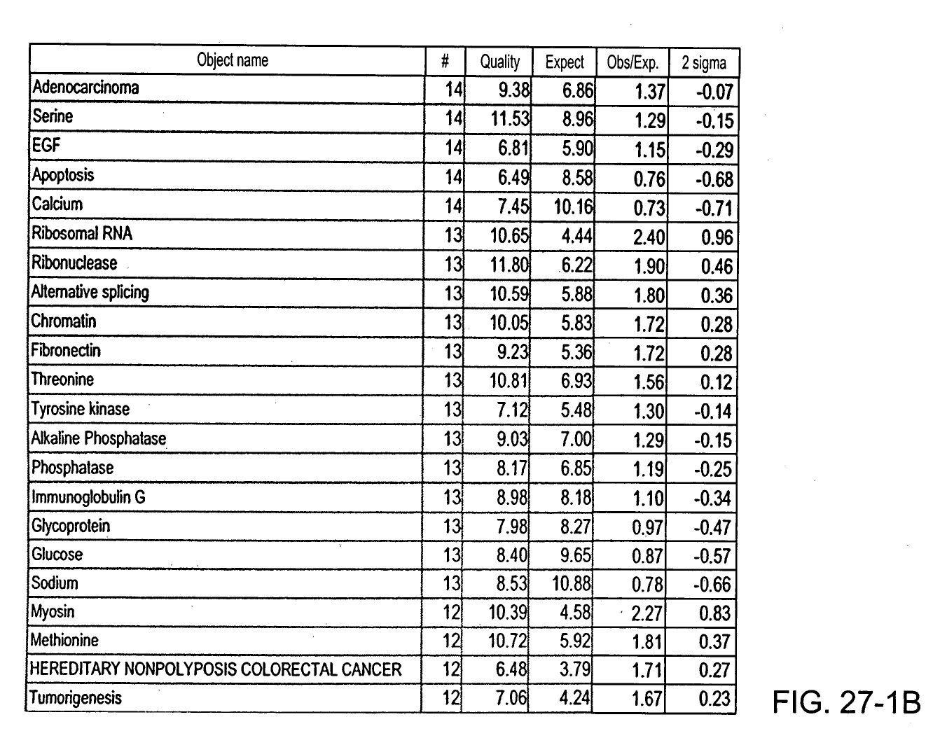

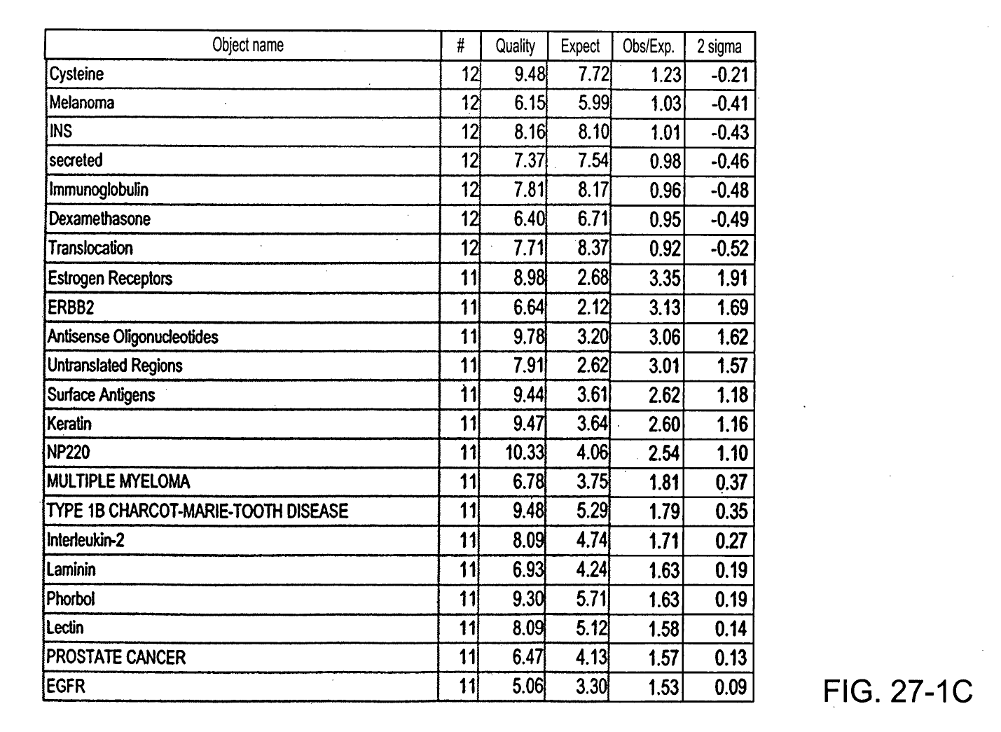

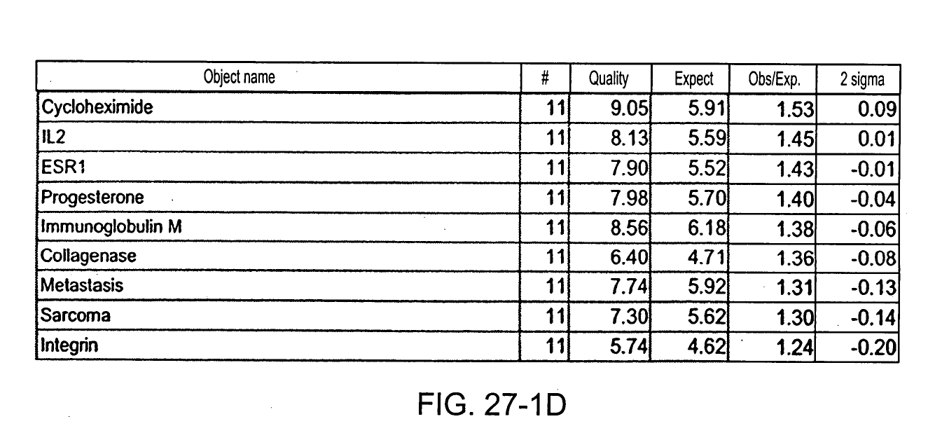

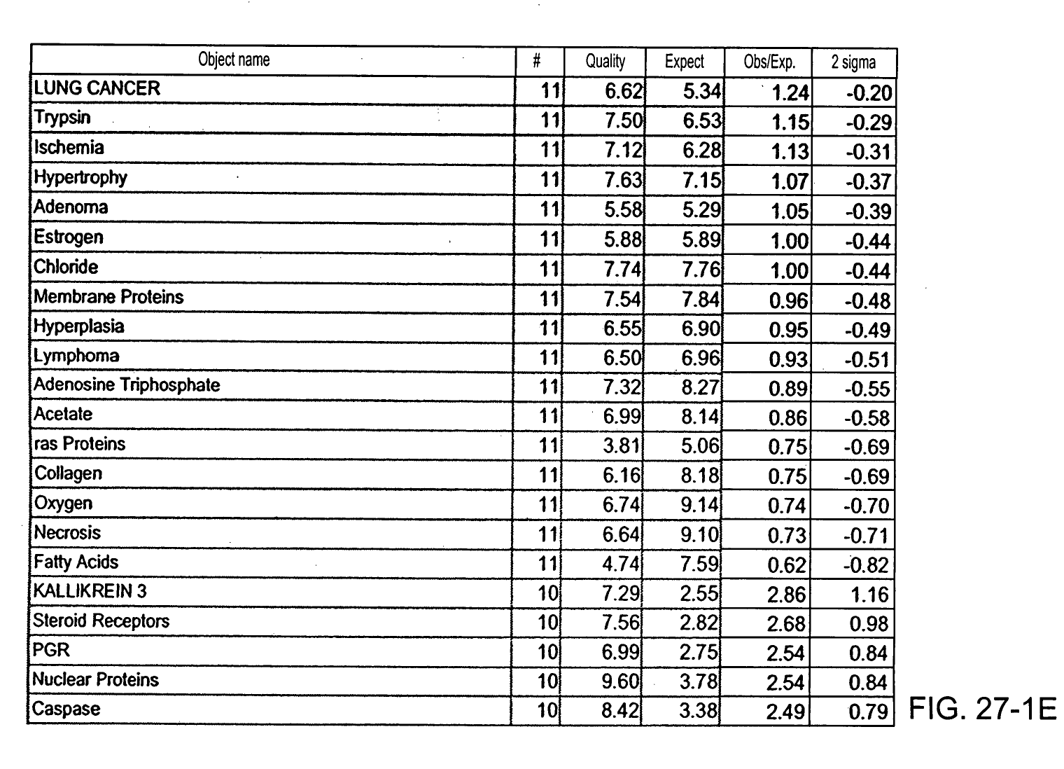

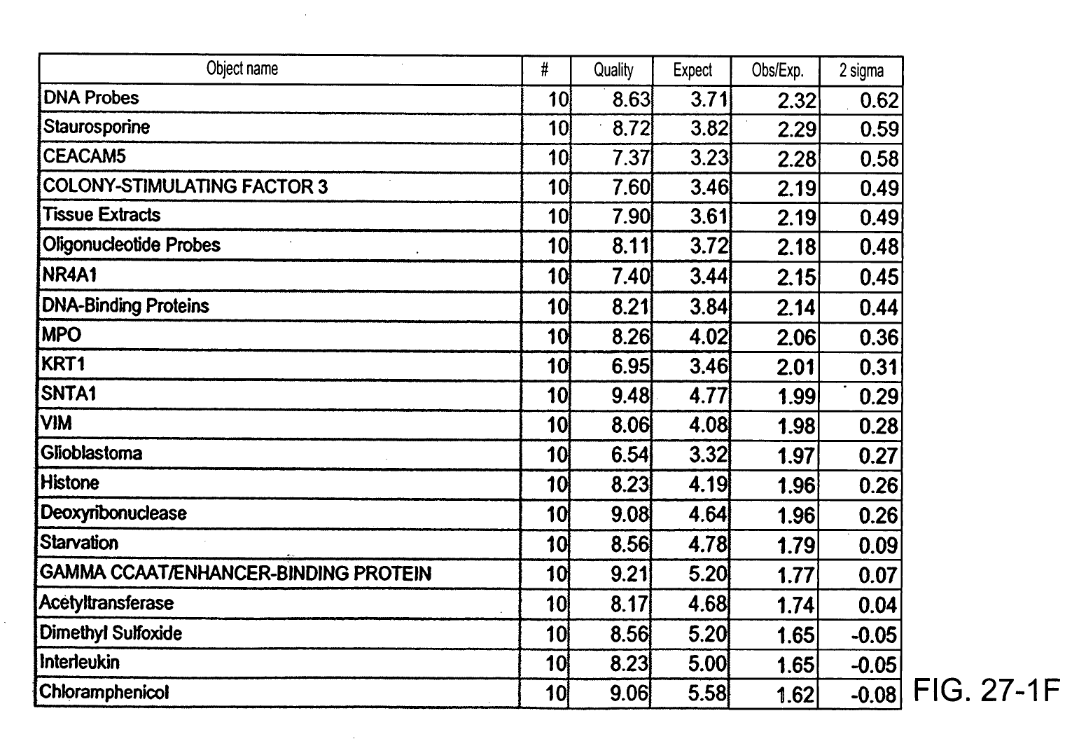

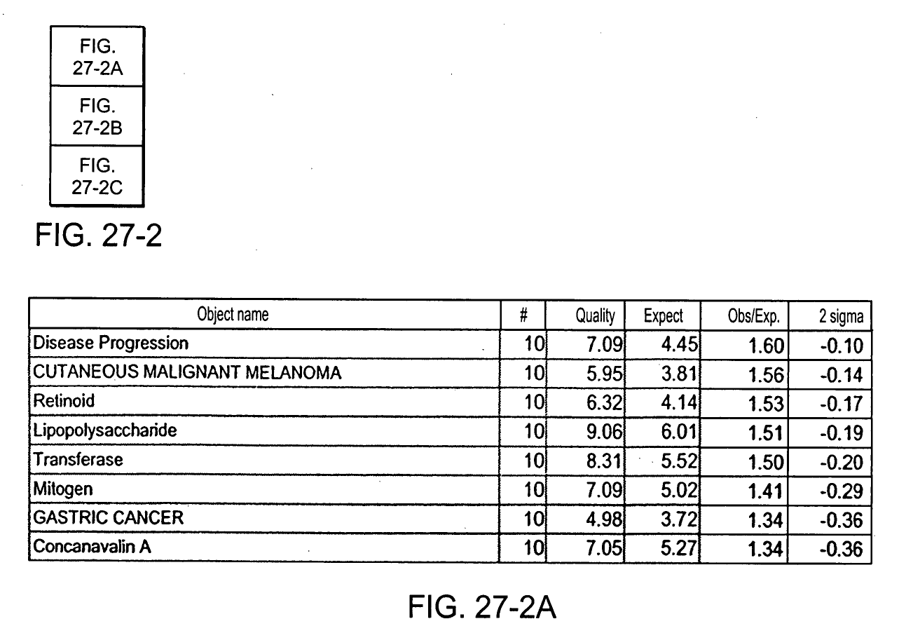

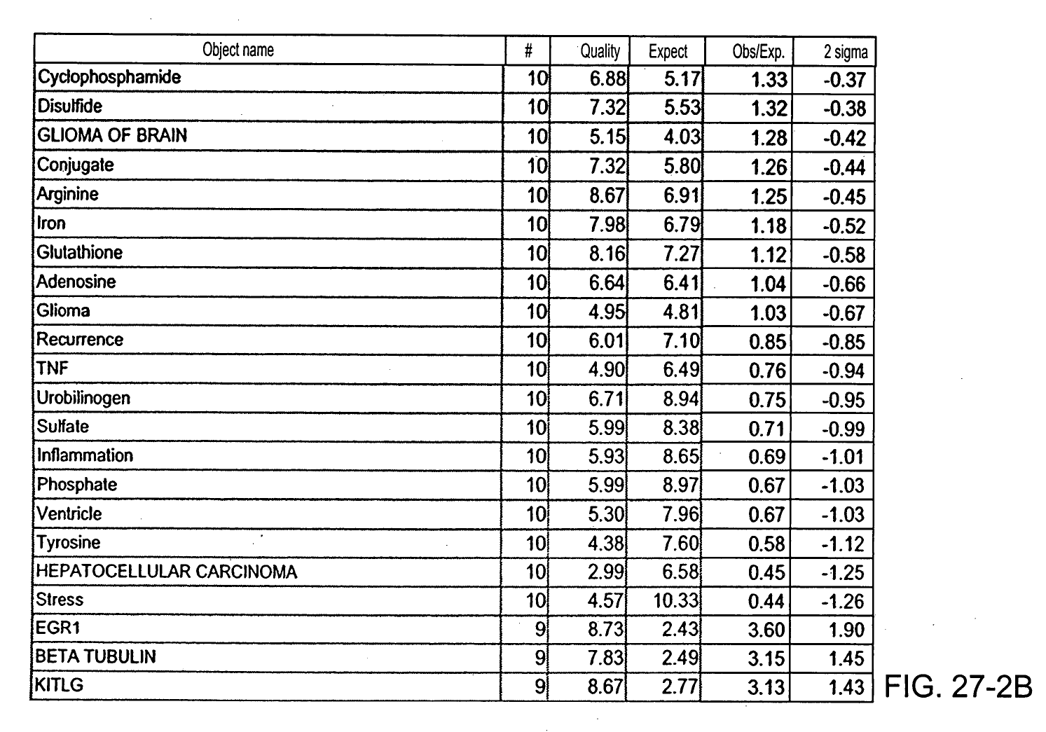

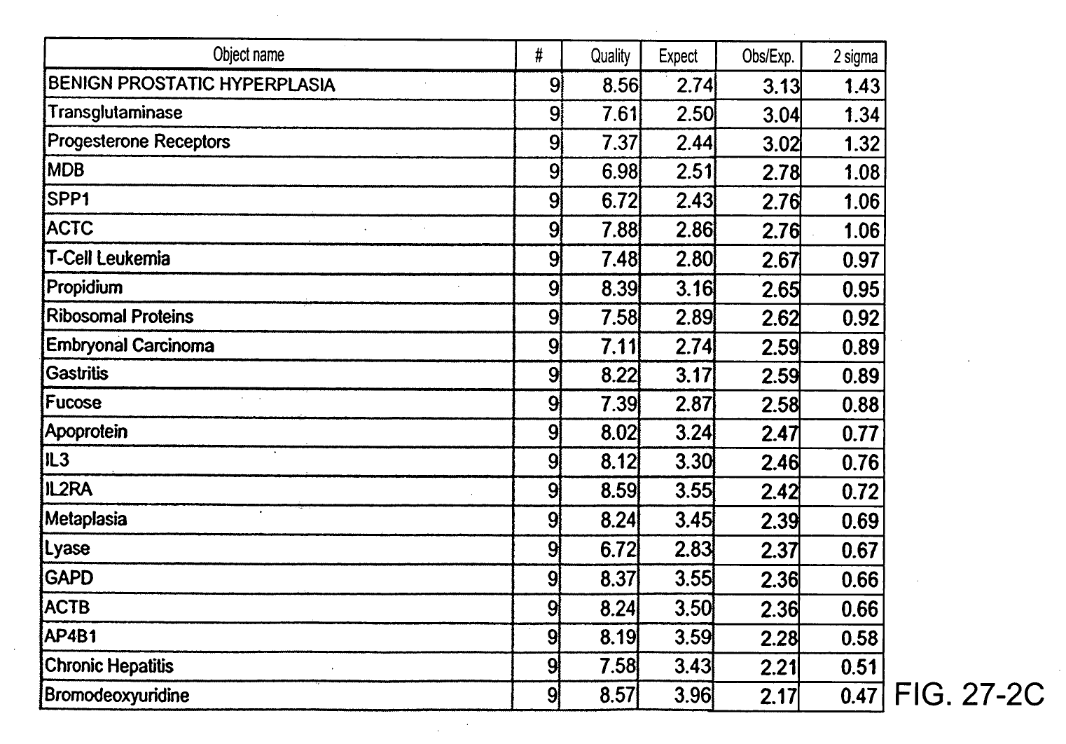

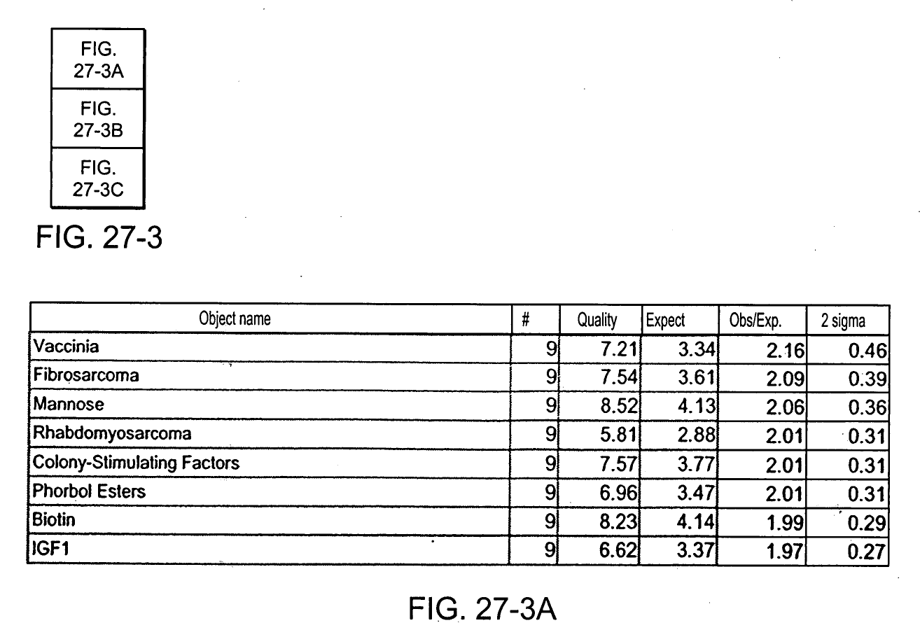

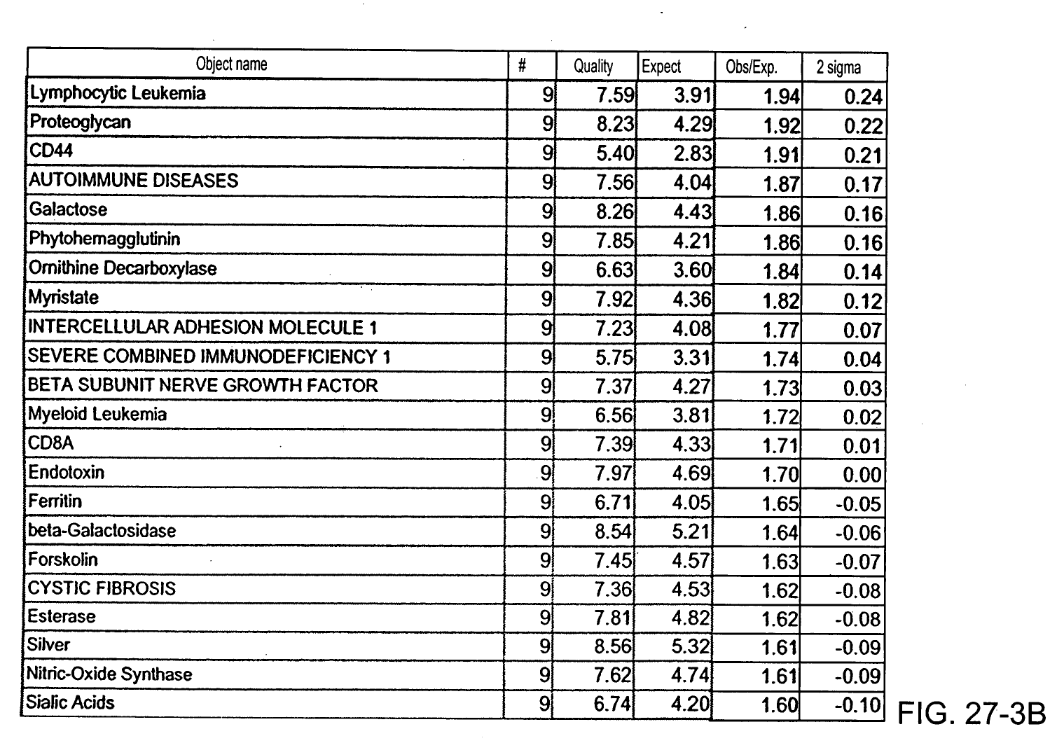

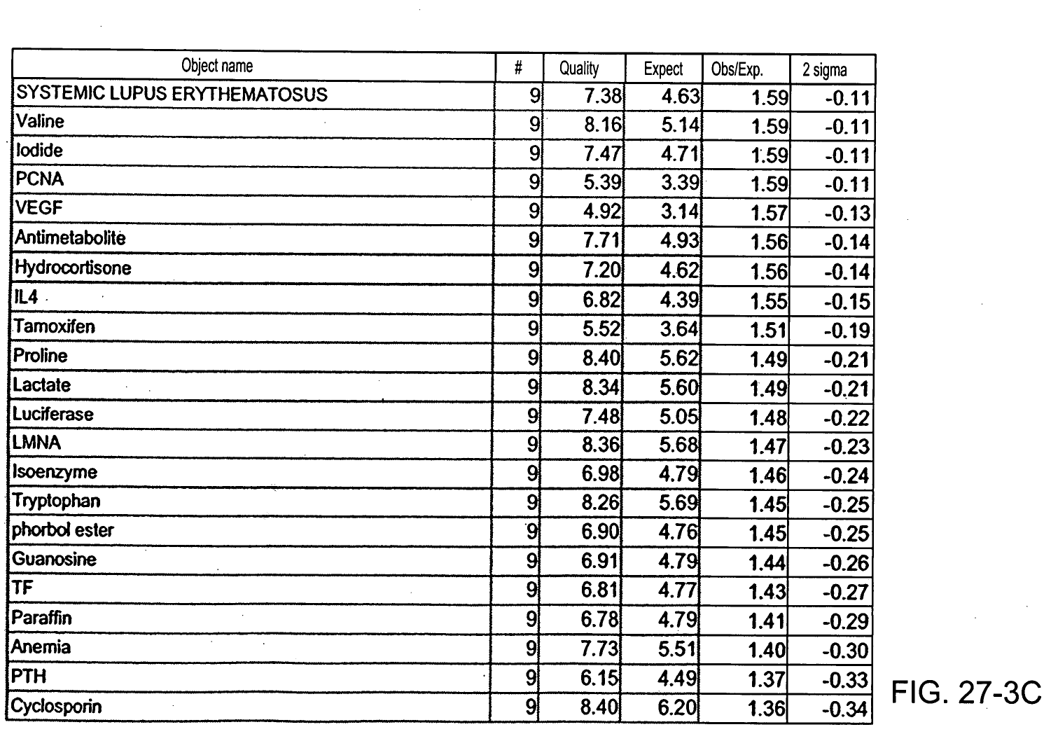

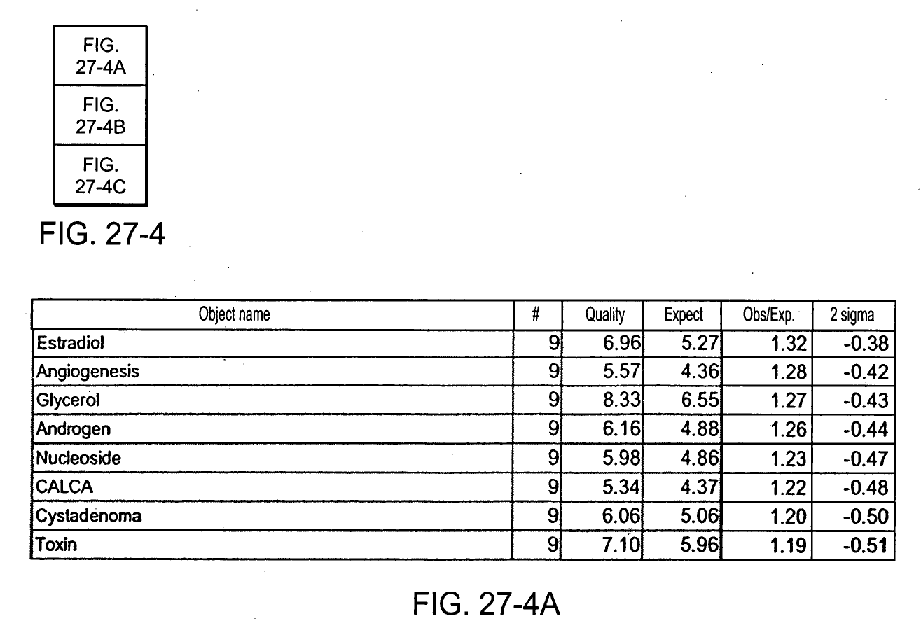

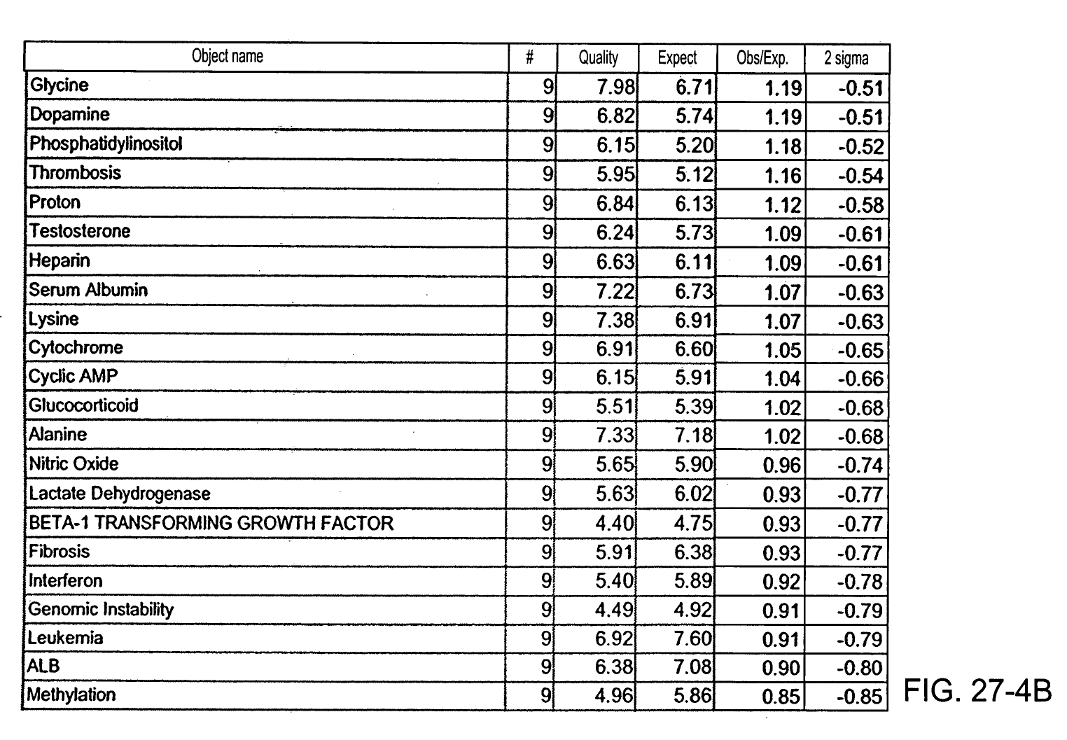

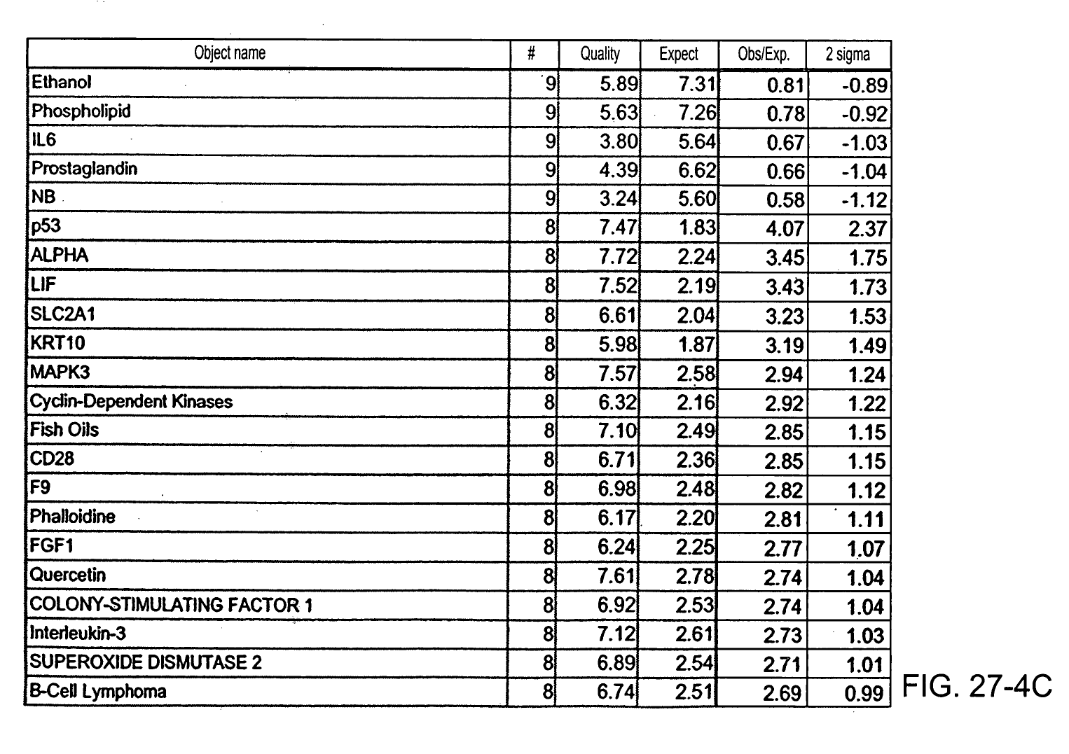

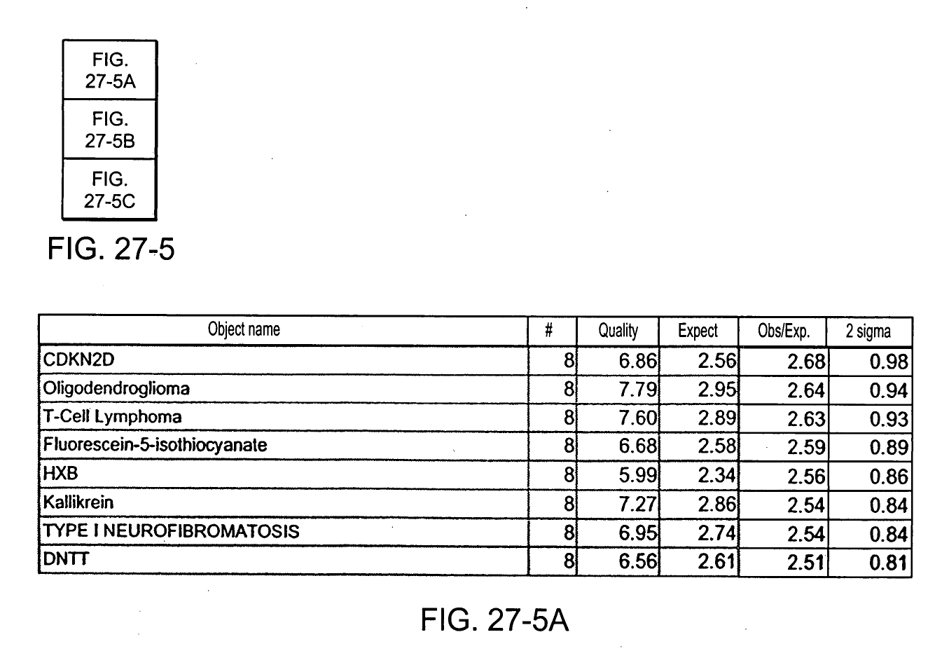

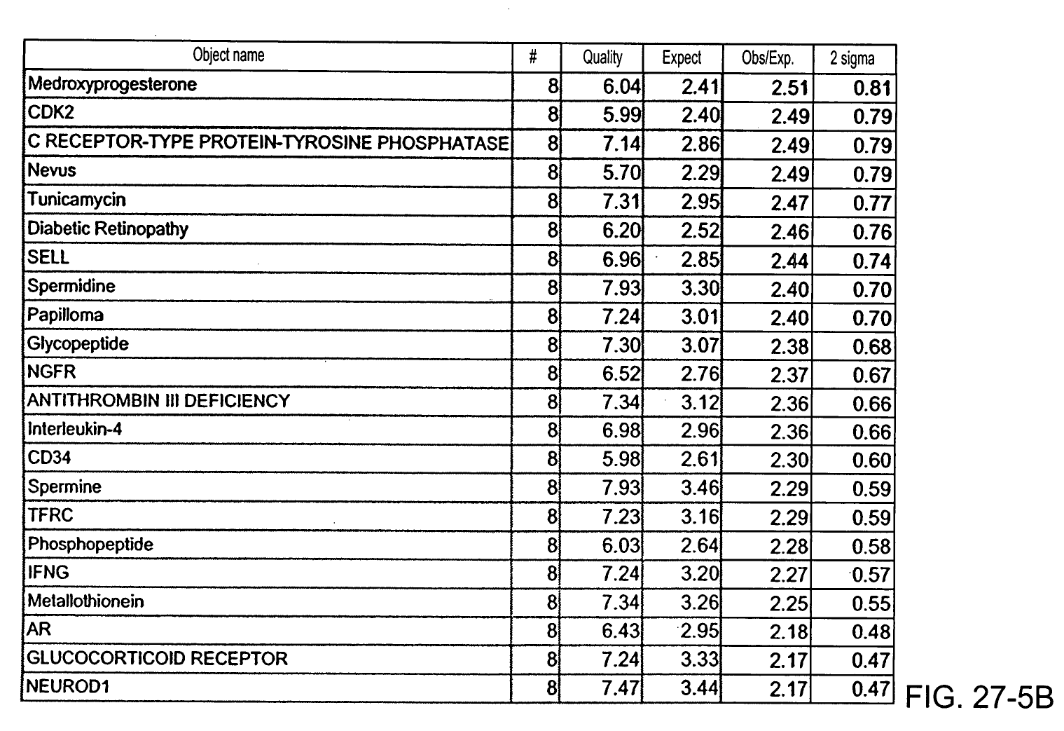

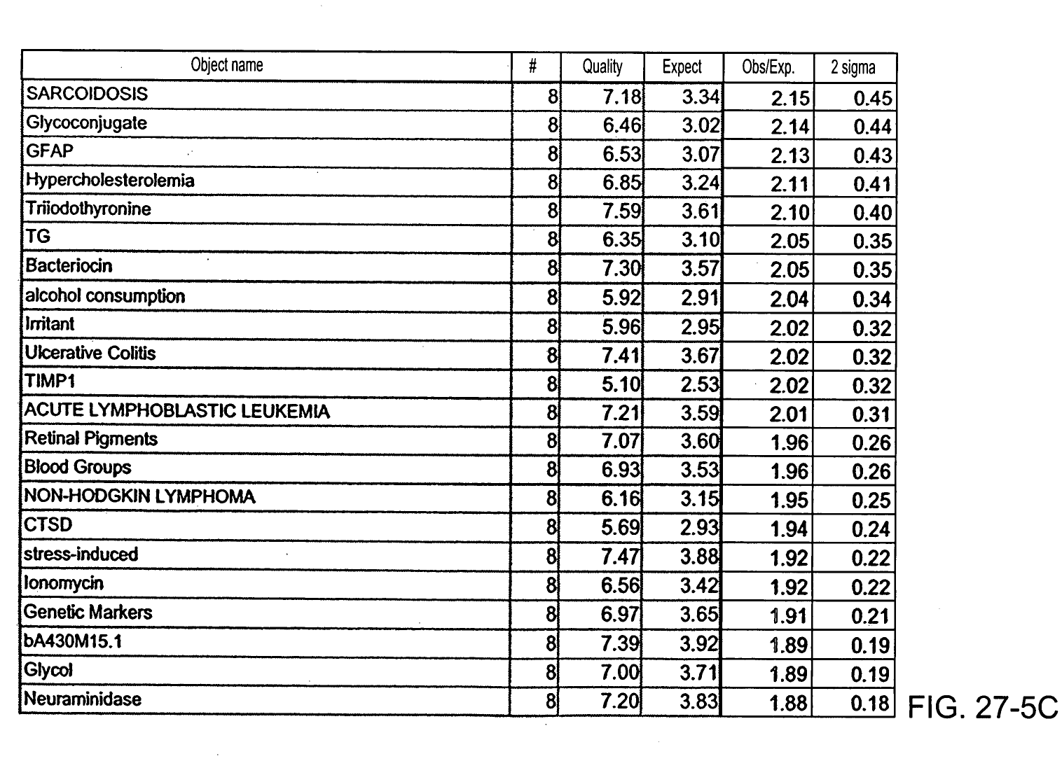

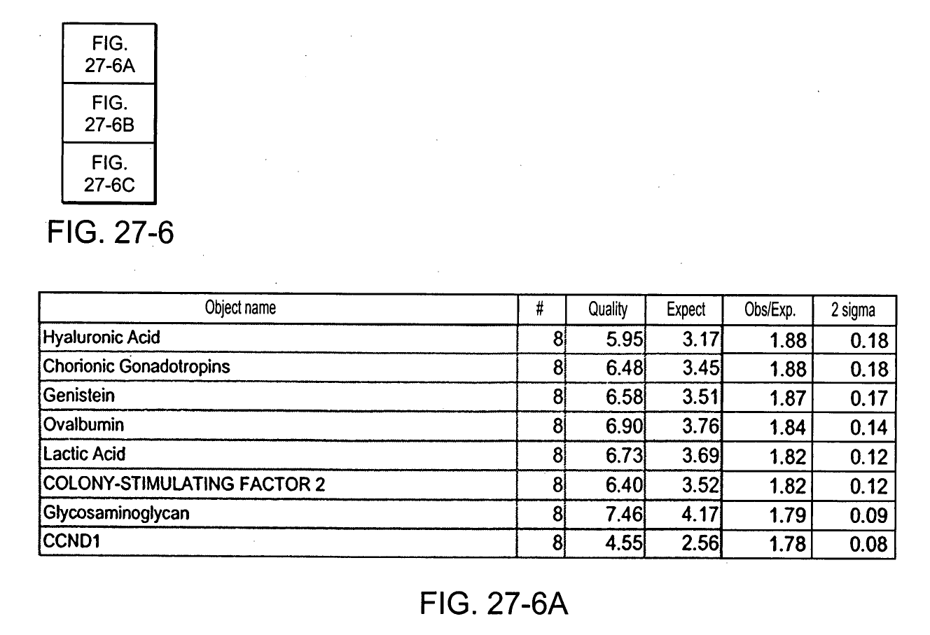

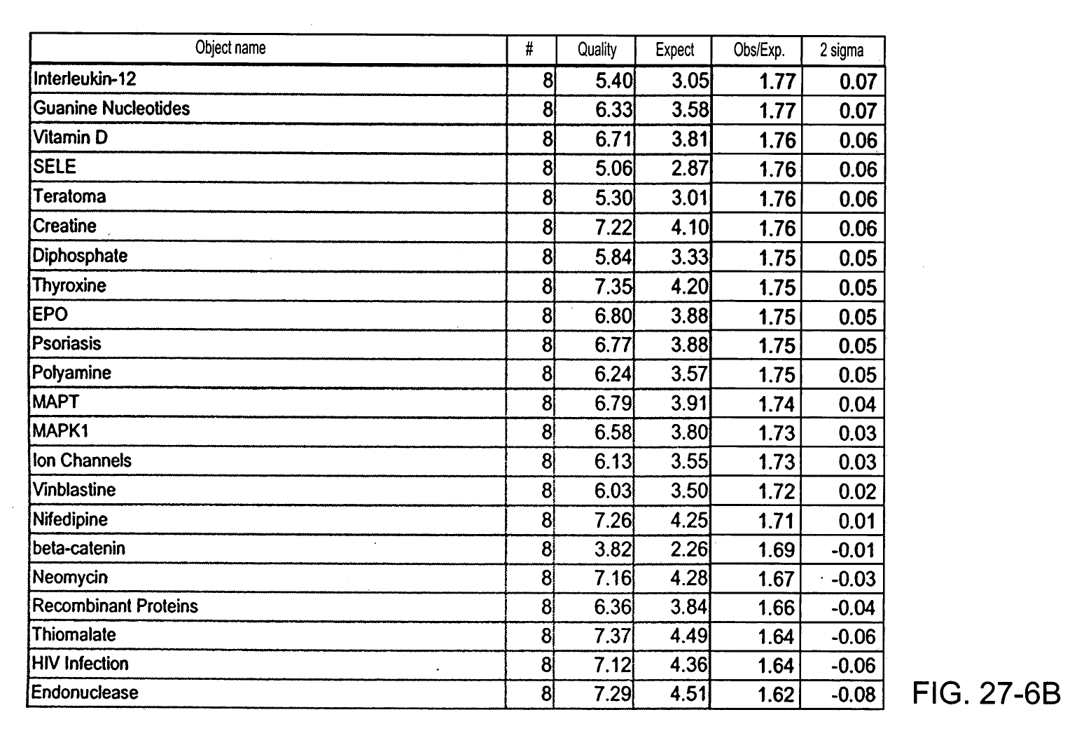

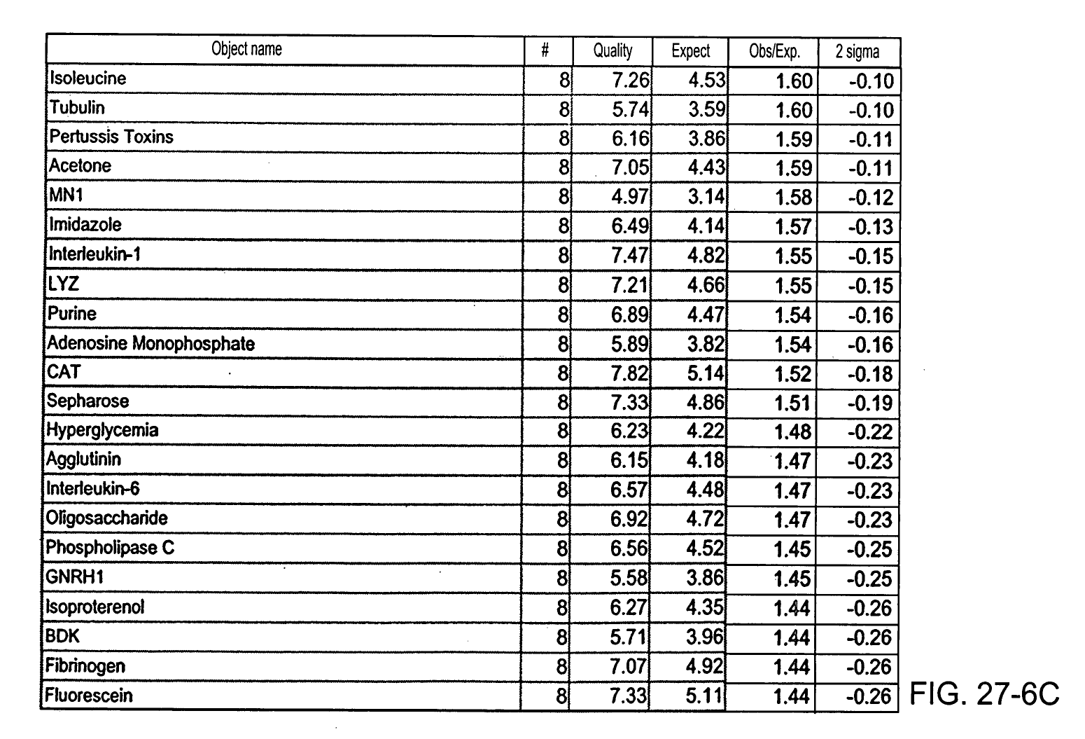

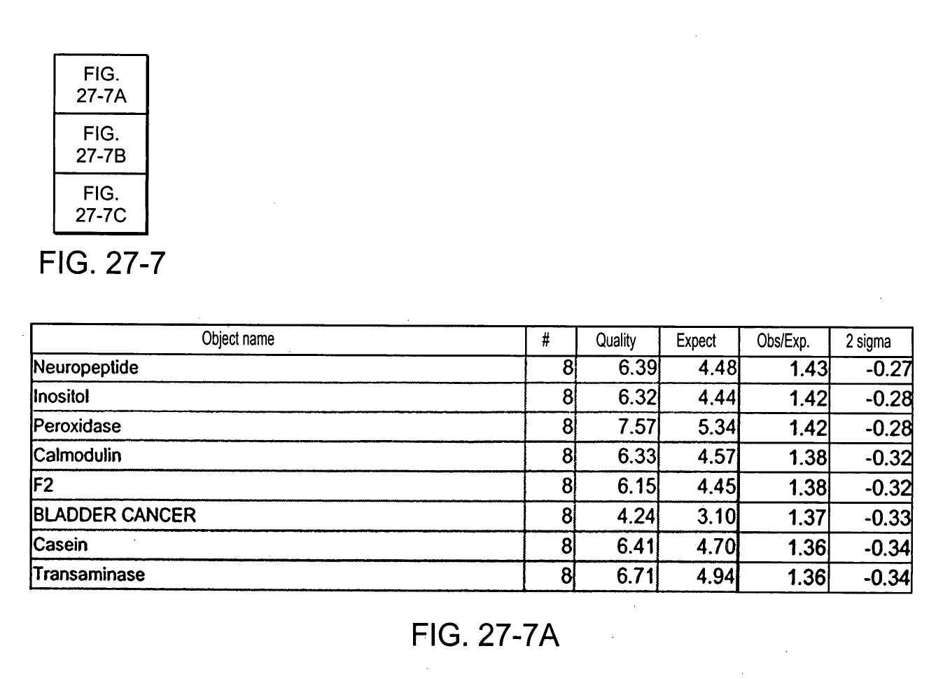

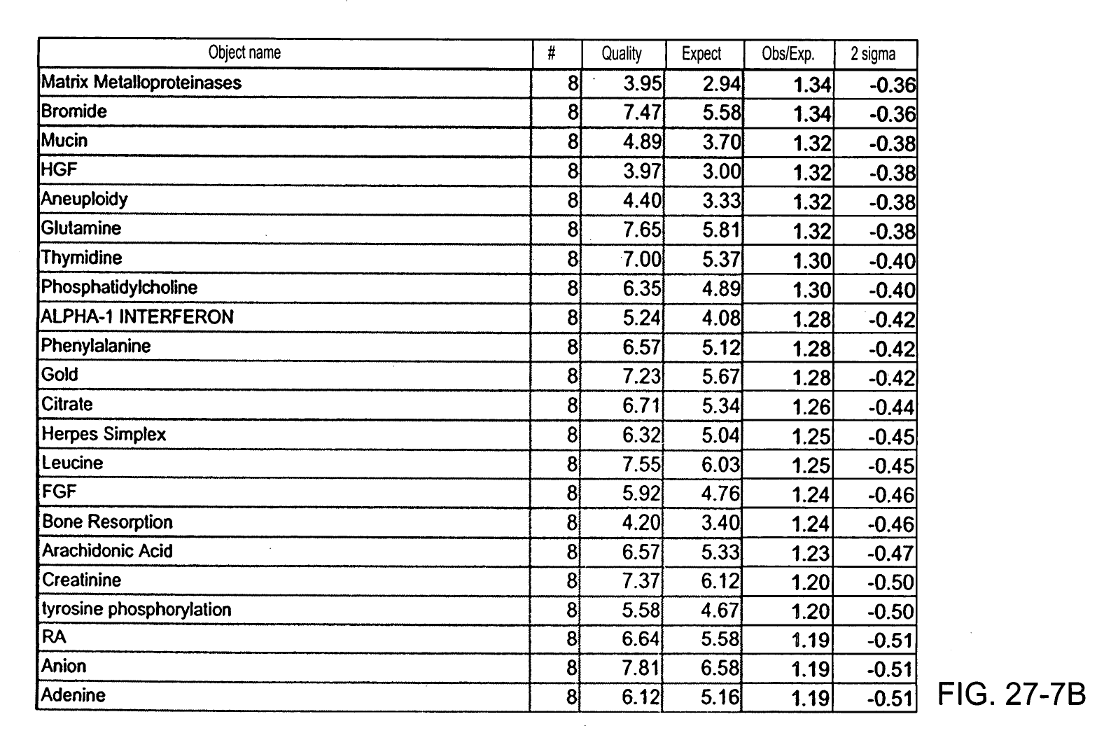

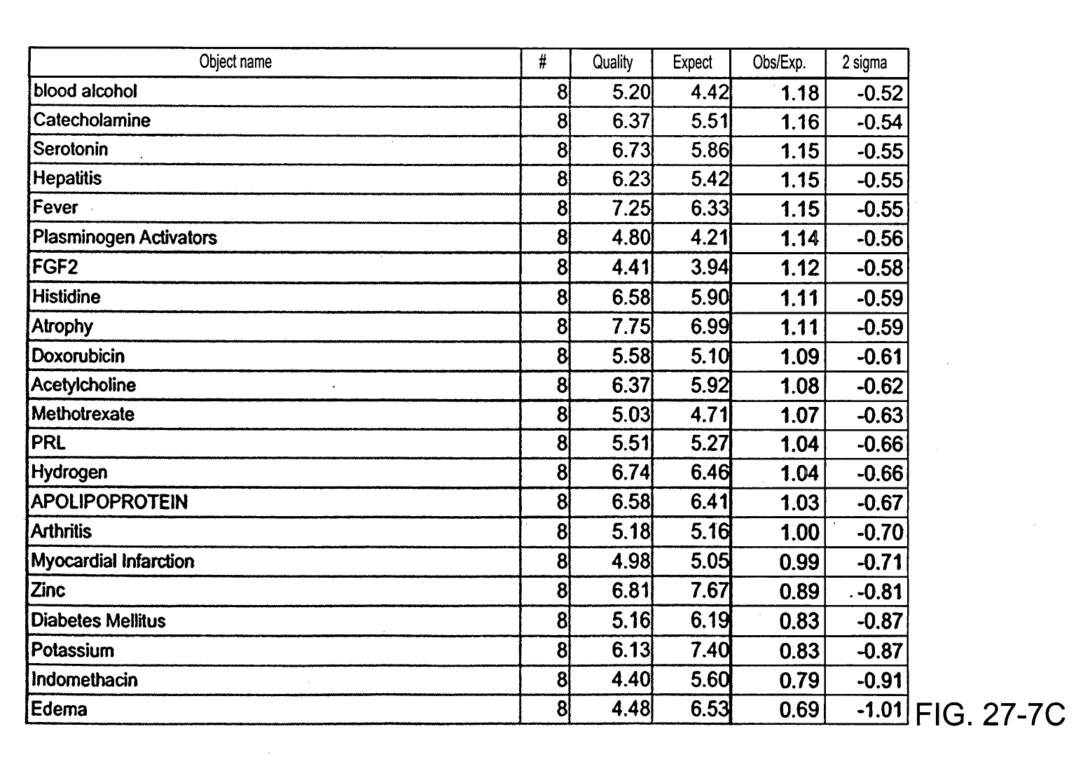

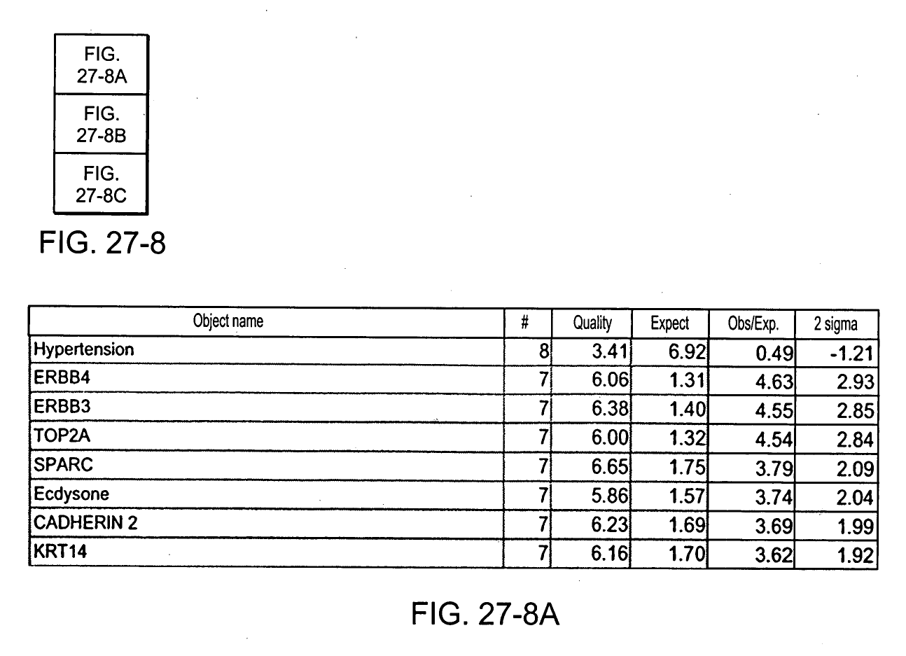

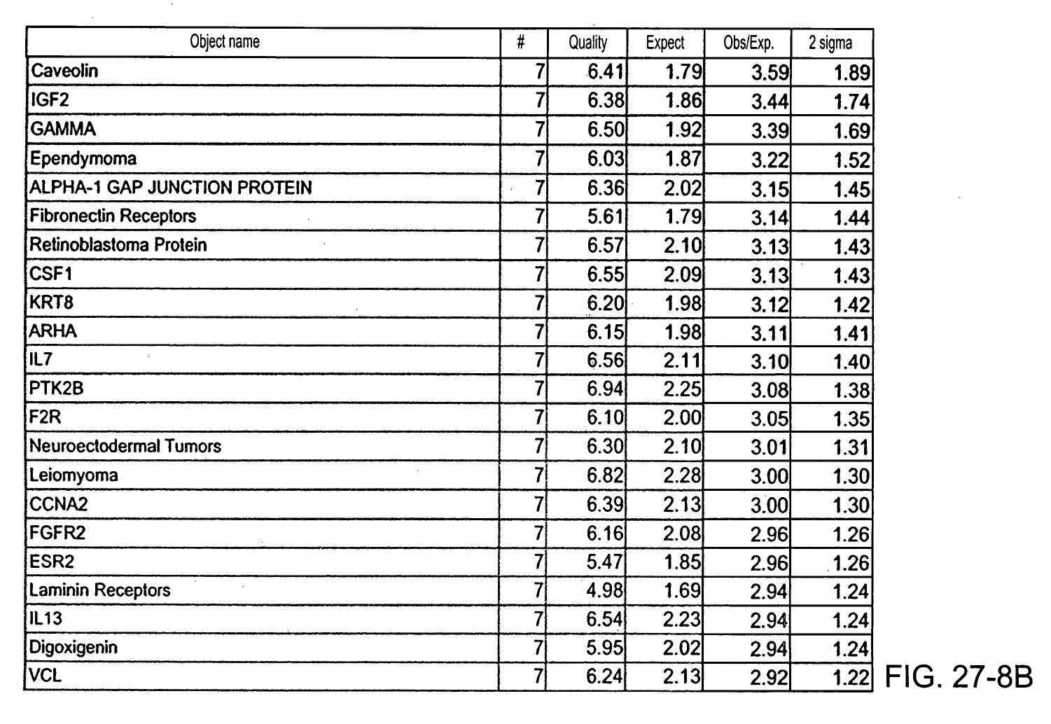

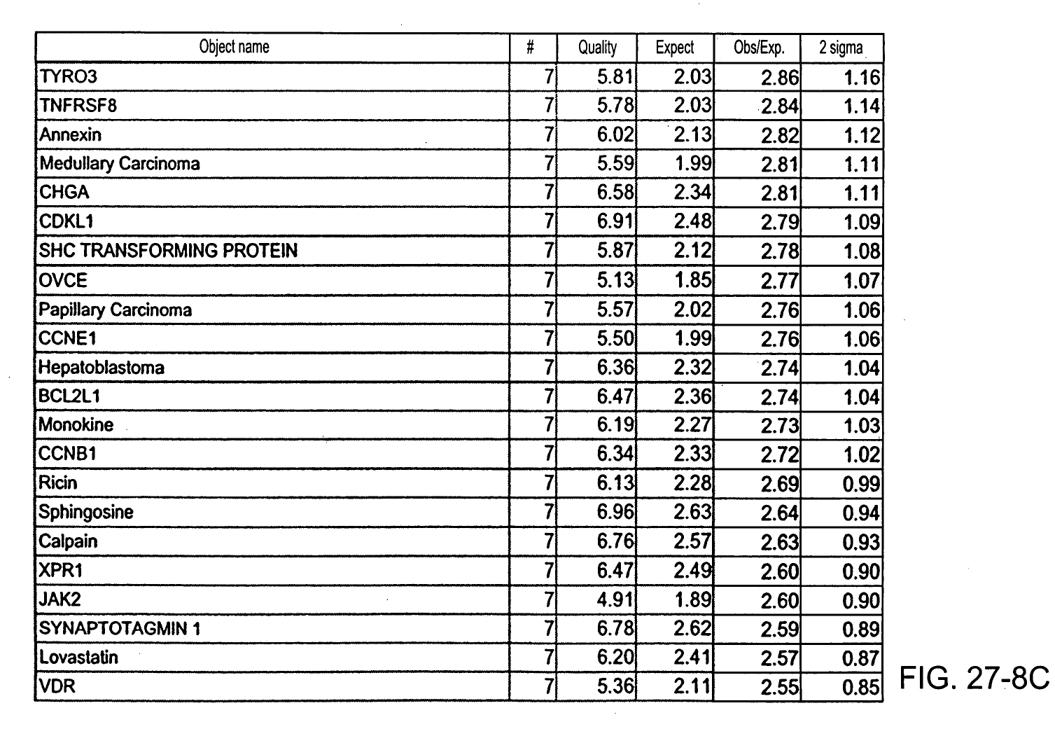

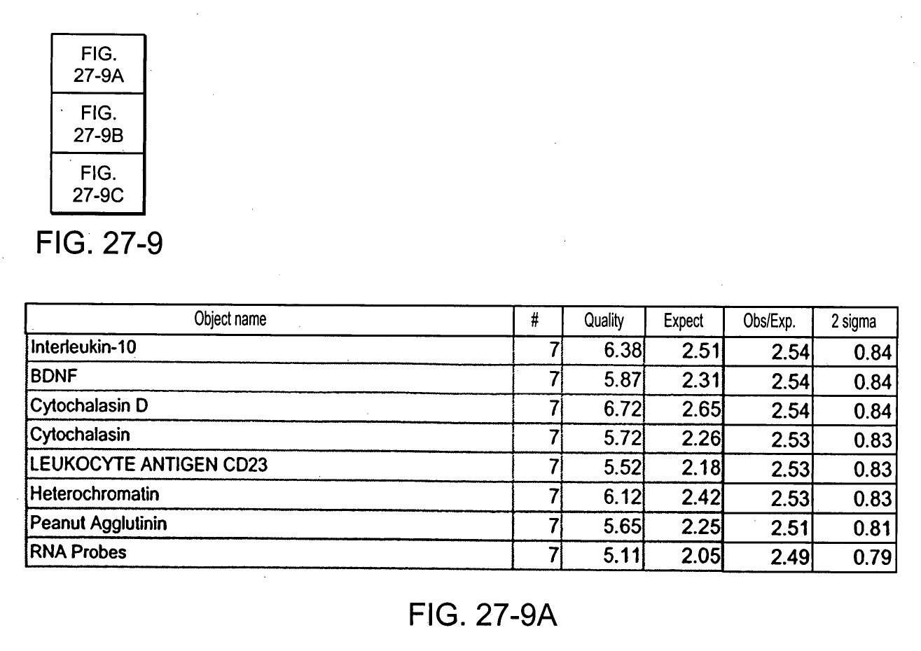

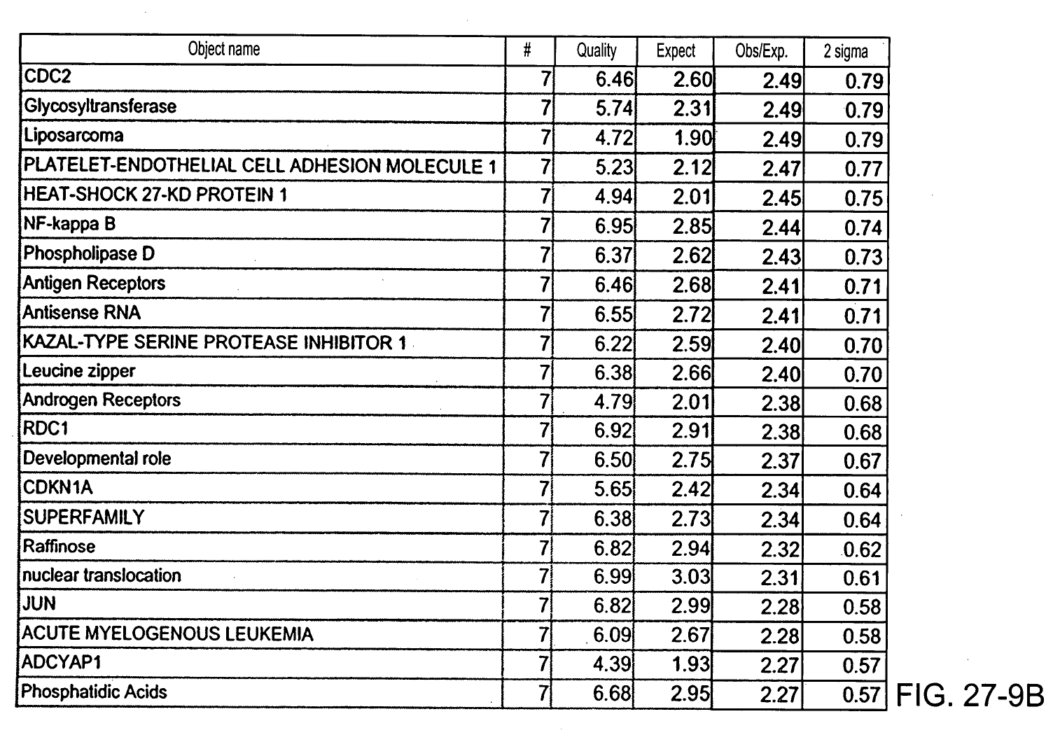

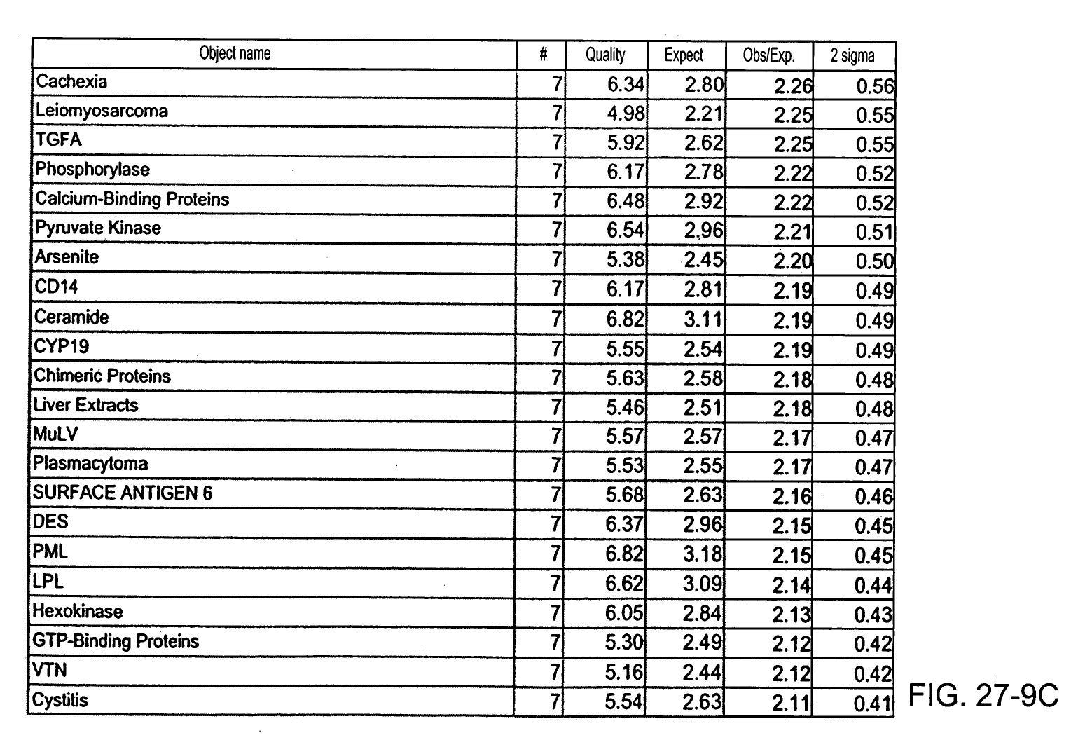

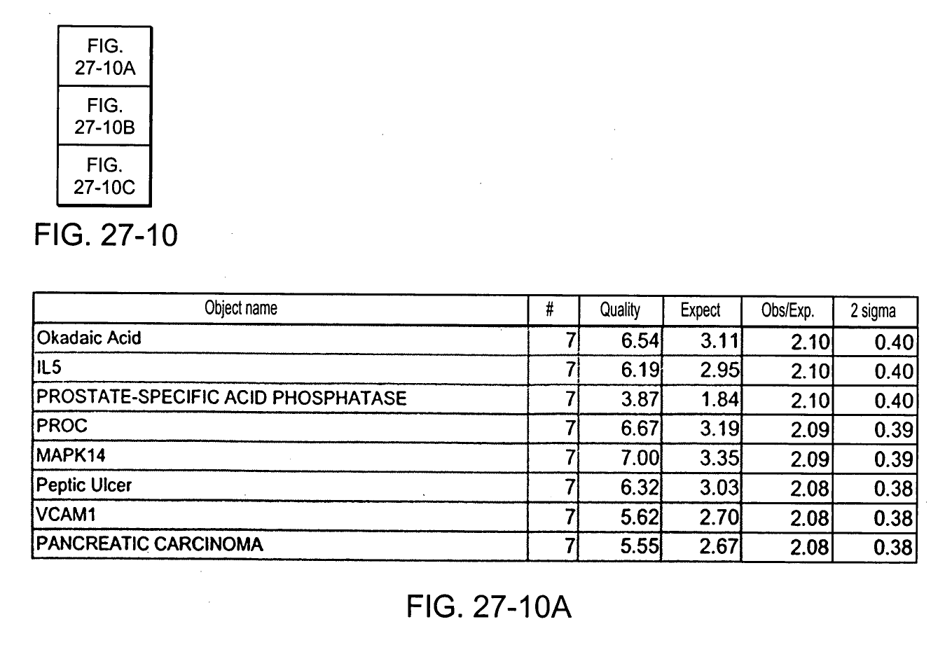

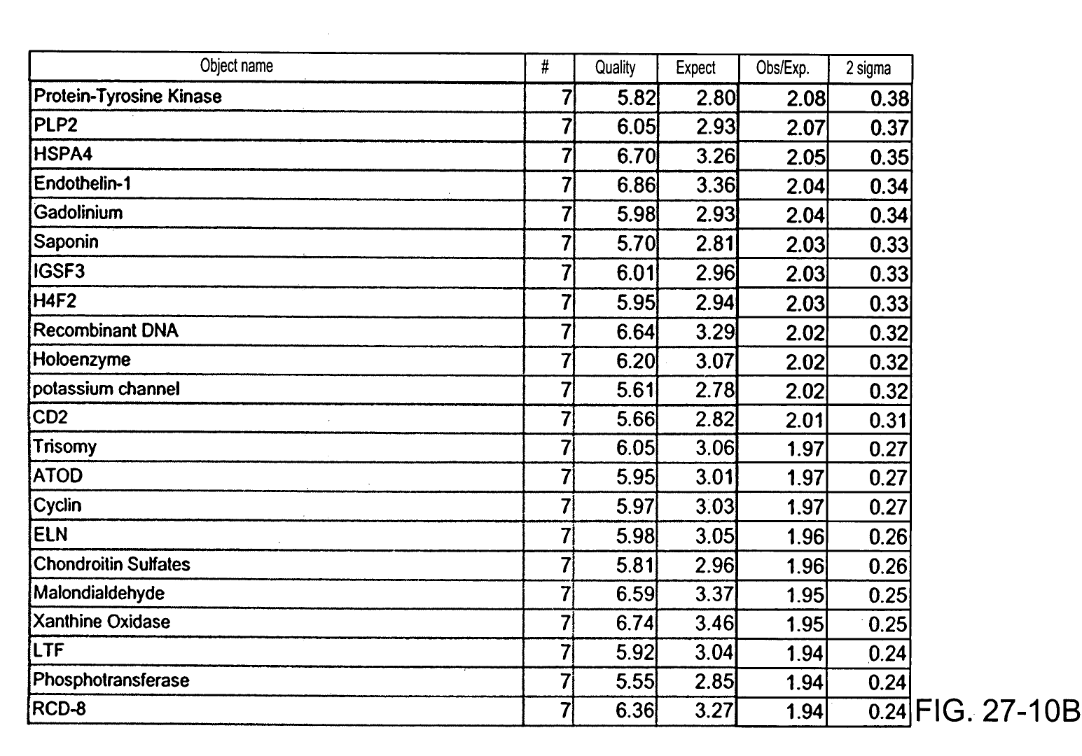

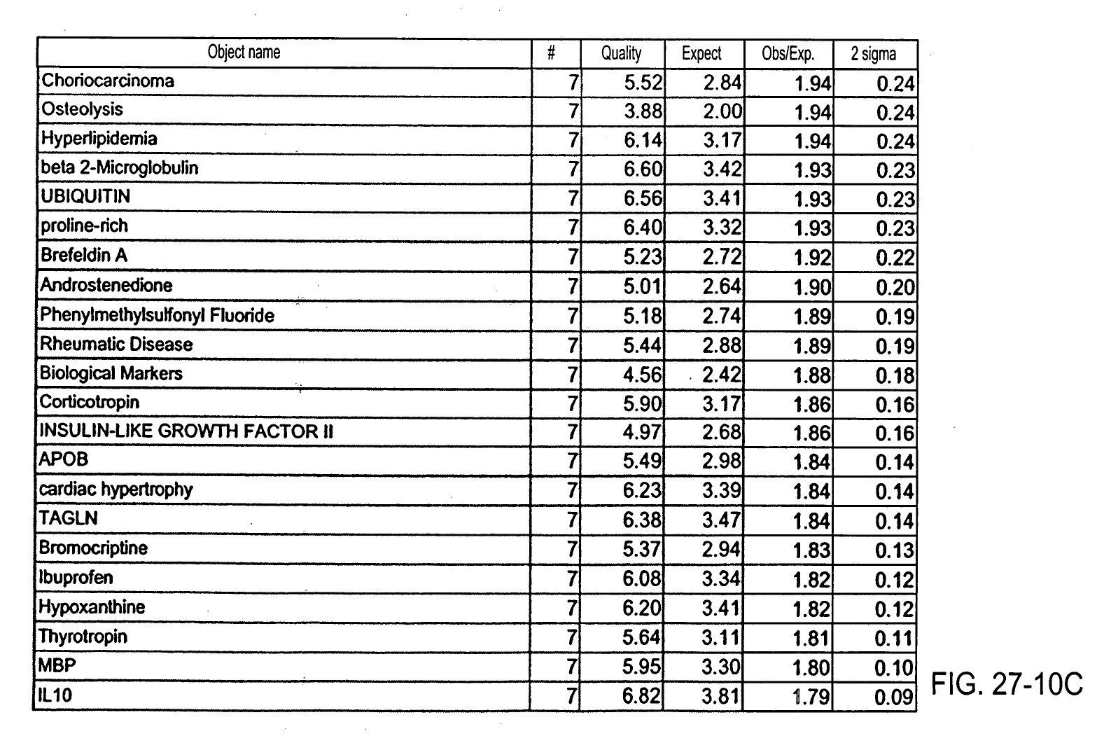

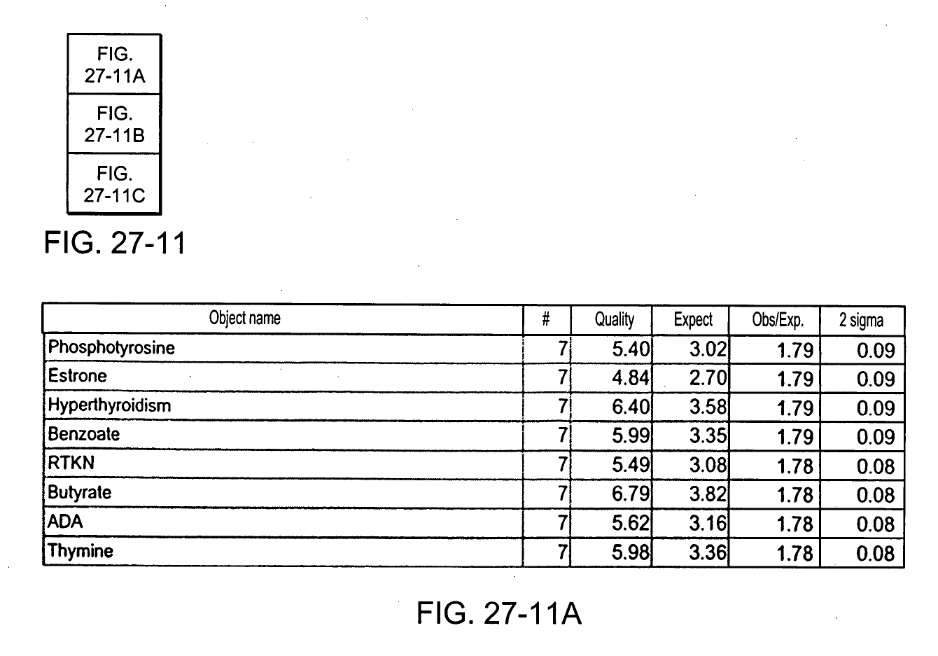

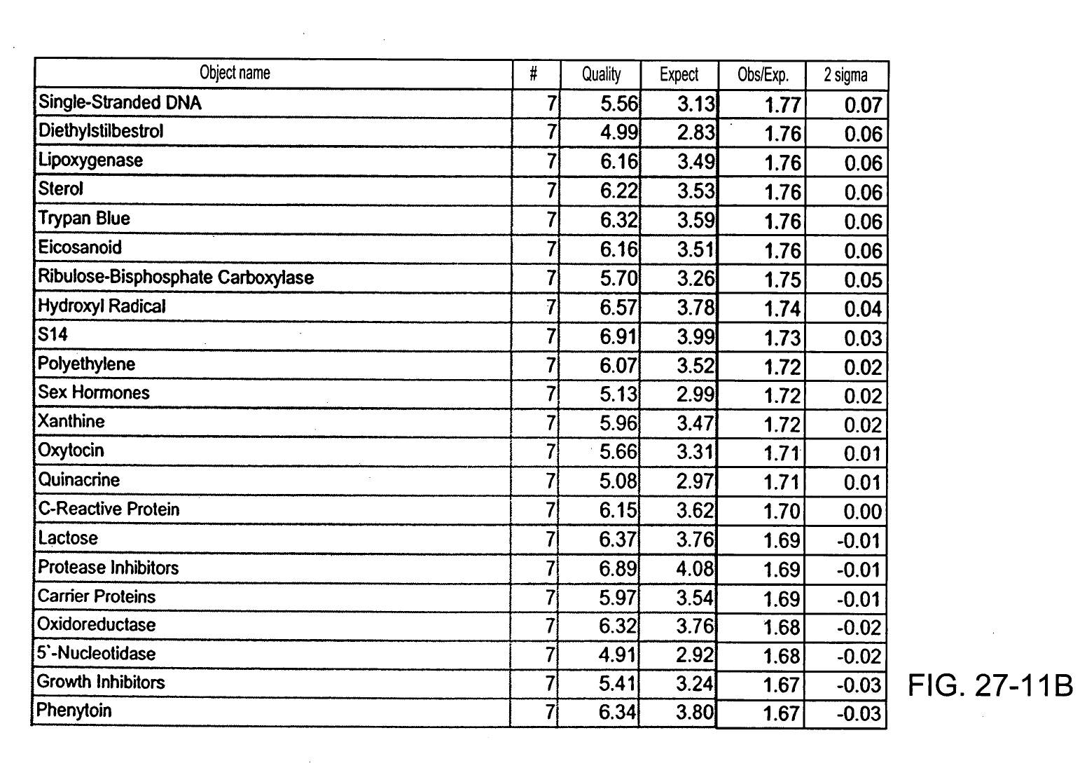

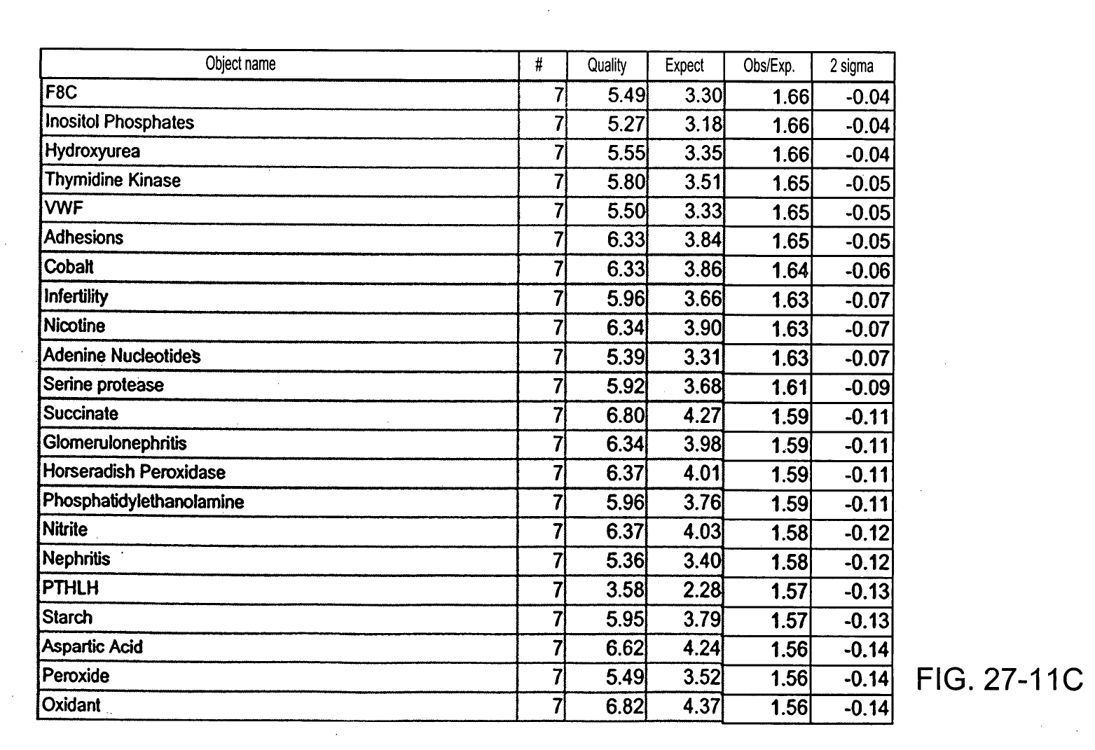

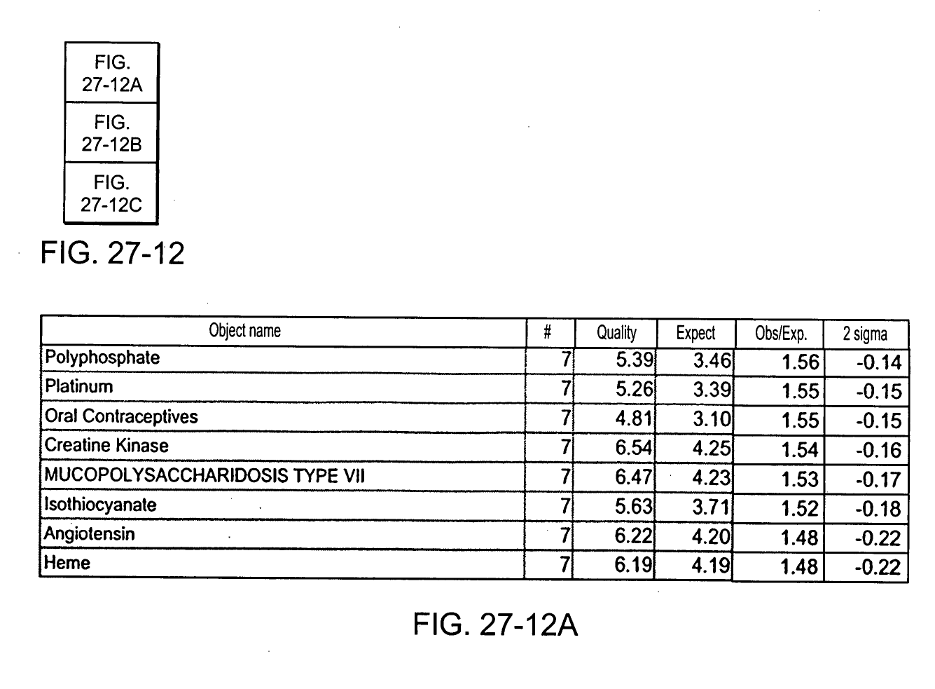

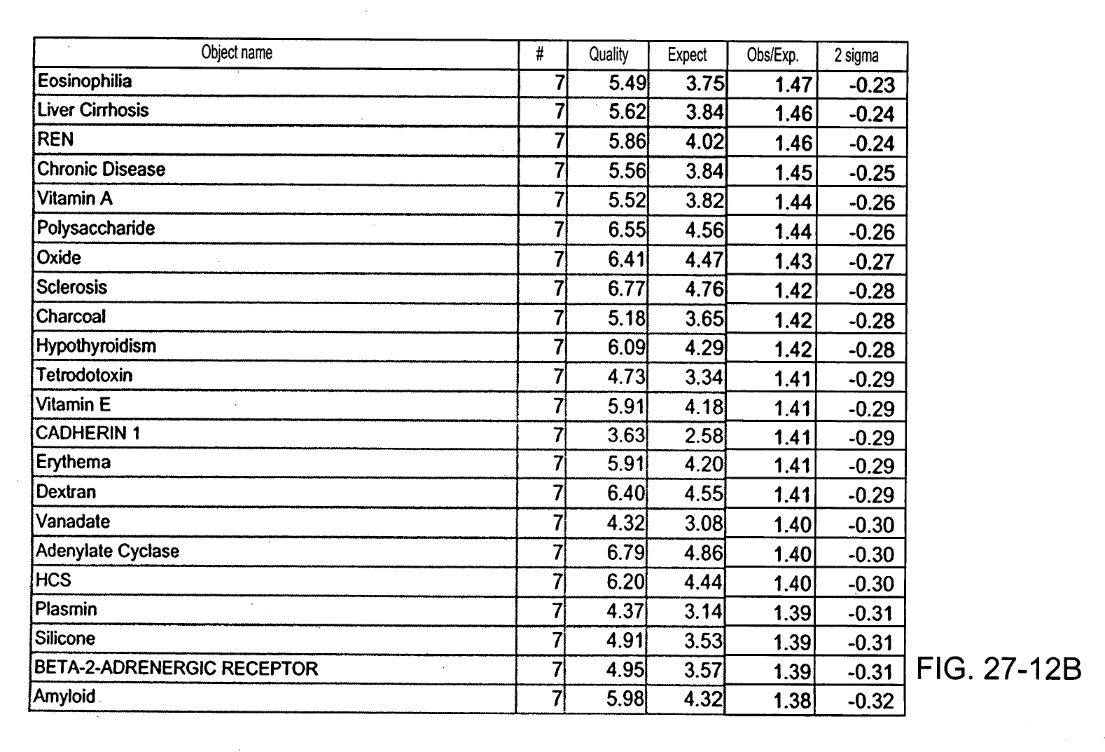

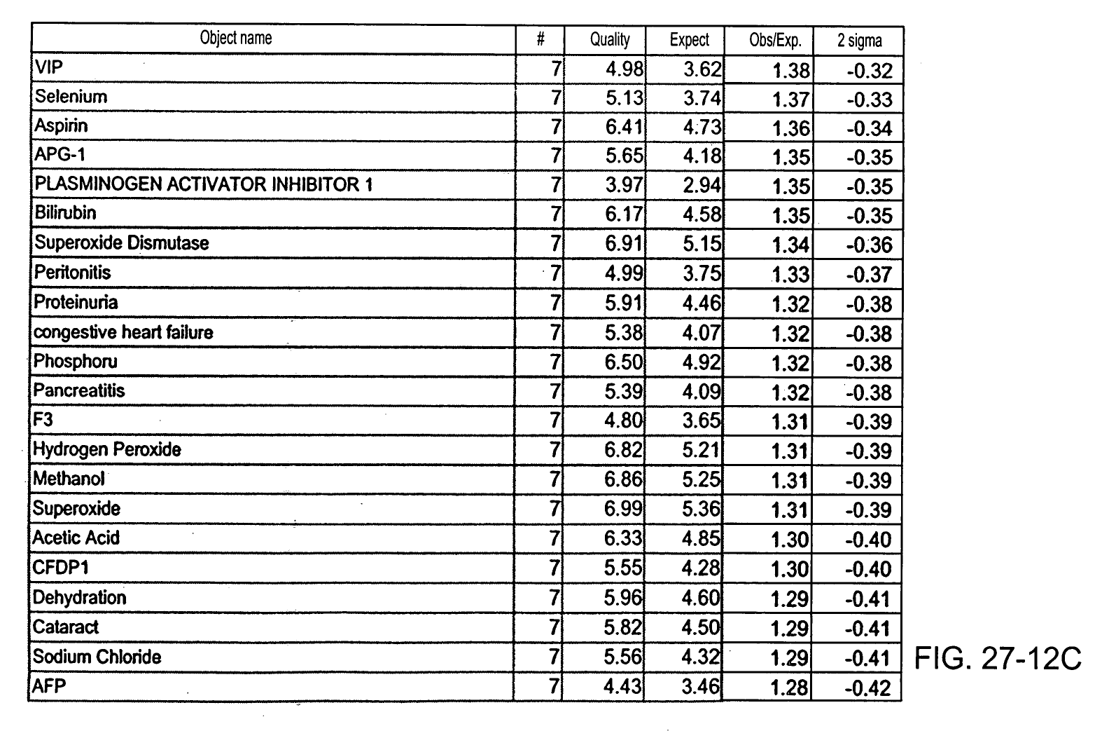

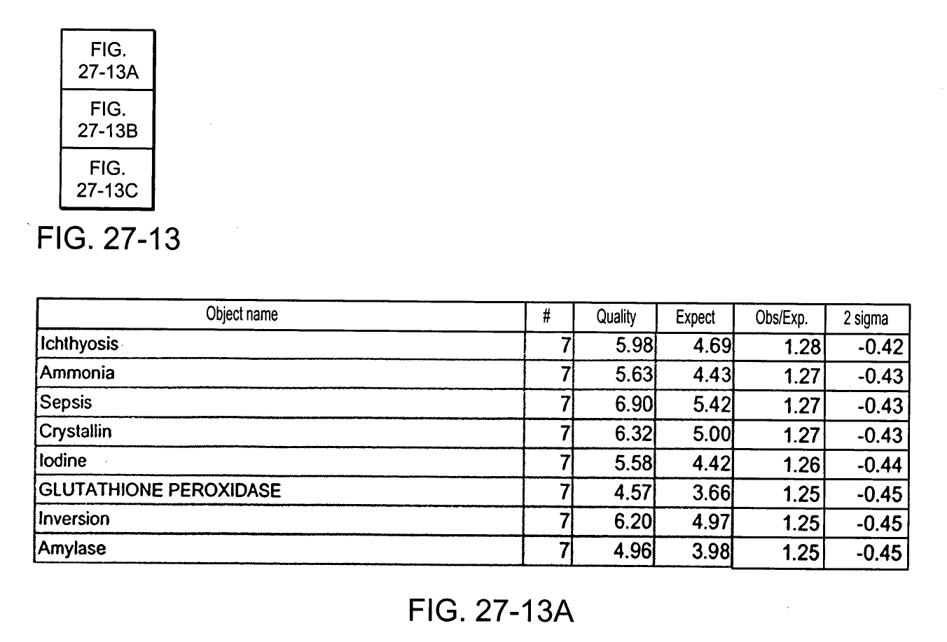

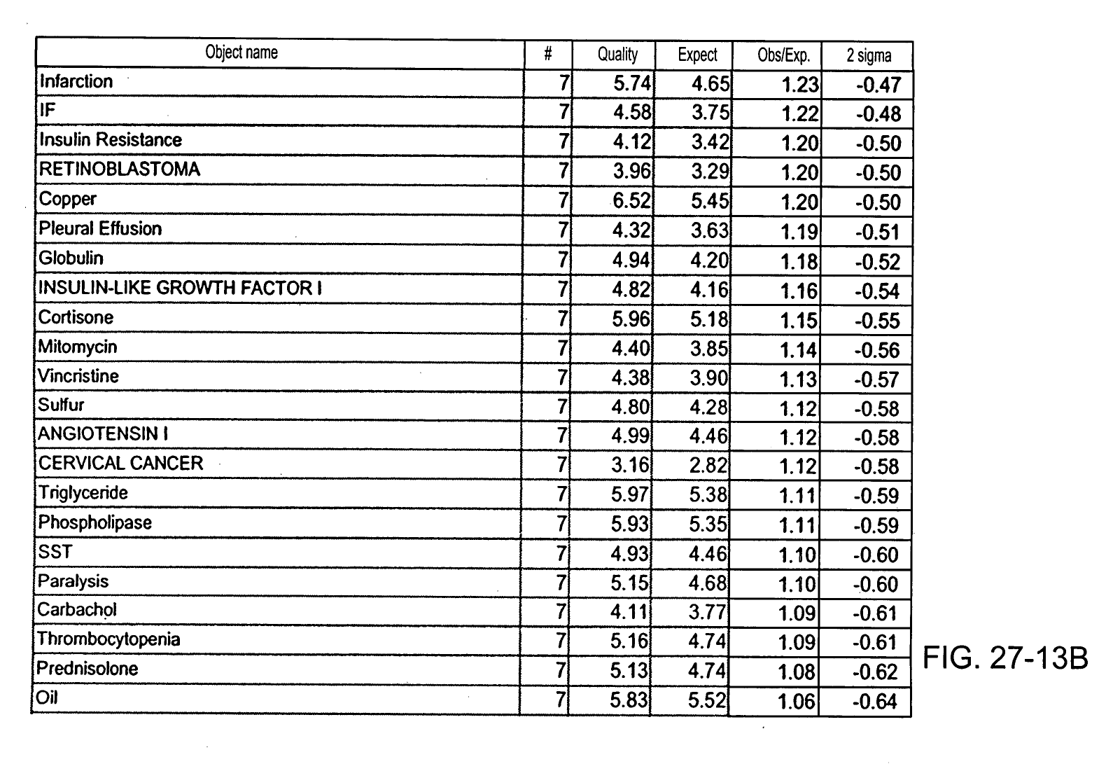

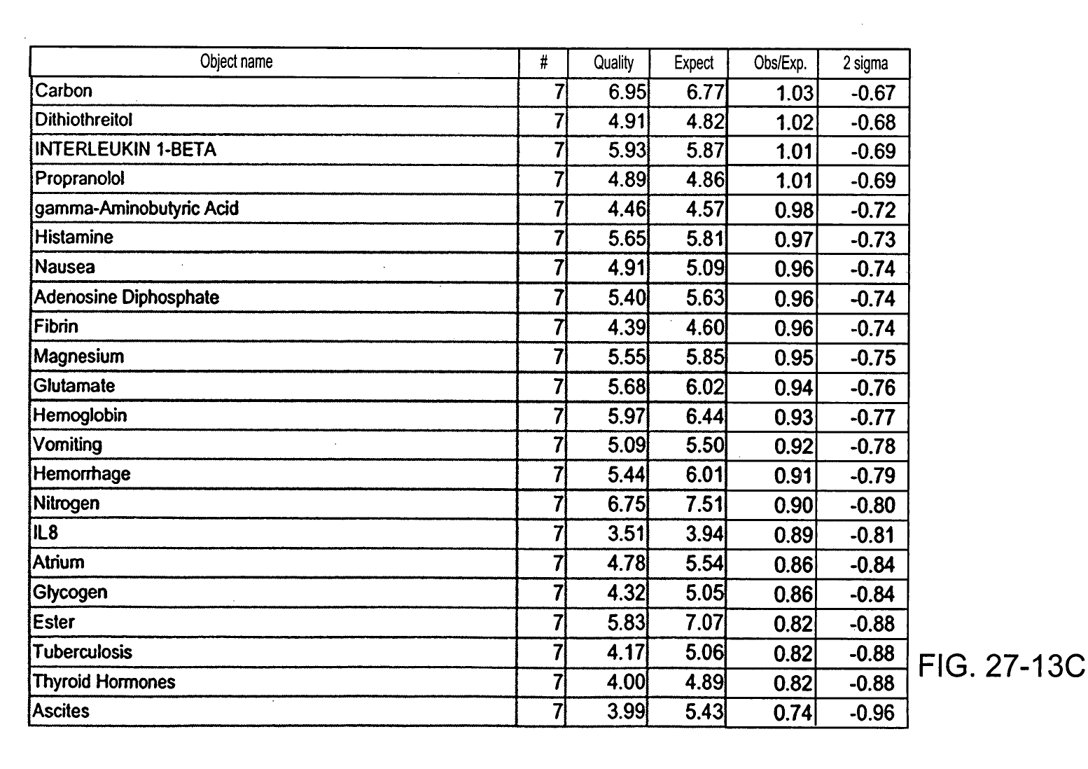

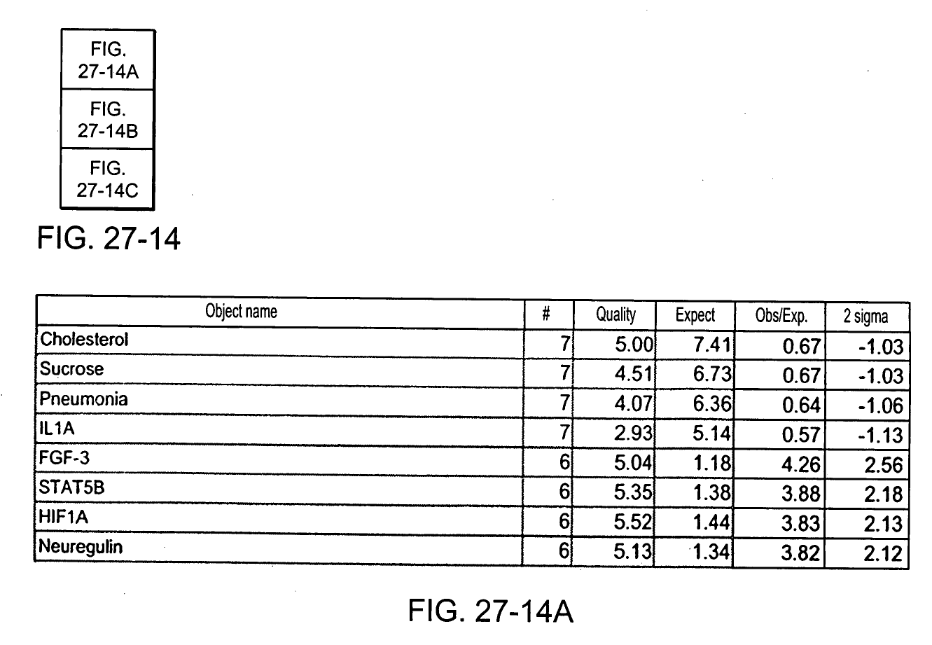

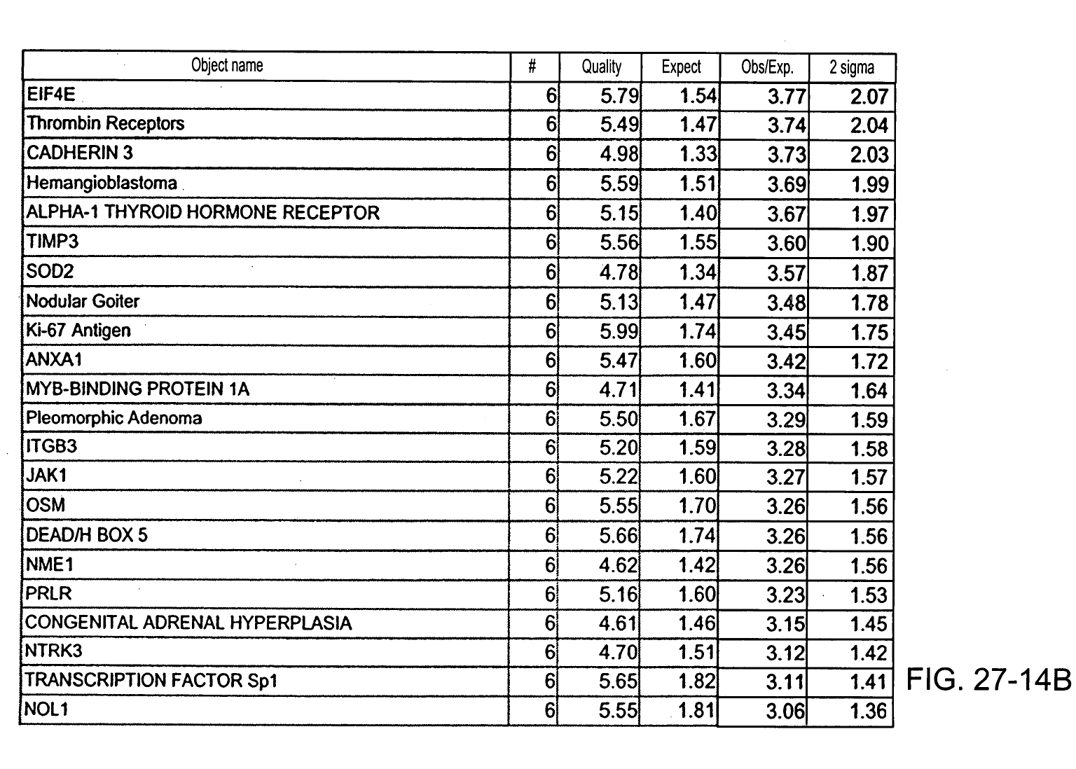

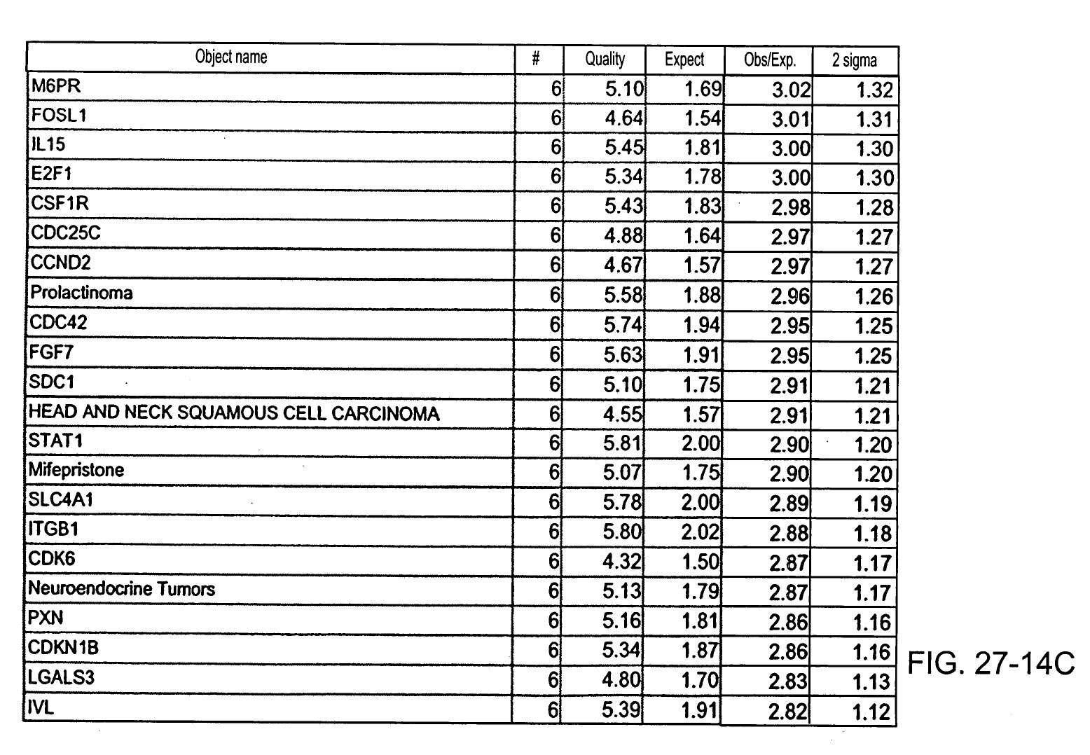

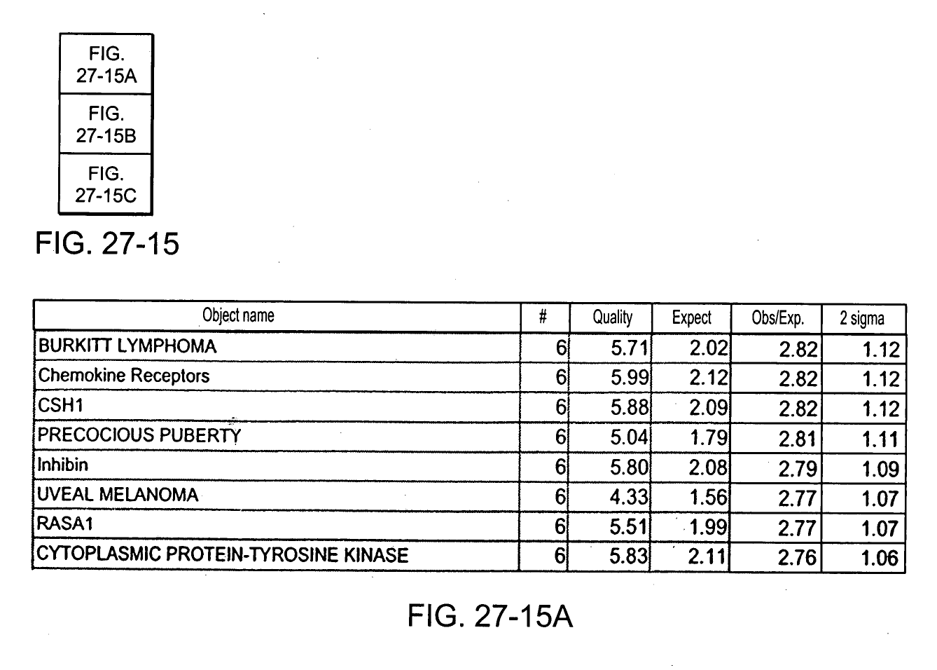

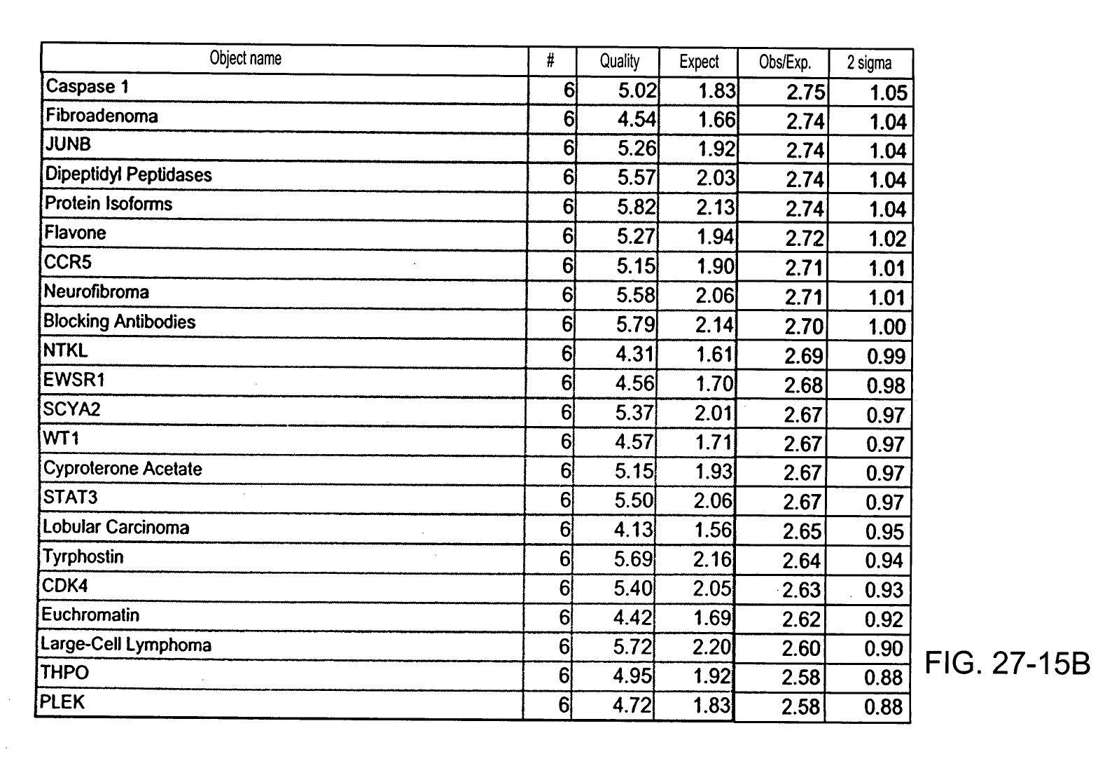

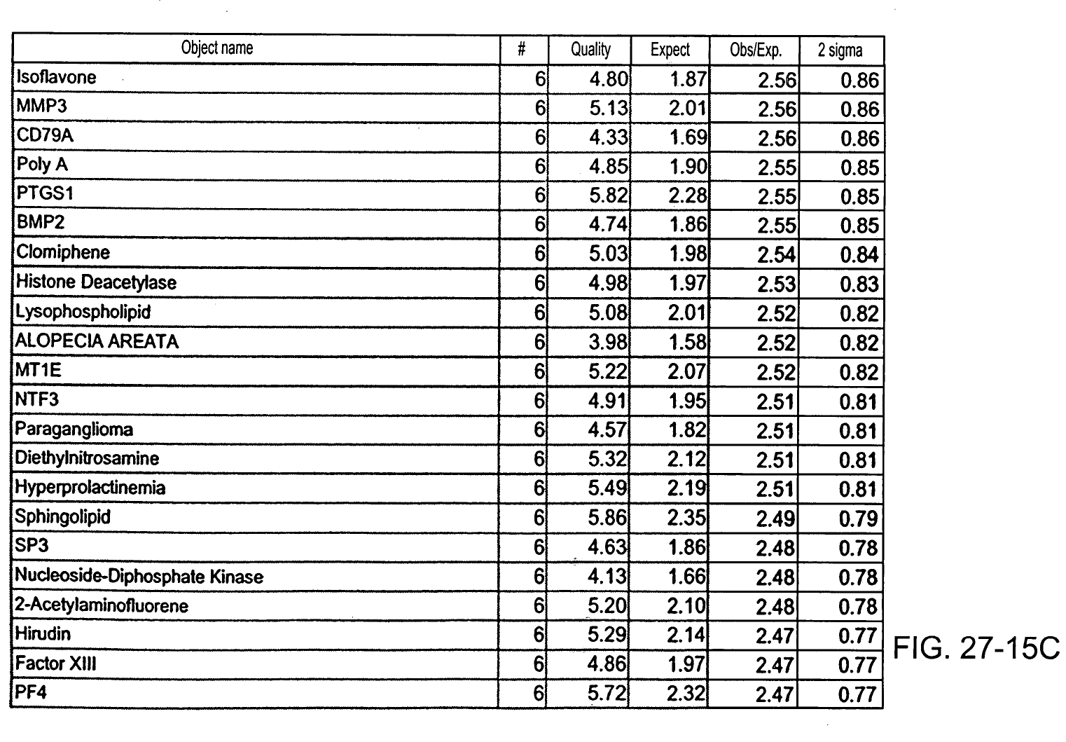

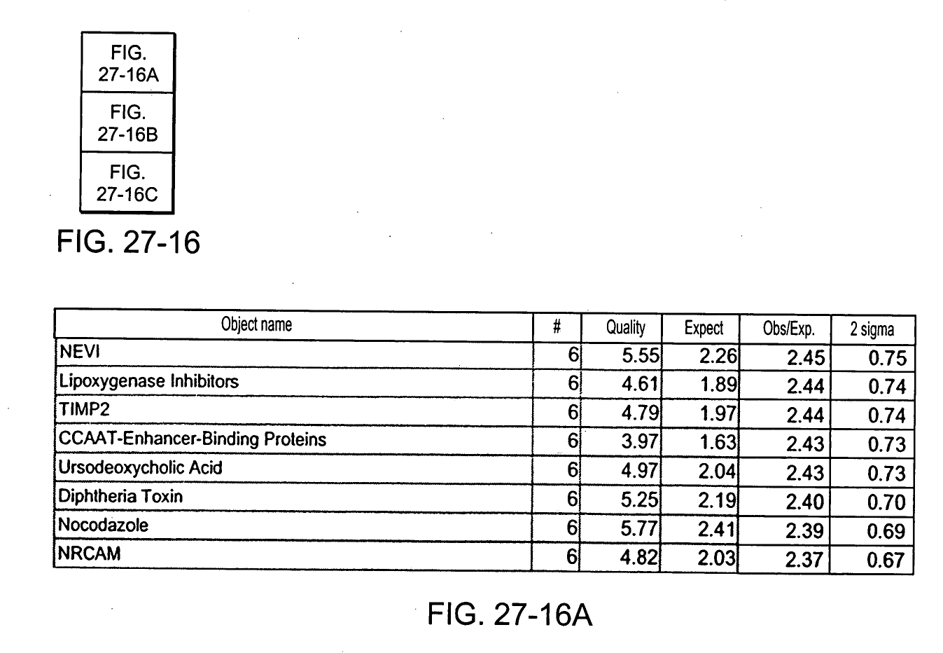

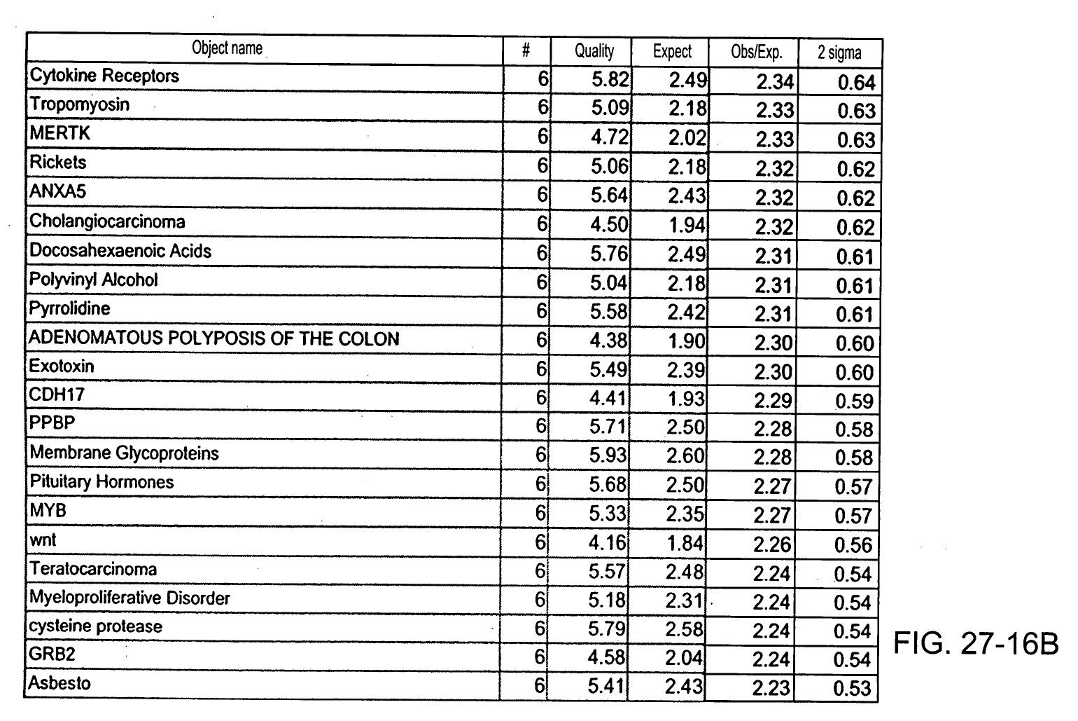

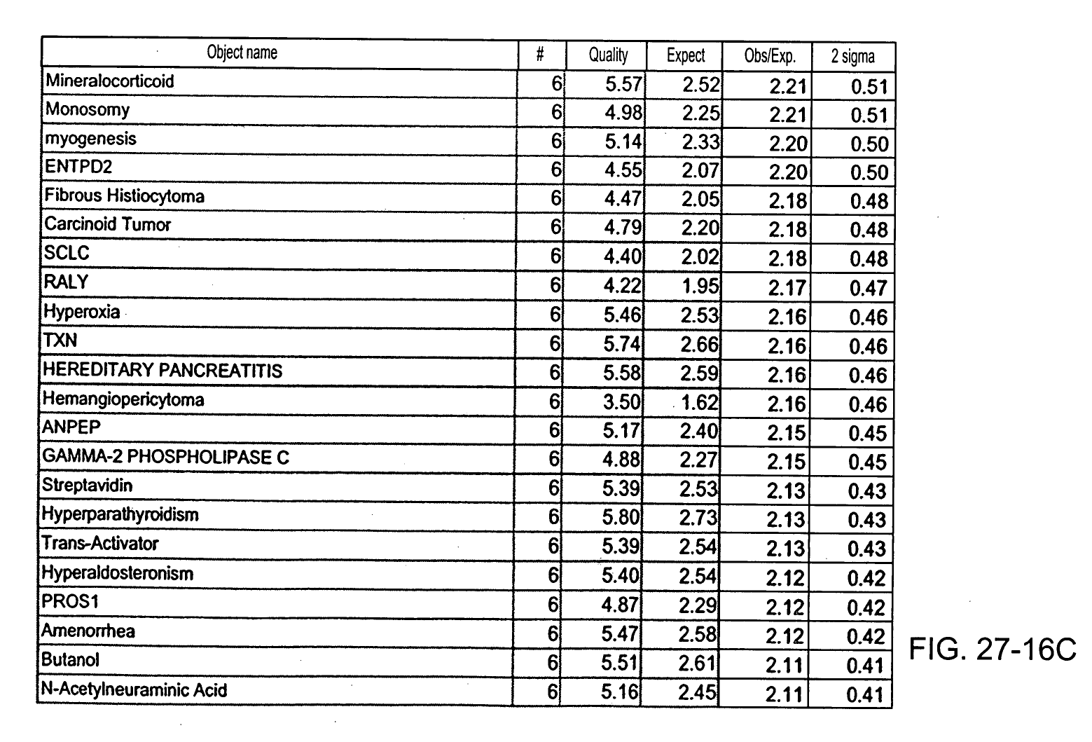

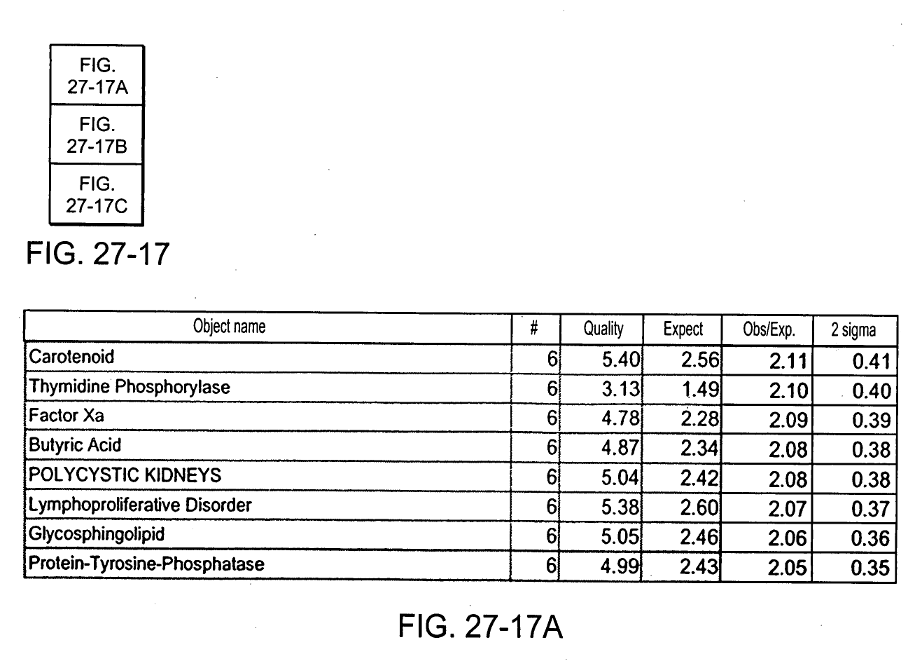

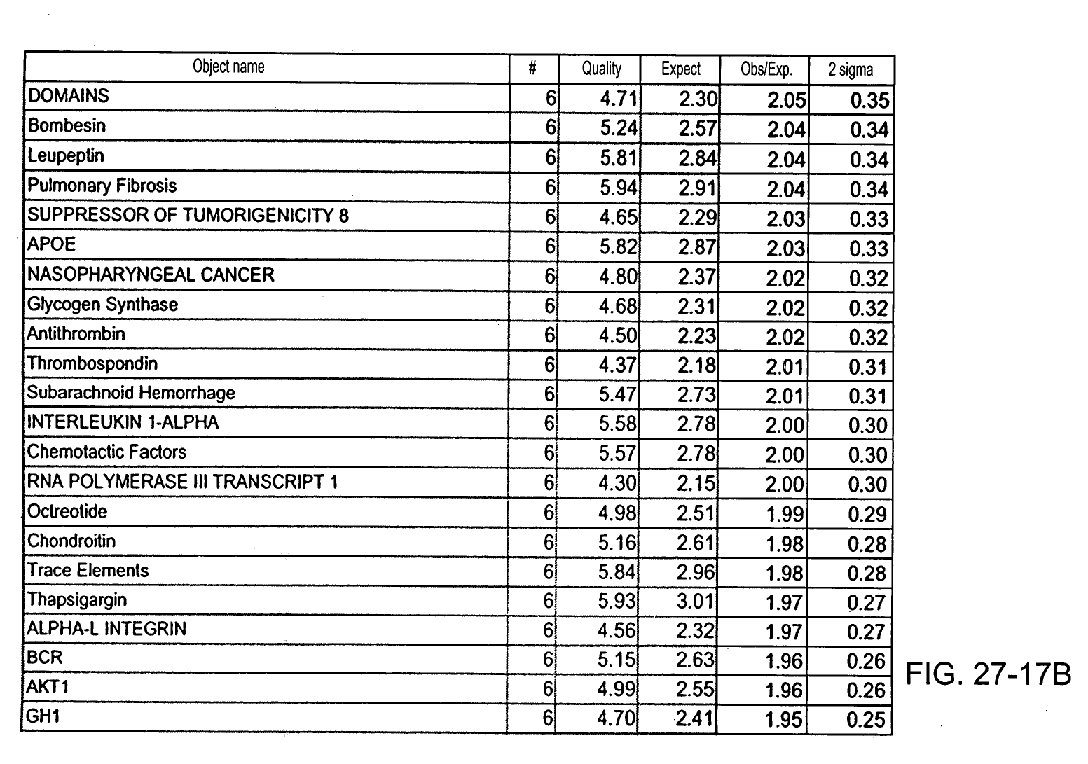

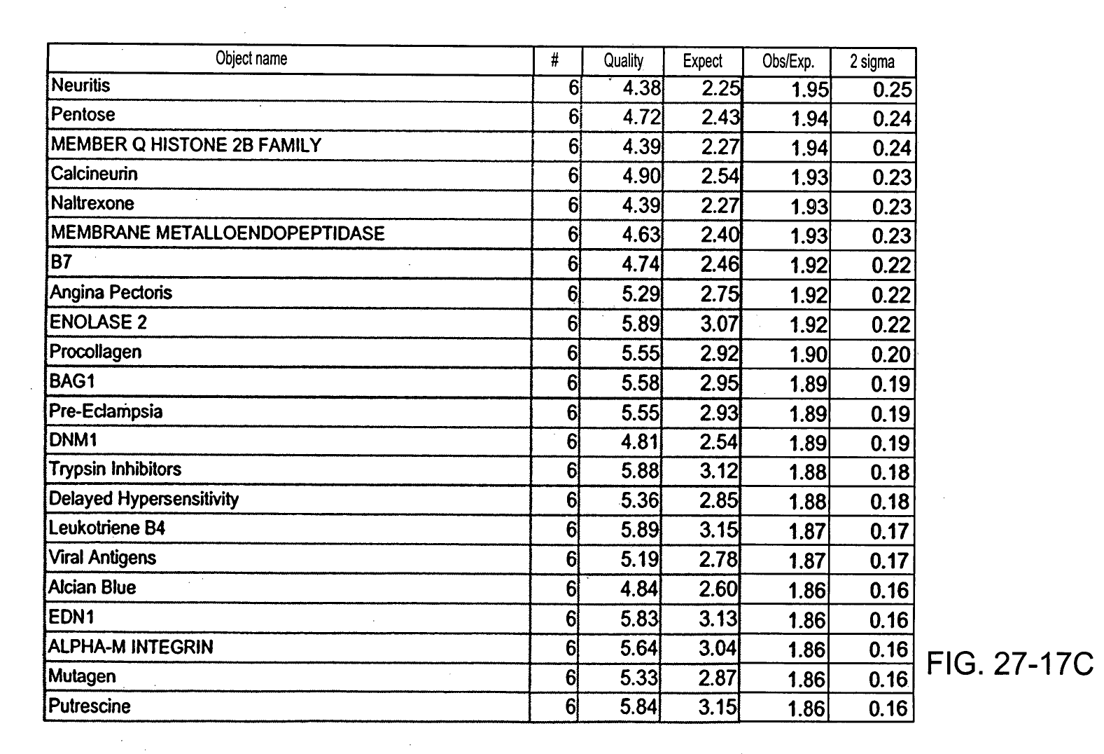

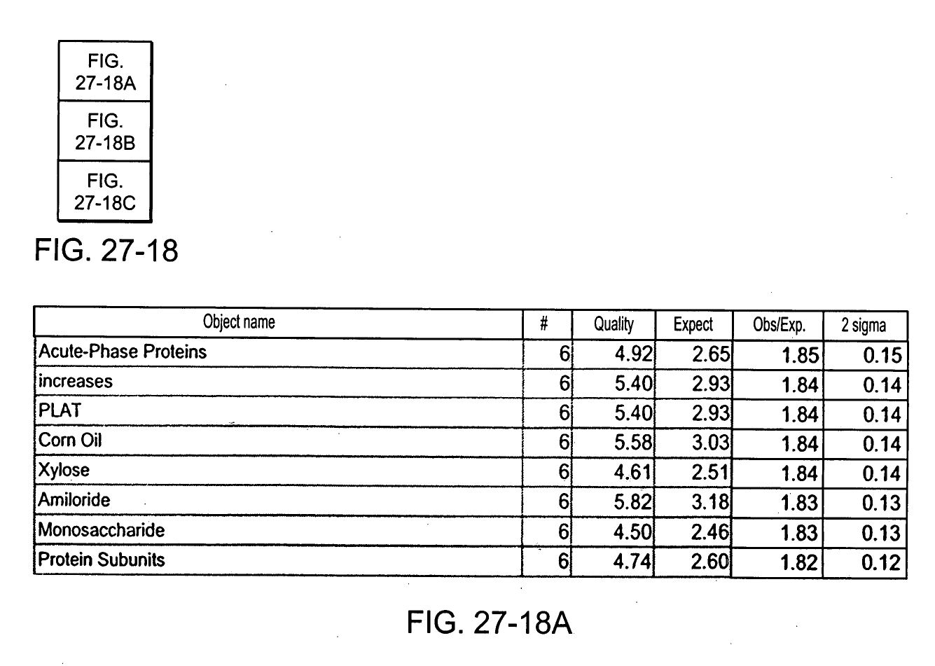

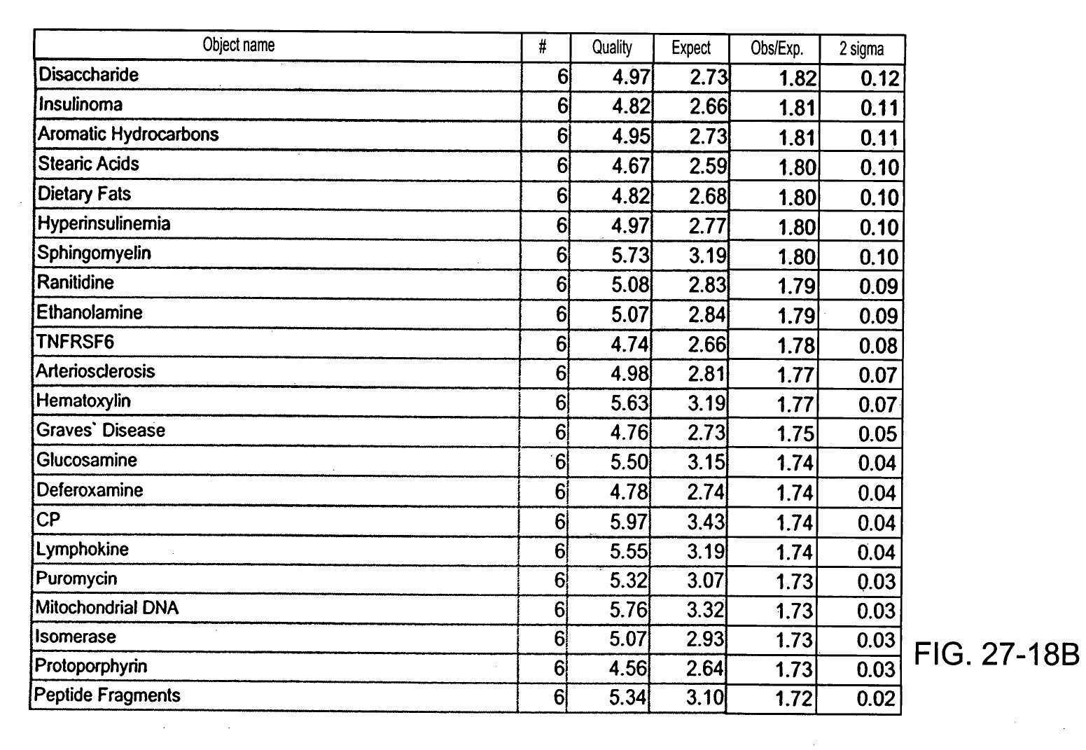

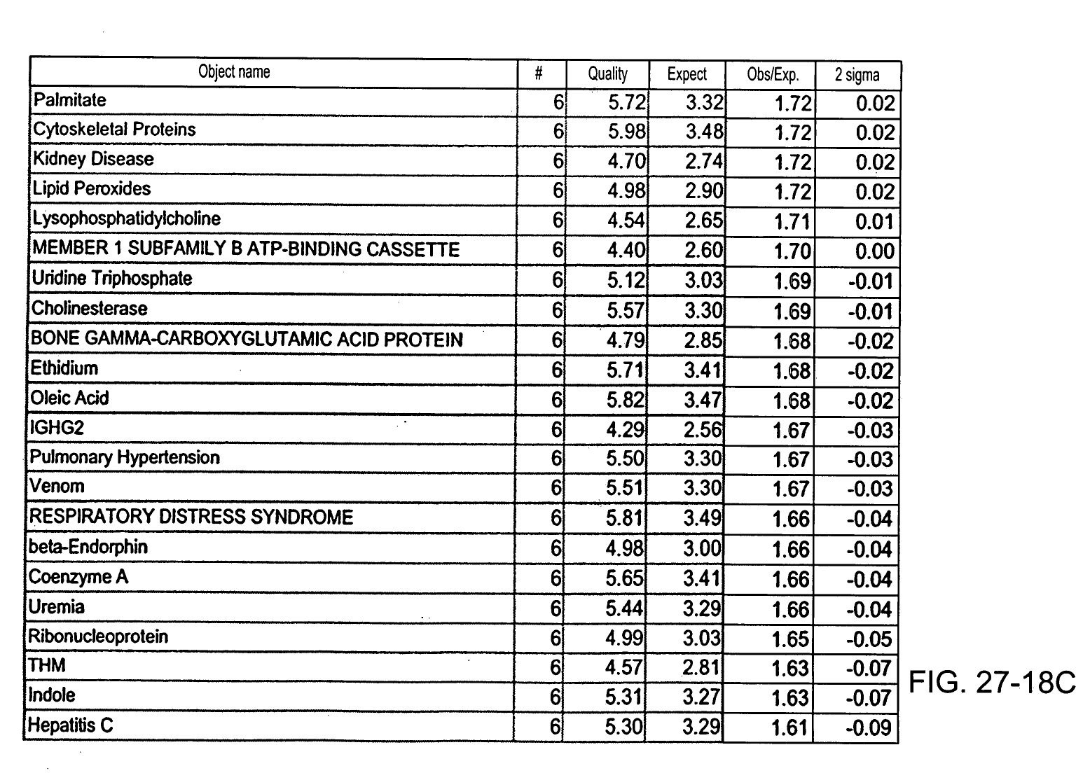

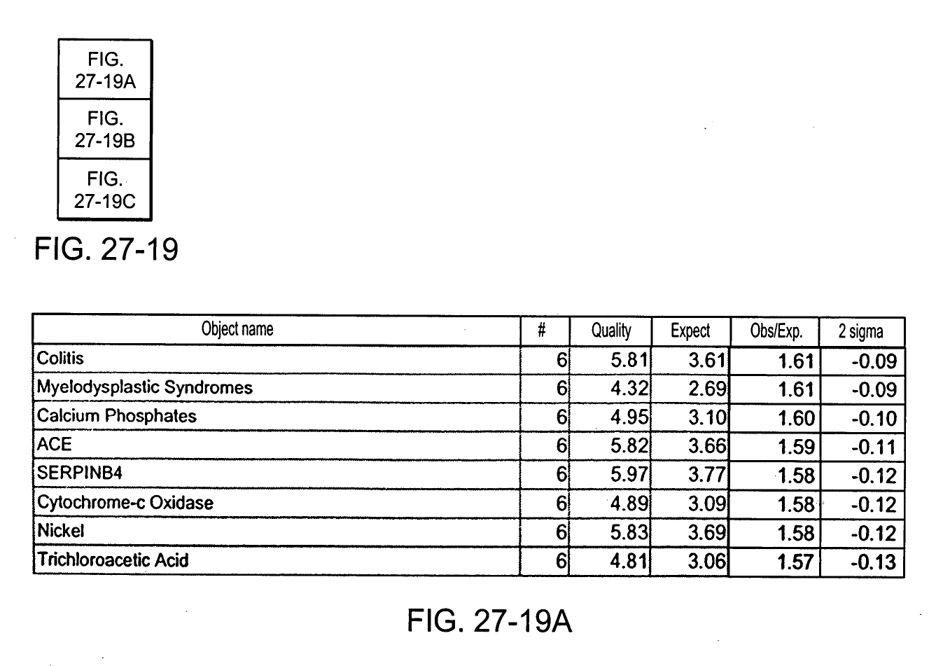

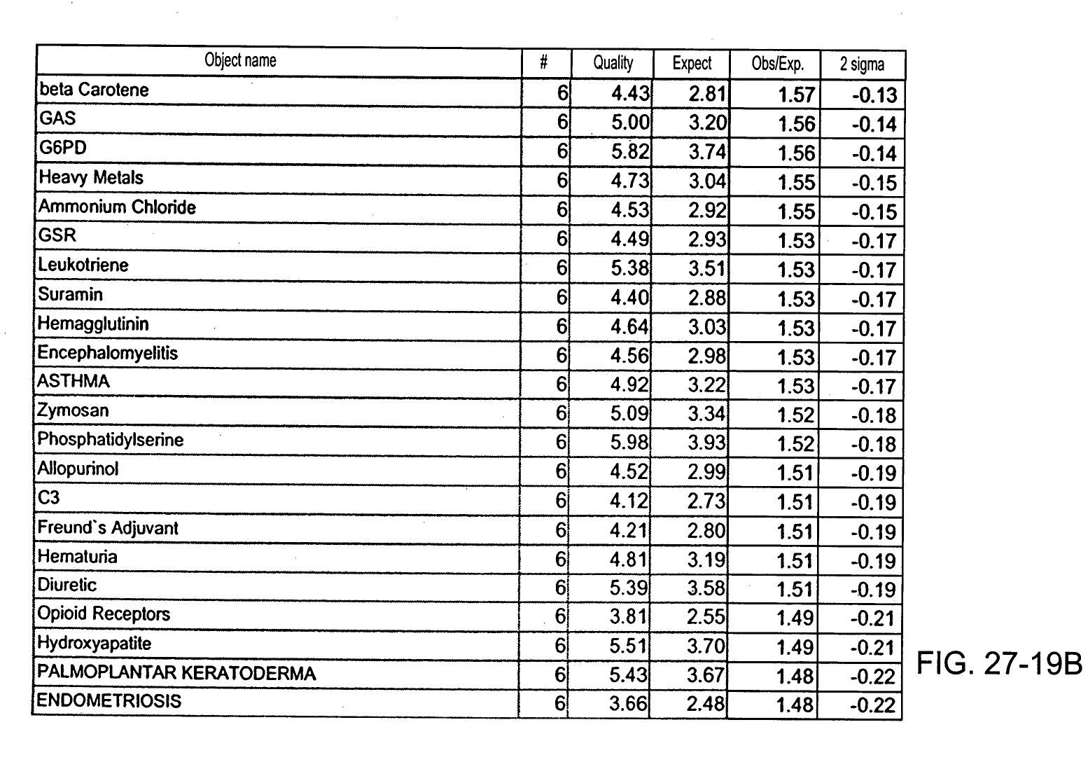

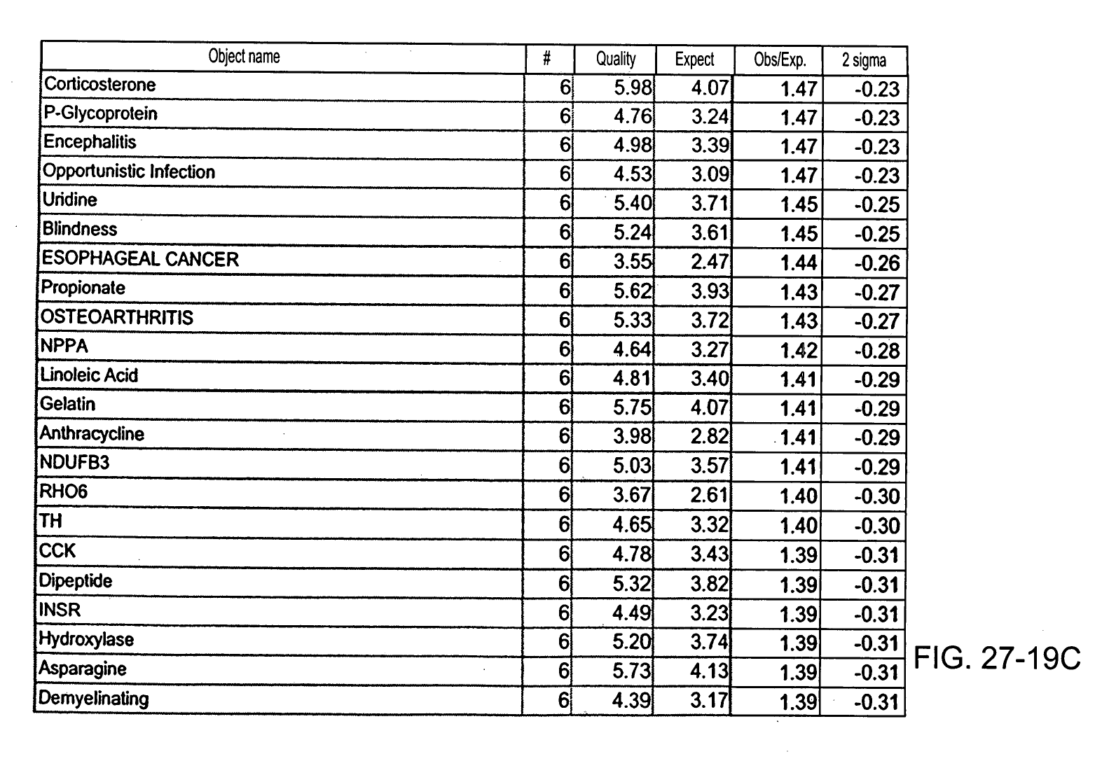

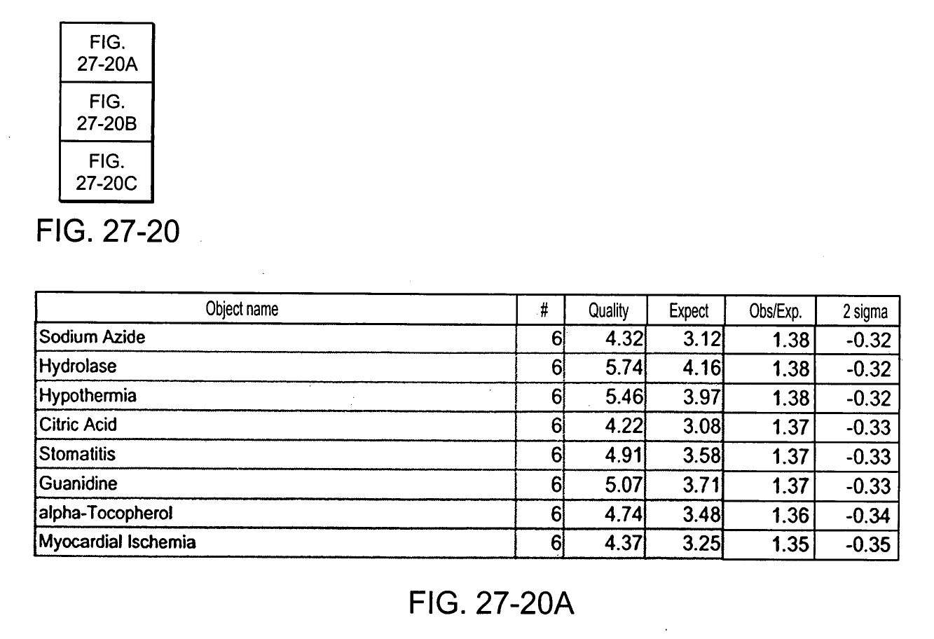

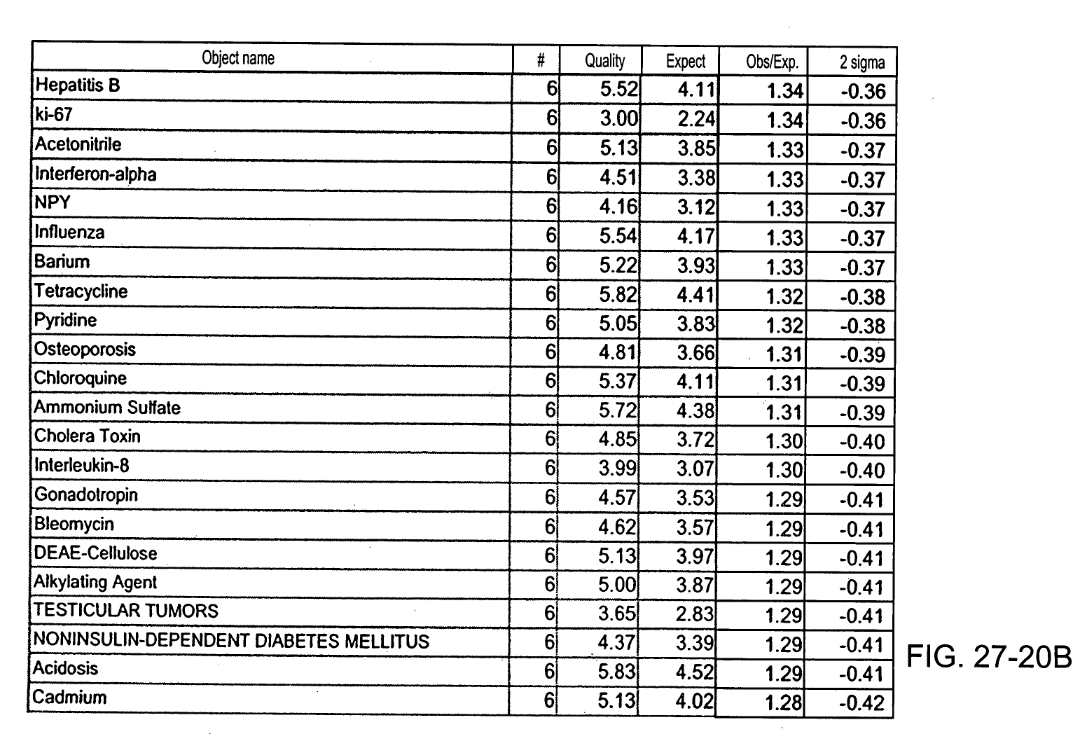

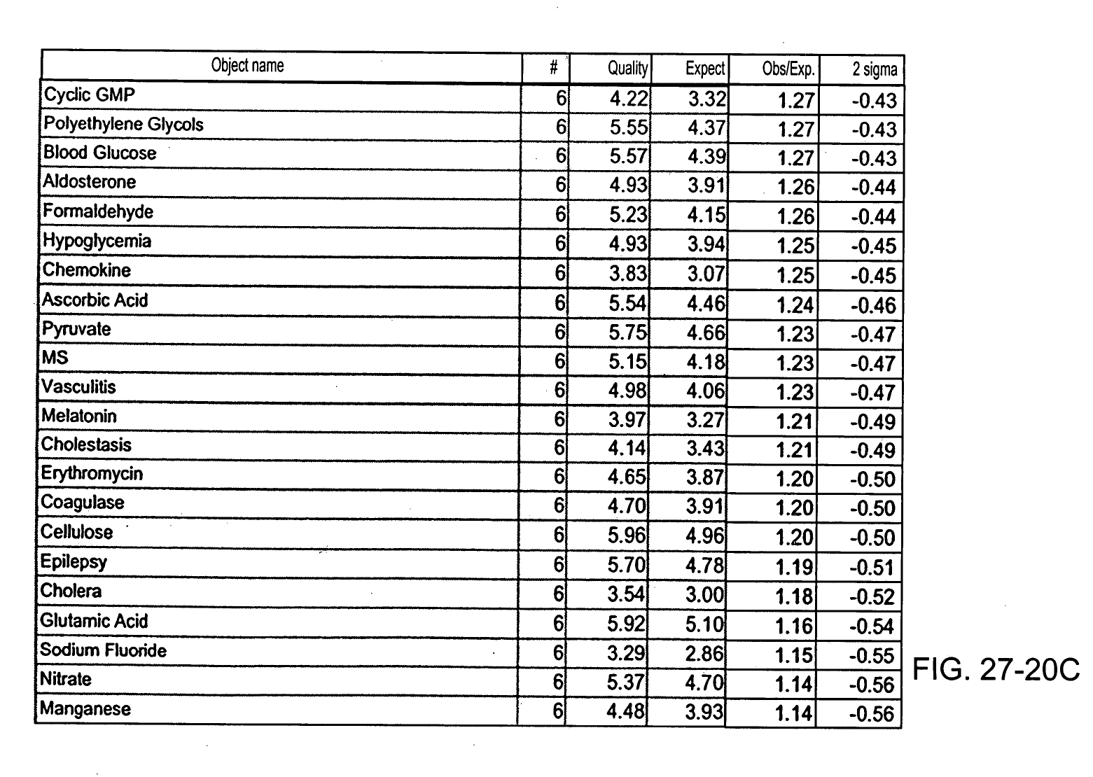

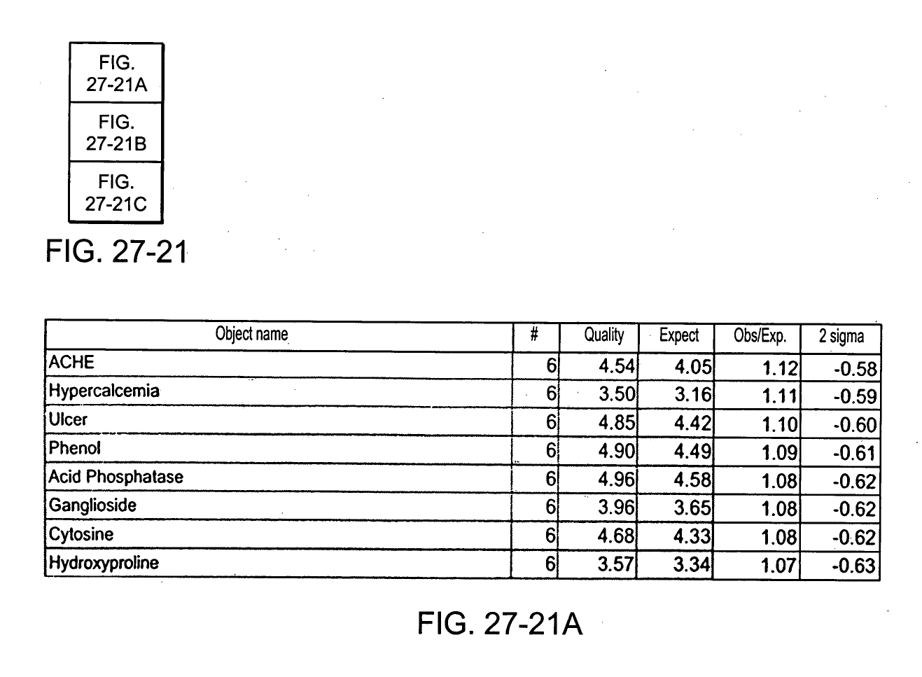

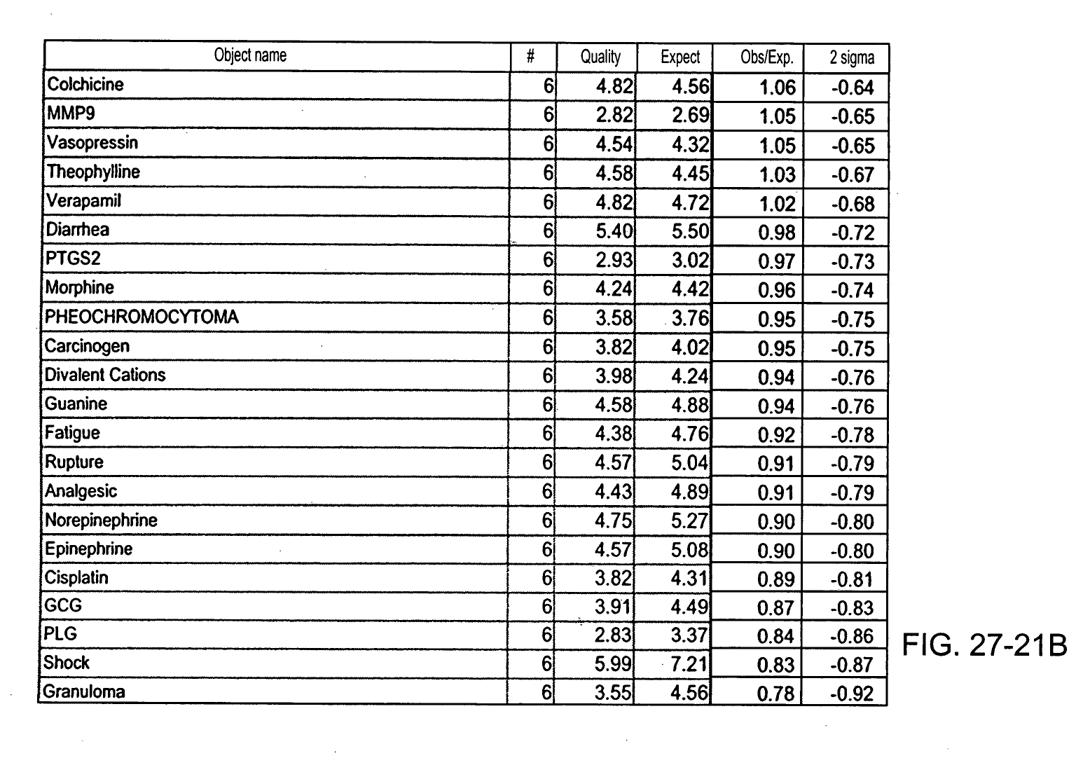

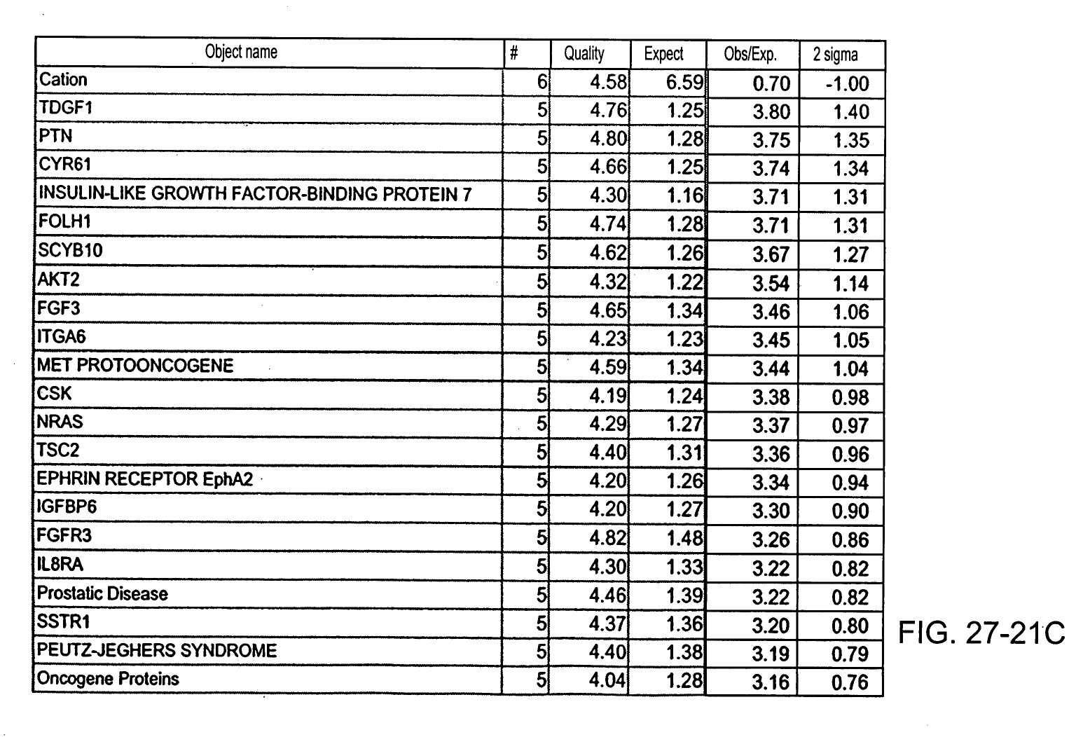

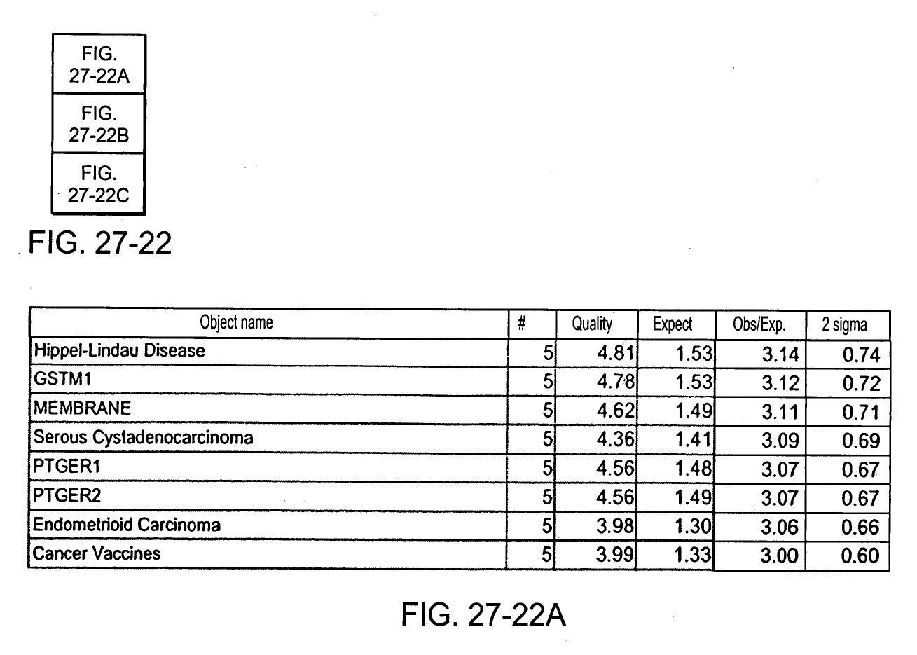

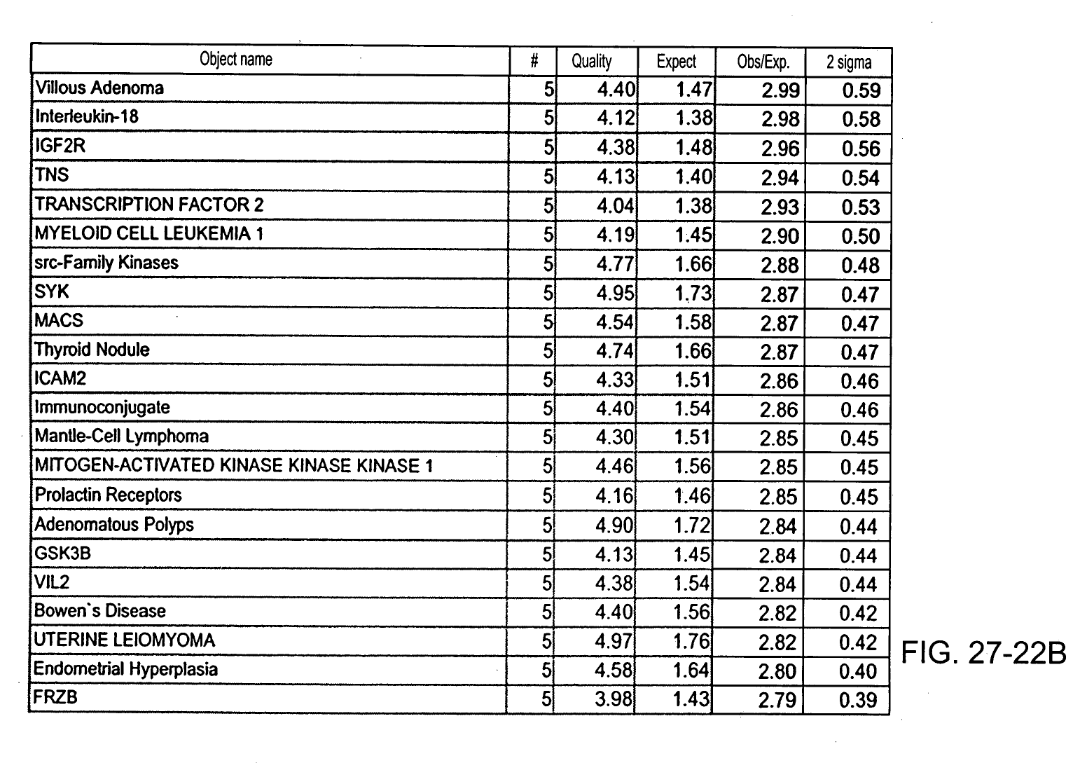

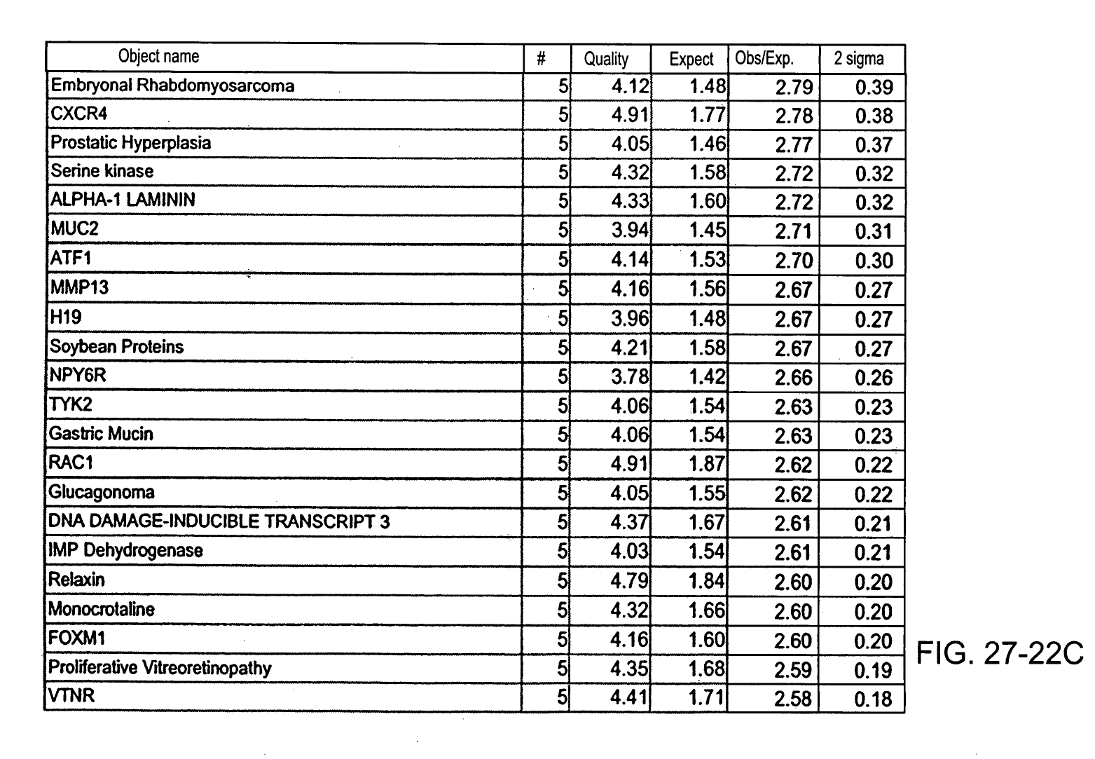

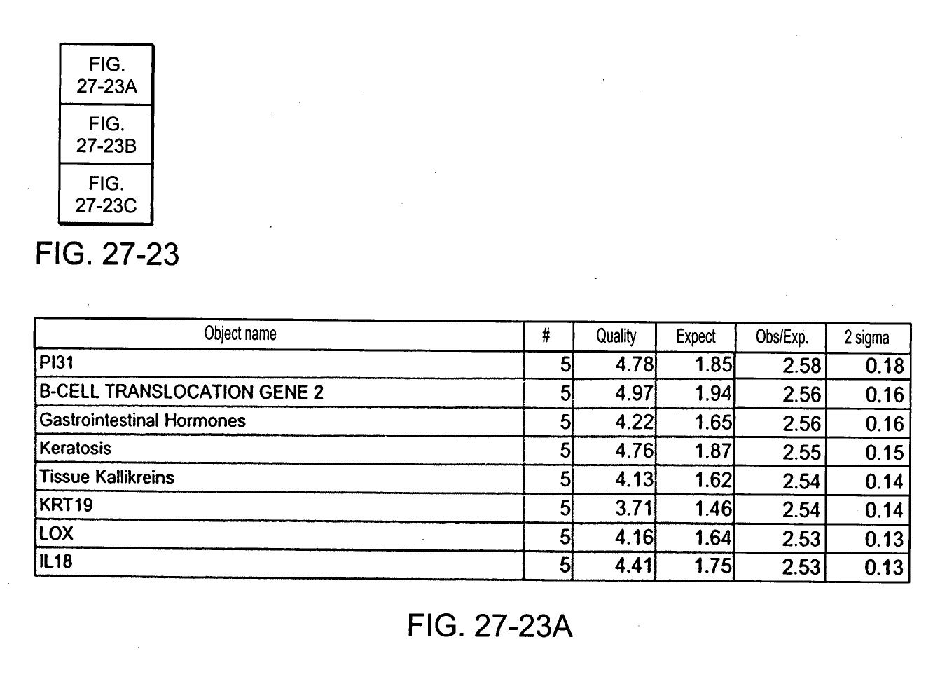

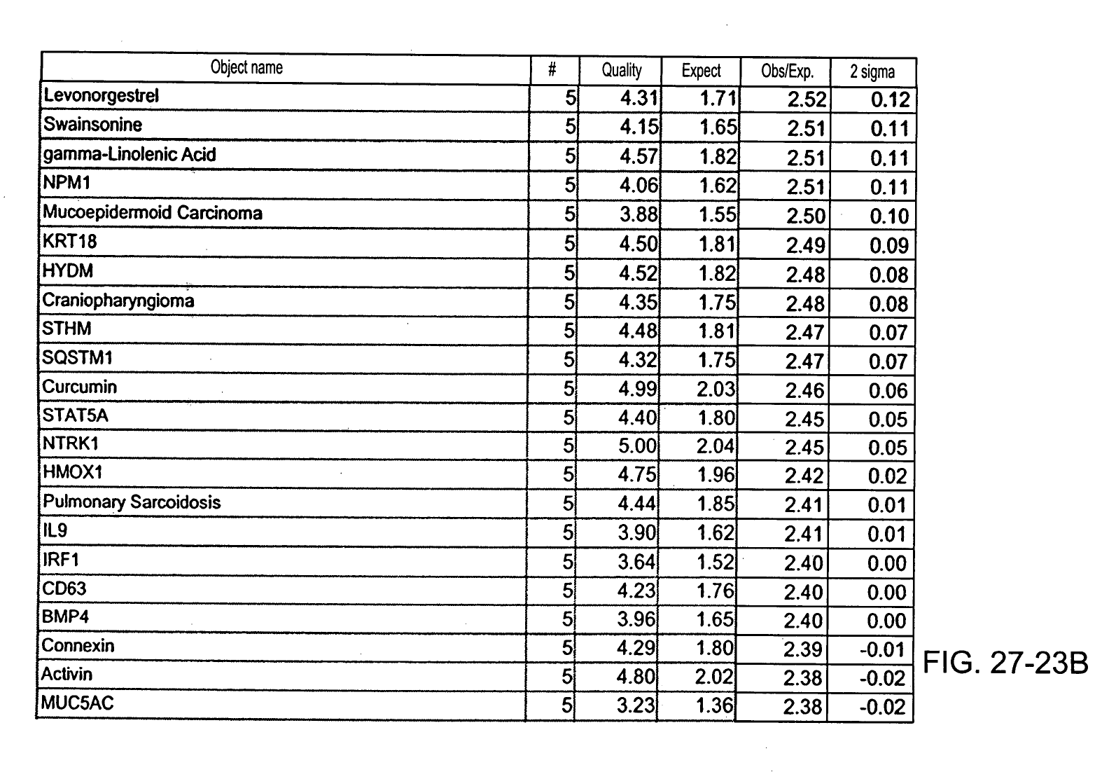

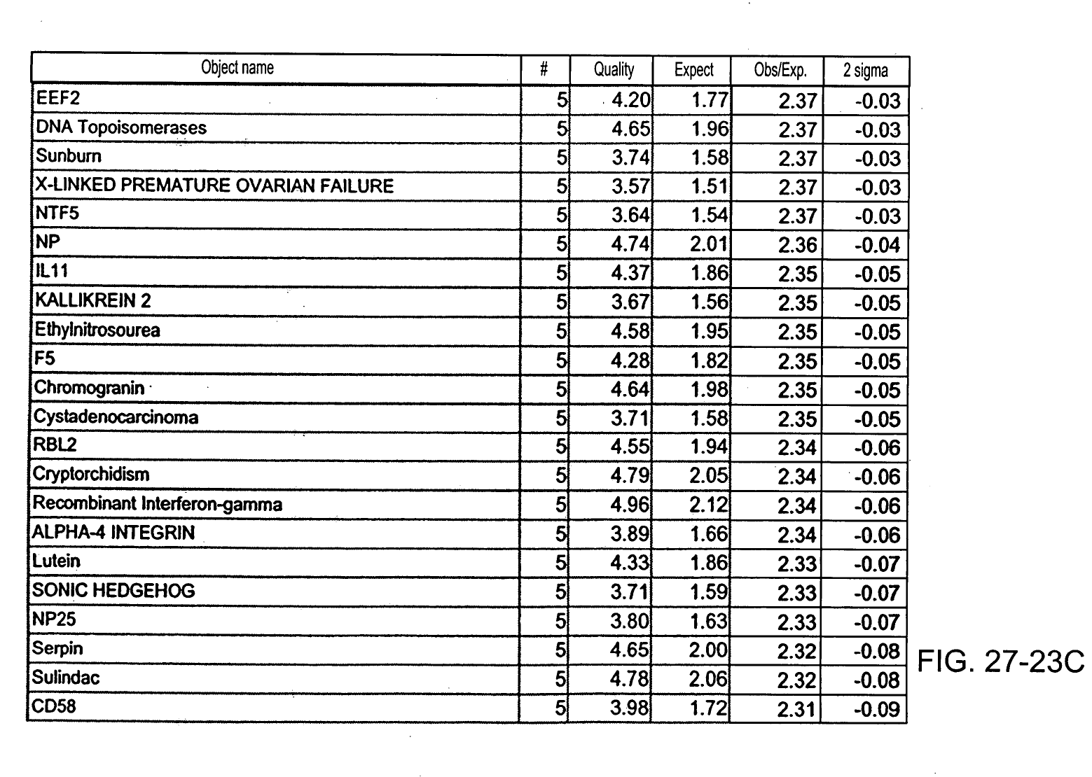

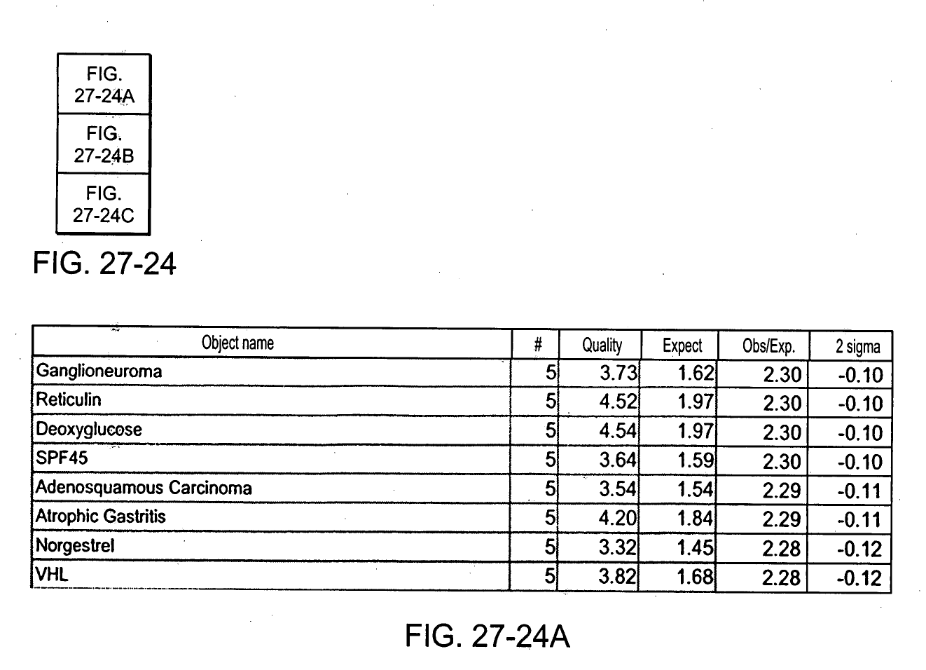

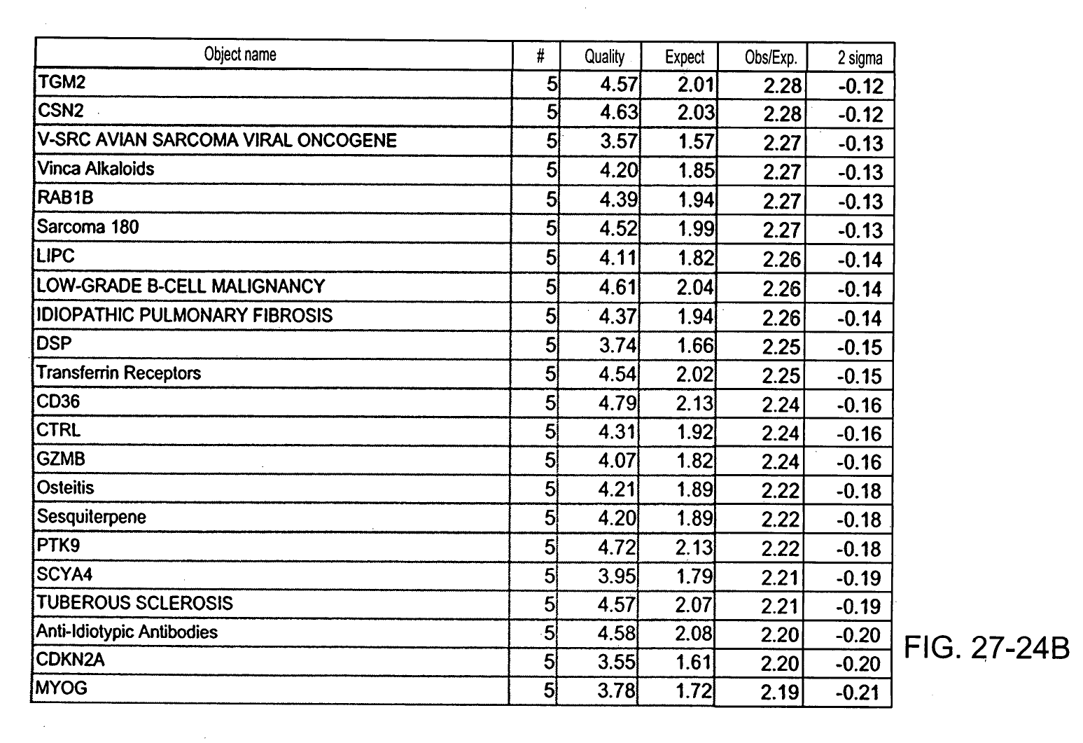

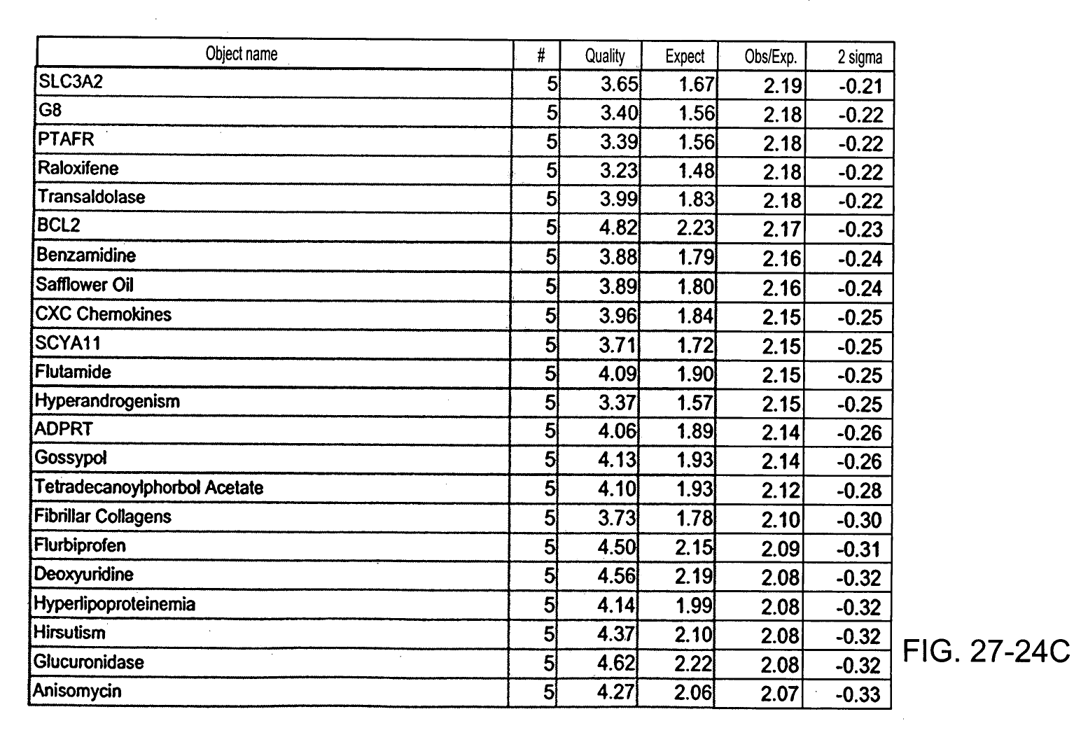

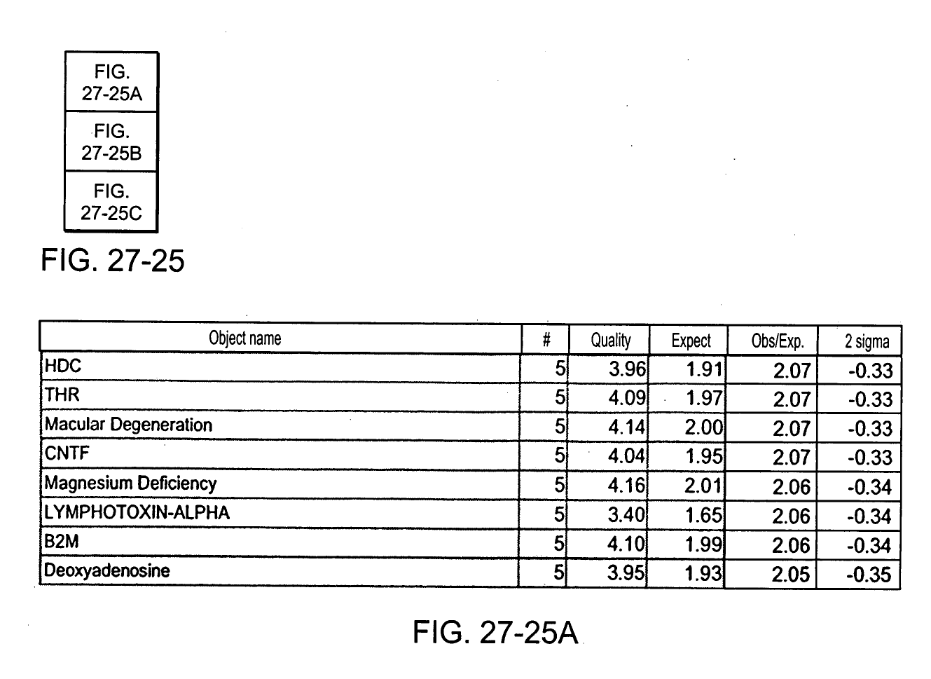

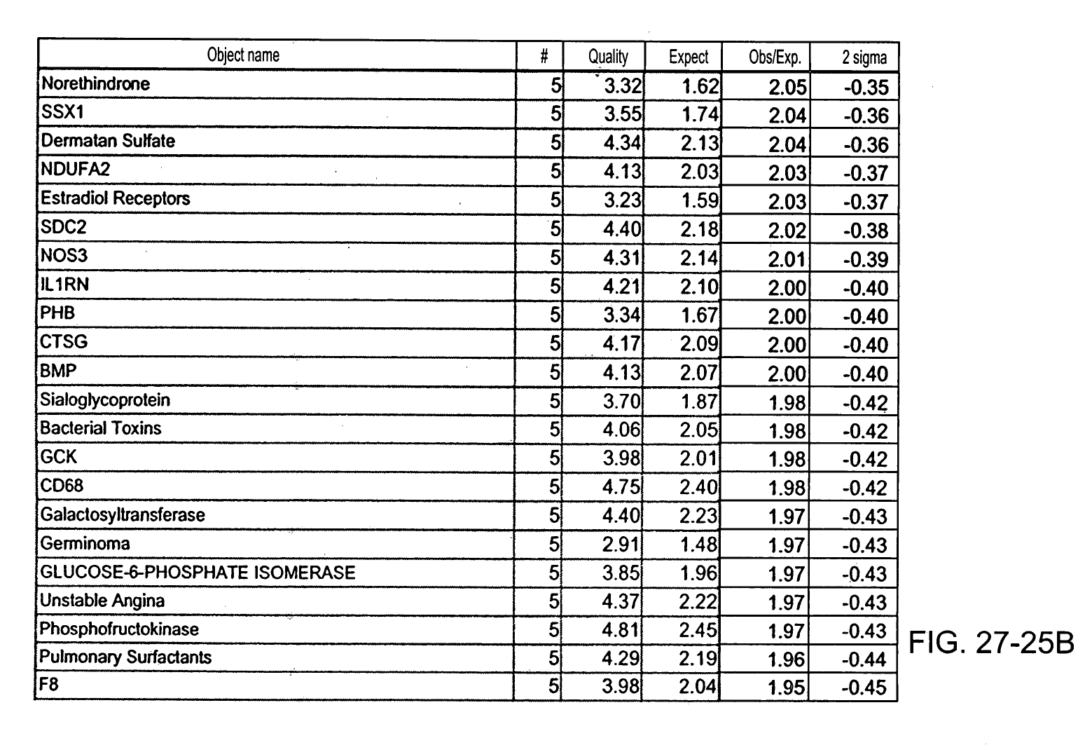

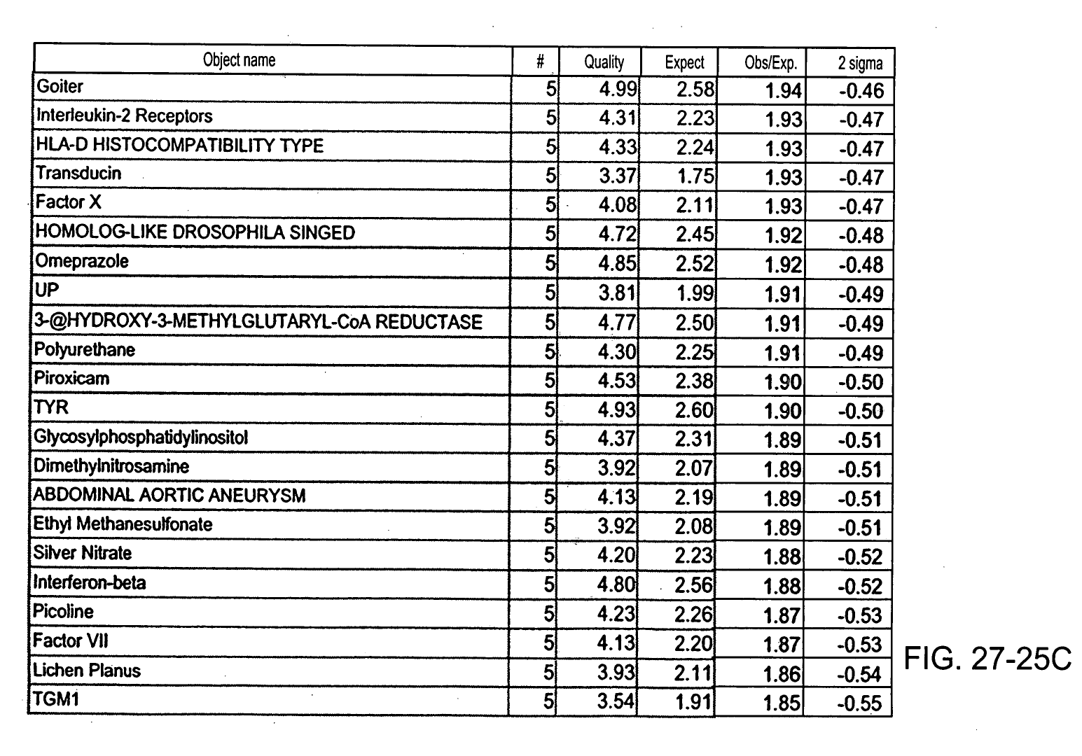

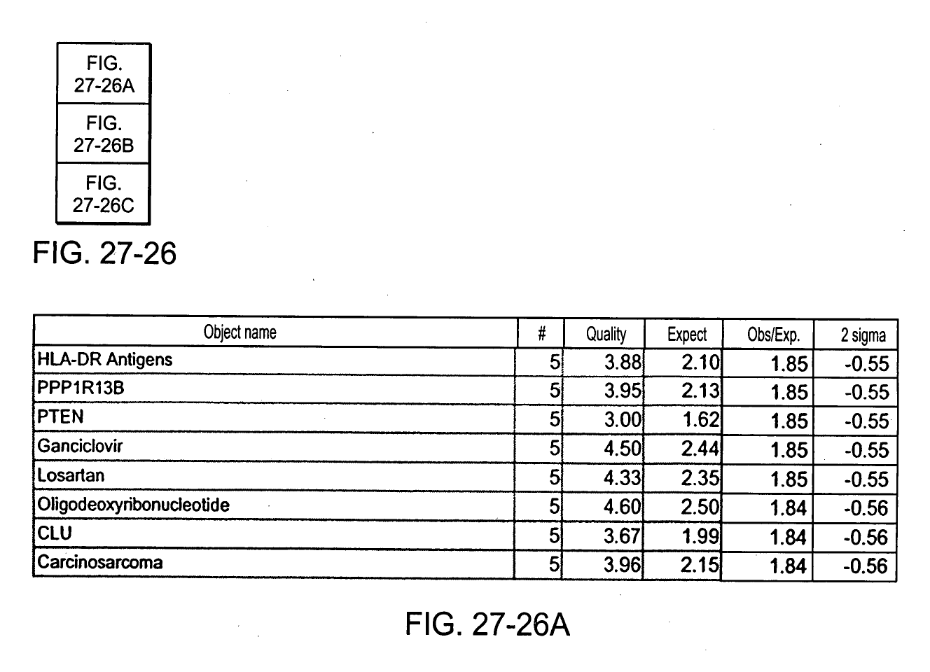

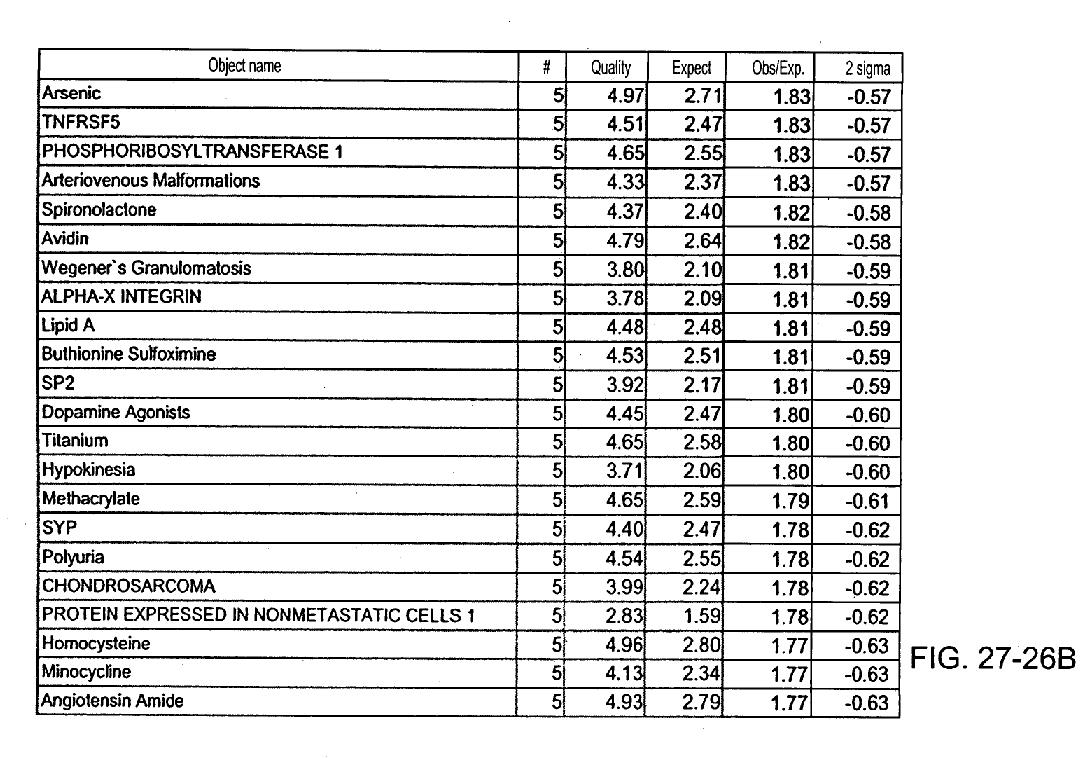

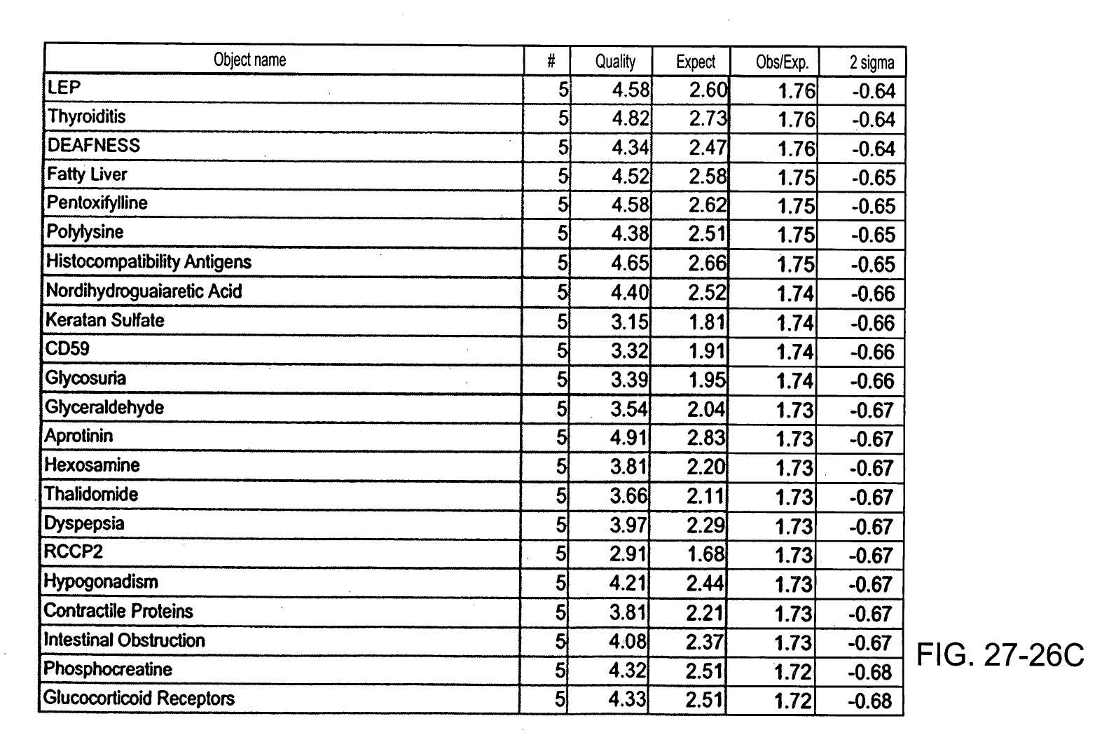

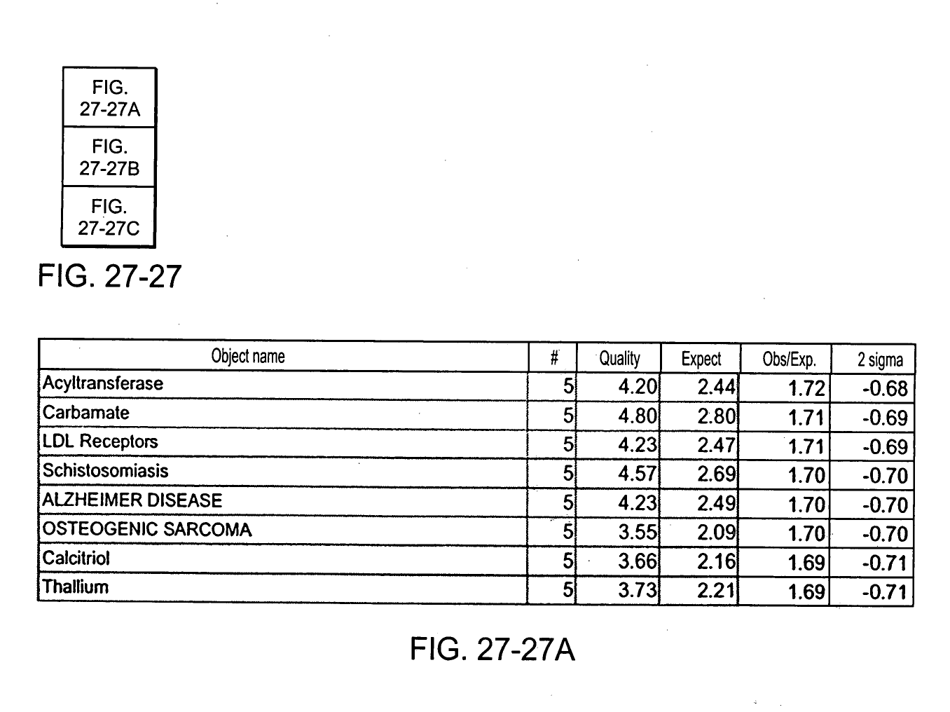

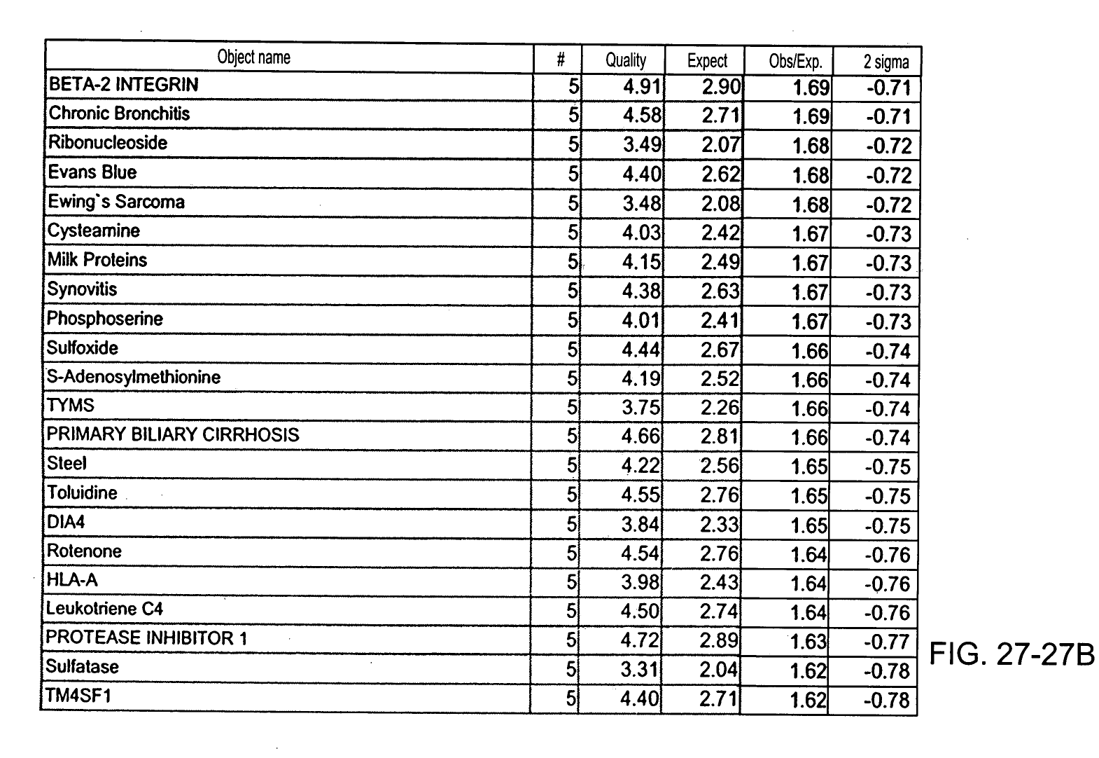

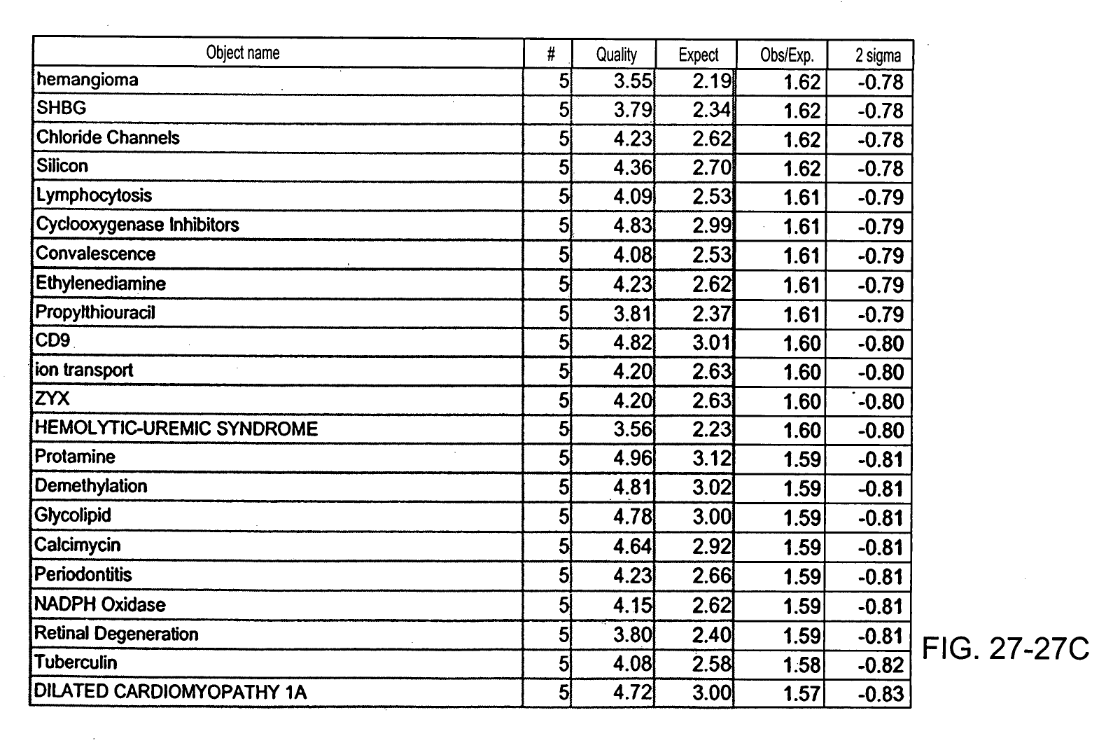

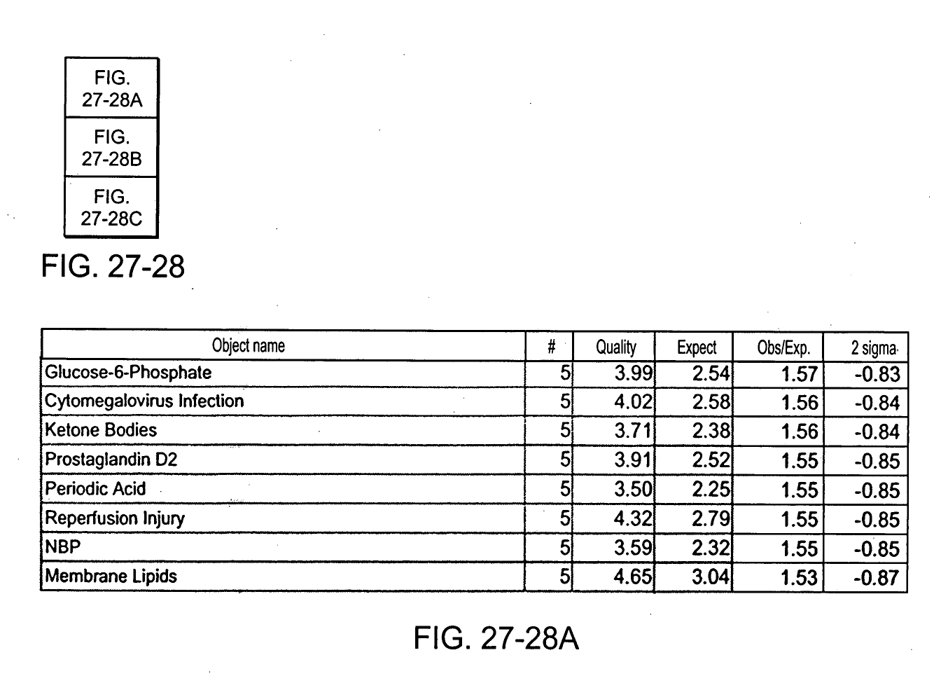

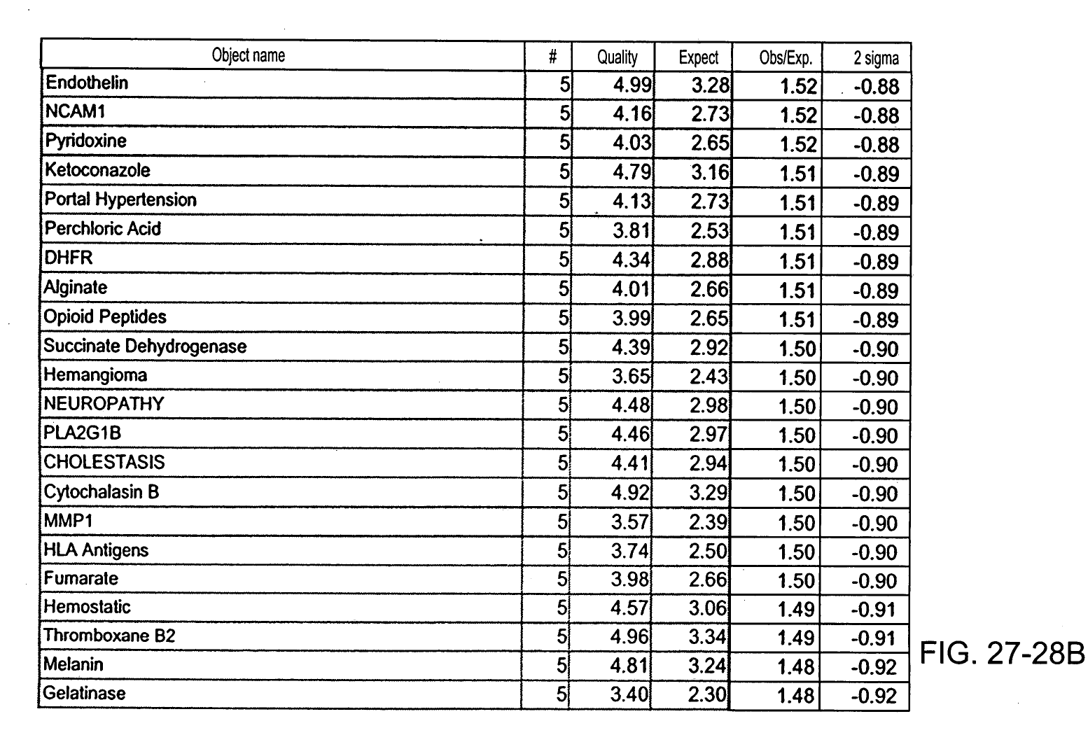

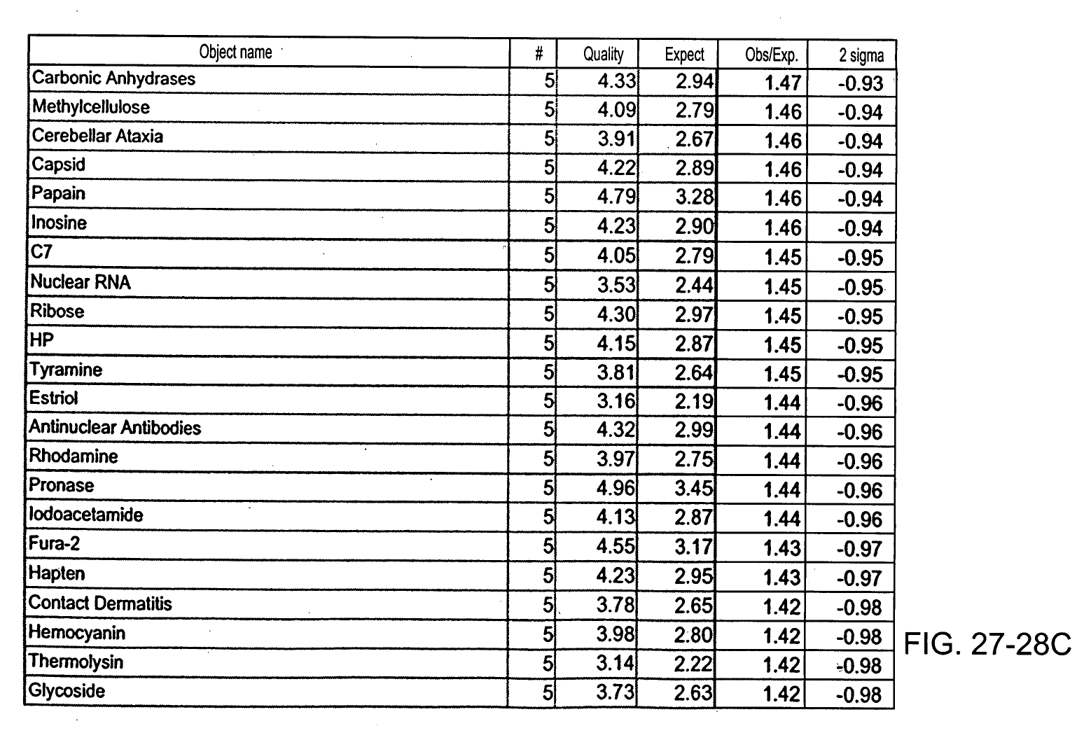

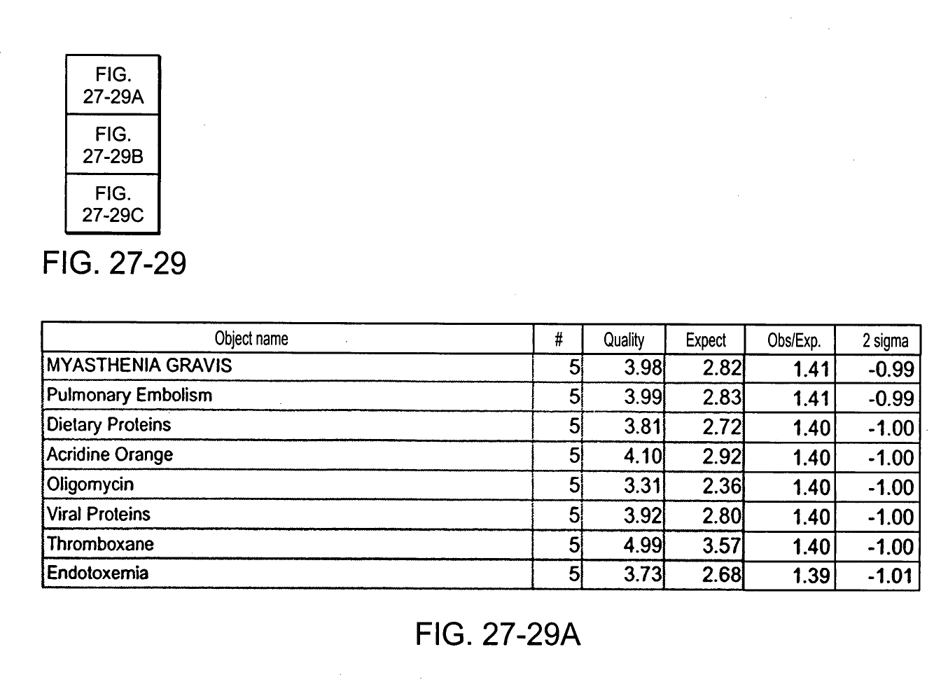

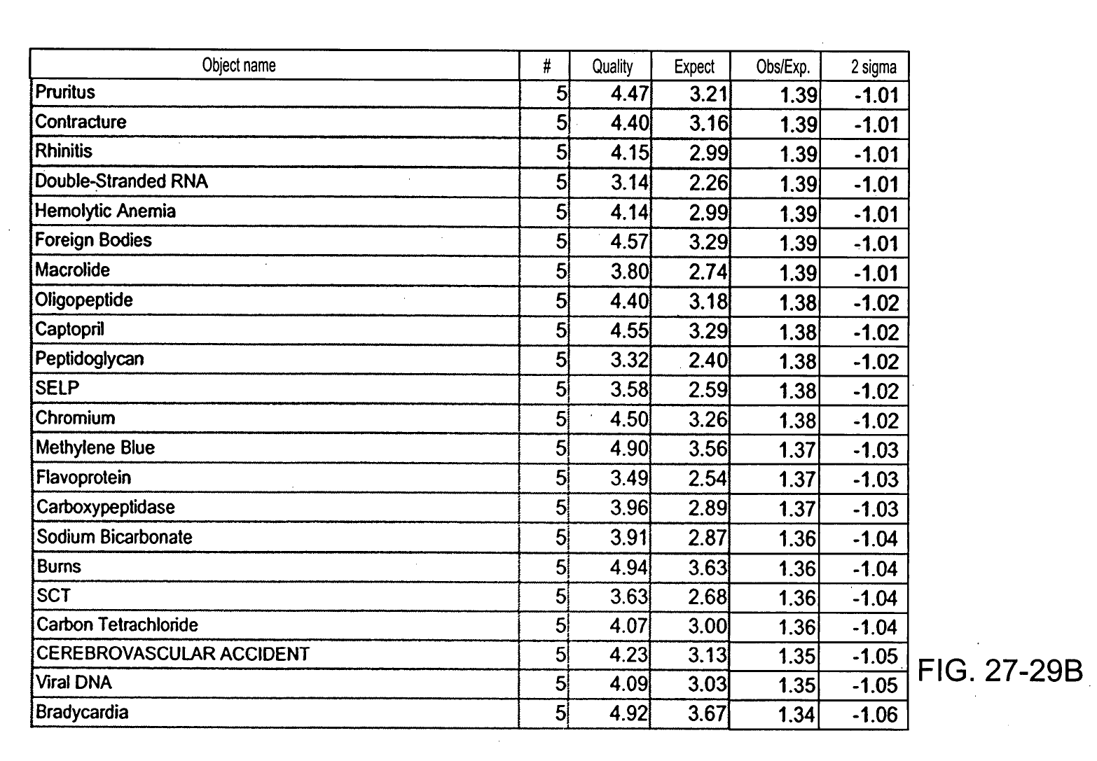

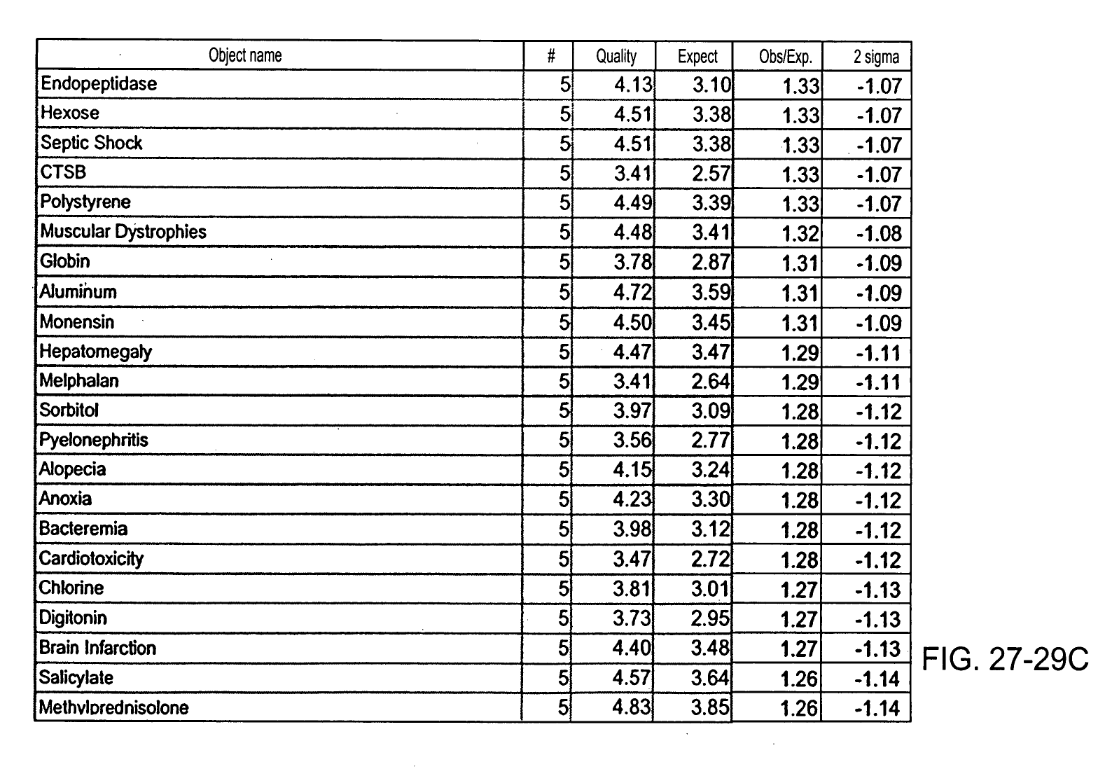

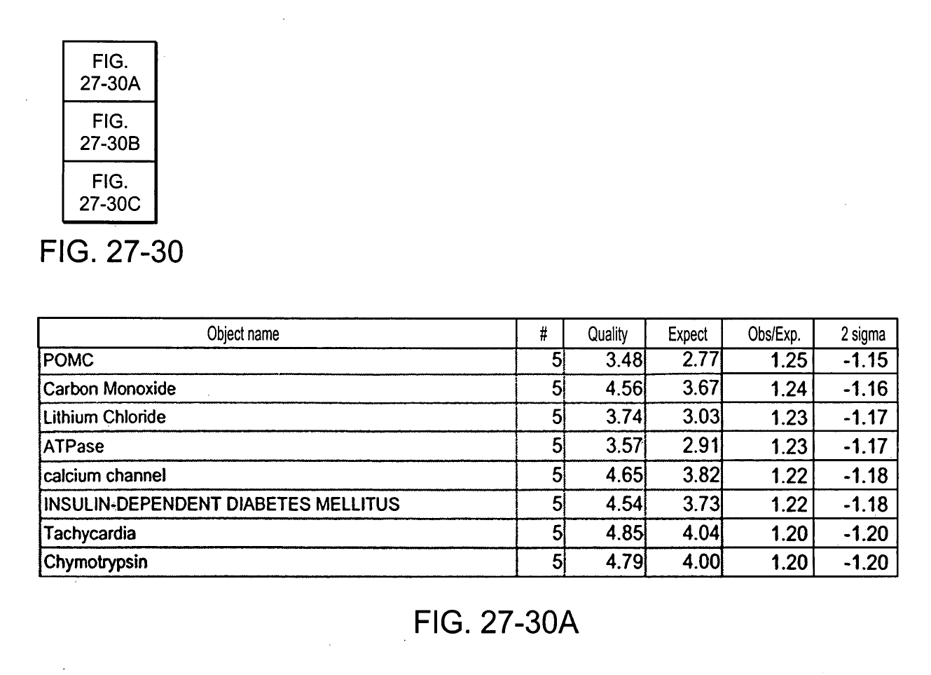

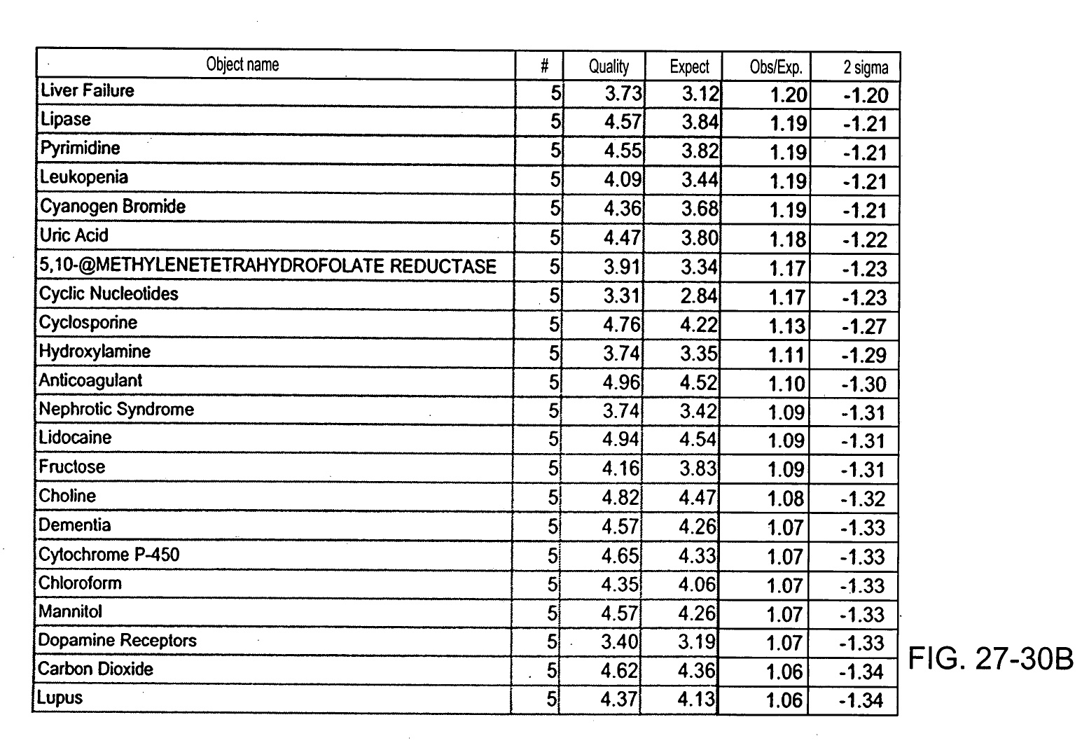

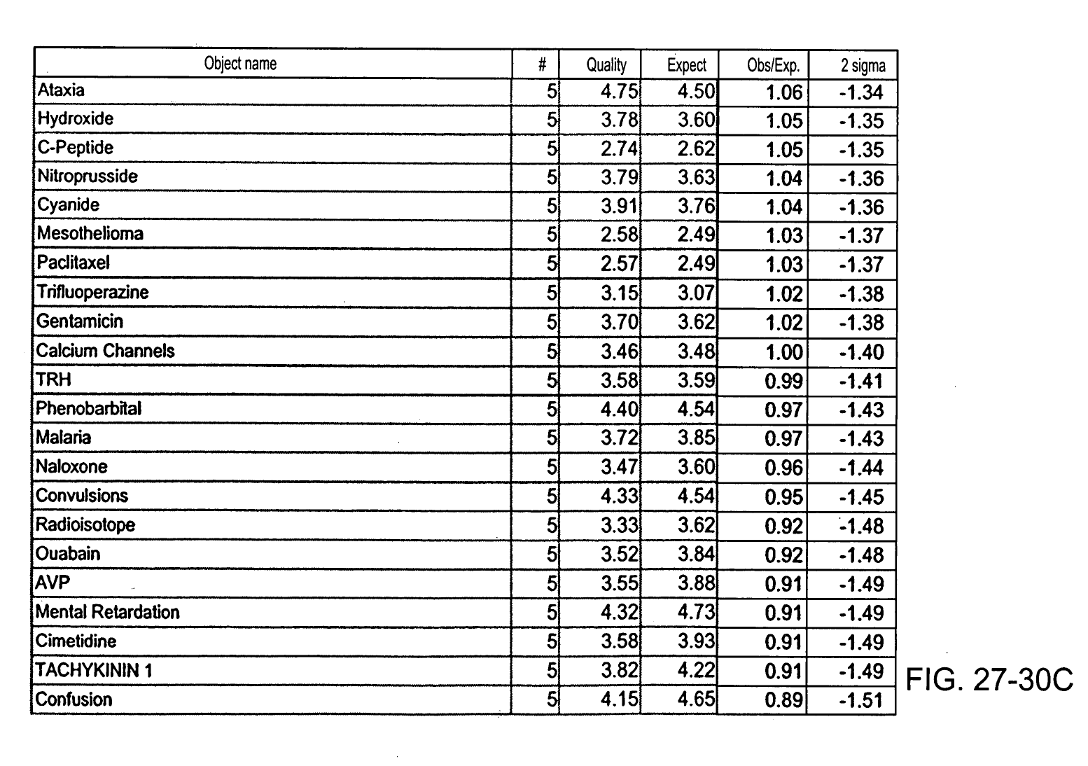

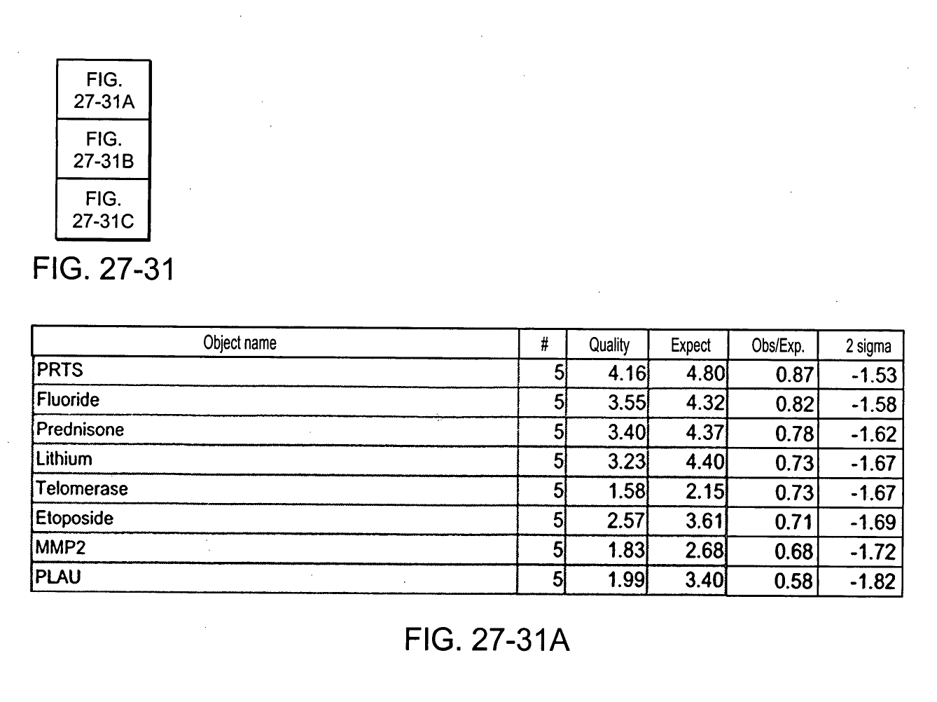

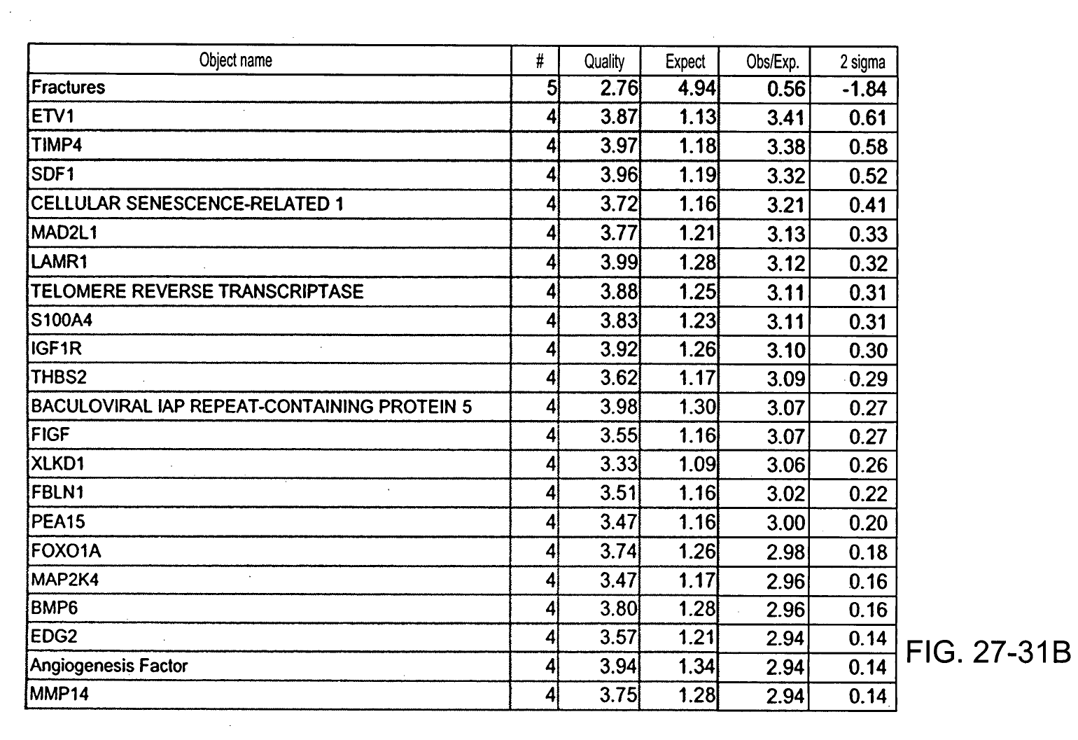

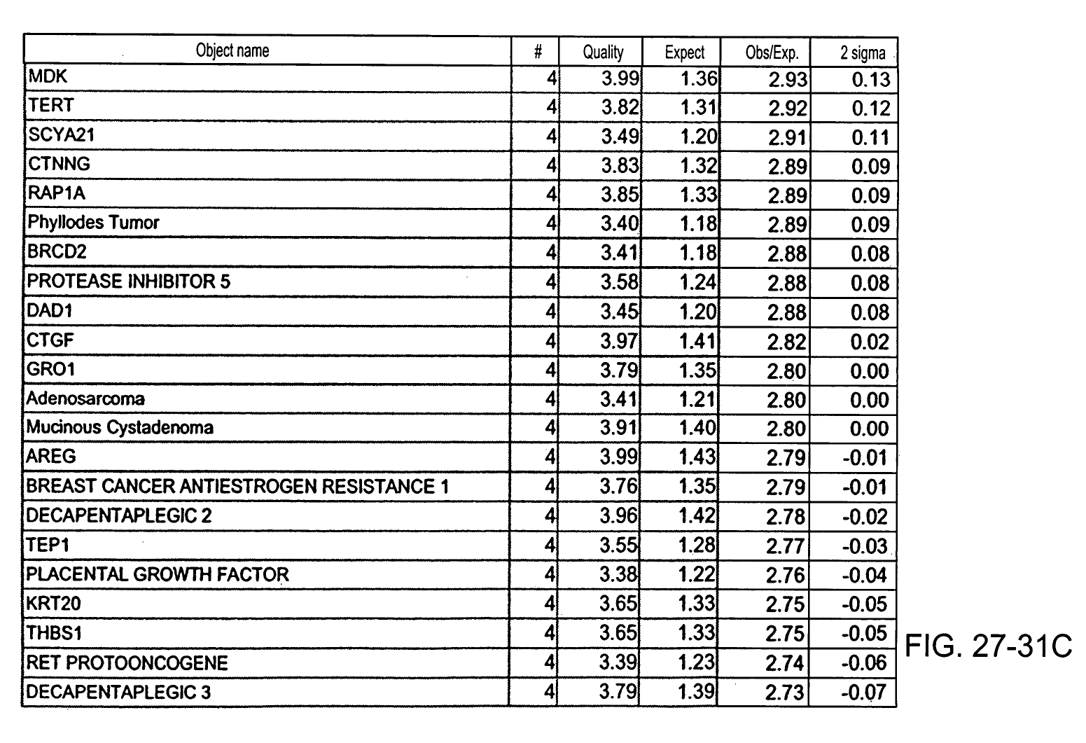

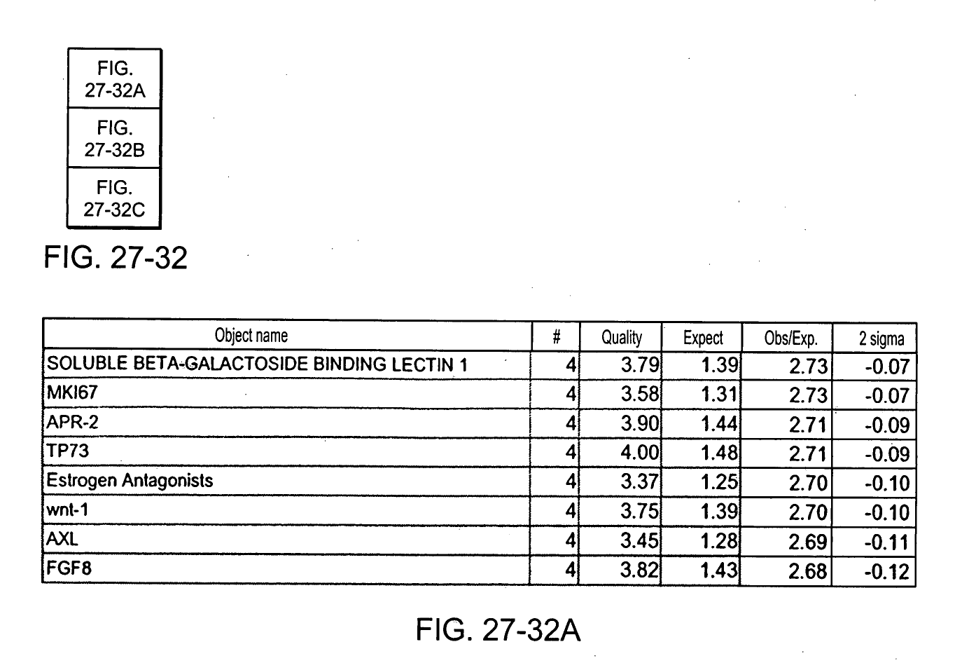

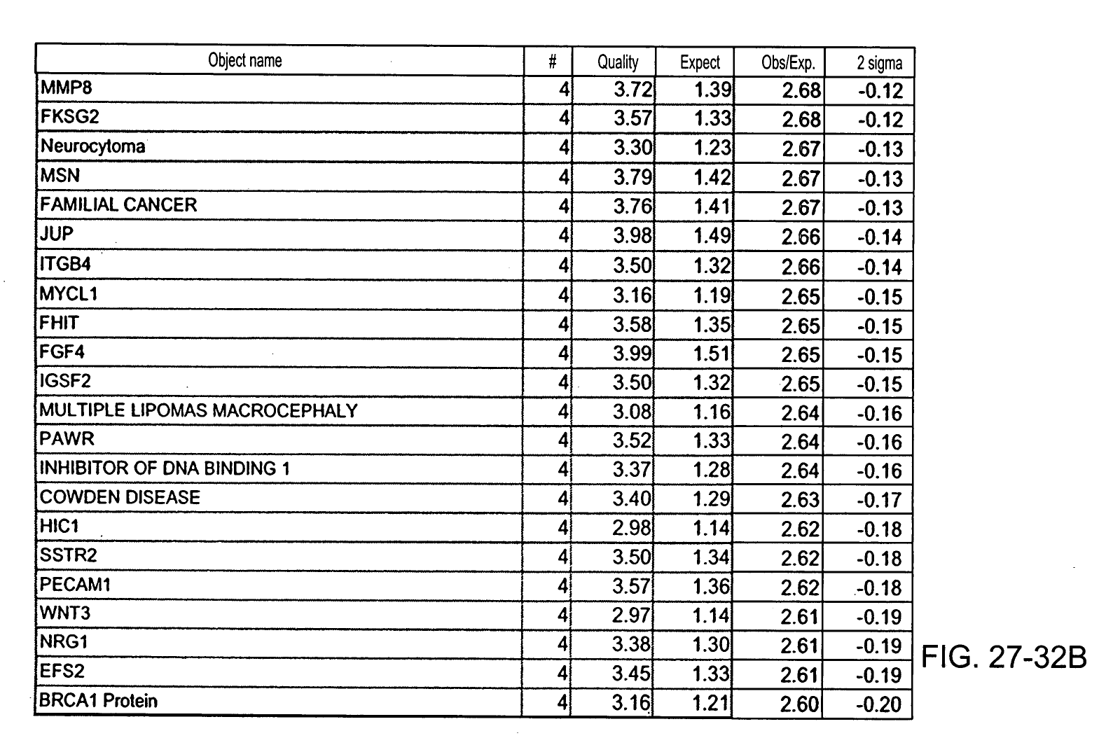

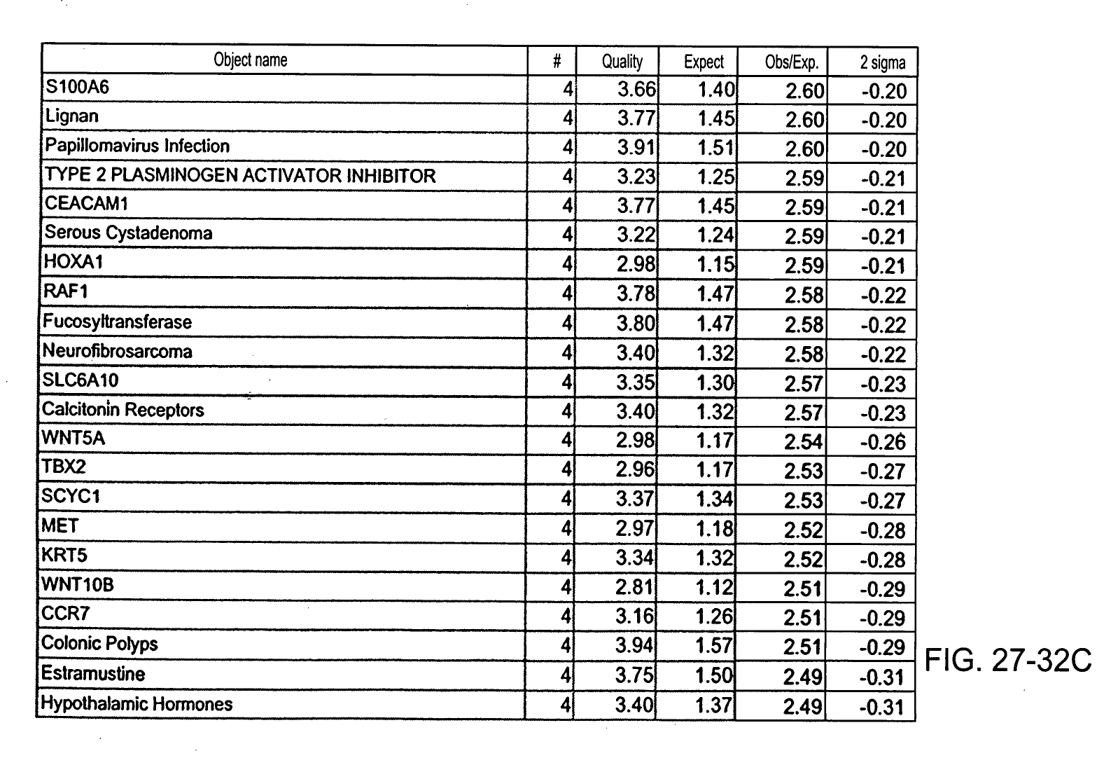

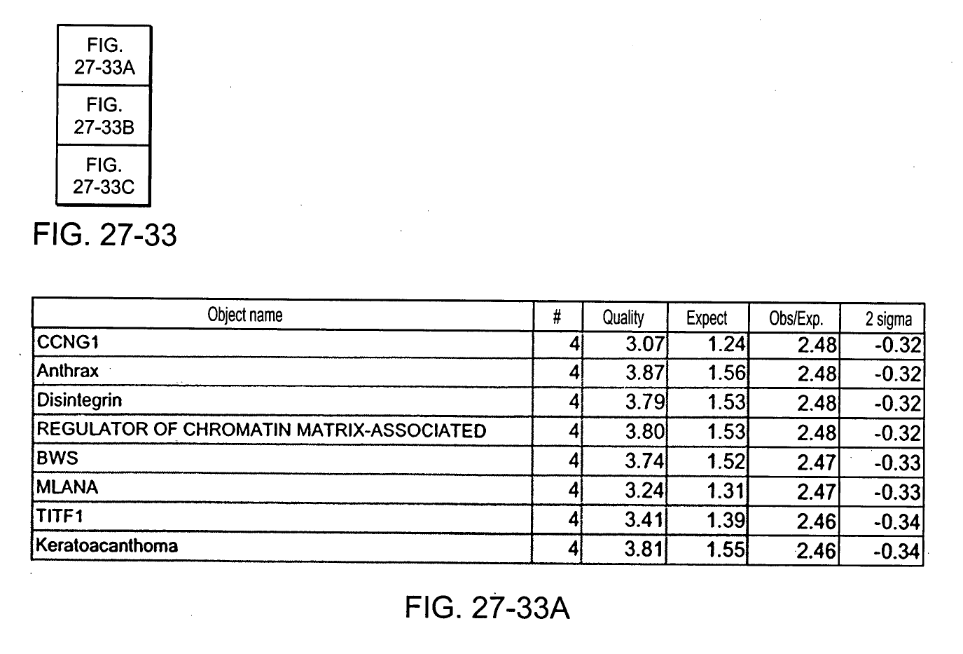

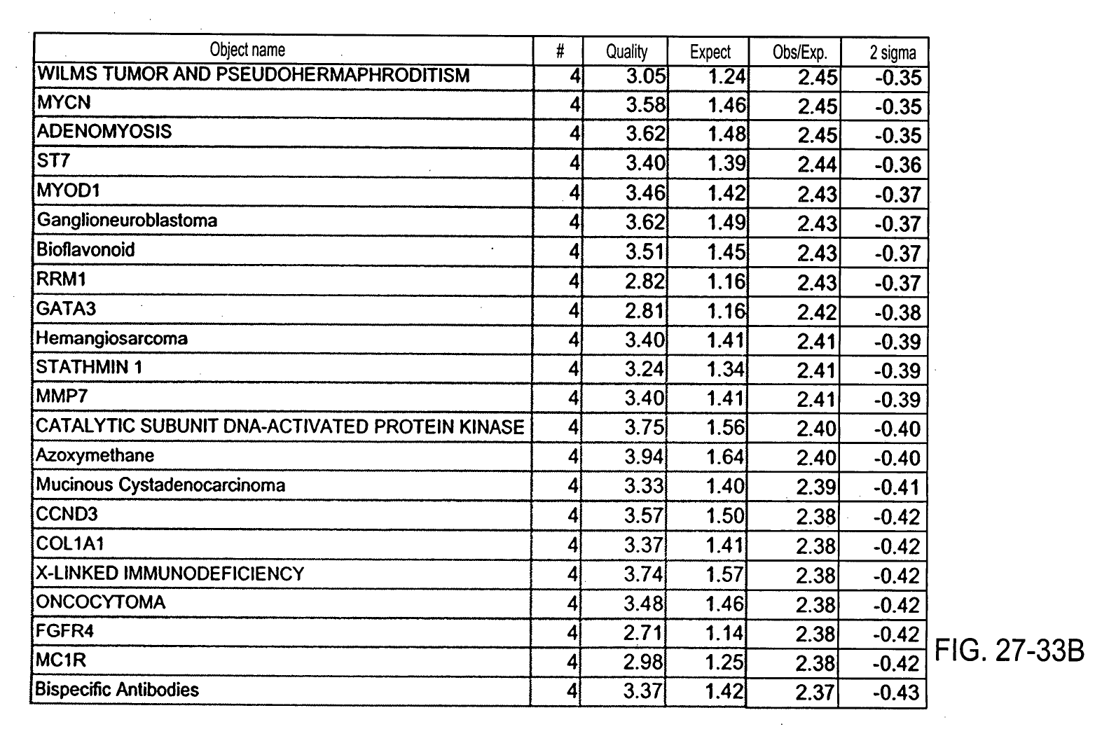

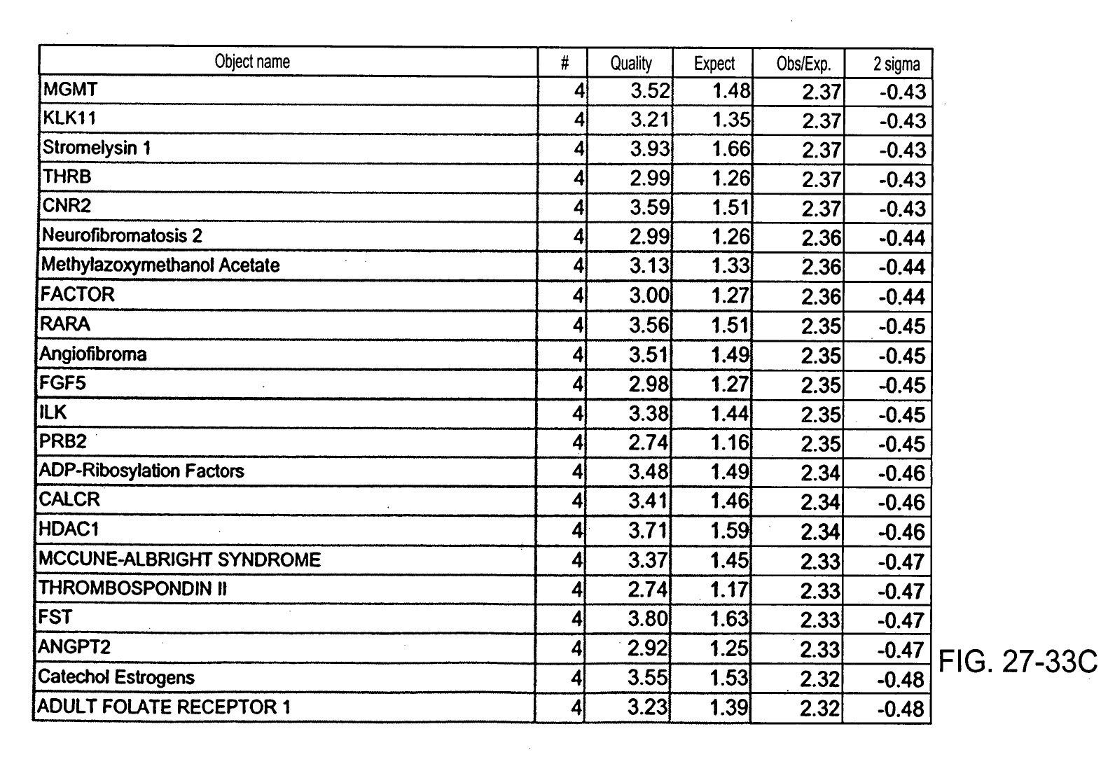

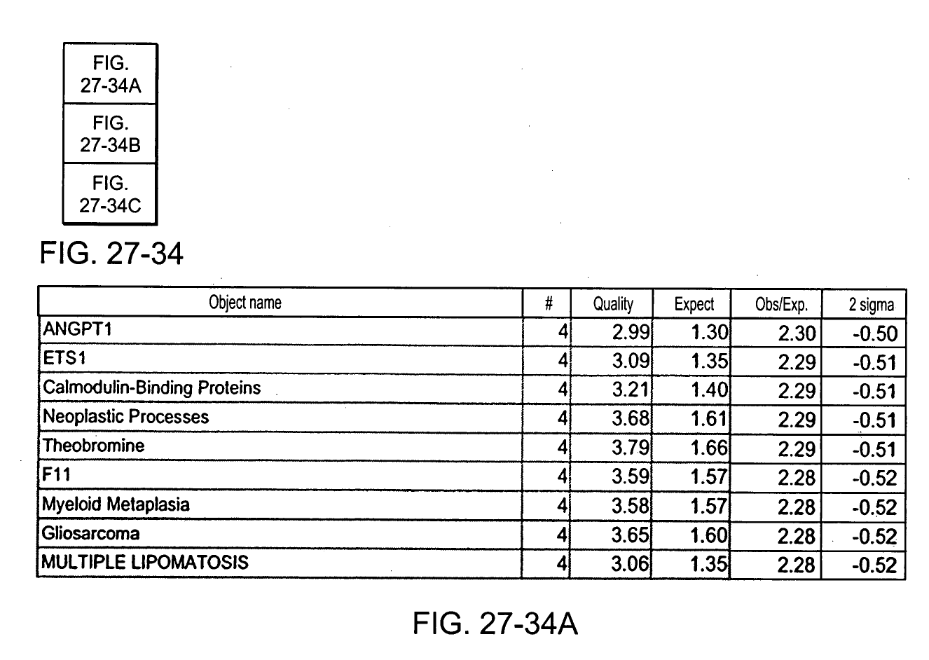

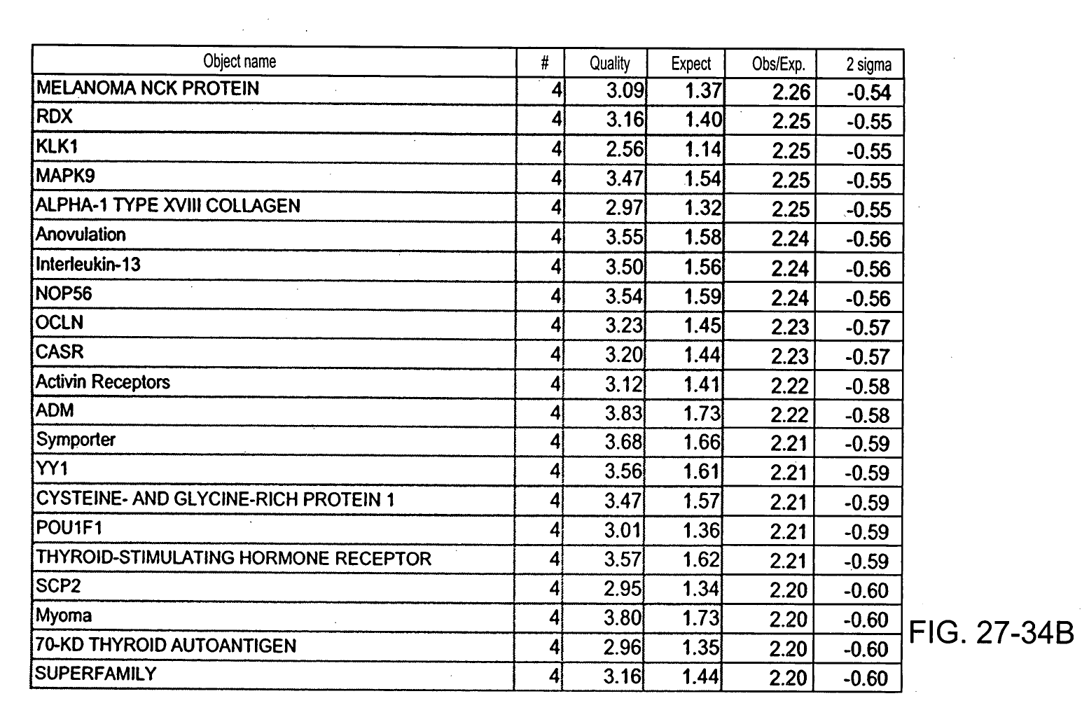

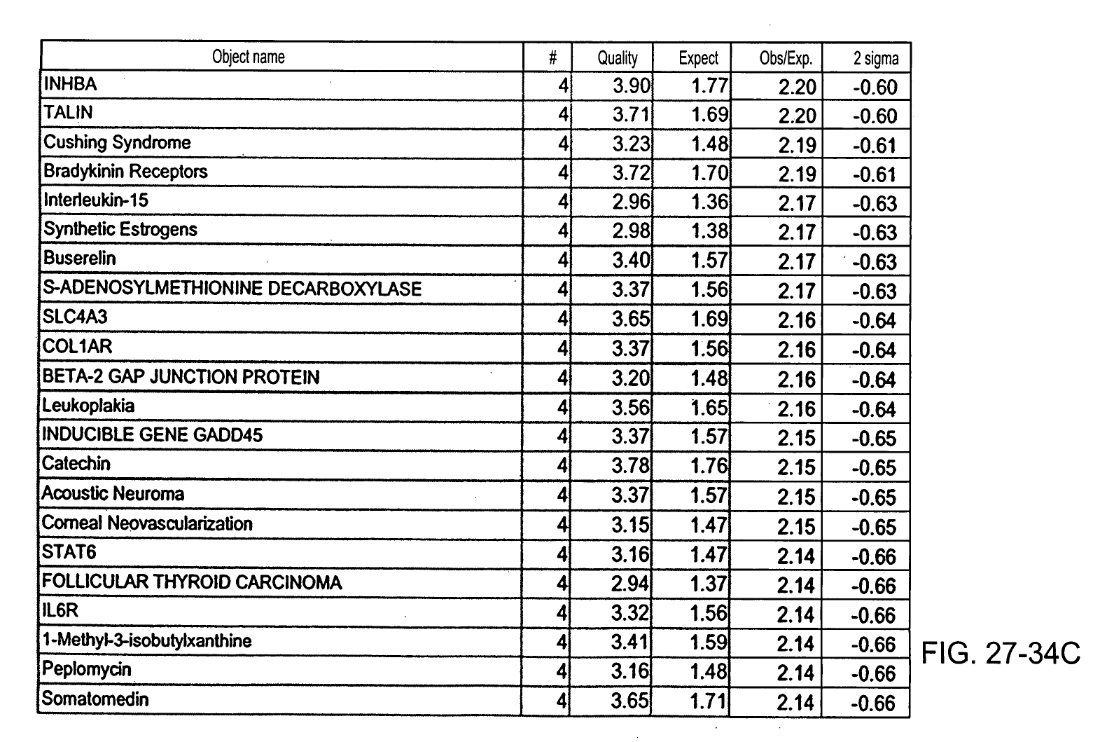

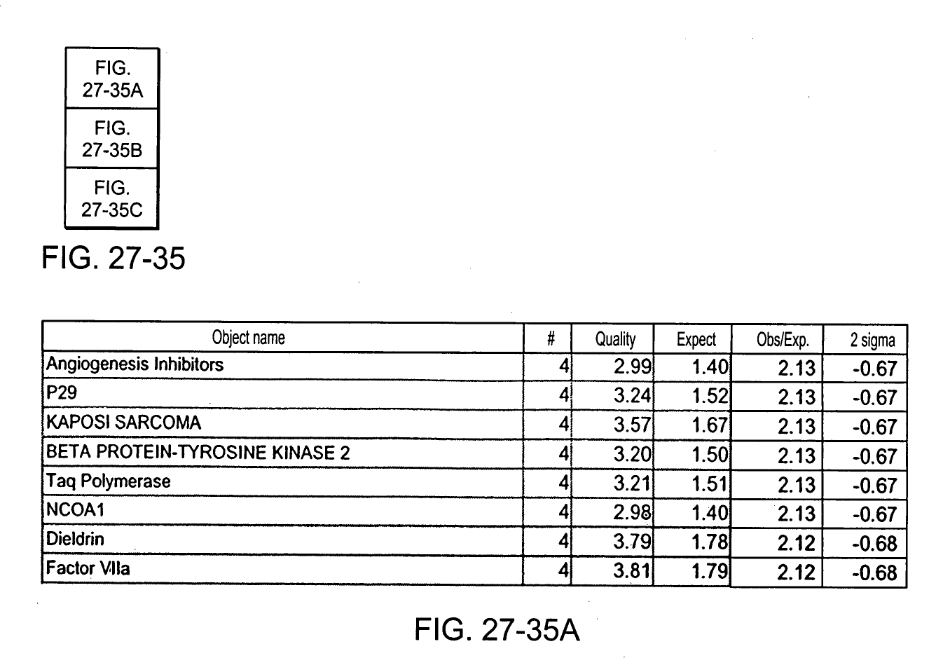

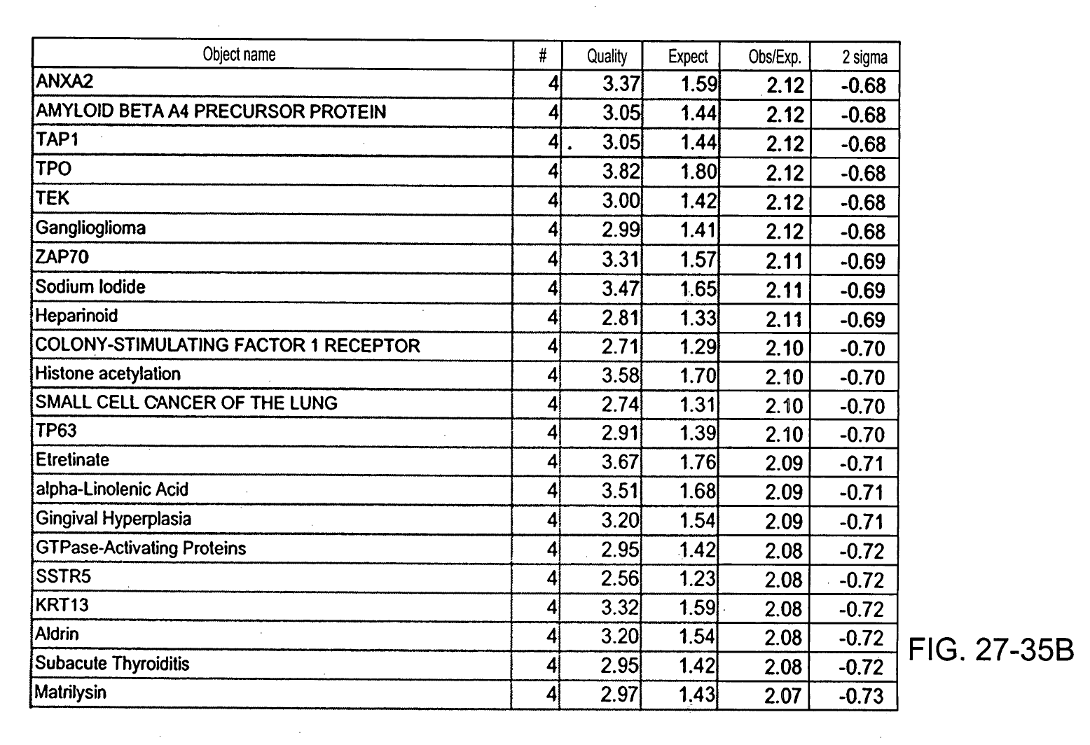

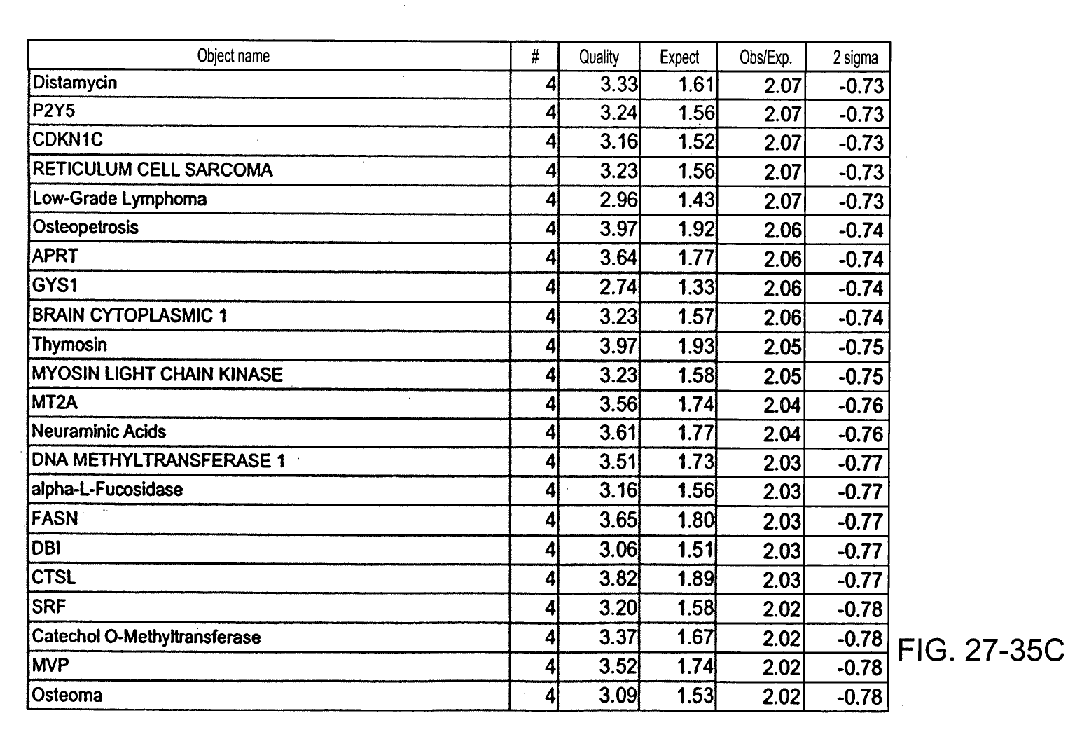

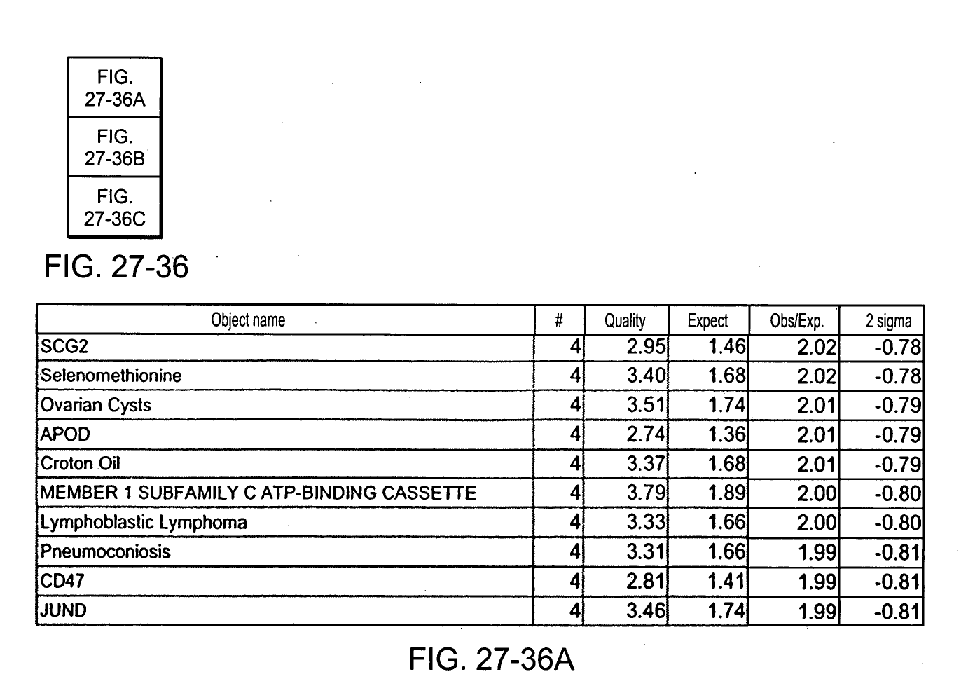

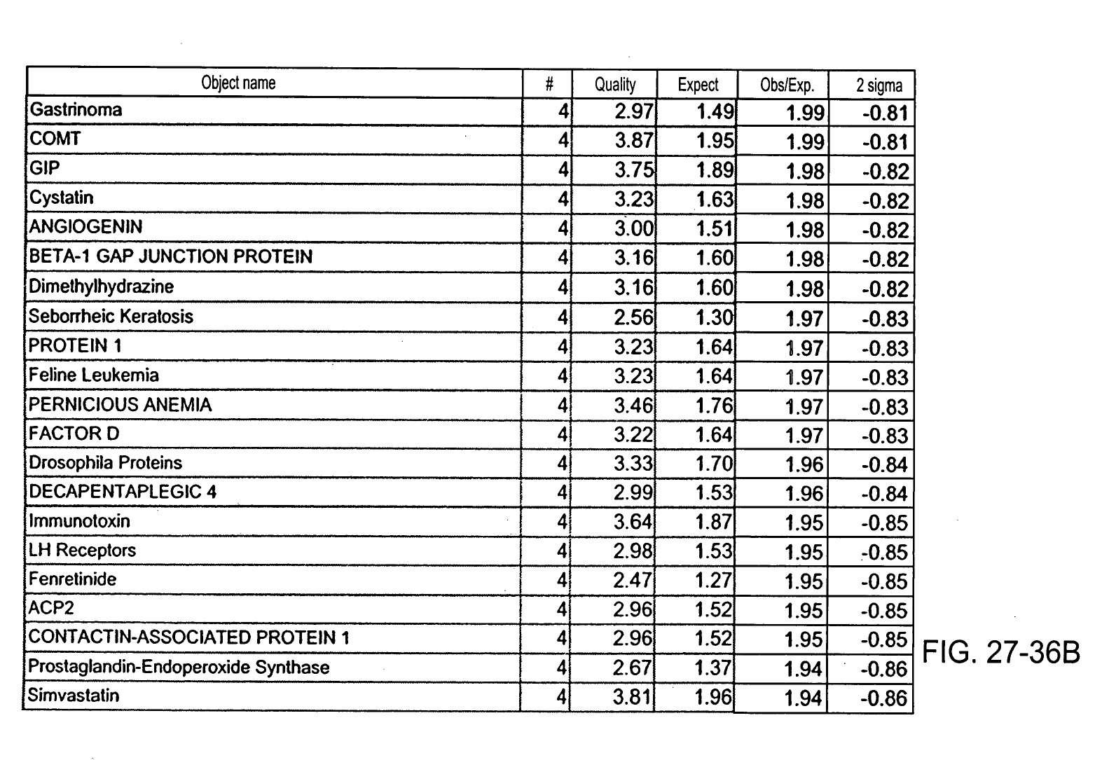

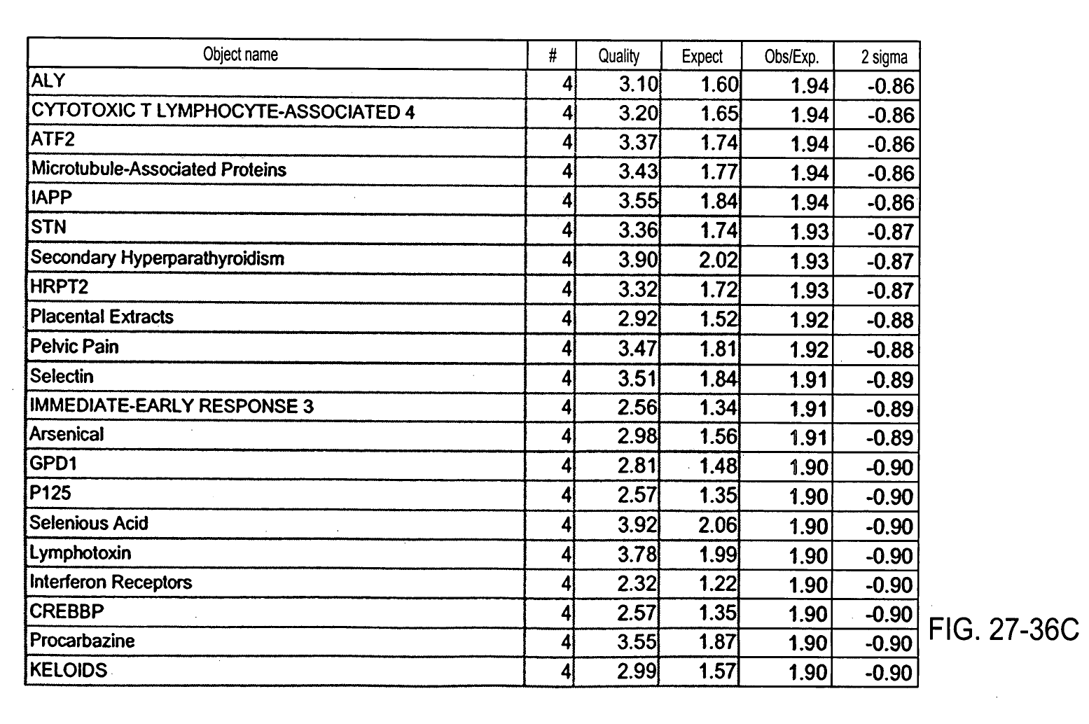

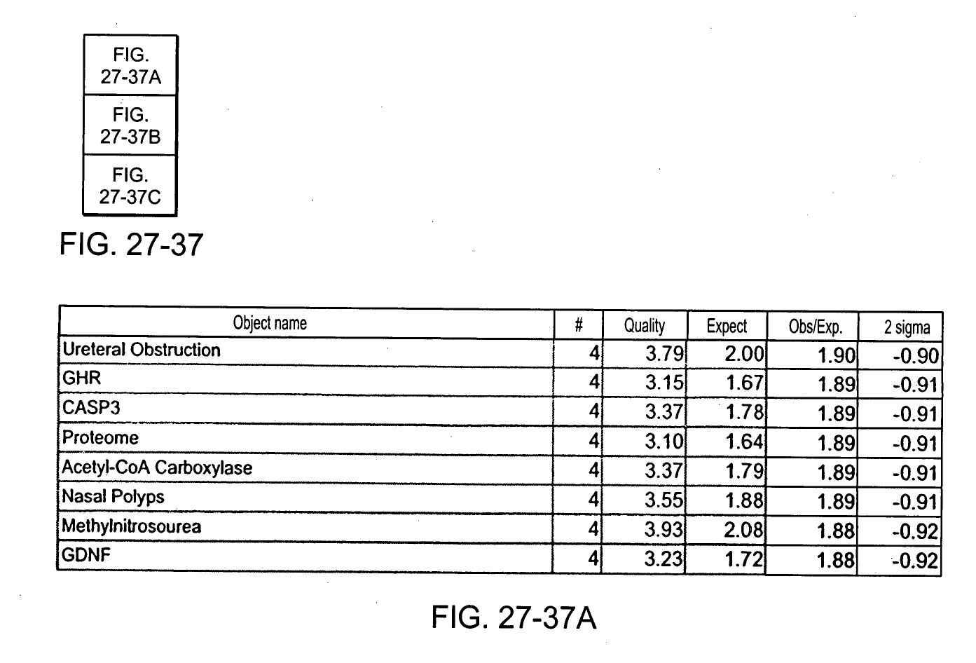

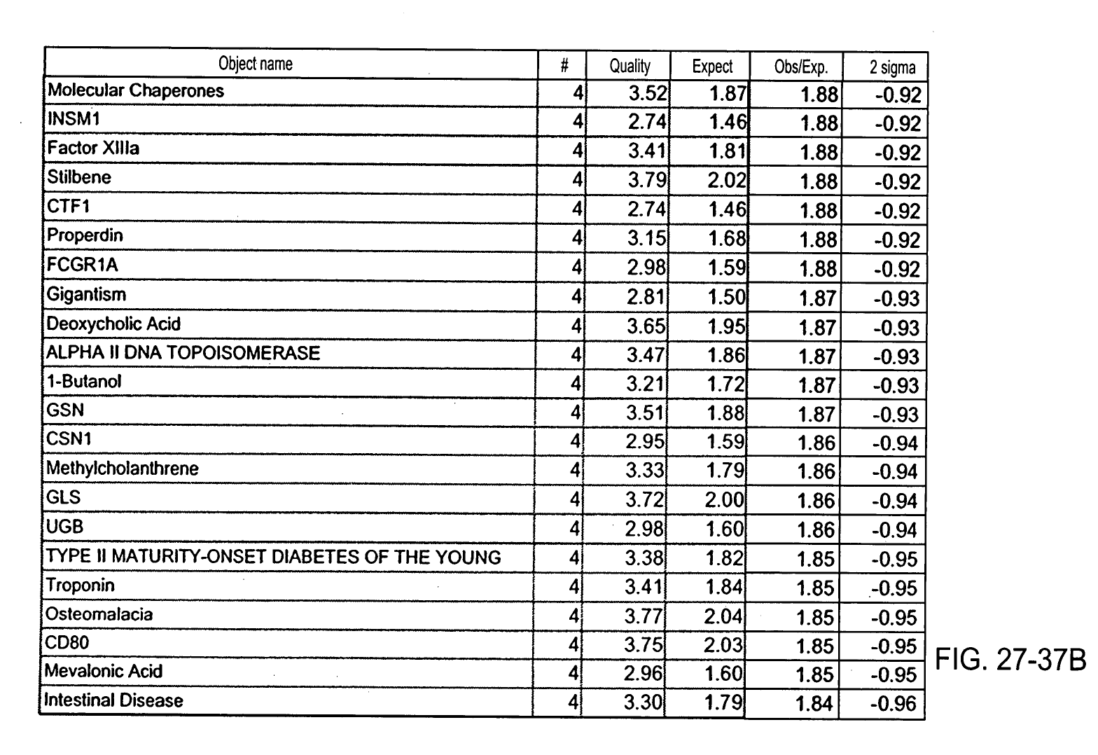

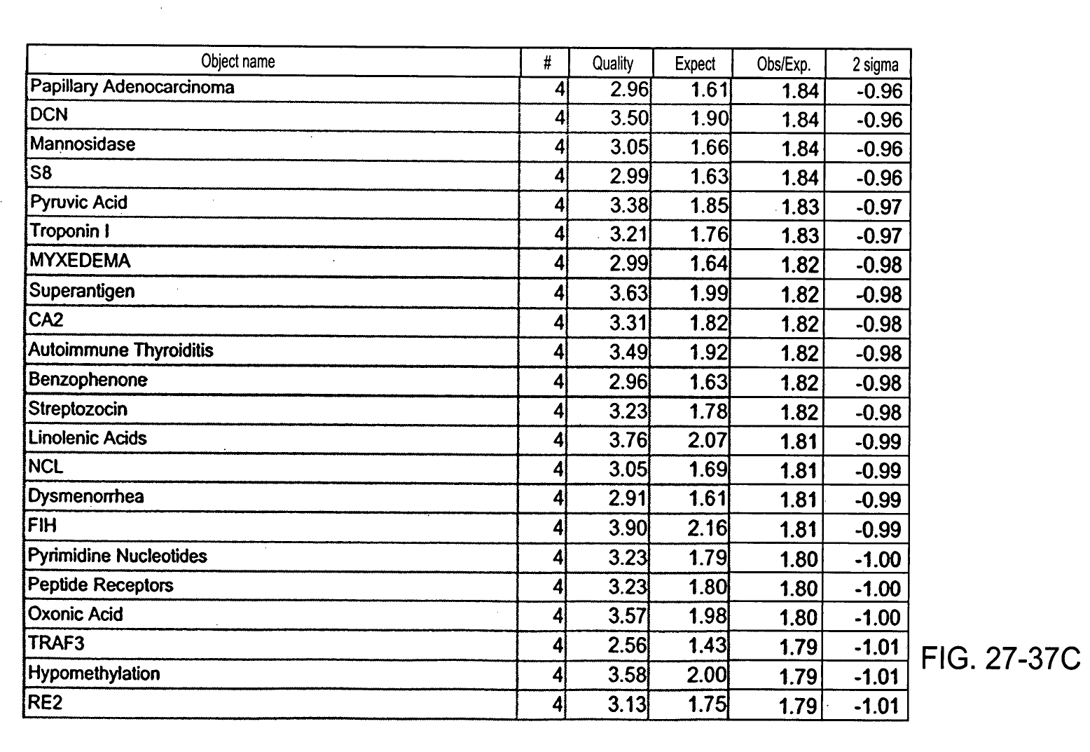

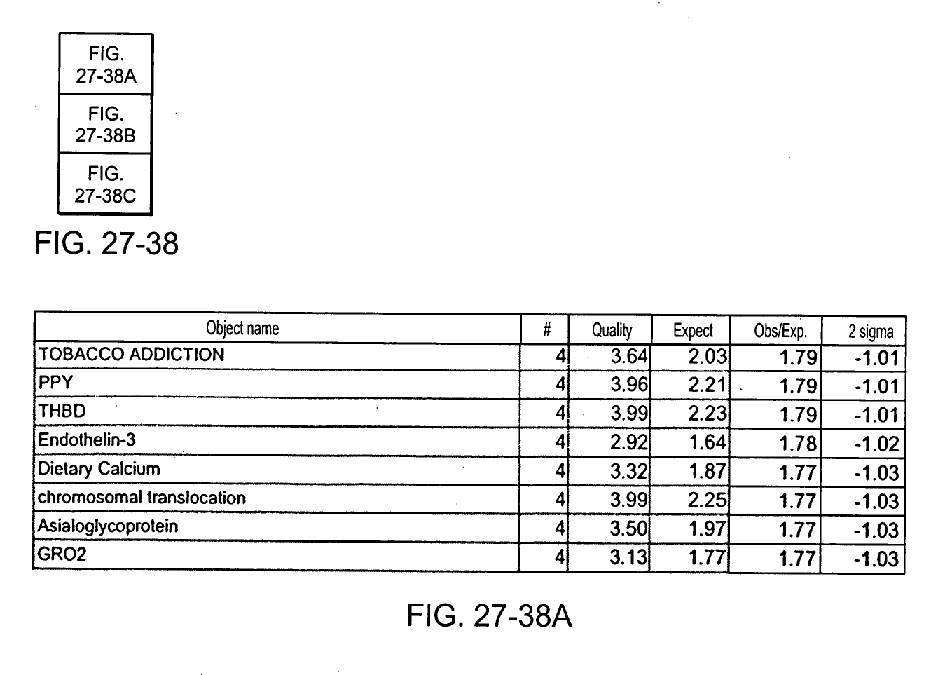

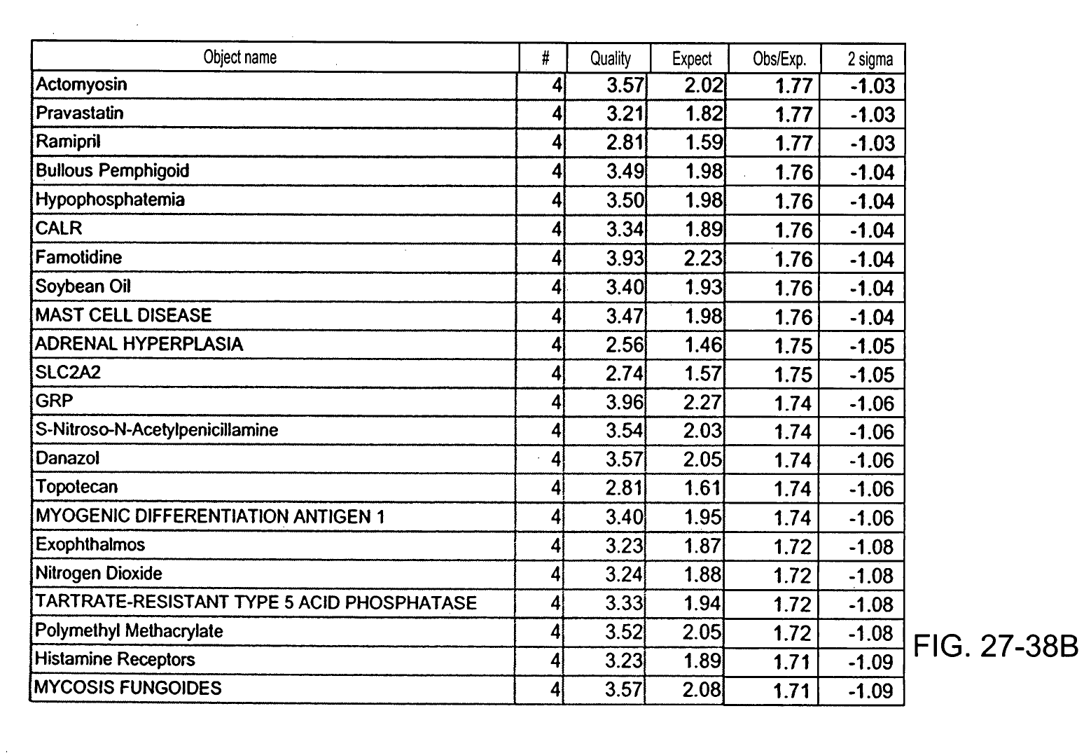

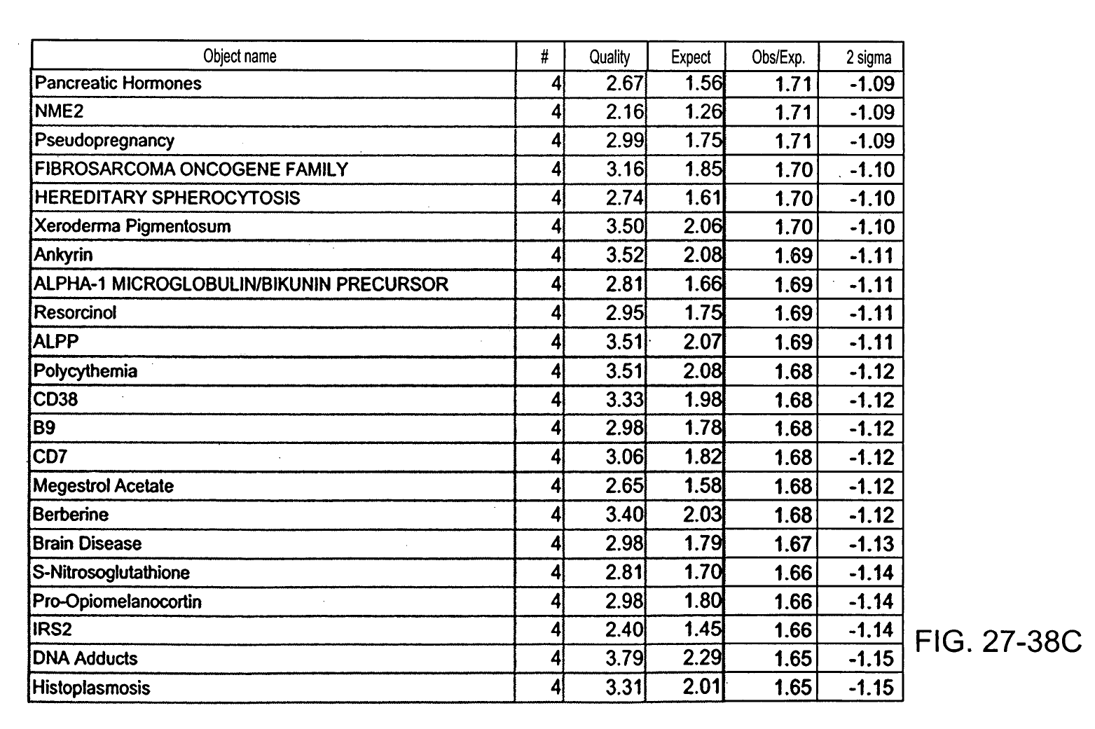

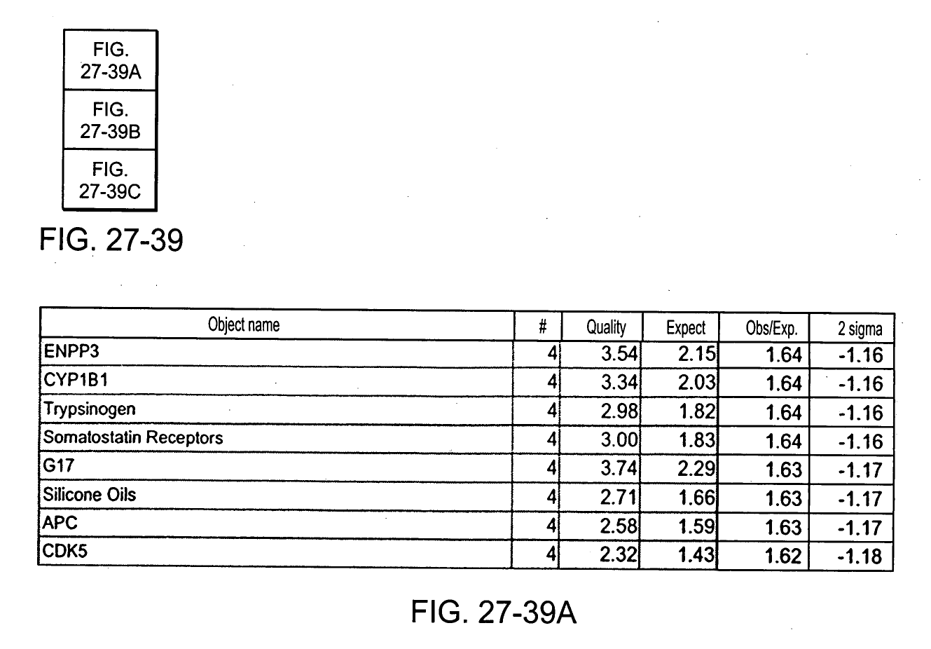

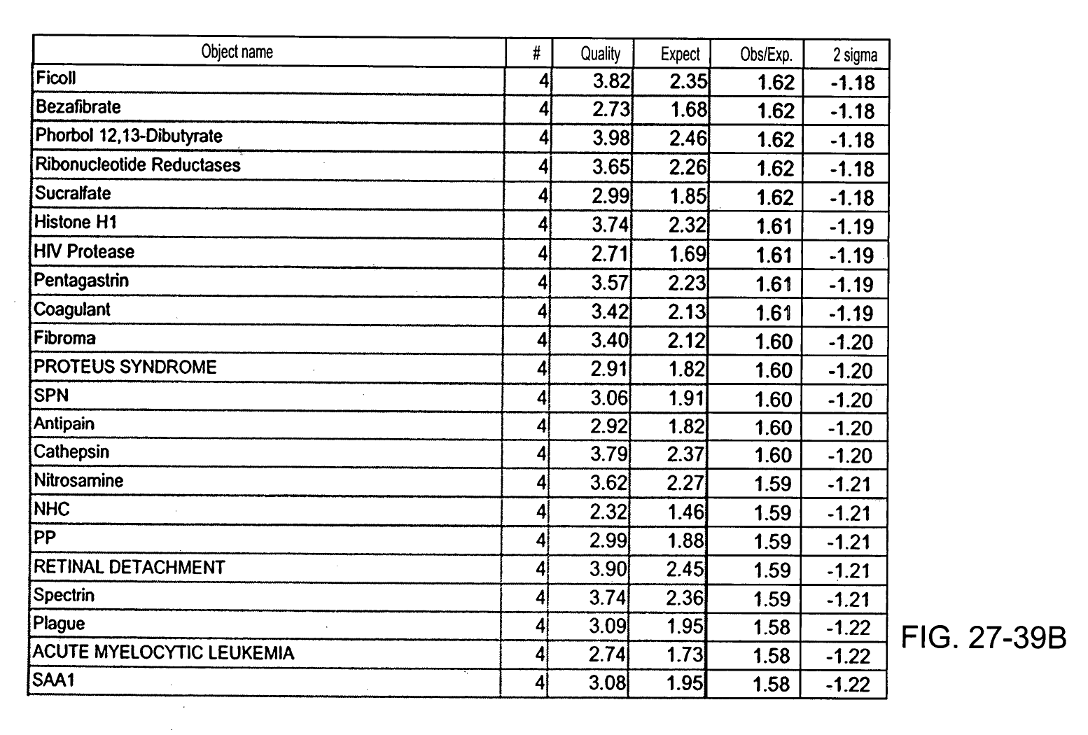

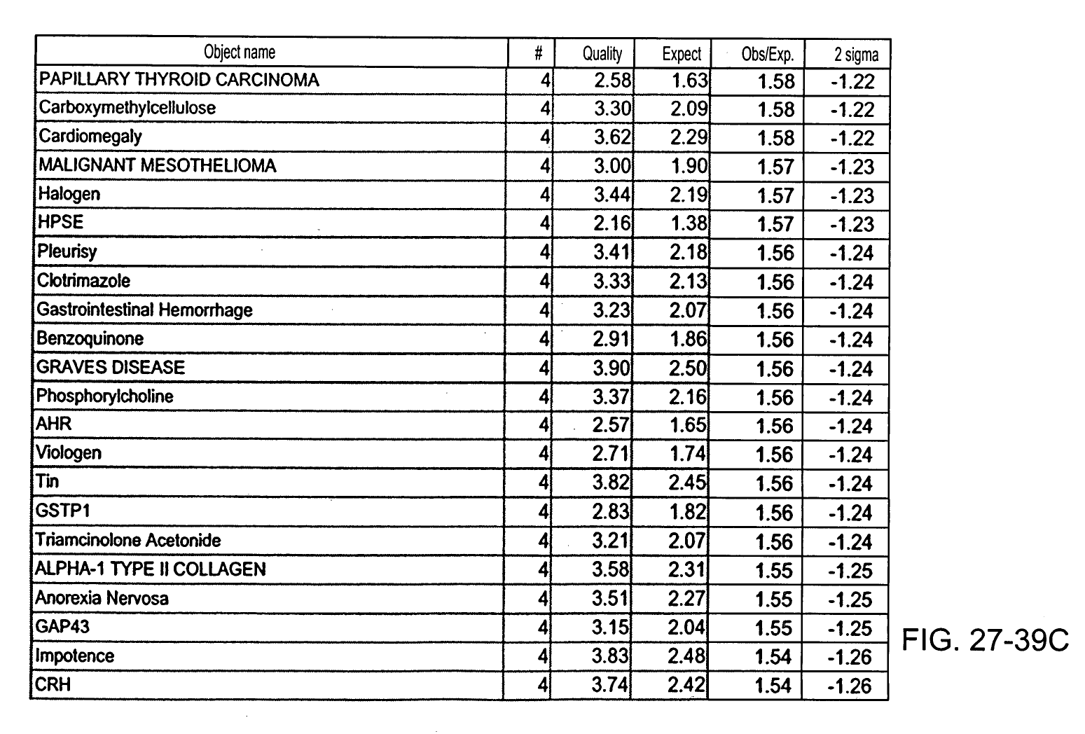

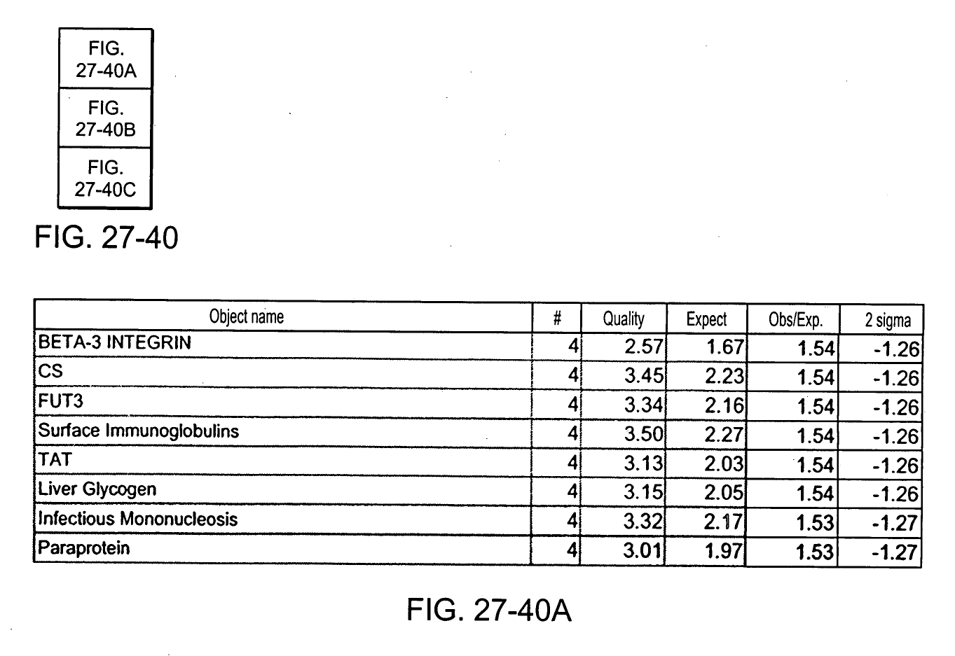

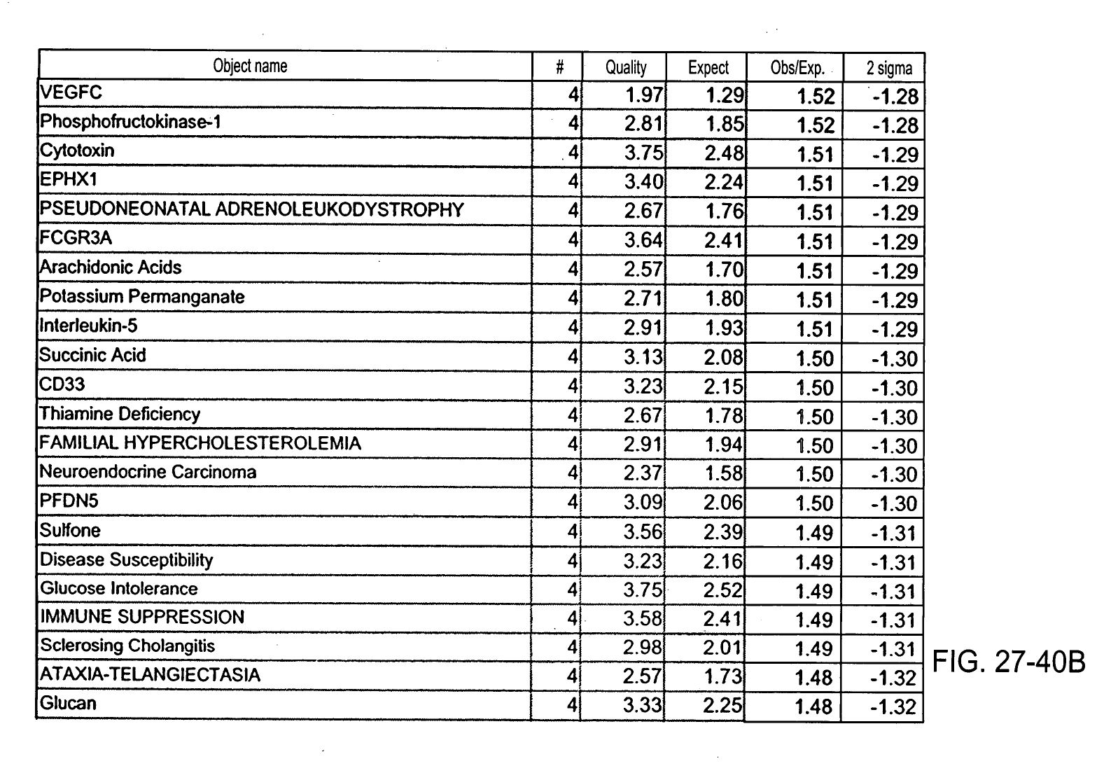

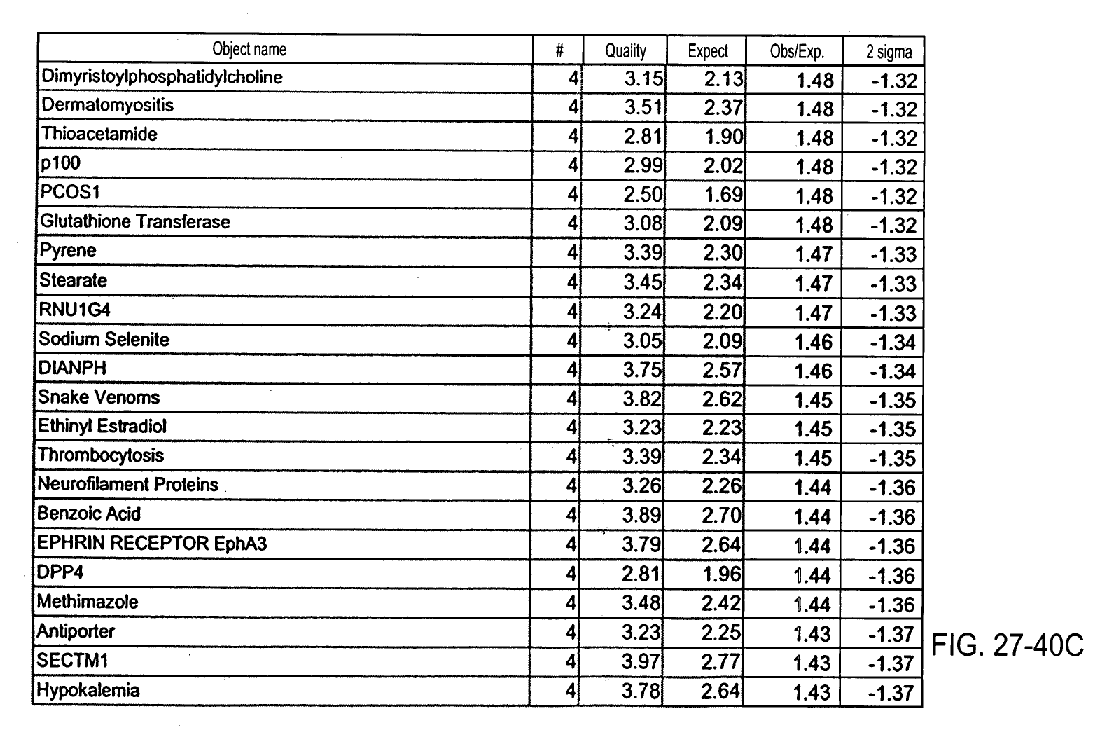

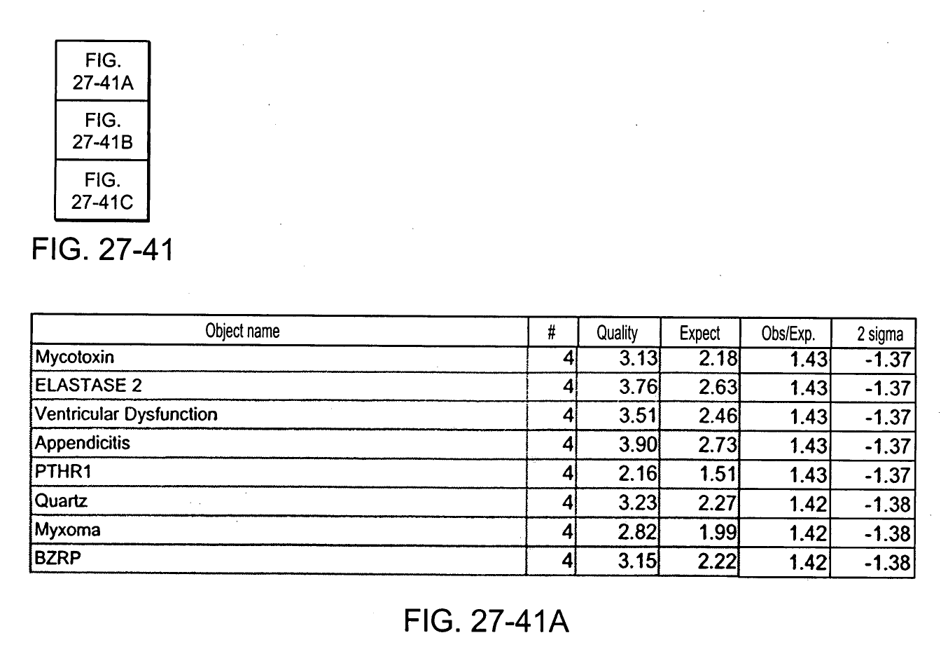

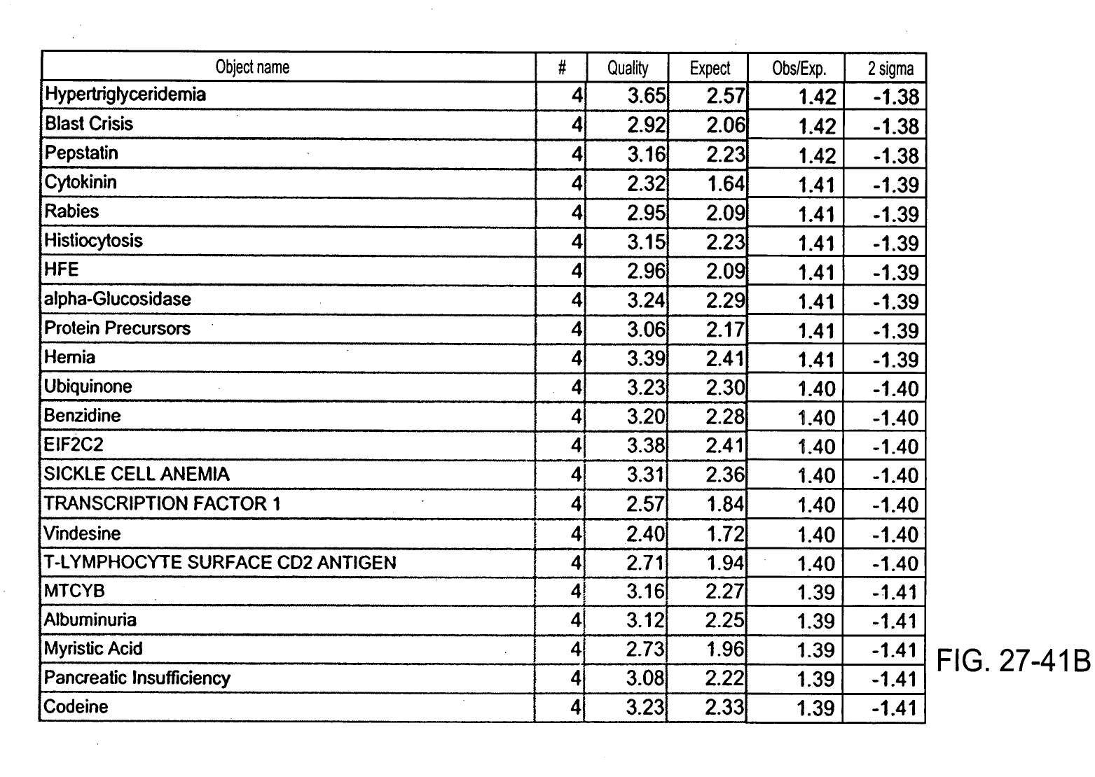

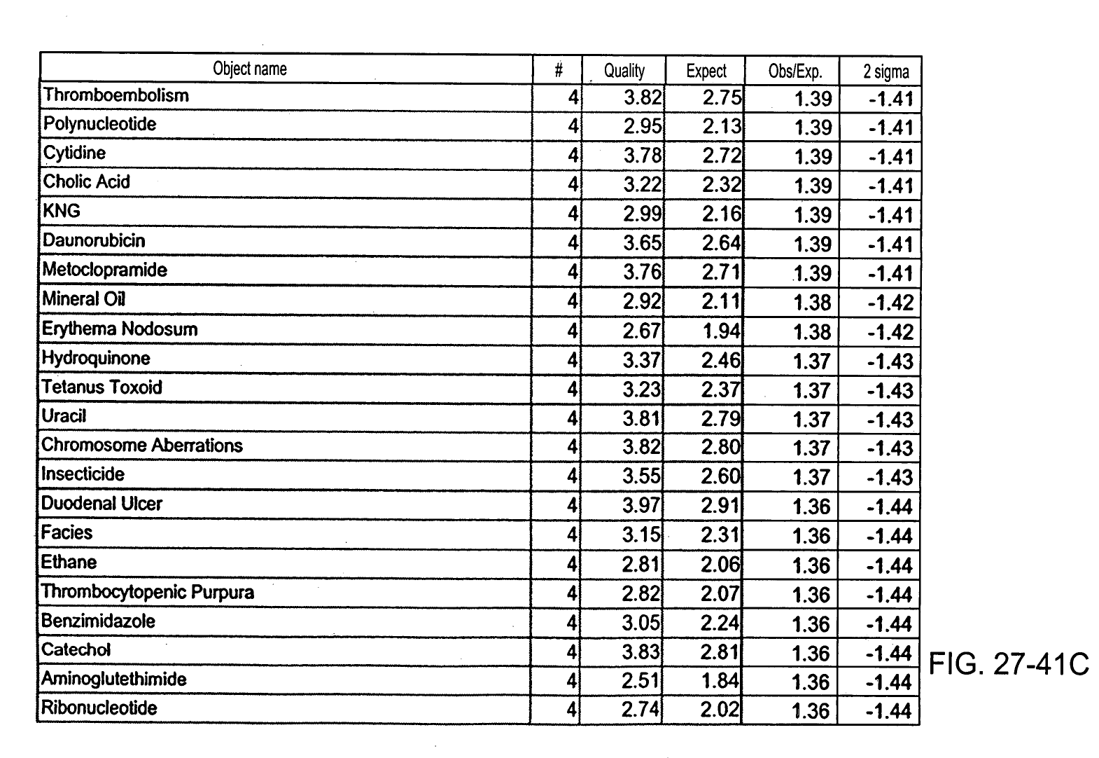

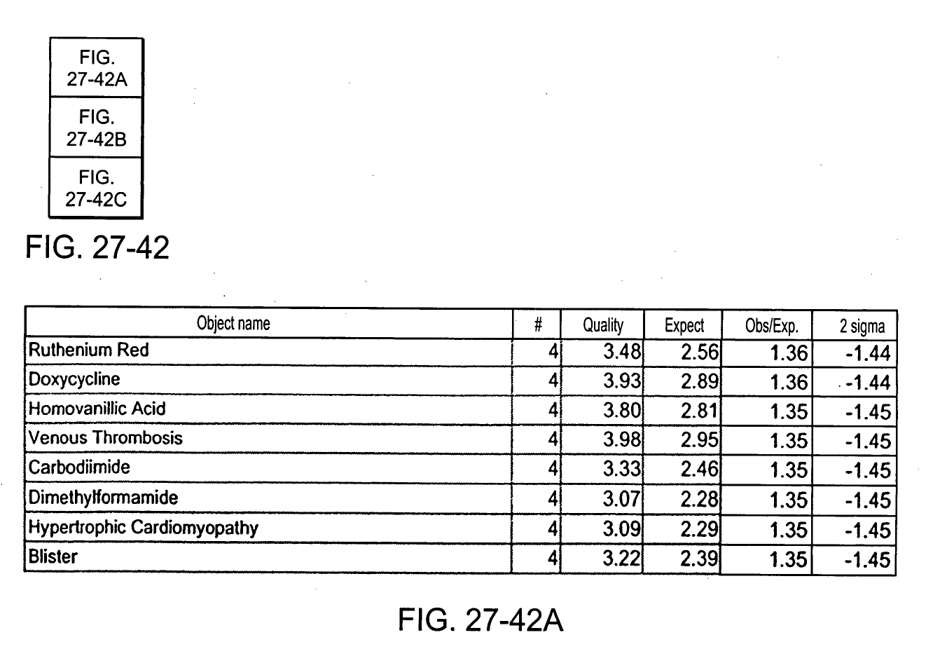

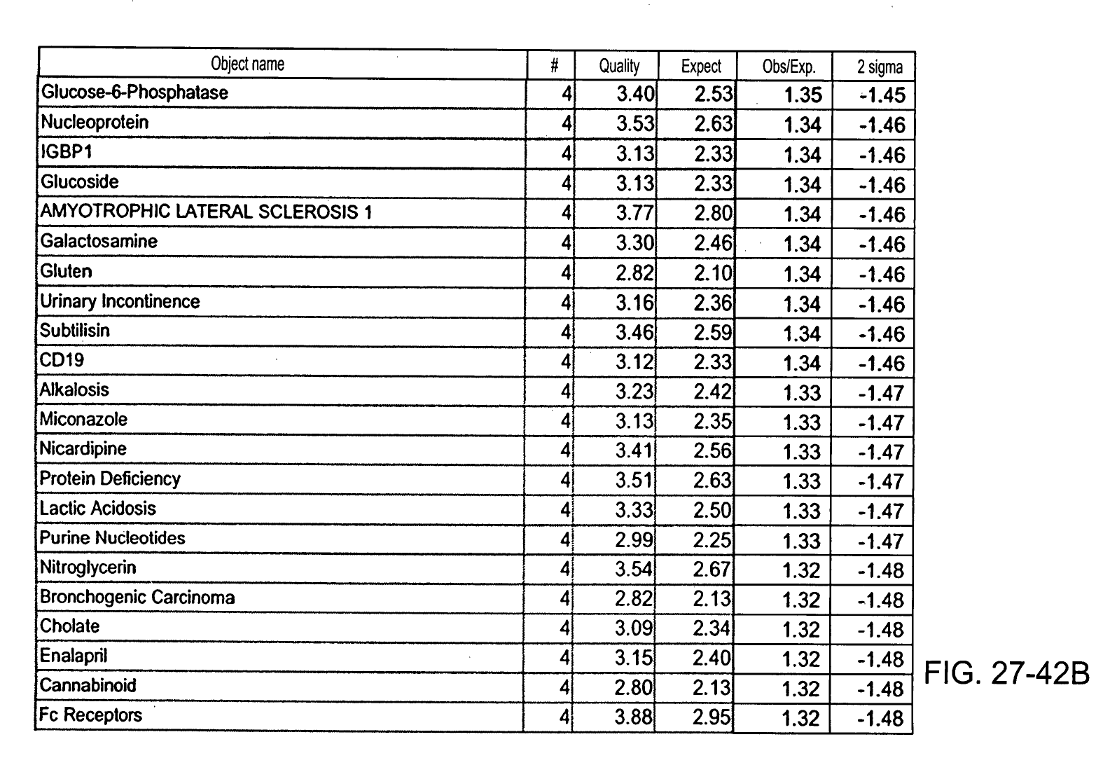

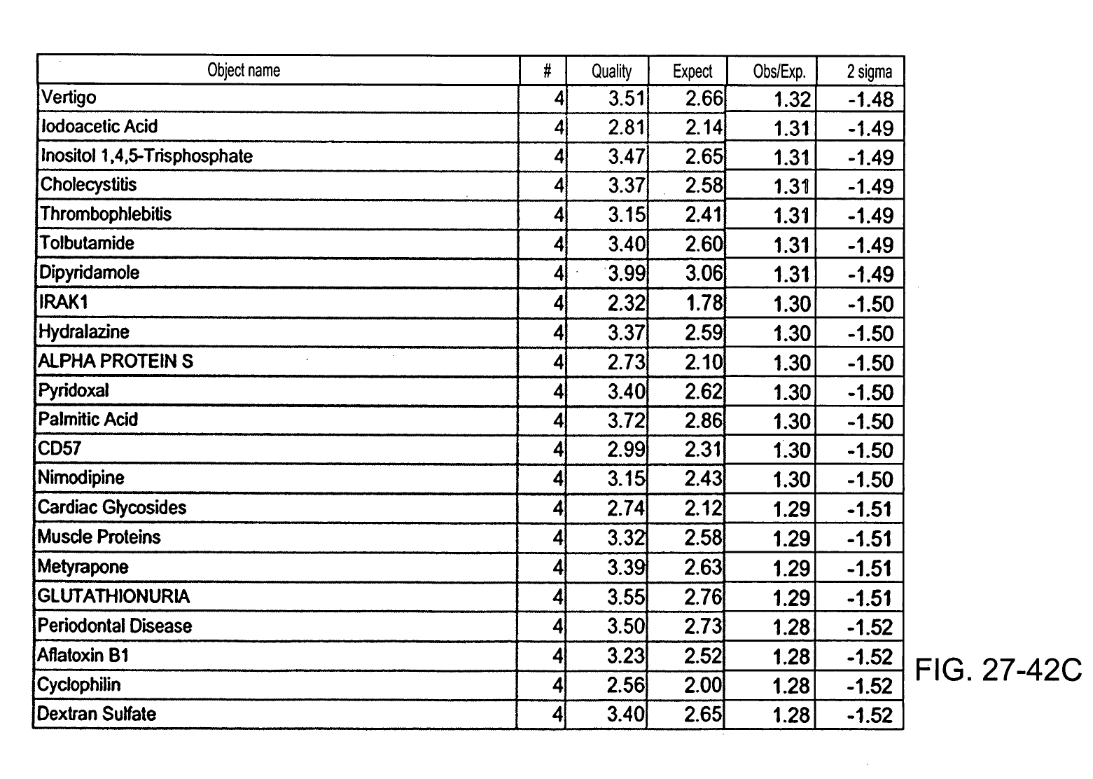

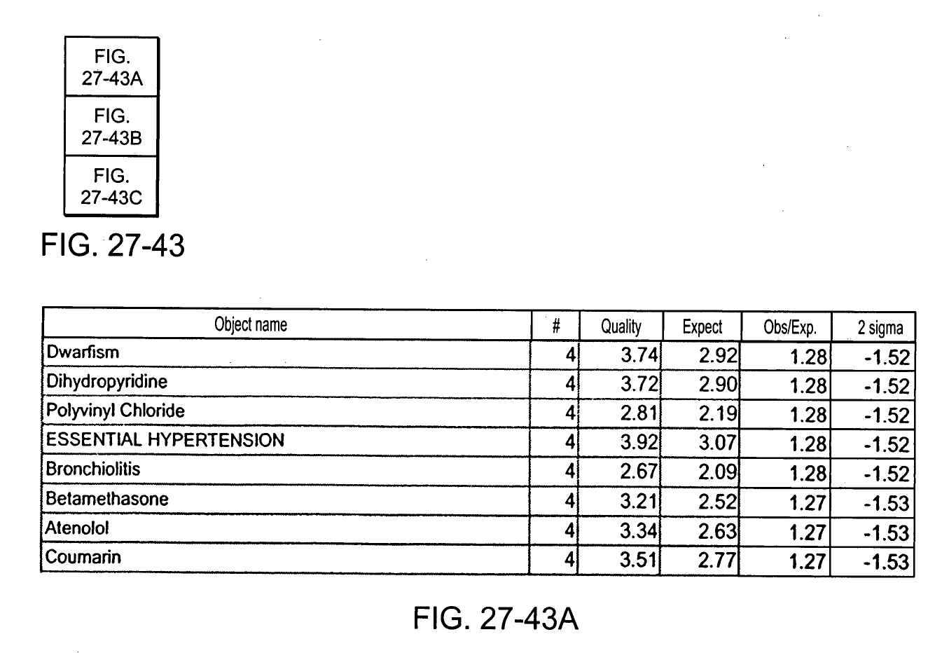

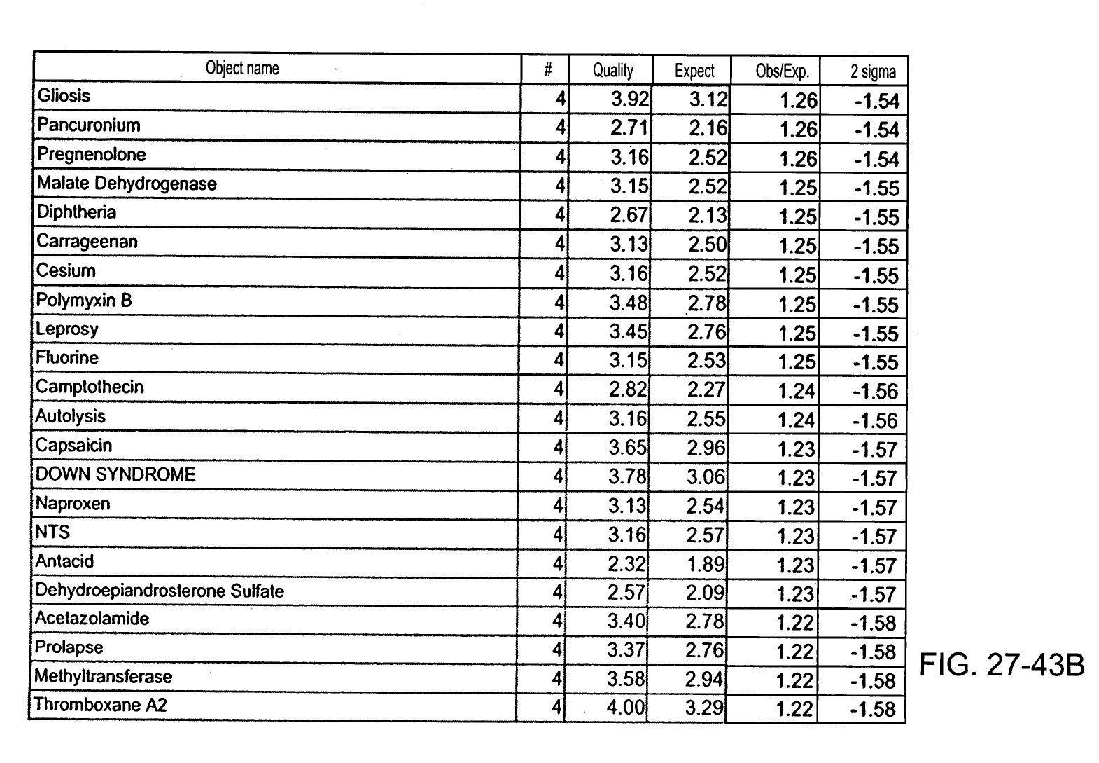

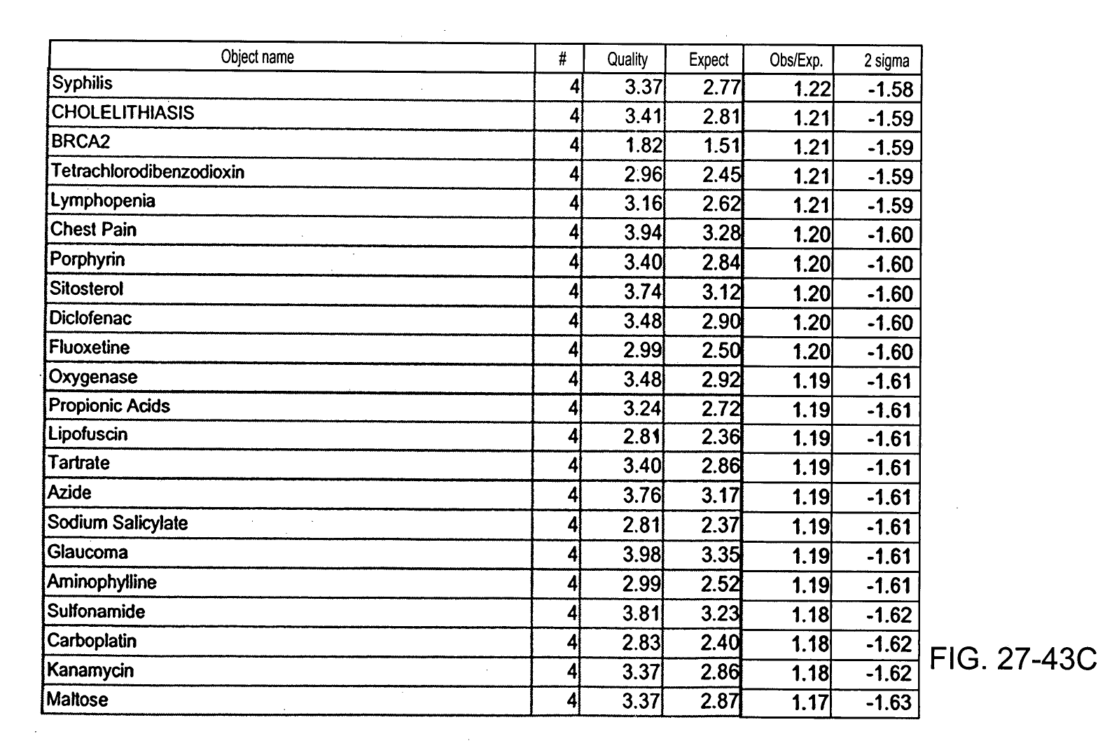

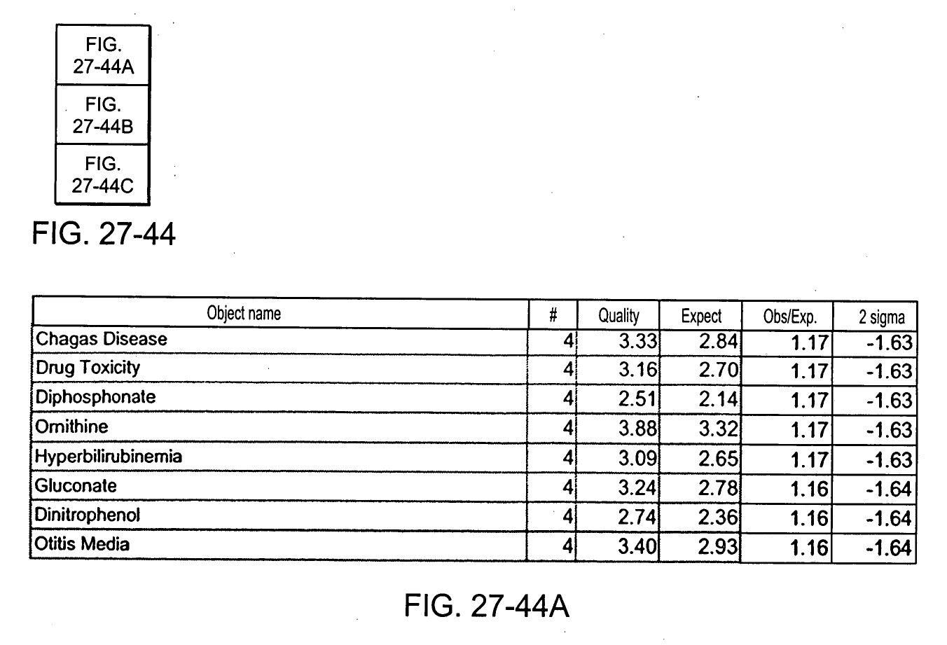

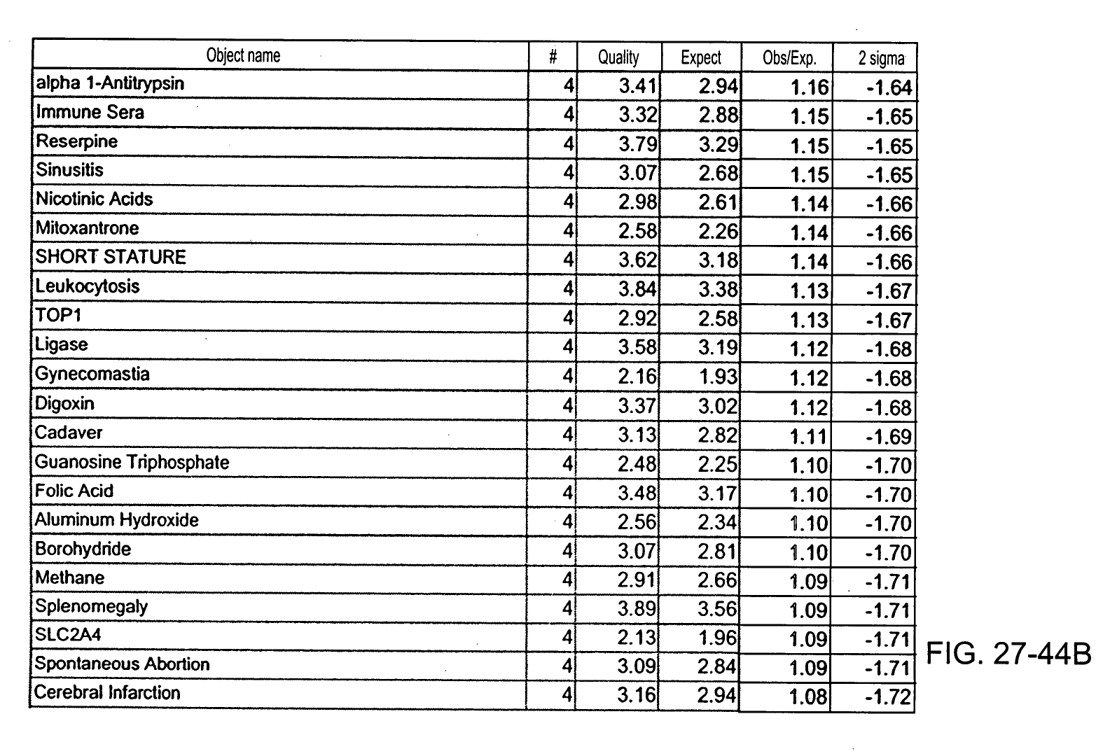

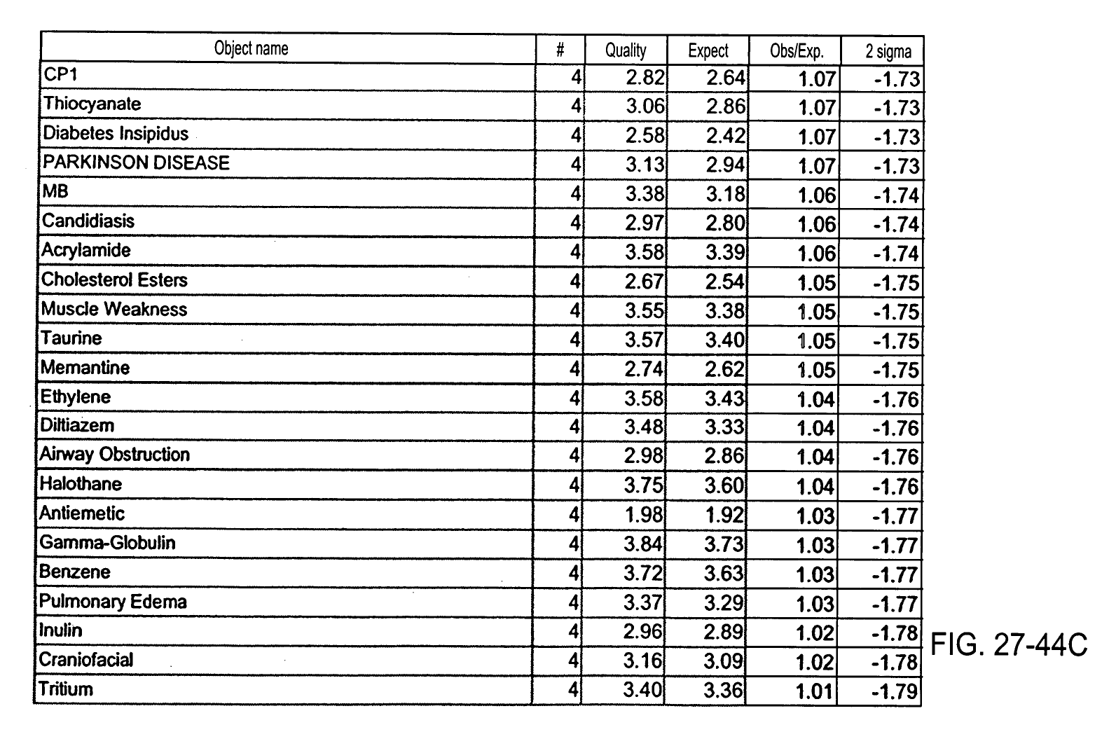

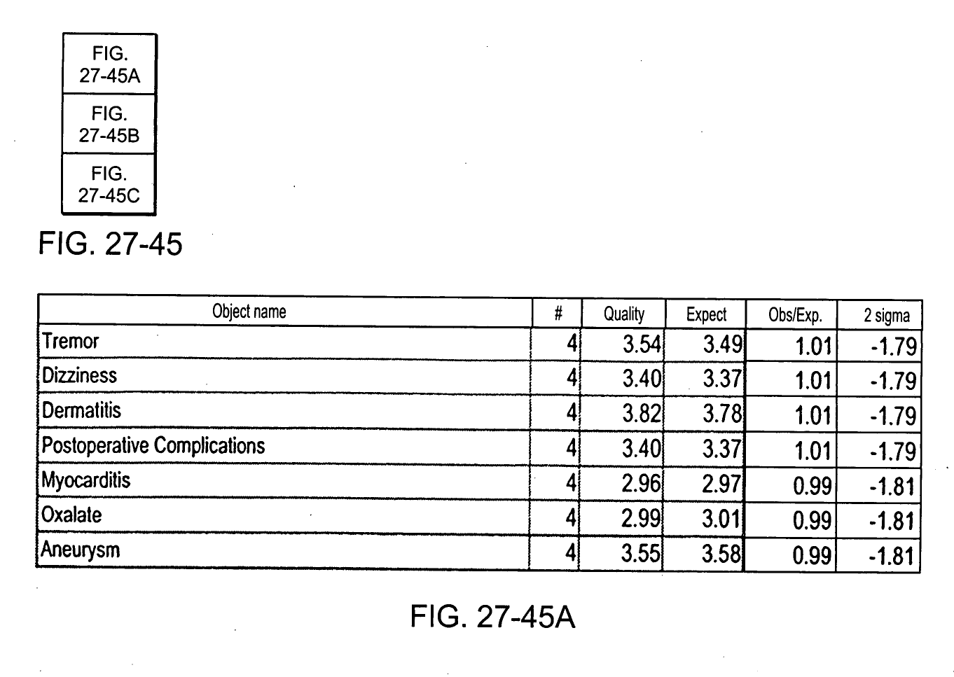

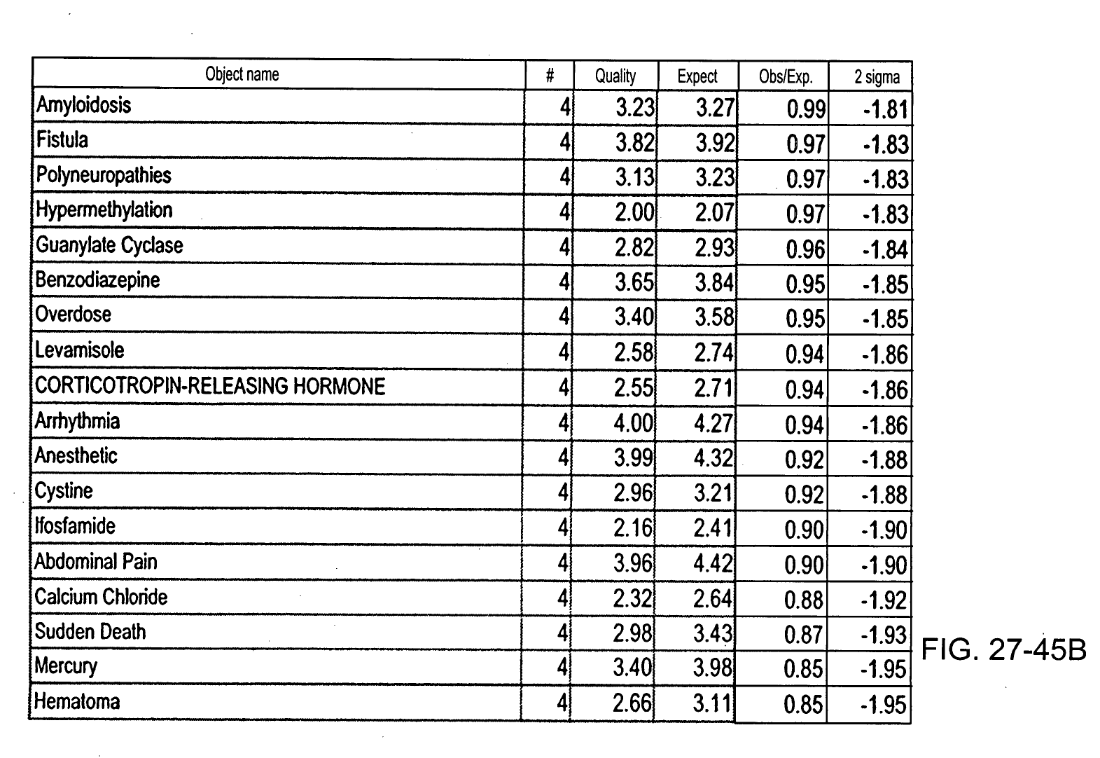

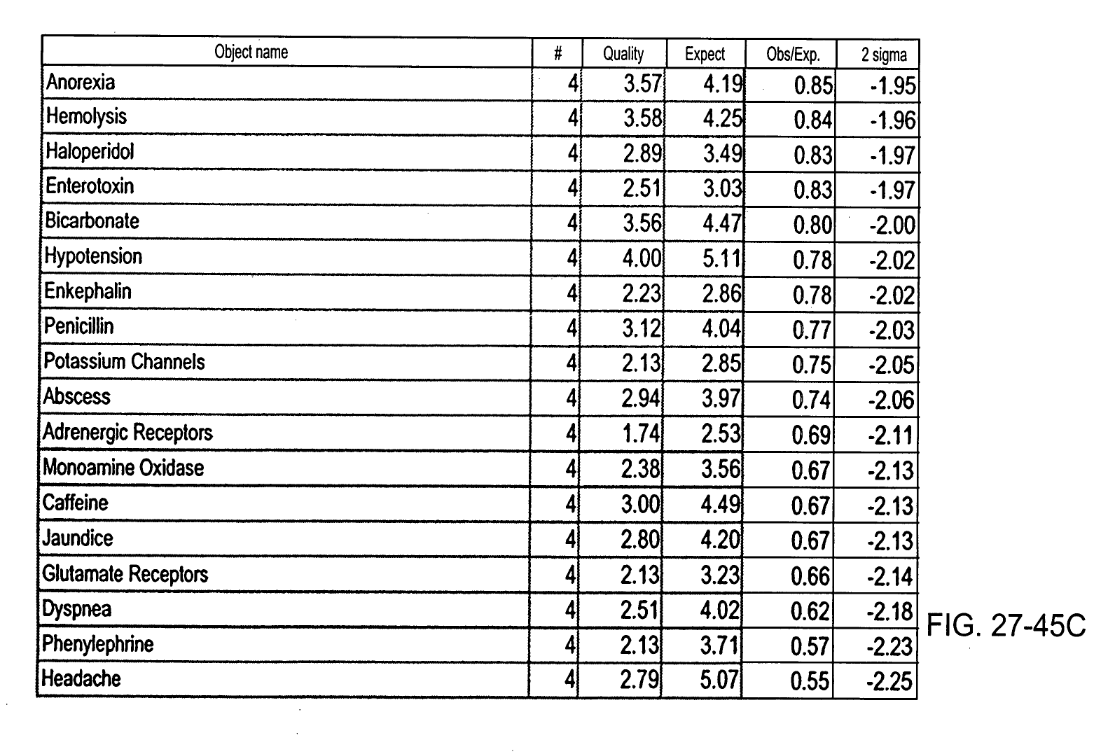

A group of genes obtained from a breast cancer microarray was obtained and processed by the system according to the invention to determine what biomedical objects the genes shared in common. This type of analysis can aid in determining what common themes or elements exist among a set of genes and draws attention to those which are particularly exceptional, which we also call a cohesion analysis. In this set, sorted by the Quality Score (the # of times the object is observed to be related to a member of the set multiplied by the overall statistical error rate for each specific observation), the system identified a number of these genes as involved in actin remodeling and initiation of transcriptional programs. See, FIG. 27. Furthermore, some of the genes have repetitive sequences, suggesting the possibility of polymorphism, and alternative splice sites, of which different splice forms could be either causal or correlative with breast cancer. The relevance of some items in the list may not be obvious, such as Methionine, which might seem to be a spurious association with a common amino acid, but metastatic breast cancer tumors are highly dependant upon this amino acid and depletion of it leads to an tumor-specific growth arrest (PMID 97194776). Some of these genes are involved in methionine metabolism/distribution and are thus candidate drug targets.

When the list is resorted by Obs/Exp ratio, the system identifies a number of genes that are related to the gene list at a rate far greater than their relative abundance in the literature, suggesting a highly relevant association. ERBB4 and 3, for example, are transmembrane tyrosine kinases that may function in growth/differentiation of normal and transformed cells and are members of the epidermal growth factor receptor (EGFR) family. If a number of these genes are associated with ERBB3/4, then it would be highly suggestive that they are also playing a role in the oncogenic transformation of breast tissue. This role may be non-transcriptional, and this is something this microarray analysis would not detect at this level of analysis. However, microarray data can be combined with data obtained from other data sources (e.g., Medline) to identify additional functional relationships.

While this invention has been described in reference to illustrative embodiments, the descriptions are not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system for data mining from one or more data sources comprising: a source of data comprising one or more domains of information;
an Object-Relationship Database comprising objects from the one or more domains of information; and
a knowledge discovery engine where relationships between two or more integrated objects are identified, retrieved, grouped, ranked, filtered and numerically evaluated.

2. The system of claim 1, wherein the source is one or more databases containing textual information.

3. The system of claim 1, wherein the source is one or more databases containing numerical information.

4. The system of claim 1, wherein the relationships between the two or more objects are identified as direct or indirect.

5. The system of claim 4, wherein the relationships between the two or more integrated objects are ranked based on the relative strength of the relationship between direct and indirect objects.

6. The system of claim 1, wherein the relationships are set into categories selected from the group consisting of positive, negative, physical and logical associations.

7. The system of claim 1, wherein the domains of information comprise parcels of data as information as text, symbol, numerals and combinations thereof.

8. The system of claim 1, wherein the system is at least partially automated.

9. The system of claim 1, wherein the knowledge discovery engine filters the two or more integrated objects by lexical processing.

10. The system of claim 1, wherein the Object-Relationship Database (ORD) is created using a method comprising the steps of:
compiling one or more data source objects;
adding the synonyms of the data source objects; and
grouping the information in the one or more data source into an object-relationship database.

11. The system of claim 10, further comprising a database of lexical variants from a data source.

12. The system of claim 11, wherein the system further comprises a program for scanning the object-relationship database with the database of lexical variants to add synonyms;

13. The system of claim 12, wherein the system comprises a program for checking the object-relationship database for errors.

14. The system of claim 10, wherein the ORD creation method further comprises the step of increasing processing efficiency by assigning each database object a unique numeric ID and storing adirectional relationships by lowest ID first.

15. The system of claim 1, wherein an object is retrieved from unstructured text, structured data, a list, a table, a phrase, a paragraph, an abstract, a program, a manual, a text book, a reference book, treatise, a lab notebook, a letter, a memo, an email, a table of contents, index, a magazine, an article, scientific literature, a patent, a patent application, an international application, a webpage, a spreadsheet, a URL, or relational database, and combinations thereof.

16. The system of claim 15, wherein the object is selected from the group consisting of from the group consisting of gene, protein, chemical compound, small molecule, drugs, diseases, clinical phenotype, and other identifiers selected from the group consisting of ChemID, MeSH, FDA, locuslink, GDB, HGNC, MeSH, Medline, Snowmed, and OMIM.

17. The system of claim 10, wherein the ORD creation method further comprises the step of screening out common words.

18. The system of claim 10, wherein the ORD further comprises the step of identifying capitalizations and patterns for words by accessing a word database.

19. The system of claim 11, wherein the step of constructing lexical variants further comprises using a synonym database.

20. The system of claim 10, wherein the step of constructing lexical variants further comprises using an acronym-resolving algorithm.

21. The system of claim 1, further comprising a graphical user interface for displaying one or more objects.

22. The system of claim 21, wherein the interface comprise a control element, which can be clicked to display the integrated object derived from the context of the source data.

23. The system of claim 1, wherein a portion of the Object-Relationship Database is constructed using a method comprising the steps of:
inputting a block of text from the source of data;
extracting information from the source to create a record and
creating one or more arrays to match words in the record against phrases in the object-relationship database.

24. The system of claim 23, wherein the method further comprises resolving acronyms.

25. The system of claim 23 or 24, wherein the method further comprises parsing the record into sentences and parsing each sentence into words.

26. The system of claim 23, wherein the information comprises title, abstract, date, and PMID fields.

27. The system of claim 22, wherein the block of text is selected from the group consisting of a list, a table, a phrase, a paragraph, an abstract, a program, a manual, a text book, a reference book, a lab notebook, a letter, a memo, an email, a table of contents, a magazine, an article, scientific literature, a patent, a patent application, an international application, a webpage, a spreadsheet, a URL, or relational database, and combinations thereof.

28. The system of claim 27, wherein the block of text is selected from the Physician's Desk Reference.

29. The system of claim 23, wherein the block of text is given a higher value if the source of the information is considered to have a higher impact than other like sources according to selected criteria for impact.

30. A system for relating objects comprising:
an object-relationship database generated from a data source comprising one or more domains of information; and
a knowledge discovery engine that recognizes relationships between objects in a data source, wherein the knowledge discovery engine identifies a one or more cooccurrences of objects within the data source, and identifies implicit relationships between the objects.

31. The system of claim 30, wherein the knowledge discovery engine generates a comprehensive network of relationships.

32. The system of claim 31, wherein the knowledge discovery network generates a partial network of relationships.

33. The system of claim 30, wherein the relationships idenfied are stored in a system database and the system further includes a query module that allows a user to access information about the implicit relationships.

34. The system of claim 30, wherein the knowledge discovery engine evaluates relationships using one or more statistically bounded network models.

35. A system for identifying a new indication for a drug comprising:
an object-relationship database generated from a data source comprising one or more domains of information including information relating to the drug; and
a knowledge discovery engine that recognizes meaningful relationships in a data source for the drug, wherein the knowledge discovery engine identifies one or more co-occurrences of objects within the data source and the drug, and
generates a comprehensive network of relationships between objects in the object-relationship database and the drug, wherein at least one relationship identifies a new indication for the drug.

36. The system of claim 35, wherein the knowledge discovery engine evaluates relationships using one or more statistically bounded network models.

37. The system of claim 35, wherein the system further stores shared and implicit relationships in a results database.

38. A system for identifying a contraindication and/or side-effect for a drug comprising:
an object-relationship database generated from a data source comprising one or more domains of information including information relating to the drug; and
a knowledge discovery engine that recognizes meaningful relationships in the object relationship database, wherein the knowledge discovery engine identifies one or more cooccurrences of objects and a drug in a data source, identifies shared and implicit relationships between objects and the drug, and identifies the likelihood that one or more of the relationships indicates one or more contraindications and/or side-effect of the drug.

39. The system of claim 38, wherein the knowledge discovery engine generates a comprehensive network of relationships between data in the data source and the drugs, and stores the shared and implicit relationships evaluated by one or more statistically bounded network models.

40. A system for identifying interactions between at least two drugs comprising:
an object-relationship database generated from a data source comprising one or more domains of information including information relating to the at least two drugs; and
a knowledge discovery engine that recognizes meaningful relationships in the object relationship database, wherein the knowledge discovery engine identifies one or more cooccurrences of objects and drugs in the data source, identifies shared and implicit relationships between objects and the drugs, and identifies the likelihood that co-occurrence of the one or more objects with the at least two drugs indicates an interaction between the at least two drugs. Could also be two genes or a drug and a gene, ie other relationships of value.

41. The system of claim 40, wherein the knowledge discovery engine generates a comprehensive network of relationships between data in the data source and the drugs and stores the shared and implicit relationships evaluated by one or more statistically bounded network models.

42. A system for identifying relationships between a chemical compound or biomolecule and a disease comprising:
an object-relationship database generated from a data source comprising one or more domains of information including information relating to the disease and a chemical compound or biomolecule; and
a knowledge discovery engine that recognizes meaningful relationships in the data source for the disease, wherein the knowledge discovery engine: identifies one or more co-occurrences of objects, the disease and/or the chemical compound or biomolecule within the data source, and identifies shared and implicit relationships between the chemical compound or biomolecule and the disease.

43. The system of claim 42, wherein the knowledge discovery engine generates a comprehensive network of relationships between data in the object-relationship database and the disease and stores the shared and implicit relationships evaluated by one or more statistically bounded network models.

44. The sysetm of claim 42, wherein the biomolecule is a nucleic acid or protein.

45. The system of any of claims 1, 30, 35, 38, 40 or 42, further comprising a scanning module comprising a scanner for scanning printed information and generating a data source from the printed information.

46. The system of any of claims 1, 30, 35, 38, 40 or 42, wherein the system comprises a processor for executing the functions of the knowledge engine.

47. The system of claim 46, further comprising a computer readable medium for storing the object-relationship database.

48. The system of claim 47, further comprising a client/server architecture wherein at least two functions of the system are distributed in a server and at least one client computer connectable to the network.

49. The system of claim 48, wherein the system comprises a program for accessing one or more data sources.

50. The system of claim 48, wherein the object relationship database is dynamic, and adds new objects from the one or more data sources to the database.

51. The system of claim 50, wherein the system recomputes an object network when new objects are added from the one or more data sources.

52. The system of claim 51, wherein the system further comprises an engine for monitoring recomputation results; and wherein the system re-evaluates relationships between objects.

53. The system of claim 48, wherein the database is downloadable to the at least one client computer.

54. The system of claim 48, wherein the database (network) is stored in memory of the server computer and the at least one client can access the database by communicating with the server.

55. The system of any of claims 1, 30, 35, 38, 40 or 42, wherein the system further comprises a results and analysis database, wherein the results and analysis database comprises:information relating to a query regarding an object relationship and results of the query.

56. The system of claim 55, wherein the results and analysis database further comprises a record of comprising information relating to an interpretation of the results.

57. The system of claim 55, wherein the results and analysis database further comprises data validating the results.

58. The system of any of claims 1, 30, 35, 38, 40 or 42, wherein the system further comprises an application program for executing a computer code comprising instructions for ranking relationships.

59. The system of claim 58, wherein the computer code includes instructions for a system processor to generate a linear or nonlinear gouping of individual ranking factors.

60. The system of claim 59, wherein each individual ranking factor is associated with a coefficient that weights each term.

61. The system of claim 60, wherein weight is determined by one or more of the following factors: the source of the data source; the date on which the data source was published; the ratio of the observed frequency of co-occurrence of objects to the expected frequency of co-occurrence of objects; the name of the author associated with the data source; the name of the institution associated with the data source; and the frequency of co-occurrence of objects in different data sources.

62. A method for data mining from a data source comprising one or more domains of knowledge comprising the steps of:
obtaining or accessing a data source;
generating an Object-Relationship Database comprising objects from the data source data; and
identifying the strength of direct and implicit relationships in the Object-Relationship database.

63. The method of claim 62, wherein data in the data source source is searched for co-occurrences of objects in the source of data, and objects are retrieved from the data source for storing in the Object-Relationship database based on the co-occurences.

64. The method of claim 61, wherein the data is selected from the group consisting of unstructured text, structured data, a list, a table, a phrase, a paragraph, an abstract, a program, a manual, a text book, a reference book, treatise, a lab notebook, a letter, a memo, an email, a table of contents, index, a magazine, an article, scientific literature, a patent, a patent application, an international application, a webpage, a spreadsheet, a URL, or relational database, and combinations thereof.

65. The method of claim 63 wherein relationships are ranked according to their strength.

66. The method of claim 63, wherein strength is determined by one or more of the following factors: the source of the data source; the date on which the data source was published; the ratio of the observed frequency of co-occurrence of objects to the expected frequency of co-occurrence of objects; the name of the author associated with the data source; the name of the institution associated with the data source; and the frequency of co-occurrence of objects in different data sources.

67. A method for relating objects comprising the steps of:
generating an object-relationship database generated from a data source comprising one or more data sources, or accessing the object-relationship database; and
identifying implicit relationships between objects using a knowledge discovery engine; and
determining the strength of the relationships.

68. The method of claim 61, wherein the frequency of co-occurrences of objects within the datasource is determined.

69. The method of claim 61, wherein the knowledge discovery engine generates a comprehensive network of relationships to identify the implicit relationships.

70. The method of claim 67, wherein the strength of the relationships are evaluated using one or more statistical bounded network models.

71. A method for identifying a new indication for a drug comprising:
obtaining or accessing an object-relationship database generated from a data source which includes information relating to the drug; and
processing information in the object-relationship database with a knowledge discovery engine that recognizes meaningful relationships, by identifying one or more co-occurrences of objects from the data source; generating a comprehensive network of relationships between objects in the object-relationship database and the drug to identify implicit relationships between the object and the drug, wherein at least one relationship identifies a new indication for the drug.

72. The method of claim 71, further comprising storing shared relationships evaluated by one or more statistical bounded network models.

73. A method for identifying a contraindication or side-effect for a drug comprising:
obtaining or accessing an object-relationship database generated from a data source comprising one or more domains of information including information relating to the drug; and
processing information in the object-relationship database with a knowledge discovery engine that recognizes meaningful relationships in the object relationship database, wherein the knowledge discovery engine identifies one or more cooccurrences of objects and a drug in a data source, identifies shared and implicit relationships between objects and the drug, and identifies the likelihood that one or more of the relationships indicates one or more contraindications and/or side-effects of the drug.

74. A method for identifying interactions between at least two drugs comprising:
obtaining or accessing an object-relationship database generated from a data source comprising one or more domains of information including information relating to the at least two drugs; and
processing information in the object-relationship database with a knowledge discovery engine that recognizes meaningful relationships in the object relationship database, wherein the knowledge discovery engine identifies one or more cooccurrences of objects and drugs in the data source, identifies shared and implicit relationships between objects and the drugs, and identifies the likelihood that co-occurrence of the one or more objects with the at least two drugs indicates an interaction between the at least two drugs.

75. A method for identifying relationships between a chemical compound or a biomolecule and a disease comprising:
obtaining an object-relationship database generated from a data source comprising one or more domains of information; and
processing information in the object-relationship database using a knowledge discovery engine wherein the knowledge discovery engine: identifies one or more co-occurrences of objects, the disease and/or the chemical compound or biomolecule within the data source, and identifies shared and implicit relationships between the chemical compound or biomolecule and the disease.

76. A method for creating an Object-Relationship Database (ORD) comprising the steps of:
compiling one or more objects from one or more data sources
grouping the information in the one or more data sources into an object-relationship database;
constructing a database of lexical variants from one or more data sources;
comparing the database of lexical variants to objects in the Object-Relationship Database;
scanning the object-relationship database with the database of lexical variants to add synonyms
assigning each object a unique numeric ID and storing adirectional relationships by lowest ID first; and
checking the object-relationship database for errors.

77. The method of claim 76, wherein the data sources used to compile the database objects are selected from the group consisting of chemical compounds, small molecules, diseases, phenotypes, genes, proteins, clinical data, drugs, identifiers from ChemID, identifiers from MeSH, identifiers from FDA, identifiers from locuslink, identifiers from GDB, identifiers from HGNC, identifiers from MeSH, identifiers from OMIM.

78. The method of claim 76, wherein the data sources to compile the database objects include a list, a table, a phrase, a paragraph, an abstract, a program, a manual, a text book, a reference book, a lab notebook, a letter, a memo, an email, a table of contents, a magazine, an article, scientific literature, a patent, a patent application, an international application, a webpage, a spreadsheet, a URL, or relational database, and combinations thereof.

79. The method of claim 76, wherein one or more data sources or portions of one or more data sources are scanned to extract new objects.

80. The method of claim 76, wherein the extracting step comprises selecting objects in the context of data from one or more data sources or portions thereof and determining whether the object is included in the Object-Relationship Database.

81. The method of claim 80, wherein if the object is not included, it is stored in Object-Relationship Database.

82. The method of claim 80, wherein information relating to whether objects are included in the Object-Relationship Database is displayed on a graphical user interface.

83. The method of claim 82, wherein the data scanned and selected is also displayed on the graphical user interface.

84. The method of claim 76, wherein an object in the object relationship database is text, a number or symbol.

85. The method of claim 76, further comprising the step of filtering the objectrelationship database for ambiguous acronyms using a word database.

86. The method of claim 76, further comprising the step of identifying lexical variants using a synonym database.

87. The method of claim 76 or 85, further comprising the step of identifying lexical variants using an acronym-resolving algorithm.

88. The method of claim 76, further comprising the step of providing the object in the context of the text from the source of data in the database.

89. The method of claim 76, furhter comprising the step of reducing redundancies in the data source.

90. The method of claim 89, wherein the method of reducing redundancies comprises the steps of:
inputting a block of text from a source;
extracting information from the source to create a record;
parsing the record into sentences; parsing each sentence into words;
creating one or more arrays to match words against phrases in the object-relationship database;
flagging acronyms; and
storing the acronyms in the database of lexical variants.

91. A method for identifying novel correlative relationships comprising the steps of: identifying one or more topical clusters from a data source;
compiling a database of objects from one or more topical clusters;
refining the database of objects to reduce redundancies;
scanning the topical set from the data source for co-occurring objects;
identifying co-occurring objects as relationships;
analyzing the identified relationships for statistical relevance with respect to one or more objects;
creating one or more relationship databases; and
storing the relationships and relationship databases.

92. The method of claim 91, wherein the step of compiling the database of objects further comprises the steps of:
creating fields of interest that are grouped together;
identifying databases that house similar groups of information;
preprocessing the database entries into pre-defined formats;
resolving the entries; and
checking for errors to remove uninteresting entries based on a pre-selected criteria.

93. The method of claim 91, wherein the step of refining the database of objects further comprises the step of flagging ambiguous acronyms using a word database for lexical variants.

94. The method of claim 91, wherein the step of refining the database of objects further comprises the step of scanning a source for the existence of co-occurring objects to reduce redundancies and create relationships, which comprises the steps of:
inputting a block of text from the source;
extracting data from the block of text;
parsing the data into sentences;
parsing each sentence into words;
putting the words into one or more arrays;
matching the object database for matches against the words from any array; and
determining whether there is a match between the object database and the words from the array.

95. The method of 94, wherein the step of identifying relationships within the relationship database comprises the steps of:
assigning each object a unique numeric ID; and
storing adirectional relationships by lowest ID first.

96. The method of claim 94, wherein the step of identifying relationships within the relationship database comprises the steps of:
identifying shared relationships after a user inputs one or more lists of objects for analysis;
compiling all from the one or more lists all the relationships for each object into a single list;
counting related objects by frequency; and
calculating an expectation value.

97. The method of claim 85, 1further comprising the steps of:
excluding shared objects with less than an x% of the total possible connection or less than a y% of the observed/expected ratio;
identifying implicitly related objects for each shared relationship; and
scoring implicitly related objects by direct observed/expected ratio times the number of unique paths to the implicit object.

98. The method of claim 97, wherein the user varies the x% of the total possible connection to vary the score of implicit relationships.

99. The method of claim 97, wherein the user varies the y% of the observed/expected ratio to vary the score of implicit relationships.

100. The method of claim 97, wherein the correlative relationship is between a drug, chemical compound, small molecule, phenotype, disease, gene, genotype and combinations thereof

101. A method of evaluating direct relationships between one or more objects comprising the steps of:
computing an association strength vector between one or more first, second and third objects;
obtaining a source impact score from a database of source impact scores for the one or more objects for the first, second or third objects; and
multiplying the strength vector by the source impact score for one or more of the first, second or third objects.

102. The method of claim 101, wherein the source impact score is based on the publication from which the one or more objects were obtained.

103. The method of claim 101, wherein the source impact score is based on the number of times the source of the one or more objects were cited by another source. 103. The method of claim 101, wherein the source impact score is based on the number of times the source of the one or more objects were cited by a treatise.

104. The method of claim 101, wherein the source impact score is based on the number of times the source of the one or more objects were cited in one or more textbooks.

105. The method of claim 101, wherein the source impact score is based on the number of times the source of the one or more objects were cited in a review article.

106. The method of claim 101, wherein the source impact score is given a score based on its estimated importance and relevance.

107. The method of claim 101, wherein the source impact score is given a score based on the number of times the source of the one or more objects were published in a peer reviewed journal.

108. The method of claim 101, wherein a higher impact score implies higher importance and relevance.

109. A computer program embodied on a computer readable medium for accessing domains of information comprising:
a code segment adapted to contain a source of data comprising one or more domains of information;
a code segment adapted to maintain an Object-Relationship Database; and
a code segment adapted to contain a knowledge discovery engine where relationships between two or more objects are searched, grouped, ranked, filtered, and retrieved.

110. A computer program embodied on a computer readable medium for creating an Object-Relationship Database (ORD) comprising:
a code segment adapted to compile one or more database objects;
a code segment adapted to group the information in the one or more databases into an object-relationship database;
a code segment adapted to construct a database of lexical variants from one or more databases;
a code segment adapted to scan the object-relationship database with the database of lexical variants to add synonyms; and
a code segment adapted to assign each object a unique numeric ID and storing adirectional relationships by lowest ID first; and
a code segment adapted to check the object-relationship database for errors.

111. A data structure comprising a plurality of candidate compounds for new drug therapy generated by a method comprising the steps of:
accessing a source of data comprising one or more domains of information;
compiling the domains of information into an Object-Relationship Database for integrating objects from the one or more domains of information; and
using a knowledge discovery engine where relationships between two or more integrated objects are identified, retrieved, grouped, ranked, filtered and numerically evaluated.

112. A data structure comprising a plurality of candidate compounds for evaluation generated by a method comprising the steps of:
obtaining an object-relationship database generated from a data source comprising one or more databases of information; and
processing one or more objects using a knowledge discovery engine to recognize meaningful relationships from a data source comprising the steps of:
identifying one or more co-occurrences of objects from the data source; generating a comprehensive network of relationships; and
storing the shared relationships evaluated by one or more statistical bounded network models, wherein a query is performed on the shared relationships to identify novel relationships from the comprehensive network of relationships.

113. A system for identifying a previously unidentified use for a compound comprising the steps of:
obtaining an object-relationship database generated from a data source comprising one or more domains of information including information relating to the compound; and
processing the information in the data source using a knowledge discovery engine thatrecognizes meaningful relationships between a drug and one or more objects by identifying one or more co-occurrences of objects in a data source; generating a comprehensive network of relationships; and
storing the shared relationships evaluated by one or more statistical bounded network models.

114. A method of treating cardiac hypertrophy comprising the steps of:
identifying a patient in need of therapy for cardiac hypertrophy; and
providing the patient with a pharmaceutically effective amount of a compound identified using the system of claim 1 using a query comprising the term cardiac hypertrophy.

115. A method of treating cardiac hypertrophy comprising the steps of:
providing a patient in need of the treatment with a therapeutically effective amount of a Chlorpromazine.

116. A method of treating cardiac hypertrophy comprising the steps of:
providing a patient in need of the treatment with therapeutically effective amount of a Chlorpromazine.

117. A method of treating cardiac hypertrophy comprising the steps of: providing a patient in need of the treatment with a therapeutically effective amount of a compound (make another claim for groups of compounds that would be used together in a combination therapy) selected from the group consisting of: compound selected from the group consisting of: Naloxone, Naltrexone, Triiodothyronine, Clonidine, Estrogen, Tamoxifen, Colchicine, Bradykinin, Omapatrilat, Apstatin, COX-2 selective inhibitor, 5-LOX inhibitor, Thromboxane A2 Receptor Antagonist, Melatonin, Morphine, Warfarin/Heparin, Cortisol, and Methionine.

118. A method for treating of non-insulin dependent diabetes mellitus (NIDDM) comprising the steps of:
identifying a patient in need of therapy for NIDDM; and
providing the patient with a therapeutically effective amount of a compound identified using the system of claim 1.

119. A method for treating of non-insulin dependent diabetes mellitus (NIDDM) comprising the steps of:
administering to a patient in need of therapy for NIDDM; a therapeutically effective amount of a compound that increases the methylation of cellular nucleic acids.

120. A method for treating of non-insulin dependent diabetes mellitus (NIDDM) comprising the steps of:
adminstering to a patient in need of therapy for NIDDM, a therapeutically effective amount of DNA methylation precursors.

121. A nutritional supplement for an individual at risk for of non-insulin dependent diabetes mellitus (NIDDM) comprising:
one or more DNA methylation precursors at an amount effective to normalize the level of DNA methylation.

122. A method for treating migraine headaches comprising the steps of:
identifying a patient in need of therapy for a migraine headache; and providing the patient with a therapeutically effective amount of sildenafil.

123. A method for treating muscular spasms comprising the steps of:
identifying a patient in need of therapy for a muscular spasm; and
providing the patient with a therapeutically effective amount of sildenafil.

124. A system for automated screening comprising:
a system as described in claim 1, wherein the object relationship database includes objects which are nucleic acid or protein sequences or identifiers of such sequences;
an oligonucleotide selection module that selects nucleic acid sequences based on relationships between objects and genes corresponding to the nucleic acid and/or protein sequences and/or identifiers of the sequences, using the knowledge engine and provides instructions to a DNA-on-chip assembly apparatus to immobilize the selected nucleic acid sequences on a solid support.

125. The system of claim 124, wherein the instructions are provided to the apparatus via a user of the system.

126. The system of claim 124, wherein the nucleic acid sequences have been identified by the system as having a correlation to NIDDM.

127. A method for numerically assigning importance to each relationship identified using the system of claim 1 comprising the steps of:
identifying one or more co-occurrences of objects within one or more topical sets in a domain of information; and
evaluating the probability that one or more co-occurrences of objects represents a meaningful relationship within one or more topical sets.

128. The method of claim 127, wherein the importance is a function of the number of times two objects are co-mentioned within the topical set in the domain of information.

129. The method of claim 127, wherein the importance is a function of the textual distance between two objects.

130. The method of claim 127, wherein the importance is based on an external measure of the topical set, wherein the external measure is selected from the group consisting of importance, relevance, and quality.

131. The method of claim 127, wherein the importance includes an evaluation of one or more co-occurrence patterns over time.

132. The method of claim 127, wherein a natural language processing engine is used to identify one or more co-occurrences of objects.

133. The method of claim 127, wherein contextual information within the topical set is used to assign importance.

134. The method of claim 133, wherein contextual information within the topical unit of text is used to assign a nature to the relationship.

135. The method of claim 127, wherein importance is veracity.

136. A method of finding implicit relationships comprising the steps of
identifying one or more objects directly related to one or more query objects as a set of directly related objects;
identifying one or more objects related to the set of directly related objects as a set of implicitly related objects; and
quantitatively evaluating each implicitly related object to determine a probability that it shares a meaningful relationship with the query object by deriving an importance score and a veracity score.

137. The method of claim 136, wherein quantitative evaluation further comprises a probability that a statistically similar relationship could be observed by chance.

138. The method of claim 136, wherein a formula (6) according to
$$P ( A ↔ {B}_{1}^{n} ) = {\sum }_{1}^{n} 1 - ( 1 - \frac{{K}_{A}}{Nt} ) * ( 1 - \frac{{K}_{{B}_{1}}^{ n}}{Nt} ) . \qquad ( 6 )$$
is used.

139. A method of identifying relationships shared by one or more objects in a set comprising a plurality of objects; comprising the steps of:
enumerating a set of objects;
identifying all new objects related to the set from a data source; and
quantitatively evaluating the statistical significance that the new object is related to the set.

140. The method of claim 139, wherein objects that link other objects to the set are identified and used to identify one or more relationships common to the set.

141. The method of claim 139, wherein one or more topical groupings in the set are identified and distinguished from random groupings based on their cohesiveness.

142. The method of claim 139, wherein the new object is added to the set if the statistical significance meets a selected value.

143. The method of claim 139, wherein at least one object corresponds to a biomolecule arrayed on a microarray, a biomolecule that binds to an array, a gene, an expression value of a biomolecule, a phenotype, a disease, a small molecule, a chemical compound, a metabolite, a drug, a therapeutic agent, a candidate gene, an expressed sequence, and combinations thereof.

144. The method of claim 143, wherein the expression value comprises 0 or 1, wherein 0 is not expressed and 1 is expressed.

145. The method of claim 143, the expression value comprises a quantitative measure of expression.

146. The method of claim 143, wherein the set comprises objects which include expression values and the new object comprises an expression value.

147. The method of claim 146, wherein the expression value of the new object is evaluated to determine its relationship to known objects of the set.

148. The method of claim 139, wherein a quantitative evaluation of the probability that the new object shares a meaningful relationship with the set is determined by deriving an importance score and a veracity score.

149. The method of claim 139, wherein quantitative evaluation further comprises a probability that a statistically similar relationship could be observed by chance.

150. A data structure comprising an implicit relationship as set forth in FIG. 25.

151. A computer program product stored on a computer readable medium comprising program code for executing functions of the system of any of claims 1, 30, 35, 38, 40 or 42, and 124.

152. The method of claim 71, wherein the drug is sildenafil.
